(19) United States
(12) Patent Application Publication
(10) Pub. No.: US 2016/0062954 A1
(43) Pub. Date: Mar. 3, 2016

(54) FLEXIBLE HIGH-SPEED GENERATION AND FORMATTING OF APPLICATION-SPECIFIED STRINGS

(71) Applicant: NumberGun LLC, Salt Lake City, UT (US)

(72) Inventors: Eric J. Ruff, Provo, UT (US); John W. Ogilvie, Salt Lake City, UT (US)

(21) Appl. No.: 14/425,046

(22) PCT Filed: Sep. 6, 2013
(86) PCT No.: PCT/US13/58410

§ 371 Date: Mar. 1, 2015

Related U.S. Application Data
(60) Provisional application No. 61/701,630, filed on Sep. 15, 2012.
(60) Provisional application No. 61/716,325, filed on Oct. 19, 2012.

(51) Int. Cl. G06F 17/21; G06F 9/45; G06F 17/27

(52) U.S. Cl. CPC G06F 17/212; G06F 17/2705; G06F 8/41

(57) ABSTRACT

Flexible high-speed generation and formatting of application-specified strings is available through table-based base conversion which may be integrated with custom formatting, and through printf-style functionality based on separate control string parsing and specialized format command sequence execution. Mechanisms include digit group tables for immediate output with or without separation characters, dynamic format templates, format localization and customization, funnels, digit extraction in left-to-right or right-to-left order, scaling and size estimation, leading bit identification, casting, indexing with exponent bits, division via multiplication by select constants and shifts, fractional value manipulations, batching transformations, stamping safety zones, rounding tools, JUMP and CALL avoidance, tailoring to processor characteristics and word size, conversions between various numeric types and representations, command stitching, stack parameter analysis, printf compilation, and others. Tools are also provided for web page rendering, embedded and realtime systems, various other application areas, string length determination, string copying, and other string operations.

### MATERIAL INCORPORATED BY REFERENCE

The present document incorporates by reference the entirety of U.S. provisional patent application Ser. No. 61/701,630 filed Sep. 15, 2012, and the entirety of U.S. provisional patent application Ser. No. 61/716,325 filed Oct. 19, 2012. To the full extent permitted by applicable law, the present document also claims priority to each of these incorporated applications. Pursuant to the United States Patent and Trademark Office Manual of Patent Examining Procedure §502.05, all material in the following American Standard Code of Information Interchange (ASCII) text file is also incorporated herein by reference: file name “Listing_{—}6058-2-3A.txt”, file creation date is Sep. 6, 2013, file size in bytes is 89,565 (size on disk may differ).

### COPYRIGHT AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

In particular, and without excluding other material, this patent document contains original assembly language listings, tables, C and C++ code listings, pseudocode, and other works, which are individually and collectively subject to copyright protection and are hereby marked as such under formal notice: Copyright NumberGun LLC, 2012, All Rights Reserved.

### BACKGROUND

Many software applications and computing systems at some time display numbers, on a display screen, in printed reports, on web pages, or elsewhere. Many programs use floating-point and/or integer numbers which are converted from their native binary format into a human-readable decimal format. Such applications run on desktop computers, laptops, mainframes, and servers, for example.

Environments for writing software in C, C++, C#, Java, .NET languages, and many other programming languages provide developers with functions to format binary representations of numeric values into one or more corresponding decimal representations, and with printf-style formatting functions. As used herein, “printf-style functions” include functions or other programming language statements which accept as input a format control string and zero or more other parameters, and produce an output string which is formatted according to the format control string and which includes values obtained from other parameters when other parameters are present. Sometimes formatting is implicit in the choice of printf-style function used, e.g., a WriteLine( ) or println( ) function would be expected to include a newline at the end of the output string even without an explicit newline in the format control string.

Many printf-style functions accept a variable number of parameters (i.e., different invocations of the function may pass a different number of parameters), while other printf-style functions expect a fixed number of parameters. Most printf-style functions of interest herein either accept a variable number of parameters, or accept a fixed number of parameters which however include at least one parameter in addition to a format control string. Parameters may be “passed” to a printf-style function via a call stack, one or more global variables, one or more registers, or another data transfer mechanism.

Some examples of printf-style functions include printf( ) itself, C-based language variations such as sprintf( ) and fprint( ) FORTRAN's FORMAT-statement-controlled PRINT statement, and a great many others. Printf-style functions are often, but not always, named using some variation of a term such as “display”, “echo”, “message”, “out”, “print”, “put”, or “write”, for example. Some printf-style functions use ‘%’ to refer 945 to parameter positions in a format control string, e.g., “printf(“Max=% d Min=% d”, max, min);” and some use curly braces, e.g., “String.Format(“Max={0} Min={1}”, max, min);” as references 945. Others may use different syntax.

### SUMMARY

Flexible high-speed generation and formatting of application-specified strings is available through table-based base conversion which may be integrated with custom formatting, and through printf-style functionality based on separate control string parsing and specialized format command sequence execution. Mechanisms include digit group tables for immediate output with or without separation characters, dynamic format templates, format localization and customization, funnels, digit extraction in left-to-right or right-to-left order, scaling and size estimation, leading bit identification, casting, indexing with exponent bits, division via multiplication by select constants and shifts, fractional value manipulations, batching transformations, stamping safety zones, rounding tools, JUMP and CALL avoidance, tailoring to processor characteristics and word size, conversions between various numeric types and representations, command stitching, stack parameter analysis, printf compilation, and others. Tools are also provided for web page rendering, embedded and realtime systems, various other application areas, string length determination, string copying, and other string operations.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system having at least one processor and at least one memory which interact with one another under the control of software and/or circuitry, and other items in an operating environment which may be present on multiple network nodes, and also illustrating configured storage medium (as opposed to a mere signal) embodiments;

FIG. 2 is a block diagram illustrating aspects of architectures for base conversion, custom formatting, and/or printf-style functionality;

FIG. 3 is a flow chart illustrating steps of some process and configured storage medium embodiments;

FIG. 4 is table of special numeric values, which are denoted here “MagicNumbers”, suitable for use in some embodiments;

FIGS. 5 and 6 collectively illustrate a jump table suitable for use in some embodiments; and

FIG. 7 is a flow chart illustrating realtime control loop steps of some embodiments.

### DETAILED DESCRIPTION

Technical Computing

Providing a sufficiently rapid formatting of output strings without an unacceptable loss of flexibility, in a given program, is often a technical challenge. Flexibility is important because these functions are sometimes used to produce an enormous variety of output strings even within a single program, such as output strings of various lengths, with various types of parameters at various positions within the output string, and with various numbers of parameters in different output strings of the program. Processing speed is important because these functions are sometimes used many times within a single program, and because they are sometimes used in programs that require a large amount of rapid processing to perform the other parts of the program, namely, the parts the output strings report on or otherwise reflect.

Improving the processing speed and/or flexibility of formatting without breaking or hampering existing software presents a technical challenge for most developers. Most developers do not have the resources or technical training to improve the internal mechanisms of numeric base conversion functions or printf-style functions, even if they were to devote time and energy to that effort, which would detract from their primary work. Most developers are quite properly focused instead on the business logic, algorithms, data structures, and other aspects of their particular application area, e.g., accounting, business applications, customer relationship management, ecommerce, education, games, medical applications, robotics, simulations, and so on, to name just a few of the many application areas in which numeric base conversion functions and printf-style functions are used. Indeed, most programmers who use numeric base conversion functions and/or printf-style functions (collectively, “formatting functions”) did not write, and have likely never even seen, the source code for the formatting functions that they frequently invoke in their own programming.

More generally, algorithm analysis and related inquiries about software or hardware functionalities may be called for when identifying technical problems and possible solutions, to determine for instance what tradeoffs would be made as to storage usage, reliability, accuracy, processing speed, usability—developer convenience and comprehension, compatibility with existing software, scope of inputs (number, type, range), error handling, thread-safety, scalability, code maintainability, code portability, transparency and functionality interfaces, and/or other technical aspects of various possible applications of the teachings herein.

Mathematics and computer programming are not the same thing. For example, the number ⅓ has an exact meaning in arithmetic, and there is only one zero on a mathematical number line. But in computing ⅓ cannot be represented exactly in standard binary floating point format, and some formats represent zero in a computer memory in two or more ways.

More generally, mathematics is abstract and unlimited—the rule for adding two numbers is the same no matter how large or small the numbers may be, no matter how accurately they are displayed, and no matter how quickly the addition is performed. By contrast, computer programming involves specific choices between different ways to accomplish a result, and tradeoffs between those choices, and limits on the input values that can be processed.

As another example of how mathematics and programming differ, consider the problem of sorting a list, such as a list of numbers or a list of names. From a mathematical perspective, it makes no difference how long each name is or how large each number is, and it makes no difference whether the list contains ten items or ten million items.

But to a person of skill in technical computing, these things could make a big difference. A computer programmer could choose between different ways to sort items (bubble sort, selection sort, insertion sort, shell sort, comb sort, merge sort, and so on). Each sorting algorithm has relative technical advantages or disadvantages, depending on factors such as the length of the list and the extent to which the list is already partially sorted. The programmer could choose between different ways of representing names as a whole, such as arrays, linked lists, or balanced trees, and between different ways of representing the individual names, such as single- or double-byte characters, and null-terminated versus other strings. A single number likewise has different possible representations in software.

The programmer might also consider questions such as whether the list items are compressed and/or encrypted, whether they are buffered, how long they persist in memory, whether their source is to be authenticated, whether checksums or other error detection mechanisms are used on them, and characteristics of data sources that provide the list items, e.g., whether they come over a network link or are generated dynamically locally (possibly with a random element).

The programmer may discover or be given performance constraints, such as limits on how slowly or how quickly list items can be processed, and limits on how much memory can be used to store list items and to process them. The programmer may be concerned with whether the sorting effort is distributed among multiple threads or multiple networked machines, and then consider how the list items are distributed and how the sorted list items are gathered (if they are gathered) for delivery. There may be other programming considerations as well.

The technical character of embodiments described herein will be apparent to one of ordinary skill in the art, and will also be apparent in several ways to a wide range of attentive readers.

First, some embodiments address the technical problem of excessive time spent in printf-style functions, which detracts from the core calculations of a program—a server for example should spend as much processing resource as possible on serving instead of spending cycles on formatting server log content.

Second, some embodiments include technical components such as computing hardware which interacts with software in a manner beyond the typical interactions within a general purpose computer. For example, in addition to normal interaction such as memory allocation in general, memory reads and writes in general, instruction execution in general, and some sort of I/O, some embodiments described herein perform runtime compilation of output format control strings, and some build a format-string-specific table of formatting commands instead of relying on standard functions such as putc( ) puts( ) and strcpy( ) Some perform numeric base conversion using technical insights that are not obvious from mere mathematical understanding of the concept of base conversion.

Third, technical effects provided by some embodiments include the extreme reduction or even the elimination of if-statements within a printf-style function implementation. Some embodiments include the use of particular numeric constants (denoted MagicNumbers) to speed up computation.

Fourth, some embodiments include technical adaptations such as justification and other formatting commands that provide greater flexibility than familiar printf-style format control string commands. Some adapt the concept of lookup tables to specific base conversion, formatting, and/or other computations.

Fifth, some embodiments modify technical functionality of existing software by providing DLL (dynamically linked library) files based on technical considerations such as the separation of formatting into a format control string parsing phase followed by a format-control-string-specific runtime formatting phase.

Sixth, some embodiments apply the abstract idea of parsing in a technical manner by parsing a format control string at runtime and then creating a custom printf-style implementation (tabular in some cases, stitched-fragment in some) during a runtime formatting that is guided by the parsing results.

Seventh, technical advantages of some embodiments include improved usability and simplified development through the addition of justification control and other enhancements, reduced hardware and energy requirements in configurations such as server farms that were spending a significant amount of cycles on the production of logs or other formatted output, faster processing of printf-style functions, and reduced processing workloads for processors that format output strings such as occurs when creating any web page.

Eighth, some embodiments apply concrete technical means such as parsing, table construction, and stitching together code fragments to obtain particular technical effects such as customized and optimized printf-style functions that are directed to the specific technical problem of rapidly producing multiple output strings which all conform to the same given format control string, thereby providing a concrete and useful technical solution.

Some embodiments described herein may be viewed in a broader context. For instance, concepts such as base two, base ten, compilation, digit grouping, indexing, lookup tables, multiplication, number base conversion, parsing, pointers, and/or processing cycles may be relevant to a particular embodiment. However, it does not follow from the availability of a broad context that exclusive rights are being sought herein for abstract ideas; they are not. Rather, the present disclosure is focused on providing appropriately specific embodiments. Other media, systems, and methods involving applications of the various concepts are outside the present scope. Accordingly, vagueness and accompanying proof problems are also avoided under a proper understanding of the present disclosure.

Multiple Innovations

The present document describes multiple innovations, which can be combined with one another in different groups or used individually. For example, innovative tools and techniques for extremely fast binary-to-decimal conversion can be used apart from, or together with, innovative printf-style functionality that is also described herein. This separability exists, even though for convenience both numeric base conversion functions and printf-style functions are referred to collectively herein as “formatting functions”. At a finer granularity, teachings which are described in their own respective sections, paragraphs, examples, steps, components, or claims, may be used with one another in some embodiments and individually in other embodiments. All combinations and separations of these disclosed sections, paragraphs, examples, steps, components, and claims are contemplated by the inventors as embodiments which are or can be presented in claims, with the sole exception of those combinations which are inoperable or logically impossible (e.g., an embodiment cannot simultaneously contain and be free of a given feature).

### SOME TERMINOLOGY AND DEFINITIONS

Reference is made below to exemplary embodiments, and specific language will be used herein to describe the same. Definitions are given for some of the terminology used in the descriptions. However, alterations and further modifications of the features illustrated herein, and additional applications of the principles illustrated herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) having possession of this disclosure will understand that other examples may also fall within the meaning of the terms used, and within the scope of one or more claims. Terms do not necessarily have the same meaning here that they have in general usage, in the usage of a particular industry, or in a particular dictionary or set of dictionaries. The inventors assert and exercise their right to their own lexicography. Terms may be defined, either explicitly or implicitly, here in the Description and/or elsewhere in the application file. Some definitions are given in this section, while others appear elsewhere in the application. Explicit definitions are signaled by quotation, by the word “namely,” by the indicator “i.e.,” and/or by similar signals. Signals such as “e.g.,” and “for example” indicate partial (non-exclusive) definitions.

Processor instructions are not specific to a particular processor unless so indicated. This point is often (but not always) emphasized by placing the instruction in all-caps and using an English word instead of a name coined as part of a processor instruction set. Thus, JUMP refers to a processor instruction to jump to another instruction at some location specified along with the JUMP, CALL refers to a processor instruction (or typical sequence of instructions) to make a function call, RETURN refers to a processor instruction to return from a function call, DIVIDE refers to a division instruction, MULTIPLY refers to a processor instruction to perform a multiplication operation, SHIFT refers to bitwise shifting, and so on.

As used herein, a “computer system” may include, for example, one or more servers, motherboards, processing nodes, personal computers (portable or not), personal digital assistants, smartphones, cell or mobile phones, other mobile devices having at least a processor and a memory, telemetry system, realtime control system, logger, computerized process controller, and/or other device(s) providing one or more processors controlled at least in part by instructions. The instructions may be in the form of firmware or other software in memory and/or specialized circuitry. In particular, although it may occur that many embodiments run on workstation, server, or laptop computers, other embodiments may run on other computing devices, and any one or more such devices may be part of a given embodiment.

A “multi-threaded” computer system is a computer system which supports multiple execution threads. The term “thread” includes code capable of or subject to scheduling (and possibly to synchronization), and may also be known by another name, such as “task,” “process,” or “coroutine,” for example. The threads may run in parallel, in sequence, or in a combination of parallel execution (e.g., multi-processing) and sequential execution (e.g., time-sliced). Multi-threaded environments have been designed in various configurations. Execution threads may run in parallel, or threads may be organized for parallel execution but actually take turns executing in sequence. Multi-threading may be implemented, for example, by running different threads on different cores in a multi-processing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware unit such as a thread-processing unit or a core in a simultaneous multi-threading implementation. As another example, a hyper-threaded quad-core chip running two threads per core has eight logical processors. A logical processor includes hardware. The term “logical” is used to prevent a mistaken conclusion that a given chip has at most one processor. Processors may be general purpose, or they may be tailored for specific uses such as graphics processing, signal processing, floating-point arithmetic processing, encryption, I/O processing, and so on.

A “multi-processor” computer system is a computer system which has multiple logical processors. Multi-processor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Kernels” include operating systems, hypervisors, virtual machines, BIOS code, and similar hardware interface software.

“Code” means processor instructions, macros, data (which includes constants, variables, and data structures), comments, or any combination of instructions, macros, data, and comments. Code may be source, object, executable, interpretable, generated by a developer, generated automatically, and/or generated by a compiler, for example, and is written in one or more computer programming languages (which support high-level, low-level, and/or machine-level software development). Code is typically organized into functions, variable declarations, modules, and the like, in ways familiar to those of skill in the art. “Function,” “routine,” “method” (in the computer science sense), and “procedure” or “process” (again in the computer science sense, as opposed to the patent law sense) are used interchangeably herein.

“Program” is used broadly herein, to include applications, kernels, drivers, interrupt handlers, libraries, DLLs, and other code written by programmers (who are also referred to as developers).

As used herein, “include” allows additional elements (i.e., includes means comprises) unless otherwise stated. “Consists of” means consists essentially of, or consists entirely of. Thus, X consists essentially of Y when the non-Y part of X, if any, can be freely altered, removed, and/or added without altering the functionality of claimed embodiments so far as a claim in question is concerned.

“Process” is sometimes used herein as a term of the computing science arts, and in that technical sense encompasses resource users, namely, coroutines, threads, tasks, interrupt handlers, application processes, kernel processes, procedures, and object methods, for example. “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose or special-purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein.

Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

Throughout this document, use of the optional plural “(5)”, “(es)”, or “(ies)” means that one or more of the indicated feature is present. For example, “processor(s)” means “one or more processors” or equivalently “at least one processor”.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest, such as the combinable and separable steps of accessing, adding, adjusting, aligning, calling, casting, communicating, compiling, conforming, controlling, converting, creating, customizing, defining, determining, displaying, dividing, executing, formatting, generating, having, identifying, implementing, including, indexing, initializing, invoking, jumping, looping, making, moving, multiplying, obtaining, outputting, overwriting, parsing, performing, popping, processing, producing, providing, pushing, residing, returning, scaling, selecting, shifting, specifying, stamping, stitching, subtracting, testing, utilizing (and accesses, accessed, adds, added, and so on) with regard to a destination or other subject may involve intervening actions (steps) such as authenticating, compressing, copying, decoding, decompressing, decrypting, downloading, encoding, encrypting, forwarding, invoking, moving, reading, storing, uploading, writing, and so on by some other party, yet still be understood as being performed directly by the party of interest.

An embodiment may include any means for performing a step or act recognized herein (e.g., recognized in the preceding paragraph and/or in the list of reference numerals), regardless of whether the means is expressly denoted in the specification using the word “means” or not, including for example any mechanism or algorithm described herein using a code listing, provided that the claim expressly recites the phrase “means for” in conjunction with the step or act in question. For clarity and convenience, the reference numeral for the step or act in question also serves as the reference numeral for such means when the phrase “means for” is used with that reference numeral, e.g., “searching means (640) for searching for a null that terminates a string”.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. Unless expressly stated otherwise in a claim, a claim does not cover a signal per se or a propagated signal per se. A memory or other computer-readable storage medium is not a propagating signal or a carrier wave outside the scope of patentable subject matter under United States Patent and Trademark Office (USPTO) interpretation of the In re Nuijten case.

Moreover, notwithstanding anything apparently to the contrary elsewhere herein, a clear distinction is to be understood between (a) computer readable storage media and computer readable memory, on the one hand, and (b) transmission media, also referred to as fleeting media or signal media, on the other hand. A transmission medium is a propagating signal or a carrier wave computer readable medium. By contrast, computer readable storage media and computer readable memory are not propagating signal or carrier wave computer readable media. Unless expressly stated otherwise, “computer readable medium” means a computer readable storage medium, not a propagating signal per se.

The terms “parm” and “parameter” refer to each of one or more parameters passed to a function. For example, “parm1” would refer to the first user-specified variable on the stack, after the buffer parameter and NG_FORMAT parameters, for the ngFormat( ) command.

Programming Language Syntax Choices

Those of skill will understand the three-tiered approach taken herein. At the highest level, various concepts are discussed; they provide context but are not themselves claimed. Some examples include the concepts of converting a numeric representation from binary to decimal, sorting a list of items, and formatting an output string according to specified criteria. At the next level down, embodiments are described. Embodiments apply concepts and principles to specific problems in specific ways, and are suitable subject matter for claims. Examples include the claims presented, and any combination of the components and steps described in the text and/or figures as pieces of an embodiment. At the lowest level, some examples of embodiment implementations are given herein, even though this is not a legal requirement for an enabling written description of claimed innovations. Implementations help illustrate features of embodiments. However, unless a claim states otherwise, a given embodiment may be implemented in various ways, so an embodiment is not limited to any particular implementation, including any particular code listing, choice of programming language, variable name, or other implementation choice. C/C++ code examples are given using C/C++ syntax as used by Microsoft Visual Studio® 2008 Professional (mark of Microsoft Corporation). This does not rule out implementations using other syntax and/or other programming languages.

Assembly-language examples herein use the FASM (Flat Assembler) assembly-language syntax used by the popular Flat Assembler product, which is freely available at www dot flatassembler dot net, as FASM syntax is somewhat clearer than the MASM (Microsoft Macro Assembler) syntax that many skilled in the art might use (web addresses herein are for convenience only; they are not meant to incorporate information and not meant to act as live hyperlinks). However, one of skill will understand either syntax. In some C/C++ examples where the_asm syntax is used, the examples used are written in the assembly syntax supported by 32-bit Microsoft Visual Studio® 2008 source code (mark of Microsoft Corporation).

For example, the FASM instruction “mov eax, triplets” will move the memory address of the “triplets” variable into the eax register, whereas the FASM instruction “mov eax, [triplets]” will move the value stored in the “triplets” variable, or the contents of the variable, into the eax register. In FASM, using brackets means code is to access the value located at that location, whereas no brackets around a memory location or variable name means code is to access the address of that location or variable. This is different from MASM syntax, where the above examples would both operate the same and would both access the value, and not the address, whether brackets are used or not. One of skill in the art of assembly language would know that certain registers, notably ebx, esi, edi, and ebp, should be appropriately preserved prior to their first use and then restored when no longer needed. Additionally, such a skilled person would ensure that registers are properly initialized to prevent unintended effects of certain CPU commands that modify more than one register (such as the MUL command which can modify both edx and eax), or which use implicit values from one or more other non-specified registers (such as the DIV command, which relies on the value in both edx and eax) or flag values (such as SBB and ADC), in addition to other effects based on previous and/or succeeding code paths.

Additionally, when assembly language is used or assumed in use, the following terms may be used to describe the size of a variable or memory location: byte or char (8 bits), word (16 bits), double word or dword (32 bits), quad word or qword (64 bits), and double quad word or dqword (128 bits). A word has two bytes (a lower and an upper); a dword has two words (a lower and an upper); and a qword has two dwords (an upper and a lower); and so forth. The lower portion is the lower half of the bits of the variable or memory location, whereas the higher portion is the upper half. Additionally, the term “natural-word-size” indicates the bit size of the current execution environment (usually 32 or 64 bits). Sometimes the term “word” is used generically where the size could be one of several of the above sizes, in which case the context will make clear which size (or sizes) are intended. Sometimes the term “char” is used to refer to either a one-byte character or a two-byte character; the context will make it clear which type is referred to, or in some cases, it can refer to both types.

Although Intel® CPU architectures (mark of Intel Corporation) are used in many examples, including in discussions of floating-point numbers, a person skilled in the art will recognize that teachings herein also apply to some other processor architectures. CPU stands for Central Processing Unit, an older term for processor or microprocessor.

The Intel® CPU platform includes intrinsic operations that can perform mathematical and logical instructions on integers (whole numbers) of various sizes: 8-bit (byte), 16-bit (short or word), 32-bit (int or dword), 64-bit (long or qword or long long or also, confusingly, int). Each integer can be either signed or unsigned. Other sizes can be created by adding bytes to any native size, although custom coding may be called on to handle those formats. Intel may well add native processor support for 128-bit numbers; there is already some Intel® processor support for handling both 128-bit and 256-bit data objects.

An Intel® FPU (Floating Point Unit, a.k.a. math coprocessor or numeric coprocessor) includes native support for three types of signed floating-point (real) numbers: 32-bit (float), 64-bit (double), 80-bit (extended precision). The Intel CPU also provides additional register/coprocessor floating-point technology that makes other registers and instructions available to those of skill when implementing the teachings in the present disclosure, such as an MMX instruction set, streaming SIMD (single instruction multiple data) extensions SSE, SSE2, SSE3, SSSE3, SSE4, an AVX instruction set extension, and others.

Since the CPU's main registers deal natively with integer types only, other coprocessors (such as the FPU) and registers (such as MMX and XMM registers) include basic support for transferring real numbers and integers to/from memory, for manipulating floating-point numbers, and for converting between integers and floating-point numbers.

As is known in the art, familiar 32-bit Intel® CPUs have eight general-purpose registers: eax, ebx, ecx, edx, esi, edi, ebp, and esp (“Intel” is a mark of Intel Corporation). The eax, ecx, and edx registers are generally available for use immediately when a function receives control, while the ebx, esi, edi, ebp, and esp registers should be preserved and used carefully so as not to corrupt the program flow. The eflags register contains flags (such as ‘zero’, ‘overflow’, and ‘carry’), and the eip instruction pointer points to the current instruction. The 64-bit Intel® CPU architecture expands those general-purpose registers to 64 bits (rax, rbx, rcx, rdx, rsi, rdi, rbp, and rsp, plus rflags and rip), while still retaining the ability to access the low 32 bits (or fewer) of those registers using 32-bit mnemonics, and adds eight additional registers (r8, r9, r10, r11, r12, r13, r14, and r15). While most examples herein are described for Intel® and Intel-compatible CPU environments and architectures, the concepts apply to other CPU environments and architectures as well, and the claims, unless specifically stated otherwise, include non-Intel CPU environments and/or architectures as well.

Some Additional Terminology

Binary integer numbers used internally by a CPU are maintained in a binary format as base-two numbers. Some embodiments described herein convert numbers from the base-two binary format used internally by the CPU into a human-readable base-ten format using ASCII display codes. One term used herein to refer to a desired output format is “ASCII format” but it will be understood that character encodings other than ASCII can also be used with teachings herein, such as Unicode and the ISO/IEC 10646 Universal Character Set (UCS). The output format in some embodiments is Binary Coded Decimal rather than ASCII. The ASCII format that uses one byte per display character (or eight bits) is sometimes referred to herein as “Unicode8” or “ASCII”, while the ASCII format that uses two bytes per display character (or sixteen bits) may be referred to as “Unicode16.”

Note that Unicode16 takes exactly twice as many bytes in the output buffer (and in some innovative tables described herein) as compared to Unicode8 when representing numbers converted to ASCII format. Other than this, one of skill may find no significant issues that impact porting the innovative algorithm between Unicode8 and Unicode16. Some examples herein assume the use of Unicode8, but many methods and structures taught herein can be readily adapted to Unicode16 by a person skilled in the art of computer programming.

### LIST OF REFERENCE NUMERALS

The following list is provided for convenience and in support of the drawing figures and the text of the specification and text, which describe a large number of innovations by reference to multiple items. Items not listed here may nonetheless be part of a given embodiment. For better legibility of the text, a given reference number is recited near some, but not all, recitations of the referenced item in the text. Those of skill will understand that omission of a reference numeral at a particular recitation therefore does not mean some other item is being recited. The list is: 100 operating environment; 102 computer system; 104 user; 106 peripheral; 108 user interface; 110 network; 112 processor (a.k.a. CPU, without limitation to general-purpose processing; “a.k.a.” means “also known as”); 114 computer-readable storage medium, e.g., memory; 116 instructions (a.k.a. code, software); 118 data; 120 hardware circuitry (includes embedded microcode, infrastructure such as printed circuit board); 122 display; 124 Integrated Development Environment (IDE); 126 compiler; 128 document, e.g., paper document, software interface and/or other electronic document; 130 library, e.g., .DLL file, .O file, other collection of software routines reusable in various applications; 132 program; 134 code, e.g., source code, object code, library code, executable code, static or dynamic table; 136 software, a.k.a. software logic; 202 digital-base conversion module; 204 printf-style function library; 206 processor register; 208 number to transform, e.g., to base convert; 210 converted output, e.g., formatted decimal, and/or result of printf-style function call; 212 output buffer; 214 output buffer pointer; 216 table; 218 lookup table, e.g., to identify scale or help scale a number; 220 table to identify a factor to subtract; 222 funnel compare statements, e.g., if-then statements to identify scale; 224 digit group, e.g., triplet value, in tables and/or output; 226 stack buffer; 228 separation character (a.k.a. separator); 230 entry size table; 232 jump table; 234 table for immediate output, e.g., without divide and without multiply (a.k.a. digit group table, triplets table); 236 table of addresses to string representations; 238 table of powers of P, where P is a power of ten; 240 user-specified template defining, e.g., digit groups, separation character, decimal point character; 242 decimal point character; 244 output-buffer template; 246 pad character(s); 248 negative number format character(s); 250 currency symbol; 252 notation, e.g., exponential notation, scientific notation; 254 rounding; 256 size, e.g., number of bits, number of bytes, number of triplets, or range; 258 lookup table with divisor or MagicNumber reciprocal plus shift value; 260 rounding table; 262 table for size estimate, e.g., table of MSB bytes for base-ten estimate, FirstTripletCommaSize; 302 transform (convert) binary to formatted decimal; 304 multiply by reciprocal, e.g., using MagicNumber; 306 execute code; 308 shift; 310 output formatted decimal left-to-right; 312 output formatted decimal right-to-left; 314 use lookup table, e.g., to identify scale; 316 transform binary to formatted decimal without divide; 318 identify scale; 320 send formatted output to a CPU; 322 use if-then statements, e.g., to identify scale, to choose next action; 324 transform binary to formatted decimal without divide and without multiply; 326 identify triplet values; 328 obtain an immediate output string by table lookup; 330 find most-significant triplet; 332 push or pop a stack buffer; 334 obtain the size of a digit grouping; 336 eliminate or reduce reversing decimal-display output; 338 use bits of an exponent and/or other high bits to index a table, e.g., to identify a scale factor; 340 reduce bus traffic; 342 loop or iterate, e.g., through digit groups; 344 use a table to identify a factor to subtract; 346 stamp a table entry or template format to output buffer; 348 identify a factor to subtract; 350 conserve battery power; 352 isolate digit groups; 354 scale a number; 356 identify leading bit; 358 select and/or identify and/or create MagicNumber; 360 use unrolled loops; 362 convert negative number to positive number; 364 use digit groups and an output buffer pointer; 366 place digit(s), e.g., by writing digit group to output buffer; 368 adjust output buffer pointer; 370 use an offset (displacement, digit-group, lookup, or other offset); 372 test and/or verify MagicNumber and shift, if any, to use; 374 adjust register and/or variable size to account for overflows; 376 create and/or initialize table; 378 split number, e.g., split 64-bit number into 32-bit components; 380 select faster functions based on binary number size; 382 create safety zone, e.g., by padding end of table; 384 transform a value between binary integer and binary floating point; 386 use digit-group funnel; 388 prefer use of unsigned division and multiplication; 390 use a ‘reinterpret_cast’ operator or other casting operator; 392 check high dword; 394 terminate string; 396 identify the leading digit group; 398 jump, e.g., use jump table or assembly language jump instruction; 402 inspect the bits of binary number; 404 construct rounding table; 406 specify that no rounding is to occur; 408 determine estimate, e.g., log estimate(s); 410 access (read) table; 412 write (output) to output buffer, e.g., stamp substring of output into output buffer; 414 scale an index; 416 index into a table; 418 get digit-group separation character; 420 specify tables to be created and/or used; 422 use user-specified template defining, e.g., digit groups, separation character, decimal point character; 424 initialize an output-buffer template; 426 user specifies output-buffer; 428 runtime system creates output-buffer; 430 specify and/or add pad character; 432 use double-byte wide chars, e.g., in lookup tables, templates; 434 convert to immutable string for managed code; 436 use single-byte wide chars, e.g., in lookup tables, templates; 438 select output format, e.g., without changing calls for formatting individual numbers; 440 parse formatting template; 442 obtain division remainder by multiplication operation of a recently obtained quotient; 444 extract digits and/or integer portion; 446 multiplication, multiply; 448 determine number of digits; 450 perform a modulus operation; 452 display (verb), output (verb), print (verb); 454 display one after another at successive locations; 456 display one after another at same location (overwrite); 458 specify choice of managed code or native code; 460 identify number of triplets in a number; 462 specify input number characteristic(s), e.g., bit size, signed/unsigned; 464 determine and/or return size of output string; 466 tailor implementation to specific processor characteristics; 468 use floating point in financial processing; 470 check floating-point entry; 472 format with decimal point; 474 discard first digit; 476 meet performance constraints; 478 modify a separator; 480 pass analog sensor inputs (a.k.a. sensor readings) into an analog-to-digital converter; 482 control number of loops or number of steps; 484 align output; 486 produce binary values, e.g., from sensor readings; 488 indicate negative/positive value in output; 490 base convert, e.g., from binary to decimal; 492 review logged data; 494 custom format (a.k.a. speciality format); 496 determine and/or handle special case(s); 498 subtract; 500 include dummy entry in table; 502 isolate digits to the left of the decimal point; 504 convert display characters into BCD characters; 506 determine whether index first identified is exact index; 508 determine the number of iterations for conversion; 510 eliminate leading zeros in the decimal-string output; 512 convert 32-bit to 64-bit, float to double, etc.; 514 truncate; 516 convert a number into exponential notation; 518 coordinate tables; 520 specify hex values; 522 round (verb); 524 output a value of 0 for any number smaller than a minimum value; 526 place digits in right-to-left order, e.g., starting from the end of a buffer; 528 Reciprocal Method A; 530 Reciprocal Method B; 532 Reciprocal Method C; 534 place digits in left-to-right order, which can eliminate a reverse copying step; 536 convert between integer and floating-point or fixed-point; 538 use fractional values to capture digits that would otherwise be lost; 540 use 32-bit code to base convert 64-bit numbers, use 64-bit code to base convert 128-bit numbers, etc.; 542 avoid multiplying by one, e.g, replace a MULTIPLY with an ADD, or substitute or lookup the value; 544 call (a.k.a. invoke); 546 provide a printf-style interface; 548 use the smallest size number that can accommodate a specified, bounded data range; 550 group according to bit-size; 552 group according to sign; 554 group according to type; 556 group according to whether separators are used; 558 process dates and/or times; 560 batch conversion (a.k.a. batching transformation), e.g., convert multiple numbers of a single array in one call that passes the array or a pointer to the array as a parameter; 562 use prefetch instructions, e.g., pre-load a data cache; 564 overlay two or more tables; 566 test and/or debug base conversion and/or custom formatting code; 568 select rounding method; 570 use divisor that fits a specified bit-size; 572 handle large divisor; 574 use bit scan reverse instruction; 576 prepare fast output code based on a custom format string, that is, compile format string into fastcode by selecting and sequencing fastcode fragments that match the format string (may be done at runtime in conventionally compiled code); 577 select fastcode fragment; 578 execute fast output code based on a custom format string, e.g., perform printf-style formatting by executing fastcode; 579 sequence fastcode fragments relative to one another; 580 parse format control string; 582 create fastcode, e.g., a table of specific formatting instructions; 584 initialize printf compiler class; 586 incur overhead; 588 make formatting decisions, determine formatting options; 589 copy entire NG_FORMAT table or other fastcode structure; 590 parse some or all format control strings upon program start, namely, prior to invocation of printf-style function by program; 592 determine the size of a variable passed on the stack; 594 validate a fastcode structure or other item; 596 justify or pad a component; 597 identify position and/or length of a specific formatted element of a string; 598 save or otherwise use a value of a fastcode output pointer, e.g., DestPtr; 600 determine amount of justification to add; 602 copy portion of a format control string; 604 stitch fastcode commands (code fragments) together, e.g., using ngStitchCommands( ) function or similar functionality; 606 build finite state machine; 608 ensure that fastcode command with a parameter will access proper position on stack; 610 access parameter; 612 create an index into a formatted string which can be used to identify the position (and in some cases also the length) of a particular formatted element of the string; 614 convert a value into a binary string of 0's and 1's; 616 convert between lowercase and uppercase; 618 converting a value into an octal string; 620 determine code path based upon alignment; 622 determine code path based upon byte position of a 0; 624 count the number of set bits in a byte; 626 find string length; 628 copy a string or part of a string; 630 generate a hash of a string; 632 format a web page; 634 initialize output buffer; 636 determine the length of a null-terminated string; 638 traverse a string or part of a string; 640 search for a null or other character; 642 other step or steps described herein; 700 realtime control loop; 702 user sees an output value; 704 user makes a decision; 706 user sends a controlled device a control signal; 708 control signal; 710 device responds to the control signal with a physical change; 712 physical change; 714 device sends back an updated result signal; 716 result signal; 802 reciprocal; 804 scale; 806 exponent; 808 factor to subtract; 810 leading bit; 812 unrolled loop(s); 814 displacement offset; 816 lookup offset; 818 safety zone; 820 table entry (used in reference to various tables); 822 funnel, e.g., digit-group funnel; 824 reinterpret_cast or other casting operator; 826 bracket boundary; 828 bracket; 830 digit-group offset; 832 index (noun); 834 division remainder; 836 quotient; 838 signed/unsigned characteristic; 840 MagicNumber, a.k.a. magic number; 842 performance constraint, e.g., speed, memory usage; 844 analog sensor input (a.k.a. sensor reading); 846 analog-to-digital converter; 848 data-logger; 850 mechanism to support review of logged data; 852 logic controller; 854 telemetry system; 856 simulation software; 858 enhanced molecular modeling program; 860 circuit; 862 embedded system; 864 medical system, e.g., surgical system, diagnostic system; 866 assembly language code; 868 high-level language, e.g., C, C++ (as opposed to assembly language or microcode); 870 MagicNumbers class; 872 itoa function(s); 874 sign (in floating point or integer); 876 mantissa; 878 PowerOfTen value; 880 buffer or memory pool; 882 thread; 884 font; 885 character; 886 BCD character; 888 dummy entry in table; 890 special case; 891 processor clock cycle; 892 data type, e.g., floating-point or integer object or character type; 894 execution environment word size; 896 hex (hexadecimal) value; 898 integer value, integer type; 900 floating-point or fixed-point value, floating-point or fixed-point type; 902 tradeoff; 904 filtering path; 906 extraction path; 908 stack frame; 910 bit(s); 912 table of values used to identify a current triplet of a number being converted; 914 variable; 916 constant; 918 parameter; 920 stack; 922 queue; 924 printf-style interface, printf-style function; 926 number-storage format; 928 managed code; 930 native code; 932 custom functions to return times and/or dates; 934 Application Program Interface (API); 936 function; 938 function header; 940 string; 942 format control string; 943 literal portion of format control string or output string; 944 L1 or L2 data cache; 945 reference in a format control string to a non-literal parameter; 946 microcode; 948 focal points of testing; 950 array, vector, or list; 952 rounding method; 954 overhead; 956 file; 958 divisor; 960 dividend; 962 pointer (a.k.a. address); 964 IP address; 966 date and/or time; 968 global memory; 970 printf compiler; 972 fast output code based on a custom format string; 974 function such as ngParse( ) to prepare fast output code based on a custom format string; 976 function such as ngFormat( ) to execute fast output code (a.k.a. fastcode); 978 formatting command of printf-style function; 980 class with printf compiler code, e.g., one or more of items 970-976; 982 table, sequence, or other collection of fastcode instructions, e.g., NG_FORMAT structure; 984 fastcode instruction (a.k.a., command, code fragment); 986 web page; 988 class property; 990 structure that contains multiple data components, e.g., date and time structures, IP addresses; 992 parameter-passing convention; 994 default type; 996 command syntax; 998 format control string component; 1000 non-parameter format command in control string; 1002 parameter format command in control string; 1004 format type specifier; 1006 format type specifier option; 1008 structures data component; 1010 default format; 1012 fastcode header; 1014 fastcode master command; 1016 fastcode sub-component function; 1018 caller; 1020 custom formatting function created by stitching together fastcode commands; 1022 initial code path of stitched fastcode commands; 1024 exit code path of stitched fastcode commands; 1026 linking command in custom formatting function; 1028 error indicator; 1030 finite state machine; 1032 GetDigitN( ) function or functionally similar code; 1034 function to return size of a given NG_FORMAT table; 1036 DetermineEmptyStack( ) function or functionally similar code; 1038 GetActualParameterSize( ) function or functionally similar code; 1040 prefix function or functionally similar code; 1042 post-fix function or functionally similar code; 1044 position of a particular formatted element of a string; 1046 length of a particular formatted element of a string; 1048 formatted element of a string; 1050 ngFormatIndex( ) function or functionally similar code; 1052 null character; 1054 switch statement; 1056 byte; 1058 ngStitchCommands( ) function or functionally similar code; 1060 string length; 1062 hash; 1064 web page rendering template; 1066 JUMP instruction; 1068 CALL instruction; 1070 code path; 1072 offline, i.e., not during execution of a program which will later use the item created offline; 1073 runtime (runtime for a given program means while the program is executing); 1074 algorithm (this reference numeral is used with regard to various algorithms); 1076 byte-wise operation; 1078 other part or parts described herein.

Some Operating Environments

An operating environment 100 for an embodiment may include a computer system 102. The computer system 102 may be a multi-processor computer system, or not. An operating environment 100 may include one or more computing machines in a given computer system, which may be clustered, client-server networked, and/or peer-to-peer networked. An individual machine is a computer system 102, and a group of cooperating machines is also a computer system 102. A given computer system may be configured for end-users, e.g., with applications, for administrators, as a server, as a distributed processing node, and/or in other ways.

Human users 104 may interact with the computer system 102 by using displays, keyboards, microphones, mice, and other peripherals 106, via typed text, touch, voice, movement, computer vision, gestures, and/or other forms of I/O. A user interface 108 may support interaction between an embodiment and one or more human users 104. A user interface 108 may include a command line interface, a graphical user interface (GUI), natural user interface (NUI), voice command interface, and/or other interface presentations. A user interface 108 may be generated on a local desktop computer, or on a smart phone, for example, or it may be generated from a web server and sent to a client. The user interface 108 may be generated as part of a service and it may be integrated with other services, such as social networking services. A given operating environment 100 includes devices and infrastructure which support these different user interface generation options and uses.

One kind of user interface 108 is a natural user interface (NUI). NUI operation may use speech recognition, touch and stylus recognition, gesture recognition both on screen and adjacent to the screen, air gestures, head and eye tracking, voice and speech, vision, touch, gestures, and/or machine intelligence, for example. Some examples of NUI technologies include peripherals 106 such as touch-sensitive displays, voice and speech recognition subsystems, intention and goal understanding subsystems, motion gesture detection using depth cameras (such as stereoscopic camera systems, infrared camera systems, RGB camera systems and combinations of these), motion gesture detection using accelerometers/gyroscopes, facial recognition, 3D displays, head, eye, and gaze tracking subsystems, immersive augmented reality and virtual reality subsystems, all of which provide a more natural interface 108, as well as subsystem technologies for sensing brain activity using electric field sensing electrodes (electroencephalograph and related tools).

One of skill will appreciate that the foregoing peripherals, devices, and other aspects presented herein as part of operating environments 100 may also form part of a given embodiment. More generally, this document's headings are not intended to provide a strict classification of features into embodiment and non-embodiment feature classes.

As another example, a game may be resident on a Microsoft XBOX Live® server (mark of Microsoft Corporation) or other game server. The game may be purchased from a console and it may be executed in whole or in part on the server, on the console, or both. Multiple users 104 may interact with the game using peripherals 106 such as standard controllers, or with air gestures, voice, or using a companion device such as a smartphone or a tablet. A given operating environment 100 includes devices and infrastructure which support these different use scenarios.

System administrators, developers, engineers, and end-users are each a particular type of user 104. Automated agents, scripts, playback software, and the like acting on behalf of one or more people may also be users. Storage devices and/or networking devices may be considered peripheral equipment in some embodiments. Other computer systems may interact in technological ways with the computer system in question or with another system embodiment using one or more connections to a network 110 via network interface equipment, for example.

The computer system 102 includes at least one logical processor 112 (a.k.a. processor 112) for executing programs 132, compilers 126, and other software 136. The computer system, like other suitable systems, also includes one or more computer-readable storage media 114. Media 114 may be of different physical types. The media 114 may be volatile memory, non-volatile memory, fixed in place media, removable media, magnetic media, optical media, and/or of other types of physical durable storage media (as opposed to merely a propagated signal). In particular, a configured medium 114 such as a CD, DVD, memory stick, or other removable non-volatile memory medium may become functionally a technological part of the computer system 102 when inserted or otherwise installed, making its content accessible for interaction with and use by a processor 112. The removable configured medium is an example of a computer-readable storage medium 114. Some other examples of computer-readable storage media 114 include built-in RAM, EEPROMS or other ROMs, disks (magnetic, optical, solid-state, internal, and/or external), and other memory storage devices, including those which are not readily removable by users. Neither a computer-readable medium nor its exemplar a computer-readable memory includes a signal per se.

A general-purpose memory 114, which may be removable or not, and may be volatile or not, can be configured into an embodiment using items such as particular tables 216 and corresponding conversion and/or formatting code 202, 204, in the form of data and instructions, read from a removable medium and/or another source such as a network connection, to form a configured storage medium 114. The configured storage medium 114 is capable of causing a computer system 102 to perform technical process steps for data formatting and other operations as disclosed herein. Discussion of configured storage-media embodiments also illuminates process embodiments, as well as system embodiments. In particular, any of the process steps taught herein may be used to help configure a storage medium to form a configured medium embodiment.

The medium 114 is configured with instructions 116 that are executable by a processor 112; “executable” is used in a broad sense herein to include machine code, interpretable code, bytecode, and/or code that runs on a virtual machine, for example. The medium 114 is also configured with data 118 which is created, modified, referenced, and/or otherwise used for technical effect by execution of the instructions 116. The instructions and the data configure the memory or other storage medium 114 in which they reside; when that memory or other computer readable storage medium is a functional part of a given computer system 102, the instructions and data also configure that computer system. In some embodiments, a portion of the data 118 is representative of real-world items such as product characteristics, inventories, physical measurements, settings, images, readings, targets, volumes, and so forth. Data 118 is also transformed by backup, restore, commits, aborts, reformatting, and/or other technical operations. Data 118 may be stored or transmitted in such as documents 128 for subsequent use.

Although an embodiment may be described as being implemented as software instructions 116 executed by one or more processors 112 in a computing device 102 (e.g., in a general purpose computer, cell phone, or gaming console), such description is not meant to exhaust all possible embodiments. One of skill will understand that the same or similar functionality can also often be implemented, in whole or in part, directly in hardware circuitry 120, to provide the same or similar technical effects. Alternatively, or in addition to software implementation, the technical functionality described herein can be performed, at least in part, by one or more hardware logic components 120. For example, and without excluding other implementations, an embodiment may include hardware logic 120 components such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In some environments, one or more applications have code instructions 116 such as user interface code 108, executable and/or interpretable code files, and metadata. Software development tools such as compilers and source-code generators assist with software development by producing and/or transforming code, e.g., by compilation of source code into object code or executable code. The code, tools, and other items may each reside partially or entirely within one or more hardware media 114, thereby configuring those media for technical effects which go beyond the “normal” (i.e., least common denominator) interactions inherent in all hardware—software cooperative operation. In addition to processors 112 (CPUs, ALUs, FPUs, and/or GPUs), memory/storage media 114, display(s) 122, other peripherals 106 such as pointing/mouse/touch input devices, and keyboards, an operating environment 100 may also include other hardware, such as battery(ies), buses, power supplies, wired and wireless network interface cards, and accelerators, for instance. As to processors 112, CPUs are central processing units, ALUs are arithmetic and logic units, FPUs are floating-point processing units, and GPUs are graphical processing units.

A given operating environment 100 may include an Integrated Development Environment (IDE) 124 which provides a developer with a set of coordinated software development tools such as compilers, source-code editors, profilers, debuggers, libraries for common operations such as I/O and formatting, and so on. In particular, some of the suitable operating environments for some embodiments include or help create a Microsoft® Visual Studio® development environment (marks of Microsoft Corporation) configured to support program development. Some suitable operating environments include MASM (Microsoft Macro Assembler) or FASM (Flat Assembler). Some suitable operating environments include Java® environments (mark of Oracle America, Inc.), and some include environments which utilize languages such as C, Objective C, C++ or C# (“C-Sharp”), but teachings herein are applicable with a wide variety of programming languages, programming models, and programs 132, as well as with endeavors outside the field of software development per se.

In some embodiments peripherals 106 such as human user I/O devices (screen, keyboard, mouse, tablet, microphone, speaker, motion sensor, etc.) will be present in operable communication with one or more processors 112 and memory 114. However, an embodiment may also be deeply embedded in a technical system 102, such that no human user 104 interacts directly with the embodiment. Software processes may be users.

In some embodiments, the system 102 includes multiple computers connected by a network 108. Networking interface equipment can provide access to networks, using system 102 components such as a packet-switched network interface card, a wireless transceiver, or a telephone network interface, one or more of which may be present in a given computer system. However, an embodiment may also communicate technical data and/or technical instructions through direct memory access, removable nonvolatile media, or other information storage-retrieval and/or transmission approaches, or an embodiment in a given computer system 102 may operate without communicating with other computer systems.

Some embodiments operate in a “cloud” computing environment and/or a “cloud” storage environment in which computing services are not owned but are provided on demand. For example, internal computational data 118 may be generated and/or stored on multiple devices/systems in a networked cloud of systems 102, may be transferred to other devices within the cloud where it is converted into a human-readable or other format for display or printing, and then be sent to the displays 122 or printers on yet other cloud device(s)/system(s).

Formatting System Architecture Overview

The operating environment 100 includes many aspects of a formatting system architecture. In addition, some embodiments (innovations) provide a computer system 102 with a logical processor 112 and a memory medium 114, configured by circuitry, firmware, and/or software to transform electronic signals into concrete, tangible, perceptible (e.g., visual or spoken) results such as documents 128 by performing operations with a digital-base conversion module 202 and/or a printf-style function library 204, as described herein.

Some formatting system 102 embodiments provide technical effects such as decreased processing time (which can also result in both longer battery life and cooler operating temperatures), simplified software development through more powerful and flexible formatting options, and reduced hardware requirements, directed at technical problems such as enhancing the speed and/or flexibility of base conversion and/or printf-style functions for programmers who are focused on other technical areas but utilize such functions, by extending formatting functionality with runtime compilation of format control strings, and other innovations described herein.

Some systems 102 described herein include computer software for data format conversion, namely, software for converting data from an internal machine computational format into a human-readable format for displaying, printing, or otherwise outputting data. Some systems 102 provide faster methods of determining the length of null-terminated character strings, while some provide faster methods of copying and/or manipulating such strings, relative to the speed of familiar methods.

Additional details and design considerations are provided below. As with the other examples herein, the features described may be used individually and/or in combination, or not at all, in a given embodiment.

Those of skill will understand that implementation details may pertain to specific code, such as specific APIs and specific sample programs, and thus need not appear in every embodiment. Those of skill will also understand that program identifiers and some other terminology used here in discussing details are implementation-specific and thus need not pertain to every embodiment. Nonetheless, although they are not necessarily required to be present here, these details are provided because they may help some readers by providing context and/or may illustrate a few of the many possible implementations of the technology discussed herein.

Base Conversion Formatting With Tables

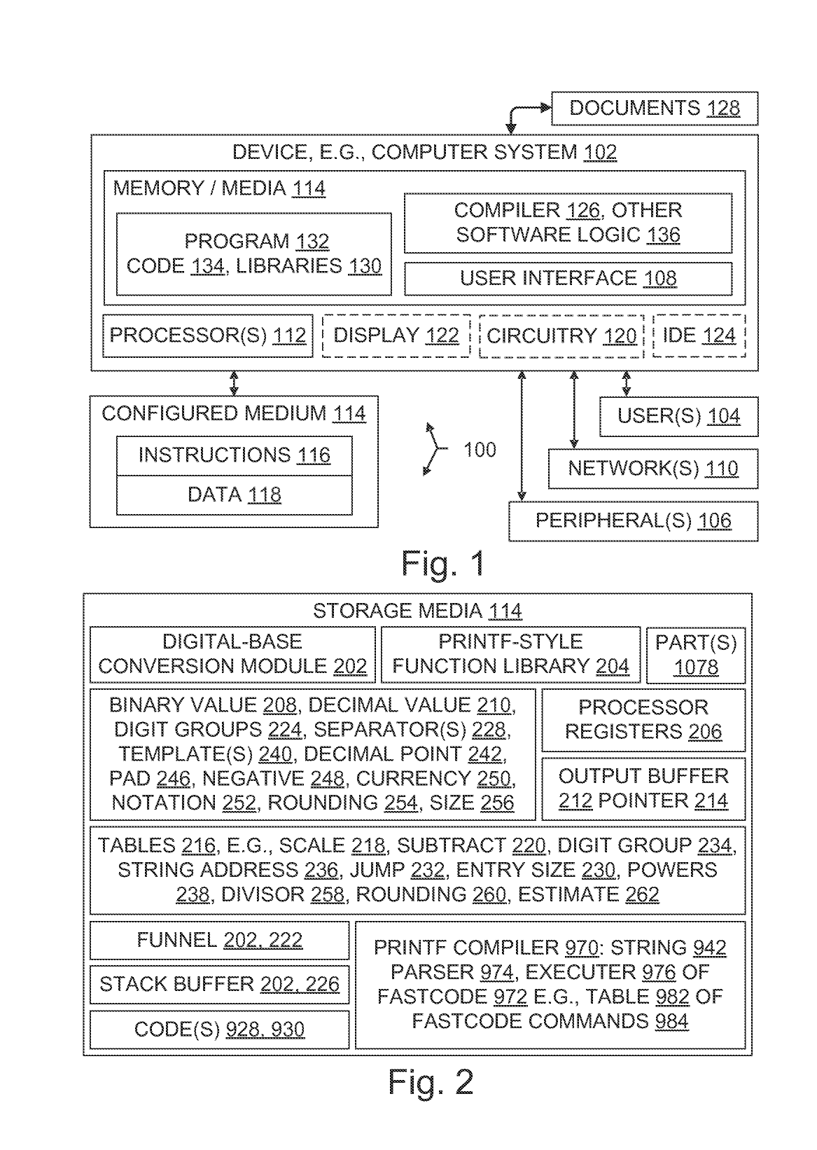

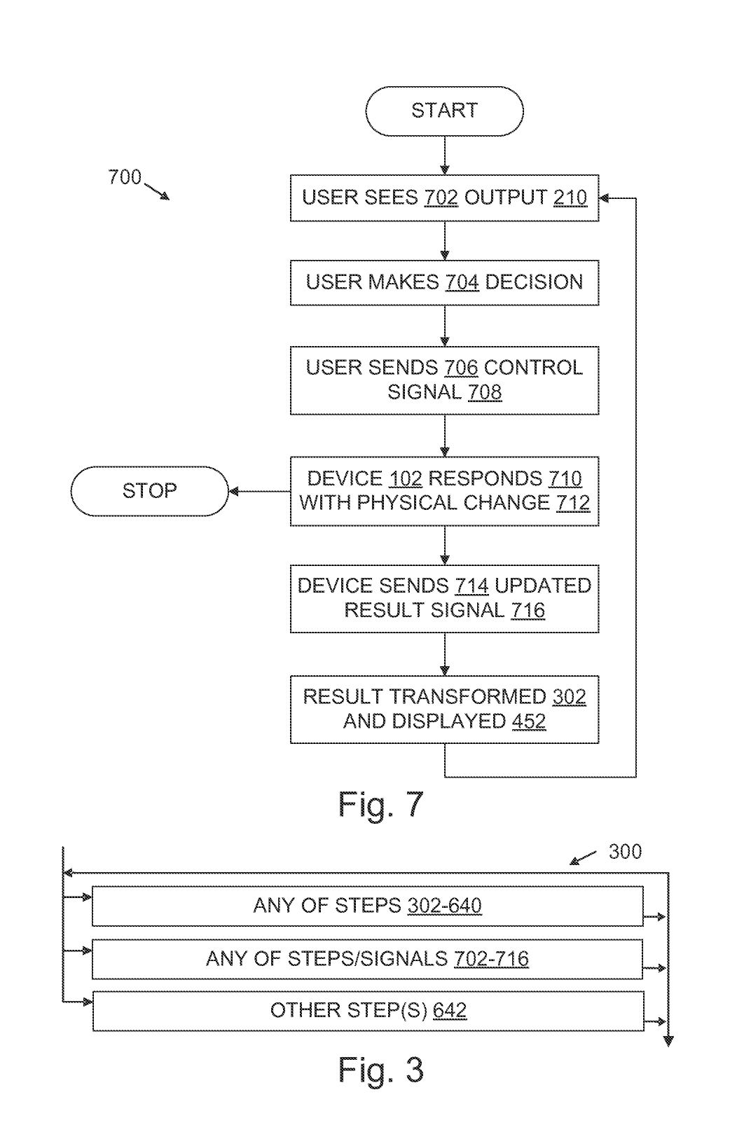

Aspects of a digital-base conversion module 202 will now be described, with reference to FIGS. 1 through 7. A given embodiment may include one, several, or many of these aspects. In some embodiments, binary integer, binary fixed-point, and/or binary floating-point values 208 are transformed 302 to formatted decimal 210, and in particular transformed 316 without integer divide or floating-point divide operation(s). Multiplication 304 by reciprocals 802 may be used instead of divides in step 316. However, as one of skill in the art understands, math is not software, so multiplying 304 by a reciprocal 802 is not always equivalent to dividing. In particular, a CPU DIVIDE operation generally provides both a complete integer quotient in one register 206 and a complete integer remainder in another register, whereas multiplying 304 by a reciprocal can provide an integer quotient in one register and a binary-fraction remainder in another, both of which may need to be shifted 308 to be complete. Also, the fact that a number has an exact representation in binary does not ensure that its reciprocal also has an exact binary representation.

In some embodiments, binary integer, binary fixed-point, and/or binary floating-point values 208 are transformed 302 into formatted decimal 210, and that output 210 is provided 310 in a left-to-right manner, namely, from most significant portion to least significant portion, rather than being provided 312 in the opposite right-to-left manner as in many familiar implementations. Some embodiments use 314 lookup tables 216, 218 to identify 318 a scale 804 for a number 208 and output 210 is provided 310 from left to right. Some embodiments use 322 if-then statements 222 to first identify 318 a size range (scale 804) for a number 208, and then output 310 the transformed number 210 from left to right. Some embodiments include a delayed-stack-buffer method wherein triplet values 224 are identified 326 in right-to-left fashion 312 as in familiar ‘itoa’ (integer-to-ASCII) implementations, via computation for performing division or reciprocal multiplication. Once the most-significant triplet is found 330, the embodiment pops 332 a stack buffer 226 to output 310 triplets 224 of the conversion result 210 in left-to-right order, thereby eliminating or reducing 336 the cost of reversing a decimal-display output that familiar implementaitons produce 312 in right-to-left order.

In some embodiments, binary integer, binary fixed-point, and/or binary floating-point values 208 are transformed 302, 324 into formatted decimal 210 without using processor 114 DIVIDE or MULTIPLY operation(s). In some embodiments for converting 302 floating-point values, bits of an exponent 806 are used 338 to index a table 218 to identify 318 a scale factor 804, then use the scale factor to loop 342 through digit groups 224 (triplets are an example of digit groups), and then use 344 a table 220 to identify 348 a factor 808 to subtract from the number. Some embodiments use multiplication rather than subtraction to isolate 352 digit groups 224. In some embodiments for converting 302 binary-integer values, the leading bit 810 is identified 356 and then used with succeeding bits to identify 318 the scale 804 of the number, with another table then used 344 to identify a factor 808 to subtract from the number. In some embodiments, the loops used 360 are unrolled loops 812.

In some embodiments, binary integer, binary fixed-point, and/or binary floating-point values 208 are transformed 316 into formatted decimal 210 without processor divide operation(s), by using digit groups 224 and an output buffer 212 pointer 214. An output buffer pointer 214, 962 may be used to place 366 digit groups in overlapping, adjacent, and/or spaced manner in the output buffer 212. In some embodiments, the output-buffer pointer is explicity adjusted and updated 368, while in others a displacement offset 814 is used 370 with the buffer 212 to identify the next position for part of the formatted decimal output, eliminating clock cycles that would otherwise be required to update the pointer.

In some embodiments, binary integer, binary fixed-point, and/or binary floating-point values 208 are transformed 302, 316, 324 into formatted decimal 210 without processor DIVIDE or MULTIPLY operation(s), by using tables to obtain 328 an immediate output string via a simple table 234 lookup. There are at least two flavors of this embodiment. In one flavor, the output string 210 for each table 234 entry 820 fits within a power-of-two size, allowing each entry to be quickly and directly accessed and then stamped (efficiently copied) 346 appropriately into an output buffer 212. A triplets table is an example of an output string table 234. In another flavor, a table 236 of addresses to the actual string representations is created 376; in this table, the entries 820 are addresses. This allows the digit group output strings to be variable sized, and/or to be longer than what would fit within a natural CPU register size. Each entry 820 in the table 236 of addresses can then be quickly accessed, and the addressed string (digit group) later copied or output as needed from the address obtained. Note that, because the address to each string is made available, this method is more dangerous than others, and special care should be taken to ensure that the actual strings—the entries 820 in the string table 234—are not overwritten. One of skill in the art could make sure those strings are stored in write-protected memory 114, or could undertake other methods to help ensure the strings are not overwritten.

Some embodiments create 382 a safety zone 818 by placing one or more “dummy” entries 820 at the end of each triplets table 234 to allow for grabbing just a portion of any entry rather than the entire entry with a full-word 894 operation to simplify/speed up the algorithm 1074 (this applies to the very last triplet to help prevent memory-access errors). This can be CPU-specific. For example, padding 382 the end of the triplets table with at least 8 extra bytes will help eliminate memory-access errors when using 64-bit MOVE operations in some embodiments. Note that other registers 206 (MMX, etc.) may be available on 32-bit processors 112 (or larger sizes) to move 64-bit data (or larger sizes) in one move operation; if these other processors 112 are used, the end of the triplets tables 234 are padded with as many bytes as that processor can move in one operation. One of skill will acknowledge that when tables 216 are stored adjacent one another, for all tables except the last one, the bytes after the end of a table may represent bytes in another accessible table, or bytes of some other readable memory. In that case, those tables won't necessarily need a safety zone; but the table that is physically the last in memory may have the safety zone 818 to prevent memory-access errors when reading the last table entry, since write-protected memory may exist immediately after that last table's entries 820.

Some embodiments transform 384 a value 208 from binary integer to binary floating point and then transform 302 the resulting value 208 from binary floating point to a formatted decimal 210. Some transform 384 a value 208 from binary floating point to binary integer and then transform 302 that result to formatted decimal 210.

Some embodiments transform 302 binary integer, binary fixed-point, and/or binary floating-point values 208 to formatted decimal 210, without looping 342 through digit groups because a digit-group funnel 822 is used 386. One such embodiment includes an algorithm 1074 implemented using a division/reciprocal multiplication 304. Some embodiments use 390 a ‘reinterpret_cast’ operator 824 to tell a compiler 126 that, for this specific operation, the size or type of a variable 914 is different than its static definition. Some funnel 822 algorithms 1074 for base conversion and formatting use a structure of if-then statements 222 to determine the size of the binary number and then output a result 210 fast with no loops.

Some embodiments transform 302 binary integer, binary fixed-point, and/or binary floating-point values 208 to formatted decimal 210 in part by using a table 234 of digit groups in which the table entries 820 include decimal digits and also include at least one digit-group separation character 228 (e.g., a table of triplets “,000”, “,001”, . . . “,999” using a comma as the separator 228). The separator 228 can be the first or the last character 885 of the digit-group 224.

Some embodiments transform 302 binary integer, binary fixed-point, and/or binary floating-point values 208 to formatted decimal 210 in part by using a table 234 of digit groups 224 in which the table entries 820 include decimal digits (e.g., table of quadruplets “0000”, “0001”, . . . “9999”).

Some embodiments transform 302 binary integer, binary fixed-point, and/or binary floating-point values 208 to formatted decimal 210 with multiple-size groupings for the formatted decimal string by using a table 234 of digit groups 224 in which the table entries 820 include decimal digits grouped with the largest grouping needed for the output. A single table 234 of triplets, for example, is the only table of digit groups needed in some embodiments. It is accessed via different offsets depending on the size of the desired grouping.

Some embodiments produce results 210 in which the digit groups 224 have more than one size, that is, some digit groups 24 have N characters 885 and some have M characters 885, with N< >M. Such a multiple-size-grouping embodiment can be customized for the specific output desired. For example, in one Hindi embodiment, decimal integers are grouped according to the following pattern (going from least-significant digit to the most-significant): triplet, doublet, doublet; triplet, doublet, doublet; and so on, repeating the series. The number one million would be formatted like this:

10,00,000
The number one trillion would be formatted like this:
1,00,000,00,00,000

One of skill could use either a funnel 822 method or a jump table 232, as described in this document, to help extract 302 the binary integer 208 into decimal form 210. Using a funnel method, powers of ten can be used to identify 396 the leading (most significant) triplet or doublet for the number. If/then statements 222 can identify 318 scale to help extract the number (using the various groupings to bracket the numbers), as shown below. This example of such statements 222 can be used for a Hindi embodiment, but can be adjusted to accommodate other embodiments:

If (Num < 1000) { // Triplet1
...
} else if (Num < 100*1000) { // Doublet2
...
} else if (Num < 100*100*1000) { // Doublet3
...
} else if (Num < 1000*100*100*1000) { // Triplet4
...
} ... // and so on

In some embodiments, using 398 a jump table 232 requires inspecting 402 the bits of the binary number at each bracket boundary 826. One of skill would recognize there are unambiguous boundaries 826 (where all numbers having that bit position as the leading bit are within the bracket 828) and ambiguous boundaries 826 (where some numbers with that leading bit 810 will fit into the current bracket 828, and some will fit into the next-higher bracket 828). Since there are relatively few brackets 828 to be identified, one of skill could visually identify the brackets by manually inspecting 402 the bit pattern for the boundary values and then testing (and then adjusting/correcting the jump table 232 as needed). For example, in this Hindi example, numbers with a leading bit less than 9 will unambiguously fit into a Triplet1 bracket 828 that covers all numbers from 0 to 511. But, whereas the numbers from 512 through 999 have bit 9 as the leading bit and fit into the Triplet1 bracket, the numbers 1000 through 1023 also have bit 9 as the leading bit but fit into a Doublet2 bracket 828. Since bit 9 is therefore ambiguous, the jump table entry 820 for this bit would point to a method that would test the number to decide which bracket the number belongs to, and then send the program 132 execution path to code handling that bracket.

In one embodiment for decimal representation according to the Hindi culture, digits are grouped either as triplets or doublets. In this case, zero-padded triplets 224 are accessed 410 from a TripletsComma table 234 with a digit-group offset 830 of 0 into the table 234 (in this table, commas are appended to each triplet, such as: “000,”, “001,”, “002,”, . . . “999,”), while doublets are accessed similarly, except with a digit-group offset 830 of one char into the table. So when the triplet for the number 2 is needed, the value “002,” will be accessed 410 and written 412 to the output 212, with the destination pointer 214 then incremented by four chars. But when the doublet for the number 2 is needed, the value “02,0” will be accessed 410, which is one byte offset to the right of the normal triplet, and then will be written 412 to the output 212, with the destination pointer 214 incremented by three chars. Note that the trailing “0” in the copied value comes from the “003,” entry in the next slot, but it will be overwritten in the output buffer 212 with the next character 885. One of skill will know to terminate 394 the output string 210, e.g., by placing a null character at the end of the last triplet to form the final null-terminated decimal string for the converted number.

In some embodiments, a FirstTripletComma table 234 is used. Each entry 820 is four chars, has a comma after the last digit of the entry, is not zero padded, and has trailing nulls if needed. The entries are:

“0,”, 0, 0, “1,”, 0, 0, . . . , “10,”, 0, “11,”, 0, . . . , “999,”

Alternately, one of skill could use a FirstTriplet table 234 that has no separators 228, such as:

“0”, 0, 0, 0, “1”, 0, 0, 0, “2”, 0, 0, 0, . . . , “999”, 0

Either table 234 can be used to access the first grouping 224, whether it is a triplet or a doublet; the choice depends on whether a separator 228 is desired in the output. It is also useful in some embodiments to have a FirstTripletCommaSize table 230 that quickly gives the size of each entry of the FirstTripletComma table 234 (the size includes the separator, so for example, the size of the entry “1,” is 2); the entries in this table 230 will return the proper size for the specified grouping to allow the destination pointer 214 for the output buffer to be properly adjusted 368. If using the FirstTriplet table (i.e., not using thousands separators), a coordinated 518 FirstTripletSize table could be used to obtain 334 the size of the first grouping.

Some embodiments transform 302 binary integer, binary fixed-point, and/or binary floating-point values 208 to formatted decimal 210 in part by using a table 234 of digit groups in which the table entries 820 include a terminating null character for each entry.

Some embodiments transform 302 binary integer, binary fixed-point, and/or binary floating-point values 208 into formatted decimal 210 in part by using a separate table 234 of digit groups to be used for the most-significant grouping (triplet 224) only, in which the table entries 820 do not include leading ‘0’ chars and are all null-terminated. A variation duplicates the above table 234, but goes from “−999” to “999” (or “999”) as the entries 820 with an actual minus sign as the leading character 885 of each negative number; this supports super-fast conversion 328 of integers 208 in the range −999 to +999 via table lookup. In this variation, a lookup offset 816 of 999 table entries would be added 370 to obtain the proper entry (since the number to be converted is the index into the table, and since a table index can't normally be negative, the index is offset appropriately).

In some embodiments the size of each entry 820 of a table 234 of digit groups is a power of two, allowing the CPU to use efficient scaling operations with no additional clock-cycle cost. For example, four-character entries 820 work well, as they are four bytes for ASCII output, and eight bytes for Unicode16; a 64-bit CPU can access 410 either the ASCII or the Unicode16 entry with one fast indexed instruction (a 32-bit CPU can move the ASCII entry with one fast indexed instruction but takes two fast indexed instructions for the Unicode16 entry). The Intel® CPU can scale 414 the index 832 while incurring no overhead. Assume an embodiment wants to access 410 the element at an index whose value is 124 in the Triplets table 234. Since each entry 820 in this table is 4 bytes, code 202 can use the following commands (this is in assembly language, but C/C++ compilers would do something similar when they compile the embodiment's code). This works for single-byte ASCII tables where each entry is 4 single-byte chars in a table named Triplets:

mov eax, 124
mov edx, dword [Triplets+eax*4]
mov dword [DestPtr], edx

One equivalent code in C++ would be:

*reinterpret_cast<int*>DestPtr=
reinterpret_cast<int*>Triplets[124];

For wide chars (Unicode16), each entry is 8 bytes (4 double-byte chars in a table named Triplets16), and the sequence on a 64-bit CPU would be:
mov rax, 124
mov rdx, qword [Triplets16+rax*8]
mov qword [DestPtr], rdx

One equivalent code in C++ would be:

*reinterpret_cast<long long*>DestPtr=
reinterpret_cast<long long*>Triplets16[124];

If the multiplier is not a power of two, the embodiment incurs a separate multiplication operation which can slow performance. The multiplication step (*4 or *8 above) incurs no additional clock-cycle cost on an Intel® (and any compatible) CPU.

Some embodiments transform 302 binary floating-point values 208 to formatted decimal 210 in part by using the exponent 806 of the input binary value 208 as an index 832 into a table 238 of powers of P, where P is a power of ten (e.g., using 338 the exponent as an index into a Doubles1000 table which is a table 238 of powers of 1000).

Some embodiments transform binary integer, binary fixed-point, and/or binary floating-point values into formatted decimal in part by using a digit-group separation character 228 (e.g., comma, space, apostrophe) globally for all operations, or just locally for a single operation. The separator 228 may be gotten 418 interactively from a user, or it may be gotten indirectly from a module 202 adeveloper in that the separator 228 is stored in the executable code 202 instructions 116 or in a configuration file which is functionally part of module 202.

Some embodiments transform binary integer values to formatted decimal in part by using 422 a user-specified template 240 that defines at least the following: digit groups, digit-group separation character, which supports a custom output in a hard-coded format template. An ngSetFormat function (which may be named differently) can be used to specify 420 to an embodiment what sets of tables 216 are to be created 376, including how to populate those tables with character strings and other values. For example, one could invoke ngSetFormat(“#,###,###”) for “1,234,567” and invoke ngSetFormat(“# ### ###”) for “1 234 567” and invoke ngSetFormat(“#######”) for “1234567”.

Similarly, some embodiments transform 302 binary fixed-point and/or binary floating-point values 208 to formatted decimal 210 in part by using 422 a user-specified template 240 that defines at least two of the following: digit groups, digit-group separation character, decimal point character 242. For example, ngSetFormat(“#,###,###.##”) defines output 210 format as in “1,234,567.89” and ngSetFormat(“# ### ###,###”) defines output 210 format as in “1 234 567,890” and ngSetFormat(“###.####”) defines output 210 format as in “123.4567”. Any element not specified by the template 240 will be handled according to a default method. In some embodiments, the default method will assume the desired format is U.S. numbers using commas for thousands separators and periods for decimals. Some embodiments allow decimal precision for integers; the decimal places may all be 0, but they line up with other formatted floating-point numbers.

Some embodiments transform 302 binary fixed-point and/or binary floating-point values 208 into formatted decimal 210 in part by using a user-specified template 240 to initialize 424 an output-buffer template 244 which is then used to very quickly stamp 346 the template format to the output buffer 212. This approach can be used in both a native code module 202 and a managed code module 202. One creates 424 a template 244 which is then bulk-copied 346 as each number 208 is formatted 302. The user will specify 426 the output buffer 212 when using native code, while managed code will create 428 a new string including characters in the output buffer 212.

Some embodiments are similar to the foregoing, but let a user specify 430 a template 244 full of characters that will be used for the pad character(s) 246; this lets the user specify more than just one char to duplicate. For instance, if a user wanted “*̂*̂*̂*34,123.38”, the user could specify 430 use of a template “*̂*̂*̂*̂*̂*̂*̂*̂*̂*̂*̂*̂*̂*̂*̂” for left padding.

Some embodiments favor using 432 double-byte wide chars in lookup tables as the fastest way to create display strings in managed code. Some keep all triplets and other character tables 216 discussed herein in a double-byte Unicode16 format. These tables can be accessed equally well from native or managed code with no performance penalty. They can dramatically speed up manipulating chars when creating display strings 210 which are then converted 434 into immutable strings 210 for managed code. For native code, it's typically fastest to use 436 single-byte chars if the desired output 210 is single-byte ASCII, or use 432 double-byte wide chars if the desired output 210 is double-byte Unicode16, but managed code uses 432 only double-byte wide chars for its Strinĝ format (“Strinĝ” denotes a string pointer 962 in managed code).

Some embodiments transform 302 binary fixed-point and/or binary floating-point values 208 into formatted decimal 210 in part by using a user-specified template 240 to define multiple output formats which are dynamically selectable 438 by the user 104 without changing calls 544 for formatting individual numbers 208. For example, a user can define 422 American and French formats and select 438 between them at runtime with ngSetFormat( . . . ) (or a similar function) without changing calls 544 to ngFormat( . . . ). The user thus switches 420 between table 216 sets at runtime and/or modifies thousands or decimal separators 228, formatting 248 for negative numbers (e.g., leading minus sign, trailing minus sign, or parentheses), and, optionally, currency symbols 250. Some embodiments involve creating one or more custom user-specified templates 240 that are hard coded and dynamically selectable 438 for a specific user 104; this reduces or eliminates overhead in parsing 440 the template.

Some embodiments transform 302 binary integer, binary fixed-point, and/or binary floating-point values 208 to formatted decimal 210 in part by obtaining 442 a division remainder 834 by a multiplication 446 operation of a recently obtained quotient 836 rather than performing 450 a modulus (“get remainder”) operation (e.g., “num−(num1*1000)” instead of “num % 1000”, where num1 is a quotient recently obtained after dividing num by 1000).

Additional Observations on Output Format and Context

In some embodiments, many individual outputs 210 can be produced 302 and displayed 452. These outputs may be displayed 454 one after another at successive locations so that each output can still be seen even after subsequent output(s) are produced (e.g., server log, list of addresses), or these outputs may be displayed 456 one after another at the same location(s) with subsequent output(s) overwriting prior outputs (e.g., changing CAD coordinates as crosshair is moved). The particular display steps 454, 456 are examples of display step 452.

In some variations on any of these embodiments, a currency symbol 250, negative indicator (‘−’ or parentheses) 248, and/or alignment and/or padding 246, is user-specified 438 for the output 210. In some variations on any of these embodiments, 8-bit or 16-bit characters in the output is user-specified 432, 436. In some variations on any of these embodiments, output in exponential notation (a.k.a. scientific notation) 252, possibly with rounding 254, is specified 438. In some variations on any of these embodiments, managed or native code 202 is specified 458 for the conversion and formatting function. In some variations on any of these embodiments, 32-bit or 64-bit or 128-bit implementation is specified for a target CPU and/or OS (operating system). In some variations on any of these embodiments, a single number or a list of numbers 208 (e.g., array, file, stream, getNextNum( ) random( ) read( ) etc.) as input is transformed 302. In some variations on any of these embodiments, various bit sizes 256 (such as 8 bits, 16 bits, 32 bits, 64 bits, 80 bits, 128 bits, 256 bits) of input 208, and signed/unsigned 838 input 208, are specified 462 for the values 208 being transformed 302. In some variations on any of these embodiments, speedy lookup for small-enough numbers (e.g., −999 . . . 999) is utilized 328, thereby eliminating extra CPU processing.

In some variations on any of these embodiments, the size 256 of the output string can be returned 464 in a CPU register 206 upon exiting the called function. One of skill in the art will understand that at the end of the conversion process the length of the converted display string 210 is known, since a destination pointer 214 is maintained (with, in some embodiments, a displacement offset 814) to ensure the string is properly created, and the exact size 256 is easily computed just before the procedure exits. Size can be stored in the ecx register 206, for example, in 32-bit Intel-compatible implementations; one of skill understands that in some implementations the eax register 206 is normally used to return the starting address of the output buffer, and the ecx register is available at this time. Returning 464 the size permits the calling code 202 path to immediately ascertain the length of the newly formatted display string 210 without having to compute the size separately as is done in many familiar approaches, thereby saving processor clock cycles that would otherwise be spent computing the string's length.

In DIVIDE-free variations on embodiments, a device 102 whose processor 112 does not support native integer division is utilized 302, 466. Similarly, some embodiments are tailored 466 to a specific processor 112 type (FPU, GPU, ASIC, etc.) based on that processor's register size, instruction cycle length (e.g., slow DIVIDE), available instructions, or other physical characteristics discussed herein.

In some variations on any of these embodiments, the output 210 can be formatted ASCII decimal or formatted binary coded decimal (e.g., for seven segment display), or any other radix.

In some variations on any of these embodiments, the outputs 210 may be part of documents 128 such as checks, registration certificates, tax notices, other legal documents, credit card and bank/investment statements, balance sheet and profit/loss and other financial statements and forms, addresses, social security numbers, latitude/longitude, stock tickers, lottery tickets, games of chance, documents containing zip codes, dates, times, IP addresses, and/or Internet/web pages, computer or server log files, documents containing temperatures, realtime updates, interfaces for realtime control by a human such as vehicle control or surgical instrument control or other precision placement control where tolerances are determined in realtime by a person, racing documents (those with stopwatch, speed, distance, positional coordinates), molecular modeling displays, simulation of physical changes (chemical reactions, electromagnetic activity, radiation, and so on), medical robotics documents, medical diagnostic equipment (e.g., ultrasound) interfaces, game heads-up display, video-game display, and other human-readable documents in paper, electronic, or other form. In some variations, the outputs 210 may include in some cases arbitrarily large integers.

In some variations on any of these embodiments, the outputs 210 can be represented in different custom formats, including money, date and/or time formats, balances, counts, quantities, quotas, measurements, etc.

In some variations on any of these embodiments, the input format 208 may differ. For example, somebody could devise a unique binary format that is internally different from the integer and floating-point formats described herein, but amenable to the use of digit-group tables 216, funnel-test base conversion 386, or other teachings herein. Arbitrary-precision numbers tend not to scale very well for output purposes, so a binary format for very large numbers could use, for example, a base-one-billion system for 32-bit environments (i.e., each internal unit ranges from 0 to 999,999,999 and occupies 32 bits), or even a base-one-quintillion system for 64-bit environments (i.e., each internal unit ranges from 0 to 999,999,999,999,999,999 and occupies 64 bits); such a format, in coordination with teachings herein, would make output 302 much faster for such large numbers.

Although use of floating point in financial applications is discouraged by some, large integers are sometimes used, e.g., to represent dollars as the number of cents. Accordingly, teachings herein may be applied to some financial documents 128 produced by software using 468 floating point in financial processing. In some embodiments, large binary integers are considered to be fixed-point integers with two decimal places. One of skill in the art will understand that the teachings herein readily apply to format 472 such numbers. In one embodiment involving such fixed-point numbers, for example, the binary number being converted 302 to decimal is first divided by 100 (when there are two decimal places), or by 1000 when there are three decimal places, and the whole number to the left of the decimal place (which is computed by that division, which in at least one embodiment is performed 304 by the appropriate MagicNumber 840 reciprocal of the divisor) is converted in the same manner as any other. Then, instead of finishing by placing a null at the end of the string, a period is inserted, followed by converting 302 the remainder into its decimal string and placing it in its place in the output string 210, followed 394 by the null terminating character.

In at least one formatting 472 alternative, a table 234 PeriodDoublets is created for the two-digit remainder to the right of the converted whole portion of the number 208, where each of the 100 entries in the table consists of a period, followed by a two-digit number from “00” to “99”, followed by a null character. This lookup table 234 is then used 328 to quickly obtain the four-character decimal string (which includes the separating period and terminating null character) for the remainder, which is quickly copied 412 to the proper destination. In yet another formatting 472 alternative, a PeriodTriplets table 234 is created to contain 1000 entries, each with a period followed by a three-digit number string from “000” to “999”. This is used when three decimal places are required, and one of skill will know a null should be inserted 394 after placing 366 the last decimal grouping in place. This process can be adjusted by one of skill for any size decimal, based on user requirements and memory available; or, when the number of decimal places is great, a process like that used 302 for the digits to the left of the decimal place can be used 302 to obtain the display characters to the right of the decimal place.

In another formatting 472 alternative, a variable number of decimal places can be supported. The number of decimal places determines the divisor used to separate the integer portion from the decimal portion (which divisor, or its MagicNumber 840 reciprocal plus shift value, if desired, can be obtained from a lookup table 258). Then, according to teachings herein, the integer portion is converted 302 into a decimal string with or without other formatting, and then the decimal portion is converted 302 into a zero-padded decimal representation of the decimal string. This involves a slight change to the basic algorithm 1074. In one formatting 472 embodiment, the number originally used as the divisor is first added to the decimal portion (which is now an integer) and the conversion process starts normally, except that the very first digit (which is always one, and which is not wanted or needed) is simply discarded 474 and the remaining process continues as usual for an embodiment. This guarantees that any padded zeros are obtained and placed appropriately. As one example, assume four decimal places are wanted, and the number to format is 432.0001. In some embodiments, after the integer portion to the left of the decimal has been converted 302, the decimal portion will be isolated after having been shifted four places to the left by multiplying it by 10,000; in this case, after that operation, the value returned will be 1 for the decimal portion. Adding 10,000 obtains the value 10,001. After skipping 474 the first digit, the characters “0001” will be extracted and copied appropriately to the output buffer. (Note that when implementing some of the rounding 522 teachings disclosed herein, one extra digit will be shifted with the desired decimals which means that the multiplier will be ten times bigger. That larger multiplier will then be added to the integer, the first digit skipped, and the next four digits will be extracted to the output buffer with the last digit also skipped.)

In one formatting 472 alternative, the number of desired leading zero characters can first be computed and then placed 366 into the output buffer (copied or stamped from a string of zeros, if desired), followed by converting 302 the remainder in the normal fashion. One of skill could adjust these examples to create other alternatives that fall within the scope and the intent of the teachings herein.

Some Performance Constraints and Related Scenarios

In some embodiments, performance constraints 842 are present, e.g., numbers output per second, which distinguish the embodiments from mere mental or pencil-paper calculations, and open the possibility of showing output in situations previously closed by lengthy conversion from binary to decimal format. Someone controlling 476 a realtime system for a drone in flight, or performing 476 ultrasound diagnostics, or controlling 476 a robotic-arm during surgery, cannot as a practical matter perform computations with a pencil and paper. As an example of extreme speed improvements from the teachings herein, one 32-bit implementation of a digital base conversion module 202 embodiment was tested on a 2.66 GHz Intel® Core™ 2 Duo CPU, running just one core on a 64-bit Windows Vista® system. Using optimized managed C++ code compiled with Microsoft Visual Studio® 2008 Professional, the implementation processed over 409.6 million conversions per second of binary integers with values between 0 and 255. This compares to the speed of Microsoft's itoa function that could process the same binary integers at a rate of about 9.26 million conversions per second in the same environment, representing a speed improvement of a conversion algorithm 1074 taught herein performing over 44 times faster than a familiar approach.

Sometimes something cannot be done at all, or done well, unless computer processors are used to meet 476 performance constraints 842 so that it is done quickly enough. In such cases, tools 202 for rapidly transforming binary values for formatted display 452 may be an important part of a realtime control loop, such as the control loop 700 illustrated in FIG. 7. A user 104 sees 702 an output value 210, makes 704 a decision, and sends 706 a controlled device 102 a control signal 708, the device 102 responds 710 to the control signal 708 with some physical change 712 and sends 714 back toward the user 104 an updated result 716 signal, the result signal 716 is transformed 302 to output 210 and displayed 452 to the user 104, the user 104 sees 702 this output 210, and the loop continues. Sufficiently rapid digital-base conversion and formatting 302 also allows time for additional processing of other kinds, which may be of special interest to makers of video games and other scenarios calling for fast video output, for example.

In some embodiments, analog sensor inputs (a.k.a. sensor readings) 844 are passed 480 into an analog-to-digital converter 846 which produces 486 corresponding binary values 208, which are then transformed 302 into formatted decimal 210 using data structures and algorithms described herein.

Some embodiments support data-logger 848 applications within systems 102. Some include a graphical user interface or physical slider mechanism 850 to support review 492 of logged data 118, e.g., with the data graphed and a corresponding updated overwritten display of graphed decimal value(s) 210. Here, as elsewhere herein, an overwritten display refers to a display in which different output values are written 456 successively at the same or overlapping screen region(s), so that the later value visually obscures or visually replaces the previous value on the screen.

Some embodiments support programmable logic controller 852 applications within systems 102, and some support telemetry systems 854 within systems 102. In each case some of these embodiments also provide an updated overwritten 456 display of decimal values 210.

Some embodiments support and enhance simulation software 856, which then benefits from the processing capacity freed up by the rapidity of innovative digital-base conversion and formatting tools 202 compared with familiar algorithms. For example, some embodiments provide rapid digital-base conversion and formatting in an enhanced and as yet unimplemented future version 858 of the Crystallographic Object-Oriented Toolkit or another molecular modeling program 132, such as those used to display and manipulate atomic models of macromolecules, such as proteins or nucleic acids, using computer graphics, for example. Reducing processor effort spent on digital-base conversion and formatting increases processor availability for other processing, such as computation of changes in objects and other data structures that represent molecules or other physical items. Similar benefits are provided to other scientific or engineering software 856 that simulates physical phenomena, when they are enhanced with innovative digital-base conversion and formatting as taught herein. Such enhancements could be performed, for example, by replacing a familiar library 130 of printf-style functions with a library 204 based on teachings herein, and then rebuilding the executable for the simulation program 856, 132.

Some embodiments support and enhance data-logger 848, 102 software and/or hardware, which thus benefits from the processing capacity that is freed up by the rapidity of innovative digital-base conversion and formatting module(s) 202 and/or 204 compared with familiar algorithms.

The following description is given in a Wikipedia article “Data logger”:

A data logger (also datalogger or data recorder) is an electronic device that records data over time or in relation to location either with a built-in instrument or sensor or via external instruments and sensors. Increasingly, but not entirely, they are based on a digital processor (or computer). They generally are small, battery powered, portable, and equipped with a microprocessor, internal memory for data storage, and sensors. Some data loggers interface with a personal computer and utilize software to activate the data logger and view and analyze the collected data, while others have a local interface device (keypad, LCD) and can be used as a stand-alone device.

Data loggers vary between general purpose types for a range of measurement applications to very specific devices for measuring in one environment or application type only. It is common for general purpose types to be programmable; however, many remain as static machines with only a limited number or no changeable parameters. Electronic dataloggers have replaced chart recorders in many applications.

One of skill in possession of the present disclosure will appreciate that by using innovations described herein to reduce processor effort spent on digital-base conversion and formatting, an enhanced logger 848 will benefit from increased processor 112 availability for other processing, thereby allowing a faster sampling rate, lower power consumption, and/or more processing time for error checking or reporting back logged data, for example. A logger 848 could be enhanced, for example, by replacing a familiar library 130 of printf-style functions with a library 204 based on teachings herein, and then rebuilding the executable for the logger, or by implementing the innovative base conversion and formatting in a circuit 860 and replacing the circuit that previously performed base conversion and formatting. One could also add formatting in loggers or other devices by replacing a circuit or a library that only performed base conversion, so that innovative base conversion and formatting are provided instead.

Some embodiments support and enhance embedded system 862, 102 software and/or hardware, which benefits from the processing capacity freed up by the rapidity of innovative digital-base conversion and formatting compared with familiar algorithms.

The following description is given in a Wikipedia article “Embedded system”:
An embedded system is a computer system designed for specific control functions within a larger system, often with realtime computing constraints. It is embedded as part of a complete device often including hardware and mechanical parts. By contrast, a general-purpose computer, such as a personal computer (PC), is designed to be flexible and to meet a wide range of end-user criteria. Embedded systems control many devices in common use today.
Embedded systems contain processing cores that are typically either microcontrollers or digital signal processors (DSP). The key characteristic, however, is being dedicated to handle a particular task. Since the embedded system is dedicated to specific tasks, design engineers can optimize it to reduce the size and cost of the product and increase the reliability and performance. Some embedded systems are mass-produced, benefiting from economies of scale.
Physically, embedded systems range from portable devices such as digital watches and MP3 players, to large stationary installations like traffic lights, factory controllers, or the systems controlling nuclear power plants.
Complexity varies from low, with a single microcontroller chip, to very high with multiple units, peripherals and networks mounted inside a large chassis or enclosure.

One of skill in possession of the present disclosure will appreciate that by using innovations described herein to reduce processor 112 effort spent on digital-base conversion and formatting, an enhanced embedded system 862 will benefit from increased processor availability for other processing, thereby allowing a faster response to meet realtime computing constraints, lower power consumption, and/or more processing time to be dedicated to specific tasks the embedded system is designed to perform, for example. A process controller, programmable logic controller system, or other embedded system 862, 120, 136 could be enhanced, for example, by replacing a familiar library 130 of printf-style functions with a library 204 based on teachings herein, and then rebuilding the executable for the embedded system, or by implementing the innovative base conversion and formatting in a circuit 860 and replacing the circuit that previously performed base conversion and formatting. One could also add formatting in embedded systems by replacing a circuit or a library that only performed base conversion, so that innovative base conversion and formatting are provided instead.

Some medical system 864 embodiments support and enhance the use of robotics and/or computer software and/or hardware during surgery, diagnosis, and other medical procedures, which benefit from the processing capacity that is freed up by the rapidity of innovative digital-base conversion and formatting compared with familiar algorithms.

The following description is given in a Wikipedia article “Robotic surgery”:
Robotic surgery, computer-assisted surgery, and robotically-assisted surgery are terms for technological developments that use robotic systems to aid in surgical procedures.
Robotically-assisted surgery was developed to overcome both the limitations of minimally-invasive surgery or to enhance the capabilities of surgeons performing open surgery. In the case of robotically-assisted minimally-invasive surgery, instead of directly moving the instruments, the surgeon uses one of two methods to control the instruments: either a direct telemanipulator or by computer control. A telemanipulator is a remote manipulator that allows the surgeon to perform the normal movements associated with the surgery whilst the robotic arms carry out those movements using end-effectors and manipulators to perform the actual surgery on the patient. In computer-controlled systems the surgeon uses a computer to control the robotic arms and its end-effectors, though these systems can also still use telemanipulators for their input. One advantage of using the computerised method is that the surgeon does not have to be present, indeed the surgeon could be anywhere in the world, leading to the possibility for remote surgery. In the case of enhanced open surgery, autonomous instruments (in familiar configurations) replace traditional steel tools, performing certain actions (such as rib spreading) with much smoother, feedback-controlled motions than could ever be achieved by a human hand. The main object of such smart instruments is to reduce or eliminate the tissue trauma traditionally associated with open surgery without imposing more than a few minutes' training on the part of surgeons. This approach seeks to improve that lion's share of surgeries, particularly cardio-thoracic, that minimally-invasive techniques have so failed to supplant.

The following description is given in a Wikipedia article “Ultrasound”:
Ultrasound is a cyclic sound-pressure wave with a frequency greater than the upper limit of human hearing. Ultrasound is thus not separated from “normal” (audible) sound based on differences in physical properties, only the fact that humans cannot hear it. Although this limit varies from person to person, it is approximately 20 kilohertz (20,000 hertz) in healthy, young adults. The production of ultrasound is used in many different fields, typically to penetrate a medium and measure the reflection signature or supply focused energy. The reflection signature can reveal details about the inner structure of the medium, a property also used by animals such as bats for hunting. The most well known application of ultrasound is its use in sonography to produce pictures of fetuses in the human womb. There are a vast number of other applications as well.

One of skill in possession of the present disclosure will appreciate that by using innovations described herein to reduce processor 112 effort spent on digital-base conversion and formatting, an enhanced surgical system 864 or enhanced diagnostic system 864, for example, will benefit from increased processor availability for other processing, thereby allowing a faster response to meet realtime computing constraints, lower power consumption, and/or more processing time to be dedicated to specific tasks the system is designed to perform, for example. A surgical system or diagnostic system could be enhanced, for example, by replacing a familiar library 130 of printf-style functions with a library 204 based on teachings herein, and then rebuilding the executable for the system, or by implementing the innovative base conversion and formatting in a circuit 860 and replacing the circuit that previously performed base conversion and formatting. One could also add formatting in surgical or diagnostic systems by replacing a circuit or a library that only performed base conversion, so that innovative base conversion and formatting are provided instead.

Some embodiments enhance applications, servers, web pages, devices, and/or other computational sources 102 that print 454 many numbers in succession on paper documents 128 or documents 128 in other media (including electronic media), such as systems 102 that print checks, lottery tickets, one-time pads for cryptographic use, telephone books, tax notices, patents, trademark certificates, financial reports, web analytics reports, server logs, financial statements, spreadsheet pages, tax returns, real estate listings, crime reports, other demographic reports, statistics, election results or other vote counts, sales reports, classified advertisements, satellite positions, other geographic positions or coordinates, dates, times, ages, social security numbers, driver license numbers, currency amounts, physical addresses, internet protocol IP addresses and/or other computational device ports or addresses, and/or other numbers.

Such application programs 132, web pages, servers, devices, and other computational printing systems 102 could be enhanced, for example, by replacing a familiar library 130 of printf-style functions with a library 204 based on teachings herein, and then rebuilding the executable for the printing systems, or by implementing the innovative base conversion and formatting in a circuit 860 and replacing the circuit that previously performed base conversion and formatting. One could add also formatting in printing applications and printing systems by replacing a circuit or a library that only performed base conversion, so that innovative base conversion and formatting are provided instead. In either event, processing formerly spent on base conversion is freed for other uses, and benefits such as reduced power consumption and speedier production of the printed material are also made available by the innovations described herein.

Some CPU Alternatives

Many examples herein are written for familiar general-purpose CPUs 112, but special-purpose processors 112 may also be used in some embodiments. For example, some embodiments are tailored for GPUs (Graphical Processing Units) 112. Although GPUs were originally designed to render graphical primitives such as points, lines, and triangles, more recent GPUS have sufficient power and flexibility for other uses. Many GPUs have access to a system memory 114 that is also accessible to a general-purpose CPU, as well as a dedicated graphics memory reserved primarily or entirely for GPU use. Some embodiments place one or more of the special-purpose digital-base conversion tables 216 described herein within the dedicated GPU memory 114 and execute 306 the base conversion and custom formatting algorithm with code 202 such as that taught herein, using the GPU, then send 320 the formatted output 210 to the CPU and/or create the formatted output 210 in an output buffer 212 in the system memory 114.

Some embodiments run on ARM processors 112 which lack a native instruction for integer division. These embodiments can perform digital-base conversion with integrated formatting, by utilizing 316 multiplication by a reciprocal in combination with elimination of dependence on CPU DIVIDE instruction-supplied remainders.

Magic Numbers to Avoid Division

Some embodiments use 304 one or more of what can be termed “magic numbers,” to avoid integer division by using suitable integer multiplications and a possible bit-wise shift. Note that the term “magic number” is used in various ways outside this disclosure, not all of which match the use herein, namely, a number used in software as a multiplier to replace division with multiplication and suitable bit-wise shifts in a binary number. In this disclosure, the term “MagicNumber” (or “magic number” etc.) and/or reference number 840 will be used to denote a positive number that is used in an integer MULTIPLY operation 446 (sometimes followed immediately by one or more RIGHT-SHIFT operations 308), to replace a DIVIDE operation of a positive integer dividend by a positive integer divisor. A suitable MagicNumber 840 is selected 358 based on input range 256. If the range can be guaranteed to be small enough, a shift operation can sometimes be eliminated.

In some embodiments, MagicNumbers 840 are directly used only for positive-integer operations. Decimal conversions described herein make direct use only of positive-integer operations, in that negative numbers are converted 362 to positive numbers before MagicNumber multiplication is performed. Negative numbers are converted 362 to their corresponding positive numbers, with the negative sign being remembered separately in the code from the binary representation of the positive number. In some embodiments, MagicNumber operations are done in assembly language 866 to take direct advantage of the CPU architecture. While it is possible to perform the MagicNumber operations in a high-level language 868 such as C or C++, using such high-level languages may incur additional overhead that could reduce the speed advantages of using assembly-language operations.

One of skill in the art will understand that integer division by a number that is a power of two can be replaced by a RIGHT-SHIFT operation 308 without any division or MagicNumber multiplication. For example, to divide a number by two, it can be RIGHT-SHIFTed one place. To divide a number by 8, it can be RIGHT-SHIFTed three places. This is easily performed by one of skill in the art and is faster than performing either a MULTIPLY or a DIVIDE.

Following is a description about MagicNumbers 840. In some embodiments, a MagicNumbers class can help identify 358 a suitable MagicNumber to be used to replace 304 a constant-division operation with a multiply (and possible shift). One of skill would understand that a class 870, such as implemented in the C++ language, would include one or more functions 936 and appropriate variables 914 to implement the algorithms and methods used to create and test MagicNumbers as described herein. This class 870 helps to identify the fastest way to divide a number by a constant 916. It does so by helping identify a suitable multiplier that computationally represents a reciprocal of the divisor. In some cases (assuming 32-bit numbers), the number is multiplied by a value, and then the high dword (edx register) is shifted a certain number of bits to the right. In some embodiments, the low dword in the eax register is also shifted the same number of bits in order to produce a suitable fractional remainder used for extracting decimal digits, and a value of 1 can be added to that fractional remainder as a correction factor to compensate for loss of precision from the CPU operation. In some special cases, the high dword will not be shifted; this results in a faster operation.

One of skill will acknowledge that dividing a number by 10, or by a multiple of 10, can cause a loss of precision (any time the remainder is not 0, by definition there is a loss of precision in the quotient). And certain fractions cannot be completely represented in a computer bounded by a finite bit size, so there can be a loss of precision as a practical matter. For example, the fraction 1/10 cannot be perfectly represented by a binary computer, which means there is some loss of precision in any representation for that number—and that fraction is the number one divided by ten. Therefore, by extension, if dividing by a certain divisor could result in a loss of precision, then multiplying by the reciprocal of that divisor could also result in a loss of precision. In computing, one method of accounting for such a loss of precision is to adjust the LSB of the result that contains that loss of precision, which can be accomplished in some embodiments by adding 1 to that number.

Before using any given MagicNumber 840 in a finished embodiment, all possible inputs are ideally tested to ensure the answer is exactly equal to that provided by the normal DIVIDE operation. Then that MagicNumber can be safely used. However, informed and reasonable users may also be willing to accept a risk of error. The examples herein described assume 32-bit MagicNumbers and 32-bit CPU operations, but can be scaled up to 64-bit MagicNumbers and 64-bit CPU operations by those of skill in the art. Note that internally to the CPU, MULTIPLY operations return results that can contain twice as many bits as in the multiplier or the multiplicand. Therefore, 64-bit operations are used to identify 358 MagicNumbers that are reciprocals of 32-bit divisors, and 128-bit operations are used to identify 358 MagicNumbers that are reciprocals of 64-bit divisors. In some cases involving large divisors approaching the maximum size that can be represented by the bit size (for example, the divisor one billion is within a few bits of the largest number that can be represented in a 32-bit binary integer), one or more additional bits will be required to account for overflows that occur when using such large numbers. In one embodiment of a class 870 used to create MagicNumbers, a multi-precision method that could handle 196-bit MULTIPLY and DIVIDE operations was sufficient to identify appropriate MagicNumbers for the reciprocals of 32-bit and 64-bit divisors, and in some cases the appropriate MagicNumber required more bits than the divisor it was to replace. In an alternative, one of skill could use one of several publicly-available arbitrary-precision math libraries to perform the appropriate mathematical and other operations described herein in order to identify appropriate MagicNumbers.

Sometimes a MagicNumber 840 can be used with no shifts if the range of inputs is guaranteed to be restricted within a certain range. For example, assume one wants a MagicNumber to let one replace the slower “divide by 1000” operation with a reciprocal multiplication. If one can guarantee that all possible input numbers to be divided by 1000 are within the range 0 to 6,100,998 inclusive, the MagicNumber 4,294,968 can be used without a shift afterward. After performing a 32-bit multiply, the exact answer (which is the quotient of the number divided by 1000) will be in the edx register. This multiplication is the fastest-possible multiplication on the Intel® chip, so any MagicNumber operations within this range can be faster than the normal divisions.

A possible 32-bit MagicNumber-plus-shift sequence can be quickly verified 372 by testing boundary conditions to make sure the MagicNumber-plus-shift sequence returns the same value as the normal division operation. One series of tests 372 which has been created by inventor Eric J. Ruff is as follows: Identify the divisor (DivisorX) and the maximum input number (MaxInput). Then identify the MagicNumber (MagicNum) and the possible shift (ShiftAmt) for that MagicNum as described below. Then for each TargetNum as defined below, and using unsigned 64-bit (or larger) variables and 64-bit math operations in C or C++ as is known in the art, confirm that the MagicNumber-plus-shift operation on TargetNum returns the same result as the normal division operation using C or C++ code to divide TargetNum by DivisorX. (Overflows must be detected and handled. For example, when two positive non-zero integers are multiplied, the result will need to have at least as many total bits as are used in the multiplier plus the bits in the multiplicand; the implementer may desire to use an arbitrary-precision numerical package, as mentioned elsewhere in this disclosure, to ensure the math is done correctly if he/she is unsure of how to account for the overflow; if not handled properly, an otherwise valid test may be deemed invalid, rendering it difficult, if not impossible, to obtain the desired MagicNumber.) If all such tests of each TargetNum are valid, the MagicNumber-plus-shift operation is also valid. The following is a list of each TargetNum to test:
TargetNum=MaxInput
TargetNum=(MaxInput/DivisorX)×DivisorX
TargetNum=((MaxInput/DivisorX)×DivisorX)+1
TargetNum=((MaxInput/DivisorX)×DivisorX)−1
TargetNum=((MaxInput/DivisorX)−1)×DivisorX
TargetNum=(((MaxInput/DivisorX)−1)×DivisorX)+1
TargetNum=(((MaxInput/DivisorX)−1)×DivisorX)−1

Note that the above tests 372 can also be performed in any other appropriate computer language, including assembly language 866. One of skill in the art would also ensure that when generating each TargetNum as above, any value outside the range of 0 through MaxInput, including any values that overflow or underflow from either adding or subtracting 1 as shown above, is not tested.

Here's some theory behind magic numbers. Dividing a number X by divisor Y is mathematically identical to multiplying X by the reciprocal of Y (which is 1/Y). Using binary integer math, however, introduces some precision errors that should be accounted for as described herein. The more digits in the multiplier, the greater the precision. For each division operation, there could be multiple appropriate MagicNumbers. The one to select depends on the range of inputs applied to the MagicNumber in its use to reduce or avoid division costs.

Here is an example. Assume one wants to divide any number X by 1000. One can write “X/1000” in most C or C++ programs 132, and a smart optimizing compiler 126 will automatically replace that with a MagicNumber sequence that will work. But sometimes the compiler may not create the most efficient MagicNumber 840 (Microsoft Visual Studio® Professional 2008 C/C++ is a case in point) because the compiler does not know the range 256 of possible inputs and therefore attempts to accommodate all possible inputs. However, even a less-than-optimal MagicNumber 840 can be noticeably faster than a division.

In assembly language, a normal divide-by-1000 scenario could look like this, where Number=the number to be divided, and Divisor=1000:

mov eax, [Number]

xor edx, edx; assumes Number is unsigned

div [Divisor]

This code returns the result from (Number/Divisor) in the eax register (edx will have the remainder). A DIVIDE operation is among the slowest operations that can be performed on modern CPUs 112, and therefore one may wish to avoid it if possible. In some cases, though, using the normal DIVIDE operation could be the most efficient process when both the quotient and the remainder are subsequently used. However, it is often still quicker to use the MagicNumber and a get-the-remainder technique that quickly obtains 442 the remainder 834 when the quotient 836 is still at hand, e.g., still in a register 206. The remainder is equal to (Number−(Quotient*Divisor)). This uses a multiply and a subtract operation to obtain the remainder (modulus operation) rather than the more-expensive divide operation. Alternative methods can extract digits directly from the remainder (which, after a MagicNumber operation, is a binary fraction) via fast MULTIPLY instructions.

Returning to the MagicNumber example, rather than using the divide operation, some codes 202 and/or 204 use the following MagicNumber scenario, where Number=the number to be divided by 1000, and MagicNumber=4,294,968:

mov eax, [Number]

mul [MagicNumber]; after this, edx=result

This code puts the result into the edx register 206, and works for any number from 0 through 6,100,998 inclusive. That means the above MagicNumber can work for all 8- and 16-bit numbers, and for many 32-bit numbers as well. Note that taking the edx register is equivalent to shifting the result to the right by 32 bits (the same as dividing the number by 4,294,967,296 (which is equal to 1<<32)). This is because, in Intel-compatible CPUs 112, the product of a 32-bit multiplication is returned as a 64-bit number in the edx:eax register pair.

Creating MagicNumbers

Creating a MagicNumber generally takes place outside of the program 132 routine that will use it. If one desires, however, one could have an initial routine that creates 358 MagicNumbers 840 on the fly, but if a MagicNumber is not created prior to use, it's not as helpful. It is relatively expensive to determine the proper MagicNumber, if each MagicNumber is fully tested 372 to ensure it works properly before committing to use it in formatting code 202, 204. A quick test 372 such as described above can work, but one skilled in the art utilizing the methods described herein may also decide to test 372 the entire range of possible inputs to ensure it works on the target CPUs before relying on the MagicNumber. Note that in the examples below for creating 358 MagicNumbers, 32-bit numbers are used and 64-bit results are obtained, although in some cases more than 64 bits are required to contain the results. This can scale to 64-bit numbers, for example, where 128-bit results are obtained, but sometimes more than 128 bits are required to contain the results.

A MagicNumber 840 can be especially useful to divide by 10, 100, 1000, or other multiples of 10, which is common in converting binary numbers 208 to decimal representation 210 and which is used in some of the teachings herein. MagicNumbers can be useful when a variable 914 is divided by a constant 916, and especially where that division operation would take place multiple times. MagicNumbers can be created 358 for any constant number that a program 132 will use multiple times for division. 32-bit MagicNumbers can be used to replace divisors of from 2 to approximately 894,000,000 by using 32-bit MULTIPLY operations; for larger divisors, MagicNumbers use more bits as is shown in the Suitable MagicNumbers Table below. 64-bit operations—either using a 64-bit CPU or a software implementation for 32-bit CPUs—are used to handle divisions of larger numbers. Each MagicNumber is ideally a constant 916 in the program 132, and properly identified and documented. If multiple MagicNumbers are used, one could keep them in a lookup table 258.

To create 358 a MagicNumber, first determine the Divisor being used. For example, to replace the instruction “divide by 1000” with the instruction “multiply by MagicNumber and then shift,” set Divisor=1000. The MagicNumber 840 is then consistent with the formula:

MagicNumber=((1ULL<<32)+(Divisor−1))/Divisor (1)

One of skill in the art will appreciate that the above formula uses 64-bit math (the “1 ULL” is an unsigned 64-bit number whose value is exactly one) to create the 32-bit MagicNumber. The above MagicNumber will work for all numbers from 0 through 6,100,998 inclusive when replacing a divide-by-1000 operation.

The reason to add (Divisor−1) before the division by Divisor is to force a round up if there is any remainder. Assuming Divisor=1000, note that the above formula is equal to:

((1ULL<<32)+(Divisor−1))/Divisor=((4,294,967,296)+(999))/1000=4,294,968.295 (2)

Rounding 522 down (since integers have no decimal places) then gives the result 4,294,968 for the MagicNumber to use instead of dividing by 1000.

Why does it work? Consider mathematical expression (3):

$$Number \times \frac{4 , 294 , 967 , 296}{1000} \times \frac{1}{4 , 294 , 967 , 296}$$

Note (a) that the value 4,294,967,296 equals the value 1 shifted to the left 32 places, and (b) that the first fraction (4,294,967,296/1000) represents the MagicNumber, which in this case will be 4,294,968. In the above expression (3), the huge numerator and the huge denominator cancel each other out (subject to computational limitations such as accurate representation and overflow avoidance), and so the above expression (3) is mathematically equivalent to Number/1000. The MagicNumber created is equal to 4,294,967,296/1000=4,294,968 (when rounded 522 up to the next integer).

When using 304 the MagicNumber 840, in some embodiments the steps of the components of expression (3) are used discretely during actual computations. First, the number to be manipulated by the MagicNumber is multiplied by the MagicNumber, which creates a 64-bit result; this step corresponds to the “Number x (4,294,967,296/1000)” portion of expression (3), and places the result in the edx:eax register pair of the Intel® CPU. Using edx for the result corresponds to the “x (1/4,294,967,296)” portion of expression (3), since “1/4,294,967,296) is equivalent to shifting the number 32 bits to the right. This works, except for rounding 522 errors which first show up when Number=6,100,999. To overcome this, one can use more bits of precision in the MagicNumber. To do so, rather than using the shift value 32 to create the MagicNumber, use a higher shift value (for example, 38):

((1ULL<<38)+(Divisor−1))/Divisor=((274,877,906,944)+(999))/1000=274,877,907.943 (4)

Rounding 522 down, the MagicNumber is 274,877,907. To use it in place of dividing a number by 1000, replace that operation with multiplying the number by this MagicNumber, then use the value in the edx register after shifting it to the right six places. (Since directly using the edx register is the same as shifting the 64-bit number right 32 places, shift it six more places right to account for all additional shifts that remain after the first 32.) In assembly language, the edx register can be used directly, while in high-level languages, the entire 64-bit result may need to be RIGHT-SHIFTED the entire 36 places to place the result into the eax register where it can be used by the high-level implementation. Note that when using more bits of precision, it is possible that the MagicNumber will require more bits that the bit size of the number being manipulated, and/or the result from multiplying by the MagicNumber could require more than twice as many bits as in the number being manipulated due to overflowing operations, and so the operations should be appropriately adjusted 374 to account for any such overflows.

That MagicNumber (274,877,907) works fine for dividing any unsigned 32-bit number by 1000 (as long as the edx register is shifted right by six places as shown above). Using that MagicNumber, then, means the code changes to:

mov eax, [Number]; unsigned 32-bit number

mul [MagicNumber]; this is 274,877,907

shr edx, 6
; using edx accounts for the first 32
; shifts right, so there are 6 remaining

That puts the result in the edx register which can then be used, and corresponds to dividing Number by 1000 (which would place the result in the eax register instead). In an alternative embodiment, the eax register is also shifted by 6 positions to the right (with low bits from edx shifted in; see NoteA below), and a correction value of 1 is then added to the eax register, to obtain the remainder of the above operation as a binary fractional.

Suitable MagicNumbers Table

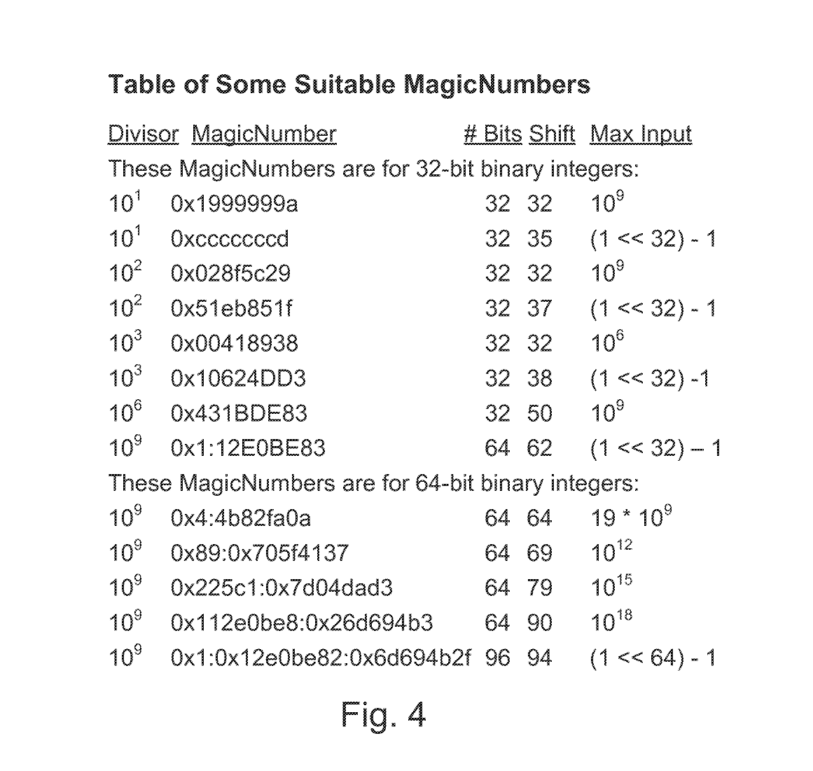

When using MagicNumbers 840, one of skill should ensure that they are not used on numbers greater than a maximum value, such as that specified in the Max Input column in FIG. 4 for the specific MagicNumbers listed, unless further testing 372 ensures that the maximum value listed can be safely exceeded. The entries in the FIG. 4 human-readable version of a table 258 show shift values that are used when the upper bits of the result cannot be directly accessed; it is assumed, though, that one of skill can directly access the upper bits, in a manner similar to that shown in various source-code examples in the present disclosure. MagicNumbers for 32-bit binary integers produce a 64-bit result (or higher, such as in the last entry in this group). Selecting the high 32 bits (or more, for the last entry) is equivalent to right shifting the quotient by 32 bits. For MagicNumbers having a Shift value of 32, that means no additional shift is needed (these are shift-less MagicNumbers when the high 32 bits are directly accessed). For a Shift value greater than 32, the quotient (the high 32 bits) must be right shifted by the value in the Shift column, less 32. If the binary-fraction remainder in the low 32 bits is to be used, it must be right shifted before the high bits are shifted (but only if the shift value is more than 32, and if so, then only by the amount exceeding 32). NoteA: bits from the low end of the higher 32 bits must shift into the high end of the lower 32 bits that will have shifted right. This shifting can be performed with one instruction by using the SHRD command as is known to those skilled in the art and as is shown in multiple examples in the present document.

MagicNumbers for 64-bit binary integers produce a 128-bit result (or higher, such as in the last entry in this group). Selecting the high 64 bits (or more, for the last entry) is equivalent to shifting the quotient by 64 bits. For MagicNumbers 840 having a Shift value of 64, that means no additional shift is needed (these are shift-less MagicNumbers when the high bits are directly accessed). For a Shift value greater than 64, the quotient (all bits after the low 64) must be shifted by the value in the Shift column, less 64. If the binary-fraction remainder in the low 64 bits is to be used, it must be shifted before the high bits are shifted (but only if the shift value is more than 64, and if so, then only by the amount exceeding 64). One of skill will acknowledge that MagicNumbers can be produced for binary numbers larger than 64 bits by using and extending methods disclosed herein to larger bit sizes.

FIG. 4 shows a human-readble table 258 of some suitable MagicNumbers 840 that can be used 304 according to the present disclosure in various embodiment implementations; this can be easily implemented in software code or hardware circuitry, which is not necessarily human-readable. Although the examples in this particular table use only multiples of ten, one of skill would agree that MagicNumbers can be used for any divisor, and therefore for any other number base.

### Some Additional Embodiment Aspects

Some embodiments include a Funnel 822 wherein the digital-base conversion algorithm code 202 uses 386 very efficient CPU operations by quickly scaling down the binary number 208 being converted 302. For example, on a 32-bit CPU 112 converting a 64-bit binary number, the algorithm 1074 will quickly split 378 the 64-bit number into smaller 32-bit components that are more quickly handled by native 32-bit CPU operations. One of skill in the art will understand that this teaching can easily scale to larger-bit CPUs, e.g., converting a 128-bit binary number by quickly splitting 378 it into 64-bit (or even smaller) components.

Additionally, one can manually or automatically select 380 faster functions 936 based on the size of the binary number being converted (in general, the smaller the number, the faster the conversion). For example, Visual Studio® 2008 Professional uses a 64-bit software implementation to convert 32-bit (and smaller) unsigned binary numbers into decimal when using native code 930, whereas the present disclosure describes better-fitting algorithms 1074 that can operate up to 44 times faster (or more).

Some embodiments emphasize or prefer 388 use of unsigned division and multiplication, which can be faster on some CPUs than signed equivalents.

One of skill in possession of the present disclosure will have flexibility to structure the choice of a particular funnel 822 algorithm so that either (a) small numbers are converted more quickly than larger numbers (if/then statements check for smallest ranges first), or (b) larger numbers are converted as quickly as possible (if/then statements check for largest ranges first). The largest numbers will not convert as quickly as the smallest, but they can be converted more quickly based on how the if-then statements are set up. In one embodiment handling 64-bit binary integers in a 32-bit execution environment, the high dword is first checked 392 to see if it is 0; if so, the number being converted can be handled as a 32-bit number.

In some familiar approaches, the smallest binary-to-decimal conversion offered is an ‘itoa’ function 872, 936 that handles 32-bit inputs; each number to be converted by it, if smaller than 32 bits, is first converted into a 32-bit number and then processed. By contrast, some embodiments provide a method that can directly handle 8-bit inputs using a table 234 lookup and can be forty to fifty times faster. Embodiments having these smaller-bit (i.e., 8-bit or 16-bit) functions 872, 936 are contemplated, even though conventional approaches provide only the larger-bit operations and appear to be unaware of the speed possible by using the 8-bit conversion directly. The smaller-bit functions may be less convenient for developers, since they must choose the right-sized function for the input rather than using a single routine for all conversions, but a tradeoff is increased speed.

Some Additional Observations About Technical Processes

Processes may be performed in some embodiments automatically, e.g., driven by requests from an application under control of a script or otherwise requiring little or no contemporaneous live user input. Processes may also be performed in part automatically and in part manually unless otherwise indicated. In a given embodiment zero or more steps of a process may be repeated, perhaps with different parameters or data to operate on. Steps in an embodiment may also be done in a different order than a top-to-bottom order that is laid out in this text. Steps may be performed serially, in a partially overlapping manner, or fully in parallel. The order in which steps are traversed may vary from one performance of the process to another performance of the process, and from one process embodiment to another process embodiment. Steps may also be omitted, combined, renamed, regrouped, or otherwise depart from the examples' flows, provided that the process performed is operable and conforms to at least one claim ultimately granted.

Examples are provided herein to help illustrate aspects of the technology, but the examples given within this document do not describe all possible embodiments. Embodiments are not limited to the specific implementations, arrangements, displays, features, approaches, or scenarios provided herein. A given embodiment may include additional or different features, mechanisms, and/or data structures, for instance, and may otherwise depart from the examples provided herein.

Some Observations about Floating-Point Numbers and FPUs

One difference between floating-point numbers and integers is that floating-point numbers can have a fractional component. Integers do not have a fractional component (or, some might say an integer does but that fractional component is always 0). Floating-point numbers have a whole-number, or integer, portion that is separated by a radix point from its fractional portion. In this description, the radix point is often termed the “decimal point” given that most of the examples herein are based on a radix of ten, or base ten, or the decimal base. Likewise, the fractional component is also sometimes called the decimal portion, again due to the examples being mostly concerned with base ten, or the decimal base.

Conversion 302 of floating-point numbers 208 into decimal format 210 is used in some examples herein, with the understanding that one of skill will also be able to apply many tools and techniques described in this document to a different radix and/or to a different binary format and/or to other displayable formats. Indeed, some embodiments provide a way of converting 302 binary integer numbers 208 into decimal format 210 by way of converting 384 the integer into a floating-point number. In this counter-intuitive approach, binary numbers of all types can be processed and converted, with some larger integer types being converted into floating-point format for faster conversion.

Real-number binary formats can handle extremely large and extremely small numbers. However, due to the binary nature of the format, some numbers that are very simple mathematically cannot be accurately stored for computation. For example, the number 0.1 has the repeating bit sequence “1101” in the mantissa, and therefore cannot be accurately stored no matter how many bits are used for the mantissa. Also, just as the representation of the value pi repeats forever and cannot be represented with decimal numbers, it likewise cannot be represented in binary. In fact, any number having a denominator with a prime factor that is not two may not be perfectly represented in binary form. Such numbers are therefore rounded 522 in order to use them. This is one reason that calculations using floating-point real numbers sometimes produce incorrect or unexpected results.

Binary floating-point numbers have three components, as shown below:

Sign 874—one bit: 0 means positive, 1 means negative

Exponent 806—varying size; includes a ‘bias’ (explained below)

Mantissa 876—varying size; also called ‘significand’

The following table shows the size of each component for several floating-point data types:

| Type | # Sign Bits | # Exp Bits | # Mantissa Bits |
|---|---|---|---|
| Float | 1 | 8 | 23 (24 incl. implied leading 1) |
| Double | 1 | 11 | 52 (53 incl. implied leading 1) |
| Extra precision | 1 | 15 | 64 (65 incl. implied leading 1) |

In an Intel® CPU 112 platform, all numbers (integer and floating-point) are stored in memory least-significant-byte (LSB) first in what is known as “little-endian” format. The LSB is stored in the lowest memory address while the most-significant-byte (MSB) is stored in the highest memory address for the variable. When transferred into a CPU, FPU, or other processor's register, the number is often depicted with the MSB at the far left and the LSB at the far right. A RIGHT-SHIFT operation will shift all the bits toward the right, or the LSB direction, making the number smaller (a RIGHT-SHIFT by one bit divides the number by two). A LEFT-SHIFT operation will shift all the bits toward the left, or the MSB direction, making the number larger (a LEFT-SHIFT by one bit multiplies the number by two, but can also cause an overflow that if left uncorrected can make the number smaller).

Floating-point numbers are stored in a binary base-two format 208 defined by the Institute of Electrical and Electronics Engineers (IEEE). Although examples herein apply specifically to IEEE formats, teachings provided herein can be applied by one skilled in the art to alternate binary formats, including floating-point numbers of other sizes and fixed- or floating-point numbers of other formats.

The value of a floating-point number can be determined by raising 2 to the power of the unbiased exponent E, multiplying that by the value of the mantissa (M) with its implied 1, and then multiplying by (−1) raised to the power of the sign bit (S):

(−1)^{s}×2^{(E-bias)}×(1+M)

The following diagrams show floating-point-number formats when a value resides in one of the FPU processor registers.

Float

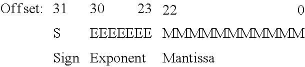

Double

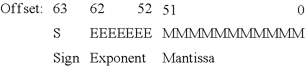

Extended-Precision

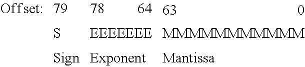

Some Observations about Real-Number Components

Sign.

The sign 874 is one bit, and is the most-significant bit. If 0, the number is positive and will range from +0 to +infinity. If 1, the number is negative and will range from −0 to −infinity. Note that in floating point, there are two types of 0: +0 and −0. For purposes of displaying values of 0 in human-readable format, these are treated as the same.

The sign bit is the only part of a floating-point number that differentiates a negative number from a positive number. The exponent 806 and mantissa 876 represent the absolute value of the number. Recognizing this fact can facilitate work with floating-point numbers.

Exponent.

The exponent 806 is the power to which the number 2 is raised to obtain the base-two integer portion of the number which will then be multiplied by the mantissa 876. The exponent can be positive (representing numbers greater than or equal to 1) or negative (representing numbers less than 1). A negative exponent represents a value that is the reciprocal of the number raised to the positive value of that exponent. For example, 2⁴ means 2 raised to the power of 4, or 2×2×2×2=16. Accordingly, 2⁻⁴ means the reciprocal of 2⁴, which can be expressed as (½)⁴ or 1/(2⁴), which is the same as ½×½×½×½=0.0625. Note that the reciprocal of the number 16 is 1 divided by 16, or 1/16, which is also equal to 0.0625.

In floating-point formats, a positive number with a non-negative exponent will be a whole number somewhere between 1 (inclusive) to the largest number represented by the format (one exception: the number 0, which has an exponent of 0). If the sign bit is set, the number range is from −1 (inclusive) and the largest-magnitude negative number represented by the format. A positive number with a negative exponent is a fractional number between 0 and 1, and can range from the smallest number greater than 0 that can be represented by the format to a number that is as close to 1 as possible, subject to the limitations of the format. If the sign bit is set, the range is from 0 to −1. However, not every number in the range can be represented exactly, unlike the mathematical numbers on a hypothetical number line.

The stored exponent is handled as an unsigned biased number. In actual use and according to the IEEE specification, a “bias value” is subtracted from the exponent to convert it to its proper negative or positive value. The bias value is at or near the middle of the range of the exponent values. This allows almost an equal-magnitude range of both very small and very large numbers. The bias for each floating-point format is specified by the IEEE 745 specification. The mathematical formula used to determine the bias is:

2^{(NumberOfExponentBits-1)}−1

Consider the exponent for a 32-bit float, which reserves 8 bits for the exponent. The above formula returns the result 2⁷−1=127 (or in hexadecimal notation, 0x7f). For a 64-bit float having an 11-bit exponent, the bias is equal to 2¹⁰−1=1023 (0x3ff). For an 80-bit extended-precision or a 128-bit quad-precision floating-point number, which both use 15 bits for the exponent, the bias is equal to 2¹⁴−1=16383 (0x3fff).

The lowest and the highest values of the possible range for the exponent are reserved to signal underflow, error, or other special computational situations (another example of how mathematics and computing differ). Under the IEEE specification, these rules apply to all floating-point exponents regardless of size.

An exponent having all bits set to 1 (the highest possible value for the exponent field) specifies that the floating point number is Not A Number (NaN). There are two types of NaNs: INFINITY and INDEFINITE. If the NaN has all zeros in the mantissa bits, the number is either +INFINITY (if sign is 0) or −INFINITY (sign bit is 1). A NaN with both the sign bit and the first bit of the mantissa set (all other bits are 0) signifies that the number is INDEFINITE, which means the result was impossible to obtain (this is what happens if one tries to subtract INFINITY from INFINITY, for example). There are two other forms of NaN: QNAN (Quiet NaN—the highest bit of the mantissa is set) or SNAN (Signaling NaN: the highest bit of the mantissa is 0, but one other bit is set). The teachings herein generally assume the floating-point binary number 208 to be converted is not a NaN but is either a normalized or a denormalized number. One of skill would want to ensure that the inputs 208 are proper floating-point values; if not, the implementer could detect the various NaN values and output either a displayable string 940, 210 indicating that case, or output a value of 0 or some other indicator that the floating-point number is a Nan.

When all exponent bits are 0, the number is 0 if all the mantissa bits are also 0. If any bits in the mantissa are set (with all exponent bits set to 0), the number is considered DENORMALIZED; the more zeros there are prior to the first set bit (moving from the MSB to the LSB), the closer to 0 the number becomes. DENORMALIZED numbers can result from storing a very small real number into a 32-bit float or 64-bit double size (the FPU normally uses 80-bit extended-precision numbers for all calculations, which helps preserve accuracy; using fewer bits can quickly lead to inaccurate calculations). DENORMALIZED numbers do not have an implied bit as the first bit of the mantissa.

Here are some key values of the exponent 806 for several different floating point types:

| Type | # Bits | Max Value | Bias | +Range | −Range | NaN |
|---|---|---|---|---|---|---|
| Float | 8 | 0xff | 0x7f | 0x7f-0xfe | 0x1-0x7e | 0xff |
| Double | 11 | 0x7ff | 0x3ff | 0x3ff-0x7fe | 0x1-0x3fe | 0x7ff |
| Ext-precision | 15 | 0x7fff | 0x3fff | 0x3fff-0x7ffe | 0x1-0x3ffe | 0x7fff |

Mantissa.

The mantissa 876 holds the fractional part of the number.

For normal numbers, there is an implied 1 in front, meaning that the actual number of bits used for the mantissa is one higher than the actual number of bits reserved for the mantissa. For DENORMALIZED numbers, however, there is no implied bit. The bit positions work similarly to the way digit positions in base 10 work, except that since this is base 2, the only possible values in any position are 0 or 1, rather than the range of 0 to 9 used in base 10.

The first bit (implied, but not stored) represents the whole number one. Then, starting with the left-most bit of the mantissa and moving from left to right, each bit represents a value that is one half of the previous bit. The left-most mantissa bit represents one half the previous value (the implied 1), or 0.5. The next bit represents half that value, or 0.25. The next bit represents half that value, or 0.125, and so on through the last bit to the right.

Note that for all numbers (except DENORMALIZED) there is an implied 1.0 to the left of the first bit of the mantissa which is added to the binary value of the mantissa base-two fractional number. This means the lowest possible value that a normal number can have in the mantissa is exactly the number 1, which is the case when all the mantissa bits are cleared to 0. A mantissa with all bits set to 1 represents the greatest number possible for the fractional part of the floating-point format; with the implied 1.0, this evaluates to a value that is very close to, yet still less than, 2. In some calculations, this value is rounded up to 2 by the numeric processor.

Some Additional Issues to Consider for Floating Point Numbers

Some numbers can have two different bit sequences 208. This is due to the fact that when the FPU works with numbers that cannot be exactly represented, it will sometimes apply rounding 254 to the number.

Consider the real number 2.0 represented as a float. Often this number would be represented with sign=0, exponent=0x80 (subtracting the bias of 0x7f returns an unbiased exponent of 1), and all zeros in the mantissa. Since 2¹=2, and since there are no fractional bits set after the implied 1.0, the number equals exactly 2×1.0=2.0. However, if all the mantissa bits are set to 1, then the mantissa approaches as close as possible to the value 2 (this creates the binary number 1.1111111 . . . ). Using an exponent of 0x7f will give an unbiased exponent of 0 (0x7f minus the bias 0x7f equals 0), so 2°=1. Then a mantissa of 1.0 with all the fractional bits set will round to 2.0 (it is actually calculated as 1.0+0.5+0.25+0.125+0.0625+0.03125+0.015625+0.0078125+ . . . , which approaches 2.0 as closely as permitted by the numeric format), and 1×2.0=2.0.

One method to deal with this is to add a rounding 254 factor to the number before it is converted. A rounding table 260 could be constructed 404 with each entry 820 representing the rounding factor to add to the number based on how many decimal places are desired to display in the output format 210. For example, if 0 decimal places are desired, add 0.5 to the number. If 1 decimal place is desired, add 0.05. For two decimal places, add 0.005, and so on. It may also be desirable to specify 406 that no rounding is to occur; it is possible the number was already rounded 522 prior to being passed to an embodiment which accordingly should not round the number again.

Overview of a Tri-Table Algorithm

An innovative triple-table method has been found useful to scale 314 a floating-point number to a certain power-of-ten range that then allows fast conversion 302 of the number to an ASCII format 210. The wider the range, the more decimal digits can be extracted at once, and the faster the algorithm can be. This method takes into account the nature of the CPU processing commands, reducing or eliminating 316 use of relatively expensive DIVIDE commands relied on by some other algorithms. It uses the MULTIPLY command to scale 354 a number to the desired range, and then uses fast commands to extract and manipulate the integer portion of numbers to the left of the decimal point.

Converting 302 a number from a base-two binary format into a base-ten decimal format in this algorithm involves determining 408 at least an estimate of the log-base-two of the number and of the log-base-ten of the converted number. Once the base-two exponent of a number is determined 408, a close estimate of the base-ten exponent can be quickly obtained 408. Some familiar methods identify 408 the base-two exponent of a floating-point number using a sequence of SHIFT, SUBTRACT, and sometimes other commands that allow that exponent to be used as an index to another table. In at least one embodiment, such a method is used to create an index, after which numbers are converted 302 by triplets into a formatted decimal display. Some embodiments described herein use a larger table 262 containing all possible combinations of the two MSB bytes 1056 of the in-memory format for a floating-point number, to more quickly identify 408 a close base-ten estimate of the number with no loss in accuracy. In some embodiments, the index obtained is not always exactly correct, and one comparison step is used to determine if it is correct (if not, the index is decremented by one). In some embodiments the tables 216 are created in reverse order, in which case the direction of operations becomes reversed (and so the index, if incorrect, would then be incremented by one after the suitable compare operation). In some embodiments, a combination of three or more tables 262 cooperating together permits fast scaling of a number to the desired range of 0 (inclusive) to 1000 (exclusive), for example, therefore facilitating fast conversion of up to three decimal digits at a time. Alternative tables 262 can allow for scaling to a range of 0 (inclusive) to 10,000 (exclusive), thereby facilitating fast conversion of up to four decimal digits at a time. Alternative tables 262 can be created 376 to support any other range, allowing more (or fewer) digits to be processed at the same time, provided sufficient memory is available and reserved for the tables.

In some embodiments, a Doubles1000 table 218 contains successive powers of 1000 (each stored in memory in the 64-bit double floating-point format), one of which is the nearest power of 1000 that is less than or equal to the binary number being converted. An Index2Doubles1000 table 218 contains pointers 962 to the Doubles1000 table that are based on a quick computed estimate of the log-base-two of of the 64-bit double floating-point number being converted (using at least some of its exponent bits for the quick estimate); the table covers all desired ranges represented by the 64-bit double floating-point format. Index2Doubles1000 is used to identify the index 832 of the Doubles1000 table that contains the nearest power of 1000 that is less than or equal to the binary number 208. That index is used to identify 318 the scaling power of 1000 from the Scale1000 table that will be used to scale the binary number to the desired range as explained herein. Similar tables could be created for manipulating 32-bit, 80-bit, 128-bit, and other floating-point sizes, and such tables provide and support alternative embodiments. Note also that since the exponent component of each of the aforementioned floating-point sizes is under 16 bits in size (according to the IEEE specification), they can be represented in an equivalent Index2formatsize table that uses 16 bits per entry. One of skill could use 80-bit extended-precision floating-point values in the Doubles1000 table, which would provide more accuracy, but which—because the 80-bit size is not a power of two—would slightly slow down accessing the table as described herein. In some embodiments, a Doubles10 table is used rather than a Doubles1000 table, but the Index2Doubles1000 table is created from the Doubles10 table, allowing access to the Doubles1000 entries as explained herein (which are every third entry in the Doubles10 table); one of skill would need to make various coordinating changes in other coordinating 518 tables and algorithms—when it is determined that the indexed value is incorrect, reduce the index by three rather than by one, for example—but the advantage would be to have just one table that can be used for all floating-point conversions (for both exponential-notation and triplets display formats), with the proper indexing tables (Index2Doubles1000 and Index2Doubles10) available as needed.

Note that in this context, “power of 1000” means a number that is an integral power of 1000. One million (which is 10⁶, or also 1000²) is an integral power of 1000. One billion (10⁹, or also 1000³) is also an integral power of 1000. One millionth (10⁻⁶, or also 1000⁻²) is also an integral power of 1000. Another way to explain this: a number is an integral power of 1000 if you can mathematically obtain the number by dividing 1 by 1000 enough times (for negative powers), or by multiplying 1 by 1000 enough times (for positive powers), assuming no precision loss due to overflow/underflow errors in the calculation.

In alternative embodiments, a Doubles10 table 218 contains successive powers of 10 stored in memory in the 64-bit double floating-point format, and cooperates with an Index2Doubles10 table, both of which are initialized in a manner similar to that used for the Doubles1000 and Index2Doubles1000 tables, with the main difference being the power of ten used (and the Doubles10 tables are larger, since they store more numbers). They cooperate with additional tables as described later in the present disclosure, and can be used to quickly convert 302 floating-point numbers into either exponential-notation format 210, or into a normal decimal-display format 210.

The term “triplet” as used herein refers to each group of three decimal digits to the left of the decimal point; triplets are an example of the more general term “digit grouping” which refers to a group 224 of digits in a decimal string or other digital-base conversion output. In decimal format, a thousands separator (e.g., a comma in the U.S.), is often used to separate triplets, making the number easier to read. The thousands separator is an example of a digit-group separator 228.

A variety of digit groups 224 and separators 228 are used around the world. For example, an American-format decimal number 45,789,001 has three triplets, and an American-format decimal number 56,980 has two triplets. In a Swiss-currency-format decimal number (such as 1′234′567.89), triplets are separated by an apostrophe. In China, commas and spaces are sometimes used to separate digit groups, a period is generally used as decimal mark, both thousands grouping (triplets) and no digit grouping can be found, and grouping can also be done every four digits (quadruplets, or 4-digit groupings, or 4-lets). In an Indian format decimal number such as 1,23,45,678 digit groupings of different sizes are used (2 digits and 3 digits). In a Mexican format decimal number such as 1′234,567.89 two different digit group separators are used (apostrophe and comma) and a period is used as a decimal marker. In Brazil and much of Europe, spaces or periods are used as thousands separators and a comma is used as a decimal marker: 1 234 567,89 or 1.234.567,89. All such formats can be handled by one of skill by implementing the teachings herein; some formats, such as the Mexican and Indian formats, may benefit from having separate tables customized with formatting characters that will be used by the various digit groups. A knowledge of the formatting rules, which varies by culture or region, helps ensure the resulting format is correct.

An American triplet is not always three digits; each of the numbers 5, 46, and 987 has just one triplet. In an American format, the left-most triplet of a number will have one, two, or three digits; but if a number has more than one triplet, all triplets after the left-most triplet contain exactly three digits. Other formats have their own respective syntax.

In some embodiments, an algorithm described herein uses multiple lookup tables 216 designed to eliminate calculations that would otherwise take more clock cycles if the values had to be calculated during the conversion process.

In order to create such tables, in some embodiments a value for the variable PowerOfTen is selected (usually a power of ten). The value determines how many digits will be extracted during each iteration of a main conversion algorithm. When PowerOfTen is equal to 10, one decimal digit at a time will be extracted. A value of 100 will extract two decimal digits at a time, a value of 10000 will extract four decimal digits at a time, and so on. In one implementation, PowerOfTen is equal to 1000, which allows conversion 302 of three decimal digits (one triplet) at a time. This value is then used to create each of the several tables 216 used by the implementation, as the tables cooperate closely with each other. One skilled in the art will be able to adapt these tables for any desired value of PowerOfTen.

In some embodiments, the value PowerOfTen (denoted by reference number 878) will be stored in memory as a 64-bit double floating-point number. In others, it is stored as an integer of the same size as a natural word 894, or as an extended-precision floating-point value.

In an alternative embodiment, two or more sets of tables 238—each based on different values of PowerOfTen (such as 1,000 and 10,000, for example)—are used, with the logic switching to alternate code paths depending on the desired number of digits to extract at a given point in the algorithm. Although that could in some cases result in faster code execution, it is more complex and takes more memory. Additionally, if a PowerOfTen equal to 10,000 is used, the digit groupings would be four characters without a separator, or five characters with the separator; so unless each entry that included separators was made equal to eight characters of storage (which doubles the size of the table, and could slow down copying the characters to display-string output buffers), although certainly feasible and helpful, this non-power-of-two size would add complexity to the algorithms described herein. An initial implementation therefore uses only one value for PowerOfTen, the value 1000 (which allows entries in the digit-groupings table to fit within four characters 885 of storage), and therefore uses cooperating tables −Index2Doubles1000, Doubles1000, and Scale1000—that reflect that value.

In some embodiments, the tables 216 will be created 376 prior to the conversion of any floating-point number to ASCII format. The table-creation process can occur at program 132 startup (as in the initial implementation), or the tables can be created beforehand by another process and made available statically to the current runtime process.

The following is an overview of one algorithm. PowerOfTen is set to 1000. To illustrate the algorithm, assume the floating-point number 208 to convert to ASCII format is 45,789,001 (accessed as the variable 914 OrigNum). The proper scale factor, used to scale 354 OrigNum to the range between 0 (inclusive) and 1000 (exclusive), is determined by accessing two lookup tables 218: Index2Doubles1000 and Doubles1000. OrigNum is then scaled to the proper range by using the Scale1000 table, and each triplet is then extracted until conversion of the entire 45,789,001 (in this example) has finished.

Prior to accessing the Doubles1000 table, bits from the exponent of OrigNum are used 338 as an index into the Index2Doubles1000 table (the value of the exponent is an adequately close approximation at this point of the log-base-two of the number) to return an index into the Doubles1000 table, NewIndex. NewIndex is then used 416 as an index into the Doubles1000 table to return a close approximation of the closest power of 1000 that is less than or equal to the number. The number at that index of the Doubles1000 table will be verified; if it is too large, NewIndex is decremented so that it points to the next-lower value from the table. In some embodiments, to verify the number, the FPU is used to compare the entry of the Doubles1000 table with the number being converted; in other embodiments, the CPU general registers are used (this can apply to all forms and versions of DoublesXXXX tables used in any methods described in the present disclosure, and is fastest when used in 64-bit, or larger, execution environments). In this case, the value returned from the Doubles1000 table is the value 1,000,000 (or 10⁶). A third table—Scale1000—will have, at the entry indexed by NewIndex, the value equal to the inverse (10⁻⁶) which is then multiplied against OrigNum to scale it to within the range 0 to 1000. In some embodiments, one or more entries of Scale1000 will be adjusted to pair with denormalized entries near the start of the Doubles1000 table, in order to ensure that the triplet groups of the scaled number are properly grouped such that, when a number bracketed by any such denormalized number is identified, it is multiplied by the proper number (or numbers) that will ensure that triplets are properly grouped after the number has been scaled.

Note that mathematically OrigNum could be divided by one million (the value at Doubles1000[NewIndex]) to return the value 45.789001, which would eliminate the need for the Scale1000 table. Alternatively, and as taught herein, OrigNum is instead multiplied 304 by the computational inverse of one million (multiplied by one-millionth) to obtain the same result, but with a MULTIPLY instruction rather than a DIVIDE. After this scaling operation, the left-most triplet ‘45’ is isolated to the left of the decimal point (and the remaining digits occupy the decimal portion to the right of the decimal point). The integer 45 can then be extracted and converted to ASCII format via another table lookup step. The value 45 will be used 416 as an index into the TripletsComma table, which includes 1000 triplets from ‘000,’ to ‘999,’—note that each triplet has an appended comma (the table can also be constructed with a prepended comma instead, with a slight change in the algorithm the adaptation of which will be straight forward to one skilled in the art; and if no separators 228 are desired, either a separate table 234 with no commas can be used, or the same TripletsComma table 234 can still be used 370, with commas being overwritten as described in the current disclosure). Each of these entries is exactly 4 bytes, or 32 bits, all of which can be accessed with one MOVE instruction with modern 32-bit (or higher) CPUs. Note that alternative tables can be built 376 using other characters as the triplets separator; or, the separators in the table can be modified from time to time as desired. In some embodiments, no additional table is used, and instead the digits are extracted 444 (one or more at a time) and then converted (one or more at a time) into ASCII display digits by effectively adding, or or-ing, the value 0x30 to each display digit, either before it is copied to the destination buffer or after; in some versions of these embodiments, separating characters 885 are also added as needed to the output buffer.

The value 45 is then used 416 as an index into TripletsComma, returning the four-byte string ‘045,’ which is placed 366 into the output buffer 212.

Then the value of the index 45 is removed from the number by subtraction (45.789001 minus 45 equals 0.789001). At this point, it can be readily determined 448 that the first triplet has only two significant digits (plus a comma), and the leading ‘0’ can be eliminated by adjustments 368 to the output buffer and its pointer, resulting in the output buffer containing the string ‘45,’ and the output buffer pointer 214 will then point to the position immediately after the comma. In some embodiments, the size of this first triplet (which has just two digits and a comma) is determined 448 prior to copying it to the output buffer, and instead of copying the string ‘045,’ to the buffer, the first byte 1056 of the string is skipped and the four-byte string ‘45,0’ is instead copied to the start of the output buffer (the ‘0’ after the comma is part of the next triplet ‘046,’ stored in the table), after which the output-buffer pointer position is incremented 368 by three (to indicate the next triplet should be copied to the byte immediately after the comma). One of skill can either quickly calculate 448 the number of digits in the first triplet, or can access 334 it from a FirstTripletCommaSize table 262 (triplets 0 thru 9 have one digit and a comma; triplets 10 thru 99 have two digits and a comma; all others have three digits and a comma), and the initial offset used to copy from the TripletsComma table can also be quickly calculated (it is equal to four minus the size of the triplet group), or it can be accessed from a FirstTripletCommaOffset table that contains the proper values.

Some other embodiments use a FirstTripletComma table 234 for the very first triplet, with each four-character entry having no prepended zeroes, but possibly having trailing nulls (use a FirstTriplet table for the first triplet when using three-character entries that have no separator). The entries 820 would be from “0,” to “999,” and each entry is easily accessed by using the integer value of the first triplet—45 in this case—as the appropriate index. In addition to being simpler and quicker, this method eliminates skipping over the unused leading zeroes, if any, in order to properly manage the output buffer. A quick access 334 of the proper entry in the FirstTripletCommaSize table will inform us that the size of entry 45 is three chars (two digits plus one comma). The appropriate entry from the FirstTripletComma table is copied 412 to the front of the output buffer and the output-buffer pointer 214 is then advanced to the correct position. After the first triplet, all remaining triplets can be handled by copying 412 the appropriate entries from the TripletsComma table and then incrementing 368 the buffer pointer by four characters for each subsequent triplet. Note that when a negative value is being converted, in some embodiments the first character of the buffer will be set to a minus sign; in other embodiments, it is placed at the end of the converted display string. In alternative embodiments, that first character will be an opening parenthesis, with a closing parenthesis at the appropriate place at the end of the number. In some embodiments, the minus sign is part of a FirstTriplet table that includes a minus sign for negative numbers (the first 999 entries), followed by the numbers 0 through 999 without signs (or with plus signs, if desired, for numbers greater than 0), and a FirstTripletSize table would be modified to reflect the new size of each entry; in such an embodiment, the table would be indexed by using the integer value of the first triplet, plus 999; and if the number being extracted had only one triplet, a null placed in the output buffer after the fourth character would ensure that any single-triplet number is properly null-terminated.

Next, the value 0.789001 is scaled by multiplying it by PowerOfTen—0.789001 times 1000 equals 789.001. The next triplet ‘789’ is now isolated as the integer portion of the floating-point number, and can be extracted and converted to ASCII format and appended to the first triplet, resulting in ‘45,789,’ in the output buffer. Then, the value 789 (which is the index) is subtracted from the number (789.001 minus 789 equals 0.001).

Next, the value 0.001 is scaled by multiplying it by PowerOfTen: 0.001 times 1000 equals 1.0. The next triplet ‘1’ is now isolated as the integer portion of the floating-point number, and its triplet ‘001’ can be extracted and appended to the output string resulting in ‘45,789,001’ in the output buffer. Then the value 1 (which is the index) is subtracted from the number (1.0 minus 1 equals 0.0), although one of skill could eliminate this last step at this point since it is not needed after the last triplet is obtained.

At this point, there are no other digits to extract 444. Since it is also known that each triplet in the output string has a comma appended, the last trailing comma is not used. A null value can be placed at its position, resulting in the completed ASCII format string ‘45,789,001’. Some variations include code for handling digits to the right of the decimal, padding, alignment, currency symbols, negative-value indicators, and so on. Such variations can be handled as explained elsewhere herein.

In some embodiments, an additional table 262 is used to identify 460 the number of triplets in the number being converted. For example, any number under 1000 is one triplet; any other number under 1,000,000 is two triplets; any other number under 1,000,000,000 is three triplets; and so on. This helps avoid the logic problem of the processing loop exiting too early when OrigNum reduces to 0 before all triplets have been extracted (which can happen for the number 1,000,000 for example). Such a table would have one entry for each entry in the Doubles1000 table. Some embodiments determine 222 the number of triplets via if/then statements that compare the magnitude of the number (i.e., “if (OrigNum<1000), numTriplets=1”).

Description of Tables Used in this Embodiment

Although in some embodiments three tables 216 are used to initiate the conversion from binary to ASCII format, additional tables 216 may also be useful in converting 302 binary numbers. The use of these additional tables can help further reduce clock cycles by avoiding various mathematical or comparison operations. The following is a description of some of the tables 216 that can be used by various embodiments. Each of the tables, or all of them, can be constructed 376 beforehand to create static tables that are loaded at program 132 startup. Or, they could be created 376 only once and then be maintained in memory 114, such as being created at some point during program 132 execution before they are needed. In some embodiments, tables 216 exist in global memory 114 by virtue of variable-initialization statements in a source code (making the compiler/assembler do the work). In some, a program 132 allocates memory from the heap and creates tables 216 programmatically after program startup; or alternatively, a program 216 can load into memory a static version of the already-created table 216 from some other location.

Doubles1000.

This is a table 238 of 64-bit doubles representing certain multiples of 1000. It is used to identify 318 the nearest power of 1000 that is less than or equal to the number being converted from binary to decimal; this table is accessed only to help initiate the conversion process. Note that this table can be extended to other formats if the desired number of digits to extract as a group is not 3. For example, a Doubles10 or Doubles100 or Doubles10000 table can be constructed if desired (using powers of 10 or of 100 or of 10000, and then appropriate multiples thereof). An aspect of constructing 376 the table is to set the first entry to 0, and the next entry will be the first and smallest power of ten fitting the desired pattern; each succeeding number is then equal to the value of the preceding entry multiplied by the desired power of ten. The number 1 is at or near the middle of the table and in proper sequence with preceding and succeeding values. As an exception, some embodiments include, as the second entry in the table, a value equal to the smallest number that can be represented by the floating-point format (equal to having only the least-significant bit of the floating-point number set); following that entry is the nearest power of 10 that is larger, according to the chosen power of ten, then followed by the normal pattern for all other entries. Special entries may be used for extremely large or extremely small numbers at either end of the table, such as so-called denormalized values (if other special entries are used, appropriate modifications may be made by one of skill to one or more tables that cooperate with the table containing the special entries). The table entries are the following:

Entry 0: 0
Entry 1: 10⁻³²¹
Entry 2: 10⁻³¹⁸
...
Entry n−1: 10³⁰³
Entry n: 10³⁰⁶

Note that one of skill in the art could implement a similar group of cooperating tables 238 with entries having values that are different than those depicted, while making the appropriate changes to the logic using such tables. All such modified table groupings are contemplated and considered part of the present disclosure, as long as each succeeding entry 820 is equal to the previous entry multiplied by PowerOfTen 878 (after the first two or three entries). (One of skill could reverse the entries in the tables and change other tables and program 132 logic accordingly). Using such alternate sets of numbers for this table is contemplated for alternative embodiments. Regardless, some embodiments use a table 218 of numbers to quickly bracket 318 the original number to a known range, after which the present algorithm or a similar alternative will quickly convert 302 it to ASCII format 210. Some embodiments use a table 218 where the first entry is one of the smallest valid numbers of the specified format (32-bit, 64-bit, 80-bit, etc. floating-point value), followed by an appropriate PowerOfTen multiple, and each succeeding entry is equal to the previous number multiplied by PowerOfTen. In some embodiments, the table 218 starts with an entry of 0, and then the next entry is the smallest number in the table, followed by an appropriate PowerOfTen multiple, followed by successive entries scaled by PowerOfTen as explained. In some embodiments, entries for denormalized power-of-ten numbers are included, such as 10⁻³²⁴, with subsequent entries scaled by PowerOfTen as explained. When certain very small numbers are used (such as 10⁻³²⁴, which is a valid denormalized number, but whose paired entry in the Scale1000 table, which should be 10³²⁴, is not a valid number in the format), the equivalent entries in the Scale1000 table are changed to smaller-than-desired entries, and appropriate logic in the algorithm is also changed so that input numbers bracketed 318 by these denormalized numbers are scaled twice, as explained later in the present disclosure (see also the Converting to Exponential Notation section below).

Imprecision of Floating-Point Values

The more precise the values in the floating-point tables, the more accurate will be the converted display string. Due to rounding issues, or the fact that many values cannot be exactly represented by the floating-point format, some entries in the Doubles1000 and Scale100 (and other tables 216 that have floating-point entries 820) are not exactly equal to the value they are supposed to represent; in fact, they can be off by one unit in the last place (ULP) which could make them either higher or lower than the desired entry. Additionally, some compilers 126 or assemblers might create values that are incorrect by more than one ULP. This can be detected and corrected by one of skill who also has access to the teachings in this present disclosure. If the value is within one ULP, it is safe to keep it as is.

One approach that can be used to check 470 floating-point entries in the tables 216 involves using an existing trusted function 936 to convert floating-point numbers 208 into decimal format 210, such as the sprintf command available with C or C++ compilers 126. Assume the double Value=1.0e−323 is to be checked. The command:

sprintf(buf, “%1.17e”, Value)
will convert the double Value into exponential format (one of skill would make sure the buffer ‘buf’ would be long enough to hold all characters of the output; 30 characters in length should suffice), resulting in the value “9.88131291682493090e−324” (this is the value produced as seen in the debugger output in Microsoft Visual Studio® 2008 Professional when executing and debugging C++ source code). It may at first appear too imprecise, but this is a denormal number, which by definition is imprecise because it uses fewer bits than normal numbers. The value at buf[0] is ‘9’, meaning the number is slightly under the desired value, and the exponent displayed is 324, and not 323 as one might have expected. One of skill can adjust the double Value by one ULP by treating the double Value as a 64-bit integer (unsigned long long, or ULL), and adding the value 1ULL to it, and then repeating the sprintf command. If buf[0] changes to [1] after adding just one ULP, the double value at that position is correct (as long as the exponent value changes only by one, also). In fact, the value will then change to “1.48219693752373960e−323”, which shows that the value in the table was within 1 ULP of the true number.

A similar (but opposite) test 470 works for numbers where buf[0] equals ‘1’. For example, when testing Value=1.0e128, the first use of the above sprintf command will return the string “1.00000000000000010e+128”, which is very close to exact. Since buf[0] is ‘1’, we can subtract one ULP by treating the double Value as a 64-bit integer and subtracting 1 ULL from it. The next invocation of sprintf returns the string “9.99999999999999880e−127”, which shows the original value was within one ULP of the desired value, so it is correct. One of skill may want to apply this check 470 to all floating-point numbers in all tables 216 containing floating-point constant values before producing a finished product incorporating teachings from the present disclosure. As a footnote, all the numbers produced in source code by Microsoft Visual Studio® 2008 were within one ULP of the desired number, so no changes had to be made to the tables (numbers were created using explicit statements declaring the variable as a constant, such as shown herein, and values included all powers of ten from 10.0e−323 to 10.0e308).

Scale1000. This table 218 is used to scale 354 the binary number to a value between 0 (inclusive) and 1000 (exclusive) according to the methods herein described. Each entry in this table is normally the reciprocal of the entry at the same index of the Doubles1000 table (when such reciprocal is a valid, normal floating-point value, such as the values from index 6 through the end of the table); it is equal to the value where the base-ten exponent is of the same magnitude yet with an opposite sign. For example, the entry at index 6 in the Doubles1000 table (at Doubles1000[6]) contains the value 10⁻³⁰⁶. The value paired with it in the Scale1000 table (at Scale1000[6]) is 10³⁰⁶—the exponent is the same magnitude (306) in both cases, but the sign is reversed in the Scale1000 table. Subsequent entries follow this pattern.

But entries 1 through 5 are much smaller than this pattern would dictate. Consider the entry at index 1. Since the value at Doubles1000[1] is equal to 10⁻³²¹, the proper entry to pair with it in the Scale1000 table is 10³²¹—but that is an invalid value and cannot exist in the 64-bit double floating-point format. But, since 10³²¹=10¹⁵×10³⁰⁶, the value 10¹⁵ is stored at entry Scale1000[1]. The algorithm takes this into account, and knows that any input number bracketed by the entry at Doubles1000[1] will have to multiplied by 10³⁰⁶ after it is first multiplied by the value at Scale1000[1] in order to arrive at OrigNum×10¹⁵×10³⁰⁶, which equals the number we want (which is OrigNum×10³²¹). This situation is the same for entries 1 through 5: each OrigNum bracketed by indexes 1 through 5 of the Doubles1000 table will be first multiplied by the entry paired with it at the same index of the Scales1000 table, and then it will additionally be multiplied by the value 10³⁰⁶ to finish scaling the number properly. Note that if tables for other powers of 10 are desired (or for powers other than 10), the equivalent ScaleXXXX table will be created according to these same rules. The table entries for the Scale1000 table are the following:

| Entry 0: 0 | |
|---|---|
| Entry 1: 10¹⁵ | // Denormal pattern here |
| Entry 2: 10¹² | |
| Entry 3: 10⁹ | |
| Entry 4: 10⁶ | |
| Entry 5: 10³ | |
| Entry 6: 10³⁰⁶ | // Normal pattern starts here |
| Entry 7: 10³⁰³ | |
| Entry 8: 10³⁰⁰ | |
| ... | |
| Entry n−1: | 10⁻³⁰³ |

Entry n: 10⁻³⁰⁶

Index2Doubles1000.

This table 262 is used to quickly estimate 408 the decimal magnitude (the log base ten) of the number 208 to convert to ASCII format 210. This table provides the index 832 for all permissible-in-the-storage-format combinations of exponent values that exist for the 16 bits at the high end of the floating-point format (where at least the exponent bits are stored). This index is used to identify the nearest power of 1000 from the Doubles1000 table that is less than or equal to the binary number being converted. Because each table entry gives only an estimate, the actual index identified in this table is tested to see if it is the correct index for scaling the number as explained previously; if it is not, the prior index (one entry closer to the start of the table) will be used. The method used to create these entries is described in detail in the section “Constructing Index2Doubles1000 Table” below. Note that this table could be constructed in reverse order with coordinating changes to the algorithms, and/or to other coordinating 518 tables 216, by one of skill in the art; such modifications are also contemplated herein.

TripletsComma.

This table 234 includes the triplet output strings 940 (each with a separator character) in Unicode8 format when extracting 444 three digits at a time. It can be used for formatting numbers left of the decimal point with thousands separators, or it can alternatively be used for non-formatted (in the sense of no digit-group separators) numbers on either side of the decimal. When formatting with thousands separators is desired, the output process will copy the four characters from the appropriate entry in the table (including the comma, space or other thousands separator) and will then increment the desired output pointer by 4 characters (for triplets). When formatting is not used, the output process will copy the four characters from the appropriate entry in the table and will then increment the output pointer by three characters rather than four (the three decimal digits). Four characters can be accessed simultaneously by using 32-bit registers—it is “more expensive” to access just three digits. Incrementing the output pointer 214, 962 by three results in a subsequent string overwriting the separator character, which is fine because no separator character is wanted in the final output. In some embodiments, the separator character is the first character; if so, one skilled in the art should modify the algorithm explained herein to accommodate and coordinate 518 such a change with other tables and processes. This table can be used when converting any type of binary number.

Some embodiments maintain this TripletsComma table in write-enabled memory 114. That allows the embodiment to quickly adjust the table for any other thousands separator by quickly modifying 478 the separator 228 for each entry. Then, all subsequent accesses of the table entries 820 will contain that new default thousands separator. If the table is made constant 916 and then placed into read-only memory, the thousands separators may not be able to be changed in place. Note also that as the decimal formats are being constructed for any specific number, one of skill in the art can easily overwrite the thousands separators with any desired separators for that number being formatted.

This TripletsComma table has 1,000 entries representing the integers 0 through 999. Each output string corresponds to the integer in the zero-padded three-digit ASCII format for that number, plus a comma. A person skilled in the art will recognize that although these strings are stored in memory in little-endian format, a similar table can be constructed 376 for a big-endian format if desired.

Note that this TripletsComma table can be quickly formatted for locales that use a space or other non-comma separator by replacing 478 the comma with the desired thousands-separator character. Alternatively, a separate table could be built and accessed as desired, e.g., one table with strings such as “000,” and another table with strings such as “000”. Note also that this table is for Unicode8; a similar table could be constructed for Unicode16, where each character requires two bytes as is known by those skilled in the art. The table can be constructed 376 at run time, or beforehand and then loaded into memory at the appropriate time, by methods known to those skilled in the art, if desired.

Entry 0: “000,”
Entry 1: “001,”
Entry 2: “002,”
Entry 3: “003,”
...
Entry 998: “998,”
Entry 999: “999,”

Triplets.

If desired, a separate Triplets table 234 can be used that includes no separator characters, and where each entry is null terminated. Using such a table to extract triplets where no separators 228 are used can then be done, and after the last triplet is copied to the buffer, the step of placing a terminating null at the end of the display string is no longer used (since each triplet is copied with a terminating null every time).

FirstTripletComma.

This table 234 is similar to the TripletsComma table, except that the entries are not zero-padded in front, and it contains the same separators as the TripletsComma table. It is used to extract the first triplet of a number.

FirstTriplet.

A separate FirstTriplet table 234 could also be used to coordinate 518 with a Triplets table for cases where no separators are required. As with the FirstTripletComma table, this table can also be used when converting any type of binary number.

TripletsCounter.

This table 262 returns the number of triplets to the left of the decimal place, which can be used to control 482 the number of program loops or steps used to extract and convert binary numbers into decimal strings. This table can be used when converting 302 any type of binary number 208. It contains the same number of entries as the coordinating 518 Doubles1000 table. All entries that pair with values in Doubles1000 that are less than one, are set to one (the first triplet for those numbers will always be “0” since they are all less than the value one).

RoundingTable.

This table 260 is a list of doubles. The number of entries in this table is equal to the maximum number of decimal places permitted, plus one. Each entry is a double, although an 80-bit extended-precision format could be used (it would slow down accessing the proper index, but might increase precision):

Entry 0: 0.5
Entry 1: 0.05
Entry 2: 0.005
Entry 3: 0.0005
Entry 4: 0.00005
Etc.

FirstGroupChars (AKA FirstTripletSize).

This table 262 is 1000 bytes (however, it can be sized according to the natural-word size 894 if desired, which could in some cases slightly speed up some embodiments). Each entry 820 is indexed by the first triplet integer created from the initial scaling of the binary number to the desired scale range. It tells how many actual ASCII characters are used to represent that first triplet. Note that when used in conjunction with comma-formatted numbers, a FirstGroupCharsComma table could be used where each value will be the number of digits plus one (to include the separator). Also note that in a C/C++ implementation, the value in the table is the number of characters, while in an assembly-language implementation, the value will be the number of bytes (one byte per character for Unicode8, two bytes per character for Unicode16).

Entry 0: 1
Entry 1: 1
...
Entry 8: 1
Entry 9: 1
Entry 10: 2
Entry 11: 2
...
Entry 99: 2
Entry 100: 3
Entry 101: 3
...
Entry 999: 3

This table can be used when converting any type of binary number.

MaxDigits.

This table 262 returns the maximum number of digits to the left of the decimal place. It is based on the index used to scale the number, and can be useful when padding or aligning the display string. The values in the table can be coordinated 518 with the values in the FirstGroupChars table to return 464 the exact number of characters in the converted display string 210. In some embodiments, this table contains, at each entry, the value equal to 3 times the number of triplets as identified in the TripletsCounter table. In an alternative embodiment, the MaxDigits table returns the size of all triplets except the first, so that adding the proper entry from FirstGroupChars to the value from MaxDigits will give the total size of the display string. (One of skill could create Comma versions of MaxDigits and FirstGroupChars that could also be used to account for separator characters.) This table can be used when converting any type of binary number.

FirstDigitAt.

This table 262 is 1000 bytes and tells us the offset to the first character in the Triplets or TripletsComma table after the initial scaling of the binary number to the desired scale range. This table can be used 370 when converting 302 any type of binary number. In some embodiments, using this table can remove the need for a FirstTriplet table. Each entry is equal to three minus the number of digits for that entry:

Entry 0: 2
Entry 1: 2
...
Entry 8: 2
Entry 9: 2
Entry 10: 1
Entry 11: 1
...
Entry 99: 1
Entry 100: 0
Entry 101: 0
...
Entry 999: 0

Some Elements of Converting from Base Two to Base Ten

Some embodiments reduce the time taken to convert 302 a binary number 208 to ASCII format 210 by using hybrid approaches that identify certain cases that can be handled much faster by custom methods, thereby dramatically speeding up conversion. Some methods allow bypassing or skipping steps used in other implementations. Some reduce or even eliminate DIVIDE operations. Some use counter-intuitive approaches such as converting large integers into floating-point format for faster conversion, or vice versa. Some use the general-purpose CPU registers to manipulate the component parts of a floating-point value to create an integer plus a binary fraction from which remaining decimal digits can be extracted using MULTIPLY commands of the CPU. Some add thousands separators without consuming extra CPU clock cycles. Some overwrite portions of the output bytes in order to speed up processing.

Some familiar-art methods teach conversion of binary numbers to a raw ASCII format, which lacks thousands separators, currency indicators, and other custom formatting. But numbers are sometimes used with more than the basic decimal point and negative sign, and therefore the teachings herein can apply when no thousands separators are desired. Using commas (or other separators) as the thousands separator 228 makes numbers more readable. A currency symbol 250 may be desired at the beginning or the end of the formatted decimal 210 display. Some locales use a different decimal separator than the period used in the United States. A number may optimally be aligned 484 (right-aligned, left-aligned, or centered). Additionally, using parentheses around a negative number instead of the negative ‘−’ sign to indicate 488 a negative value in output 210 may be desired; or a trailing negative sign may used 488, and/or a positive sign at the front or the end of the number may be used 488. Some embodiments presented herein combine in step 302 the custom formatting of numbers and the conversion from binary to decimal, including for example inserting thousands separators without adding extra clock cycles to the conversion process for each individual separator placement. That is, no extra clocks are needed when using separators, and when not using them one can avoid the separate step of adding a null terminator.

If desired, one of skill in the art can incorporate and combine any one or more formatting processes in a digital-conversion function 936 that can save clock cycles by reducing the number of function calls 544 made. The various formatting issues are common across all number types (even including exponential notation which, although normally reserved for use in displaying floating-point values, can certainly apply to formatting any type of binary number).

Some Observations about Memory Usage

Some embodiments use memory 114 differently than in other conversion methods. At times, some embodiments cause more characters to be written 412 to an output buffer 212 than are actually desired as part of the final output 210. Assuming 32-bit instruction processing and with PowerOfTen=1000, it is possible for up to three extra characters to be written to the front of the output buffer and/or to the end of the buffer in implementations that may write to such a buffer safety zone 818. Therefore, some embodiments include in the buffer two safety zones 818, each sufficient to handle at least four characters (one triplet) more than expected for the final custom formatted decimal output (or other output), one zone 818 being at the front of the buffer and one zone 818 being at the end of the buffer 212. This allows the algorithm to use fast 32-bit-wide MOVE instructions without clobbering memory. Alternative implementations use larger registers 206 that transfer 64, 128, or 256 bits at a time (or more), which have an equivalent-sized buffer 212 to prevent memory access or memory-overwrite errors. The safety buffer 818 is at least equal in size to the largest block that could be accessed at one time by the algorithm.

In one implementation, the buffer 212 used is internal to the algorithm; the buffer is eight-byte aligned in memory 114 and is carved out of a larger buffer pool 880. Or, the user 104 can supply the output buffer 212, and the algorithm starts the output at the first byte of the user-specified buffer 212. More generally, in some implementations, the starting position for output (assuming Unicode8) is immediately after the first four-byte safety zone 818 of an internal buffer 212, and there is another safety zone 818 of at least four bytes at the end of the buffer 212. (In other implementations, where the user-supplied buffer is large enough, it can be handled as though it had safety buffers on each end, and the returning function will return a pointer 962 to the first byte of the actual converted display string 210.) The total size of the buffer 212 accomodates the largest possible output string 210 that will be generated, taking into account all types of custom formatting, including the longest type of padding 246 expected, plus possible overwriting at either end. The actual buffer 212 used can be part of a much larger circular buffer pool 880 that is reused over time, eliminating the overhead of allocating memory for each numeric conversion. Once the number 208 has been formatted, the formatted number 210 is copied via one or more very fast MOV (a.k.a. MOVE) commands to the user-specified buffer to position it where it is used. Alternately, in some cases a pointer 214 to the start of the ASCII format for the just-converted buffer will be passed to the caller, without copying the output elsewhere; one of skill using teachings herein can adjust the address of the buffer to start at the very first digit of the first triplet of the converted number. Those skilled in the art will appreciate that, when using Unicode16, two bytes are required for each character, so each buffer, with the associated safety zones 818, may need to be increased in size accordingly. Note that when a circular buffer is used, at some point the algorithm will re-use portions of the buffer; one of skill would recognize that in some heavy-use scenarios, either the buffer must be enlarged and/or care must be taken to ensure that earlier buffers containing converted display strings are no longer needed, or are quickly released, by the code paths using them in order to prevent buffer collisions (i.e., using for a buffer a portion of memory that is still being used elsewhere). Such a scenario could render the algorithm thread 882 unsafe.

Additionally, an implementer can determine how and when to add 430 pad characters 246, if requested. In one embodiment, it is possible to calculate the exact position of the first actual digit once the first TruncatedNum is calculated (see below). At that point, it is possible to determine exactly how many digits on either side of the decimal point will be generated, how many characters (if any) are used for thousands separators, whether and where a currency indicator would be placed, how to handle various ways of dealing with the display of negative numbers, and the number of desired pad characters, and therefore where the first digit ought to be placed depending on the justification alignment (left, right, or centered). This is possible for one of skill in the art having possession of this disclosure; various tables as further described in the present disclosure can be referenced to save time or to simplify these calculations. Padding 430 and alignment 484 may assume a mono-spaced font 884. One of skill in the art will be able to change to a variable-spaced font 884, at the cost of additional complexity and processing time to determine padding and alignment characteristics. Such a skilled implementer could also apply these teachings to either floating-point, fixed-point, or integer values, or to binary numbers 208 of other formats.

If desired, one of skill in the art can quickly determine 464 the size of the formatted output (prior to actually converting the binary number) via the use of lookup tables. Once the scale of the number is determined, the number of triplets can be readily determined, and the full size of the number (with commas or other formatting, as desired) can be determined.

The size 256 will be adjusted by the size of the leading first triplet and by whether the number is negative or positive, and if negative, whether a leading minus sign or enclosing parentheses are used 488. Then, where padding or other alignment is desired, one of skill in the art can readily determine the number of leading pad characters and can insert them quickly.

In some embodiments, a buffer 212 filled with pad characters 246 can be created prior to being overwritten by numeric values, and then any padding can be copied to the front of the buffer using large multi-byte natural-word-size 894 moves from that pad buffer into the output buffer, rather than inserting the pad characters one at a time. Then, the binary number can be converted starting at the exact desired location for the first digit of the decimal output, followed by any trailing padding desired.

In some embodiments, before any other formatting is performed—including the addition 430 of padding characters at the front of the converted number—the digits to the left of the decimal place are extracted 444 (with or without the thousands separators, which are automatically copied), followed by the decimal point and any digits to the right of the decimal point. This is due to speed enhancements that cause 32-bit (or sometimes, 16-bit) values to be placed in the output buffer when fewer bits are actually needed, and where this action could overwrite characters either to the left or to the right of the numeric output. Following the teachings herein will help ensure that none of the digits or formatting of the output are overwritten. Then, once the number has been converted, the size (string length) 256 of the converted number can be quickly obtained (both the front and the end of the buffer would be known at that time), and the remaining custom formatting can be added very quickly in minimal time without overwriting the desired output. In some variations, the number is first converted to a temporary buffer, and then copied quickly into the destination buffer 212 with care to not overwrite any bytes other than those required to hold the converted number string (to preserve specialty formatting, for example, that might have been pre-written across that buffer). It has been found that using a FirstTriplet and a FirstTripletSize table, or similar tables for separators as explained in the present disclosure, can sometimes increase the speed of the algorithm by allowing exact placement of the converted number to the desired output-buffer location, without requiring subsequent copying to another location.

As shown in the preceding paragraph, some discussion herein uses “conversion” and similar terms (convert, converting) to mean numeric base conversion, e.g., from binary to decimal, and uses “formatting” to mean custom or speciality formatting of a converted value, such as padding 430, alignment 484, indication 488 of negative/positive value, choice of notation 252, or use of a currency symbol 250 or separator 228 or decimal point character 242. However, other discussion herein uses “formatting” to mean conversion, custom or speciality formatting, or both, e.g., unless stated otherwise step 302 “formatting” or “transformation” or “conversion” can include base conversion 490, custom or speciality formatting 494, or both. Indeed, those of skill will appreciate the performance advantages of embodiments herein in which base conversion 490 and speciality formatting 494 are tightly integrated with one another.

Regardless of the terminology used, if a change from binary to decimal representation of a number is part of a process or system, then base conversion 490 is part of that process or system. Likewise, regardless of the terminology used, if padding, alignment, indication of negative/positive value, choice of notation, or use of a currency symbol or separator or decimal point character is part of a process or system, then custom formatting (a.k.a. speciality formatting) 494 is part of that process or system.

An Algorithm to Convert a Floating-Point Binary Number to an ASCII Format String

This algorithm can be implemented in C, C++, or assembly language, for example. Although assembly language 866 has long been recognized as potentially producing the fastest code, programmers skilled in assembly language are relatively rare in comparison to those skilled in high-level languages 868. Also, assembly language has not been widely available for producing managed (e.g., .NET) code. This may change with the recently introduced Microsoft WinRT cross-platform application architecture, which supports development in C++/CX, managed languages, and JavaScript, and natively supports both the x86 and ARM processor architectures. Similarly, assembly language has not been widely available for Java® environments (mark of Oracle America, Inc.), or some other environments, and so determining the best or fastest method may involve significant manual coding and testing.

For native implementations 930, C or C++ programming language code can often be used for an initial implementation, with assembly-language-tuned implementations to follow, allowing the implementer to use fast CPU instructions or special optimizations which might not be available otherwise via a C/C++compiler. Also, when variables are created or referenced, the implementer can determine which ones would reside in CPU registers and which ones in memory.

A step in some approaches is the determination 496 of special cases 890. This is further described in the section below entitled “Some Special Cases”. One special case 890 to be detected 496 is whether the number 208 is a NaN; if so, the implementer will decide what to do. Also, since the floating-point methods taught herein are designed for positive numbers, another case 890 to be determined 496 is whether the number 208 is negative or not. If it is negative, that fact is acted 488 upon by setting a flag, by entering a minus sign at the start of the buffer, or by some other method desired by one of skill; then the number is made 362 positive by clearing the sign bit to 0 (or by some other method available to the implementer, such as using an FPU instruction, negating the number, etc.). Some special cases 890 will move processing to a separate code path for conversion, and others will return to the main process algorithm code path as described herein.

The next step involves determining 408 an estimate of the log₁₀ of the binary number so an embodiment can determine how to scale 354 the number so that it is between 0 (inclusive) and 1000 (exclusive). Several known methods can be used to perform this determination, but are computationally expensive. For example, a known sequence of commands uses the FYL2X floating-point command 116 of the Intel (and compatible) FPU to determine the log₁₀ of the binary number. This command alone can consume over 100 clock cycles on some CPUs, and is used in conjunction with other commands that add further cycles, all of which is done before any number conversion can commence.

An alternate method that allows the CPU to do much of the work involves use of the FBSTP command (a.k.a. function or instruction 116). This command converts a binary number into packed BCD (binary coded decimal) format, which can then be extracted and converted into the desired ASCII format. But this command alone can take from 125 to 400 clock cycles, depending on the CPU—and that is before outputting any display characters into the output buffer.

One improvement to methods using the FBSTP command is to create and use a BCDtoAscii table 234 that contains doublet strings 940, allowing output of two digits per BCD byte (the FPSTP command outputs a string of 10 packed BCD bytes 886, with each byte representing up to two digits). Each entry of the table is coordinated 518 with each of the possible BCD values 886; there are just 100 “legal” values for any given BCD byte that represent the numbers from 0 through 99, and such legal values range from 0x00 through 0x99. The table should be designed so that the packed BCD byte can be used as a direct index 416 to access the proper string. Given that many byte values are invalid BCD values (such as any value whose hexadecimal representation uses any letter from ‘A’ through ‘F’), some entries will not be used, but are “space-holding” entries that enable each valid index to access its proper string 940. Also, since any value greater than 0x99 is not a valid packed BCD value, one might be tempted to shorten the table and not represent strings for values greater than 0x99. That might work if one could guarantee that no invalid byte would ever be returned, but it is safer to plan for the unexpected and include 500 “dummy” entries 888 for all invalid entries (use all spaces, for example). For example, the BCD byte 0x75 should convert to the string “75” and not to the string represented by the decimal value of 0x75 (which is 117). The first 20 entries of a BCDtoAscii table 234, therefore, would be:
“00”, “01”, “02”, “03”, “04”, “05”, “06”, “07”, “08”, “09”, “ ”, “ ”, “ ”, “ ”, “ ”, “ ”, “10”, “11”, “12”, “13”, etc.

One could construct 376 the table with two bytes per entry 820 (in which case, the implementer would need to add a terminating null at the end of the display string) or with four bytes per entry (two nulls after each string); also, each table could be constructed to handle Unicode16 strings, with such a table requiring twice as many bytes for each string and for the total table size. In either case, or in other similar cases, and combined with other teachings herein, one of skill will be able to quickly create a display string 210 after executing the FBSTP command.

One additional method that can be useful where packed BCD numbers are used is to incorporate a pair of tables 216 (AtoBCD_Lo and AtoBCD_Hi) that help in converting 504 ASCII display strings into appropriate BCD values 886. Each table would have 256 integer entries (8-bit integers are acceptable, although using integers that are the natural-word size 894 may be faster in some embodiments); all unused entries are set to 0. The AtoBCD_Lo table has ten used entries, 0x30 through 0x39 (representing the ASCII values of ‘0’ through ‘9’), which are set to the values 0 through 9, respectively. The AtoBCD_Hi table also has ten used entries, 0x30 through 0x39, which are set to the values 0x00, 0x10, 0x20, 0x30, 0x40, 0x50, 0x60, 0x70, 0x80, and 0x90, in that order. An ASCII string can then be converted 504, by one of skill using teachings of this disclosure, from either least-significant digit to most-significant digit, or in the reverse direction. Each pair of decimal digits in the ASCII string convert 504 to a single BCD value: the first, or most-significant, digit of the pair can be used as an index into AtoBCD_Hi and would return a value from 0x00 to 0x90. The second digit can be used as an index into AtoBCD_Lo and would return a value from 0 to 9, as shown. Assume the variable Str contains the display string “123456”, which is six bytes in length. The BCD value 886 of the string of digits can be quickly extracted by the commands:
Value12=AtoBCD_Hi[Str[0]]+AtoBCD_Lo[Str[1]];
Value34=AtoBCD_Hi[Str[2]]+AtoBCD_Lo[Str[3]];
Value56=AtoBCD_Hi[Str[4]]+AtoBCD_Lo[Str[5]];

One of skill can extend this example to convert 504 display characters into BCD characters 886 until all digits have been converted, paying care to not extend beyond either end of the string being converted, and to account for non-digit characters in the string. If there is an odd number of digits in the ASCII string being converted to packed BCD format, the most-significant digit should be converted separately, and not in combination with any other, by using the AtoBCD_Lo table. Note that one of skill can convert this method to handle display formats other than ASCII.

One approach described in U.S. Pat. No. 5,796,641 (“the '641 patent”) uses a SUBTRACT, a SHIFT, and two LOOKUP operations, plus an AND operation that appears to be called for but was not mentioned in the '641 patent, followed by one COMPARE and either a JUMP or a second SUBTRACT operation to determine a close approximation of the base-10 equivalent for the base-two number. These operations operate quickly to approximate the base-ten equivalent of the number. But even this approach can be improved. The entire '641 patent is incorporated herein by reference.

As taught herein, some embodiments eliminate the SUBTRACT, SHIFT, and AND operations noted above, through the use of a larger first lookup table 218. The embodiment consults a pre-computed table 218 to find 318 the closest power of 1000 (rather than 10) that is less than or equal to the number. This will allow the number to be scaled 354 so that up to three digits at a time will be isolated to the left of the decimal point, with all other digits to the right. Note that with the first scaling—for example considering the number 1,234—the digit ‘1’ will be to the left of the decimal, with the digits 234 to the right; on the next iteration the digits ‘234’ will be to the left of the decimal. At each iteration, with creative use of simple and fast CPU instructions, the integer portion of the number can be extracted 444 and an appropriate sequence of ASCII format characters identified and copied into an output buffer 212. Then that integer portion can be subtracted 498 from the number, and the remaining fraction again scaled 354 to isolate 502, to the left of the decimal point, the next group of digits to convert.

Although any power of 10 can be used in this method, it will be appreciated by those of skill in the art that using the value of 10 will isolate 502 just one digit at a time to the left of the decimal place, while successively higher powers of 10 will isolate 502 successively more digits. Using powers of 100, for example, would isolate 502 two digits at a time; using powers of 10,000 would isolate 502 four digits at a time. In an initial implementation, using powers of 1000 will isolate 502 up to three digits at a time and will allow for natural grouping when a thousands separator 228 is desired to make the final format of the number more readable, with such custom formatting 494 not requiring additional clock cycles 891. Those of skill in the art having possession of this disclosure will also appreciate that the more digits converted at a time the faster the algorithm 1074 will tend to be. They will also appreciate that this method can be used by bases other than ten; for example, base-eight tables 216 could be used to convert binary numbers 208 into an octal ASCII format 210.

Alternate implementations include a hybrid approach that uses multiple sets of tables. For example, when thousands separators are not desired, or when processing digits to the right of the decimal point where group separators are not desired, it may be faster to use a table 234 based on powers of 10000. This could be slightly faster for numbers with many digits on either side of the decimal place when no commas are desired, as it could eliminate one or more iterations from the main loop. For example, processing a number with 15 digits to the left of the decimal place would take five iterations when using powers of 1000, but only four iterations when using powers of 10000, a speed gain for the inner portion of the algorithm.

As herein described, one implementation uses the value 1000 for the power-of-ten value, and several tables 216 customized for that value are pre-computed and available to the algorithm 1074. The Doubles1000 table 262 is a list of 64-bit double floating-point numbers, each a power of 10. The first number is 10⁻³²¹ followed by 10⁻³¹⁸ and then continuing, each number being 1000 times greater than the previous (i.e., the exponent is 3 units higher), until the last entry of 10³⁰⁸. This table is used to determine an index that identifies the exact power of 1000 that is nearest to the number and also less than or equal to the number. That index will then be used to scale 354 the number to a value between 0 (inclusive) and 1000 (exclusive) so an embodiment can start converting digits to ASCII format. The Doubles1000 table takes less than 2 k of memory.

To determine the proper index identifying the desired value from the Doubles1000 table, another table 262 is used. This table Index2Doubles1000 has 65,536 short (two-byte) entries, therefore using 128 k bytes of storage. This table allows an embodiment to eliminate the SUBTRACT and SHIFT (and AND) operations of the method taught in the '641 Patent, thereby speeding up the process. To use this table, the two most-significant bytes of the double floating-point value are used 416 as the index into the table. No SHIFT or AND instructions are used, and this works no matter the sign of the number. Alternatively, if a smaller memory footprint is desired, a much smaller table can be used. However, to use this smaller table, the exponent is first isolated by SHIFTing the 64-bit double to the right 52 places, ANDing that result with the value (2¹⁰−1) to remove unwanted bits, and then SUBTRACTing the bias to obtain the index into a smaller TinyIndex2Doubles1000 table, which is then used to access the Doubles1000 table. The initial implementation uses the much larger and faster Log2Double1000 table as herein described. Those of skill in the art having possession of this disclosure understand that the components of the 64-bit double could be accessed via byte- or word- or other-bit-oriented instructions, in which case the SHIFT, AND, and SUBTRACT values given above may be changed to reflect the method used to manipulate the bits of the binary number. Other methods could also be employed to determine the index into the Doubles1000 table.

The use of the Index2Doubles1000 table relies on the storage format of the 64-bit double. Those of skill in the art having possession of this disclosure will recognize that similar tables and extraction methods would be used for 32-bit or other-size floating-point numbers.

Some embodiments use a shortcut to quickly determine the index into the Doubles1000 table. Taking advantage of the fact that a portion of the floating-point number can be accessed by the CPU without having to load the entire number into the FPU, and with the understanding that the Intel® CPU stores binary numbers in little-endian format (least-significant byte first), an embodiment can quickly isolate the 16 most-significant bits of the double number. In the 64-bit double format, the most-significant bit is a sign bit, followed by 11 exponent bits. These 12 bits (plus four bits from the mantissa) are located in the two right-most bytes of the double when stored in memory, which can be accessed as a 16-bit word. With that portion of the double in a general register of the CPU, it can be used 338 directly as an index into the Index2Doubles1000 table to obtain the index for the Doubles1000 table.

Assume the number to convert is the 64-bit double number OrigNum=2,048. Since OrigNum is actually an integer power of 2, all the mantissa bits will be clear (this makes the explanation clearer). Since OrigNum equals 2¹¹, the exponent portion 806 will have the unbiased value of 11. Using a familiar method, this number 11 would be extracted by using the various SUBTRACT, SHIFT, and AND functions. However, the raw unconverted portion of OrigNum that contains the exponent bits can be used 338 unmodified with an intelligently created table that eliminates reliance on those extraction functions.

In some embodiments, the last two bytes of the in-memory structure for OrigNum are extracted using a word-based operator. In the example, the value obtained will be 1034 (which is equal to the exponent 11 after adding the bias of 1,023). If OrigNum had been a negative number equal to −2,048, then the sign bit would be set and the number extracted would be 33802 (the absolute value of the number is used after this step, so the method herein described applies equally to both positive and negative numbers). Inside the Index2Doubles1000 table, the entry indexed by either of the above two values 1034 or 33802 will contain the value 104, which value when used as an index into the Doubles1000 table points to the value 1000 (i.e., Doubles1000[104]=1000), which is expected to be the nearest power of 1000 less than or equal to OrigNum. In other words, both Index2Doubles1000[1034] and Index2Doubles1000 [33802] contain the value 104.

This index result (Index=104) indicates that the number found at Doubles1000[Index] is likely to be the nearest power of 1000 that is less than or equal to the number. However, approximately 25% of the time the number sought is actually the preceding number in the table. This is due to the fact that the Index2Doubles1000 table can give only an approximate value since it does not take into account any mantissa bits of the floating-point number, and the table returns a whole integer with no fraction. This makes this algorithm faster within reasonable memory constraints, with inaccuracy bounded and easily identified.

Due to the structure of the tables herein used, it is known that any time the Index first identified for the Doubles1000 table is not the exact Index sought, the correct Index will be the one immediately prior to it. A quick COMPARE operation will determine 506 if the number at Doubles1000[Index] is less than or equal to the original number. If so, OrigNum will be scaled with the next step; if not, 1 is first subtracted from Index before OrigNum is scaled with the next step.

At this point, the embodiment will MULTIPLY OrigNum by the double indexed at Scale1000 [Index] (which is 10⁻³, or 0.001) to produce ScaledNum (ScaledNum=OrigNum×Scale1000 [Index]=2.048) which will be a floating-point number that is now greater than or equal to 0 and less than 1000. Then the embodiment can determine 508 the number of iterations to use for the conversion method by obtaining the number at TripletsCounter[Index], which will be 2 in this case for the example source number of 2048 since there are two triplets: the first group which returns the number 2 and the associated ASCII format string “002,” from the TripletsComma table, and the second group that returns the number 48 and the ASCII format string “048,”.

The TripletsCounter table indicates the number of triplets to extract when converting OrigNum into the ASCII format; the value from this table can be used to determine 508 the number of loops, or iterations, required by a conversion process. It can also be used to determine the maximum number of decimal digits (multiply the number by three, or consult a separate table that avoids any calculation, or use another means) that will be to the left of the decimal point, which for large numbers can be in the hundreds. The largest display string could have more than 300 digits (plus separators and other formatting) to the left of the decimal point. However, since the double format can only accurately represent 16 or 17 digits, it is not always desirable to show all the converted digits for such large numbers (digits extracted after the 16^{th} or 17^{th} digit are usually not correct). A bounded version of the TripletsCounter table could be alternatively used that would not show more than 6 triplet groups, for example, meaning a maximum of 6 groups of three digits apiece is the maximum permitted to display, which would allow 16, 17, or 18 digits maximum.

One way to address this issue is to convert numbers into scientific-notation format 252 (see Converting to Exponential Notation section below). Alternatively, when numbers are determined to be outside the desired range, it may be useful to display a string of asterisks or some other character string rather than displaying a number in exponential notation. This is a method used by Microsoft® Excel® spreadsheet software, for example (marks of Microsoft Corporation).

As can be seen by the eye but which is unknown yet to the transformation 302 algorithm, the first group of thousands (or triplet) in OrigNum (which is 2048), which has now been isolated 502 as the integer portion of ScaledNum (which is 2.048) and is to the left of the decimal point, takes only one character 885—not three—for the ASCII format. This will be addressed shortly to ensure 510 there are no leading ‘0’ digits at the front of the number. Note that in an alternative embodiment, one of skill could use the FirstTripletComma and FirstGroupChars tables as described elsewhere in the present disclosure to eliminate 510 leading zeros in the decimal-string output.

Once ScaledNum has been obtained, a copy of ScaledNum is first made (ScaledNumCopy), and then ScaledNum is converted to a truncated 514 integer (whose value will be 2) and stored in memory (into a variable TruncatedNum) or in a register (for embodiments in assembly language). Note that the very fast command CVTTSD2SI (one of the SSE2 instructions for the CPU) can be used to convert ScaledNum to an integer without manipulation of the rounding 522 behavior of the FPU.

At this point, and before this transformation 302 embodiment implementation jumps into the MainLoop, the two values TruncatedNum and Index can be used to determine other numbers that are used by the algorithm. In an initial implementation, the padding and formatting criteria will be referenced so that the exact desired position of the first character 885 will be determined. This can be done in a straight-forward manner by those skilled in the art who are also in possession of this disclosure. At this point, the OutputPtr variable 214 will be computed so that it will place the first digit of output at the exact character position desired.

To determine 508 the total number of loops for the algorithm, use NumLoops=TripletsCounter[Index]. In this case, the number returned is 2, showing two loops for the algorithm. The TripletsCounter table is constructed 376 to return the number of thousands groups to process.

To determine 448 the actual number of significant digits in the first ScaledNum (which right now looks like “002,” in this case), use CharsInFirstGroup=FirstGroupChars[TruncatedNum]. This returns the number 1, which indicates there is only one digit in the first triplet number. This table will return 1 if TruncatedNum is less than 10, else 2 if TruncatedNum is less than 100, else 3.

To determine 448 the maximum number of digits to the left of the decimal point, an embodiment can use MaxDigits=NumLoops×3 (or MaxDigits=NumLoops×4 if triplets separators are used). Alternately, one of skill could use a fast assembly-language command (when the value to be multiplied by 3 is in eax) such as “lea eax, [eax+eax*2]). Alternately, an embodiment can use a MaxCharsInNumber table; MaxDigits=MaxCharsInNumber[NumLoops] indicates there are a maximum of 6 digits to the left of the decimal, since there are two groups of thousands, each group being three digits. FirstDigitAt[TruncatedNum] returns the offset of the first digit (0 if there are three digits, 1 if there are two, or 2 if there is only one significant digit as in our example with OrigNum). Other tables can be consulted or created to return other useful values in some embodiments. For example, an embodiment can determine the total number of digits to the left of the decimal place with the formula TotalDigits=MaxCharsInNumber[Index]−FirstDigitAt[TruncatedNum]. If separators 228 are included, initialized tables will have a separator included with each triplet; and in this case, the value 1 will be subtracted since there is no separator after the right-most triplet.

A person who is skilled in the art and guided by this disclosure will recognize that by using several tables such as those above, this transformation 302 embodiment can eliminate reliance on other MULTIPLY, SHIFT, ADD, SUBTRACT, COMPARE, JUMP/BRANCH, etc., instructions, the selective elimination of which can reduce the number of clock cycles 891 elapsed to convert a binary number to ASCII format, therefore speeding up the process. It is up to each implementer to determine which, if any, of the additional tables will be used. Of course, the algorithm also works in some embodiments with alternatives to these tables.

Also, each implementer can decide consistent with teachings herein whether to store the multiple TruncatedNum values and to perform the output formatting 494 at the end, or whether to use each value as it comes and to perform the formatting 494 for that triplet before iterating 342 to the next triplet. Both embodiments are contemplated. In an initial implementation, each value of TruncatedNum is processed as soon as it is available.

At this time, a transformation 302 embodiment is ready to jump into a main loop. In alternative embodiments, the loops will be unrolled 360 as is known in the art. But since it already scaled the number, converted it into an integer and stored it in memory, it can jump to the point immediately after those instructions, which is labeled FirstEntry: below.

MainLoop: For each iteration of the transformation 302 algorithm, ScaledNum is multiplied by PowerOfTen (which is equal to 1000 in the initial implementation, and which is located in memory). Next, a copy of the result is kept (ScaledNumCopy), and ScaledNum is converted to a truncated integer (TruncatedNum=truncated integer portion of ScaledNum) and stored into memory. Immediately after this (at the FirstEntry: label) is the point at which the MainLoop is entered the first time, since the truncated integer is already stored.

FirstEntry: TruncatedNum will be a whole integer which is less than 1000. This integer is used 416 as an index 832 into the TripletsComma table to extract the three-digit ASCII format for this number, including a comma as the fourth character. For Unicode16, twice as many digits will exist in the equivalent TripletsComma16 table. The ASCII format is stored at the address pointed to by OutputPtr, which is then incremented by 4. If using the TripletsComma table when no commas are desired, increment OutputPtr 3; this causes the thousands separator character to be overwritten by the next stored ASCII format string. One of skill in the art will note that when using Unicode16, OutputPtr is increased by twice as many bytes 1056 as the size indicated for ASCII/Unicode8 format, which is important to know when using an assembly-language implementation.

Subtract TruncatedNum from ScaledNumCopy to Produce a New ScaledNum (ScaledNum=ScaledNumCopy−TruncatedNum).

Decrement NumLoops.

If NumLoops is greater than 0, jump to MainLoop

When the transformation 302 embodiment software 136 comes to this point, all digits to the left of the decimal place have been converted to decimal. Digits to the right of the decimal point are converted using a process similar to the one used to extract digits to the left, after placing a decimal separator into the output buffer. (In some embodiments, a separate table FirstDecimalGroup is used in a way similar to how the FirstTriplet table is used, except that this table includes a decimal separator in front of each triplet or other grouping; using this table removes the need to separately place the decimal separator into the output buffer.) The current value of ScaledNum is between 0 (inclusive) and 1 (exclusive), and is the value of the decimal portion. When extracting/converting the decimal portion, an embodiment can use a higher value for PowerOfTen if there is no formatting desired in the decimal digits, or it can select a PowerOfTen that will extract the number of digits between digit group separators. In an initial implementation, PowerOfTen=1000. Note several reasons why PowerOfTen equal to 1000 is helpful. First, that means there is only one set of tables to produce, so the algorithm is cleaner and memory requirements are smaller. Secondly, the implementation works very well with switching instantly between using thousands separators and not using thousands separators. Thirdly, much business software uses dollars or another currency having only two decimal places, and the algorithm allows the placement of up to three decimal places as quickly as one or two.

If no decimal places are desired, jump to FinishFormat.

When decimal places are desired, the number of decimal places will be known, and the transformation 302 embodiment implementer will determine the proper loop value to take place. Note that there will usually be more characters stored than will appear in the final result; if two decimal places are wanted, four characters are actually written to the output buffer, but one of skill will then place a null terminator at the correct position, overwriting at least one of the extra unwanted characters.

At each iteration 342 of converting decimal places, an embodiment will first multiply ScaledNum by PowerOfTen, then make a copy, and then truncate to an integer, similar to the algorithm that handles digits to the left of the decimal point. That integer is stored in memory and can then be used to extract the ASCII format string. Then the TruncatedNum will be subtracted from ScaledNum until all the decimal places have been extracted in a manner similar to that described for converting digits to the left of the decimal point. In some embodiments, the loop that generates the decimal digits will be unrolled, as is known in the art.

In an initial transformation 302 embodiment implementation using the TripletsComma table, the OutputPtr will be pointing to the exact place where the decimal point is to be placed. At this point, a decimal point (or other character used as decimal marker, based on the locale) can be inserted and OutputPtr incremented by 1.

A loop similar to the above will now be entered, where ScaledNum is converted to TruncatedNum, and used 416 to index TripletsComma (or Triplets) to copy the ASCII format to OutputPtr. OutputPtr will be incremented by 3 (to skip over the unwanted separator character, or if using Triplets, to skip over the null), ScaledNumCopy will be converted to a new ScaledNum, and the process will continue until all desired decimal digits have been extracted.

FinishFormat: At this point, the exact position of both the first and the last desired digit of the ASCII format string 210 can be identified and used to permit custom formatting 494. The first digit was previously identified, and the last digit will be known: the number of decimal places determines where the last digit is located; backup by one if no decimal digits were obtained in order to write over the comma that was written in that position by the algorithm. A terminating null can be placed 394 at the appropriate position to signify the end of the decimal string 210; if other formatting 494 is yet to be performed, as elsewhere described in the present disclosure, one of skill can place a terminating null in the appropriate position at the end of the finished display string 210 after all such formatting is completed.

Other formatting 494 can be done priot to exiting. A numeric sign can be added 488: if the number is positive and the user wants to insert a positive ‘+’ sign, that can be inserted now at the front of the number or at the end, as desired. In an initial implementation, ‘+’ signs are not inserted. If the user has requested that parentheses be used 488 to indicate negative numbers, a space may be maintained after the last digit for positive numbers (for example, that position may be occupied by a closing parenthesis for negative numbers, or possibly by a minus sign at the end of negative numbers) so that both negative and positive numbers will be aligned when output in columnar format. So if the number is positive and parentheses are used to indicate 488 negative numbers, a space can be stored at this point. If the number is negative, a negative ‘−’ sign can be placed at either end of the ASCII format, as desired. If parentheses are desired to indicate negative numbers, a closing parenthesis will be placed immediately after the last digit, and an opening parenthesis placed before the first digit. Note that the SafetyZone (if used) to the left of the start of the converted string can be readily used to accommodate some formatting, and one of skill could then adjust the returned pointer to the buffer to appropriately point to the first character of the finished display string.

If a currency indicator 250 such as a dollar sign, Euro sign, or the like is desired, it can be placed in its desired position relative to all other formatting 494 which has taken place. Next, if padding characters 246 are desired, they can be added 494 at this point. (As noted previously, this could also take place prior to the number conversion.) If the number 210 is to be left justified 484, no padding is called for. If the number 210 is to be right justified 484, then padding characters can be added four (or eight) characters at a time (assuming 32- or 64-bit code, for example) by stamping them in proper position to the left of the ASCII format, decrementing an output pointer by four for each stamp, until sufficient pad characters have been added to the front, with the output pointer adjusted as appropriate once the padding is complete. If the number 210 is to be centered 484, the proper number of pad characters will be determined to add to the left of the ASCII format and to the right, and again the pad chars can be stamped 346 using 32-bit MOV instructions. One of skill would most likely add padding to the right of the number only after having first converted the number to its decimal string in order to eliminate the possibility that some needed portions of the finished display string would be accidentally overwritten. Alternately, an embodiment can use equivalent 64-bit instructions when in 64-bit mode, as known to those of skill in the art guided by the teachings herein.

A NULL terminator is placed 394 after the last character in the ASCII format string for null-terminated strings. In some embodiments, a string length is placed 394 at the beginning of the string for strings stored in some formats instead of (or in addition to, depending on the format requirements) a null-terminated format. Then control returns to the caller 1018 the address of the start of the formatted number in the buffer. In some embodiments, the size of the formatted display string can be returned 464 in a register 206 other than the register used to return the address. Alternatively, a user can specify 426 a desired buffer 212, in which case the completed ASCII format string can be copied quickly using any combination of very-fast MOV instructions. Or in a coordinated way, the calling 544 method could be prepared to identify a buffer 212 which is selected to have sufficient room for safety zones 818. Some embodiments use the calling method's buffer as the first and only buffer for accepting the ASCII format string of characters.

Due to the safety zone 818 one at each end of the buffer, it is possible to overwrite parts of either or both the safety zones, but with correct selection of the original OutputPtr as described, nothing intended for the final output 210 will be overwritten. Those of skill in the art guided by teachings herein will understand that the original value for OutputPtr can be determined such that the address to the ASCII format string that is created will be 32-bit aligned (or 64-bit or otherwise) if desired.

In some embodiments, especially when performing formatting 494 in addition to thousands separators 228, binary numbers are first converted 490 to an internal buffer with safety zones at each end. Once the number is converted 490, formatting 494 for negative, positive, currency, or other issues is applied, at which point the starting and ending positions of the created string 210 are known; this can eliminate clock cycles 891 that would otherwise be needed to calculate sizes of various portions of the converted number string. Then, and especially in cases where padding and/or alignment are provided, the padding is applied 494 to the user-defined buffer first, then the formatted display is quickly copied from the internal buffer to the precise desired position inside the user-specified buffer via fast MOV operations using any method desired by one of skill, being careful to not overwrite any portion other than exactly those character positions where the formatted display string is to be copied.

With regard to tradeoffs between speed and memory requirements, in some embodiments 32-bit floats are first converted 512 into 64-bit doubles and a copy of the number is stored in memory. Thus, the Double1000 table will be accessed as part of this algorithm. However, if it is desired to eliminate this step and speed up the process, a Floats1000 table can be created with a related Index2Floats table. As in the case of the Index2Doubles1000 table, the Index2Floats table will use 128 k of memory. Also, other tables 216 supporting other flavors of floating-point numbers 208 can also be created 376 and used in embodiments according to the teachings herein. Note that a substantially smaller amount of memory can be used if SHIFT and AND instructions are used to mask the result, as previously explained; in that case, the tables would require 8 k and 1 k of memory, respectively.

Some Special Cases

In some embodiments, before a number enters the main loop, a quick test 496 for special cases 890 takes place. Multiple entry points, depending on the binary structure of the number, are used to help ensure numbers that are formatted as desired. Some special cases 890 that can be handled by very fast alternate means are identified and handled 496 separately. For methods handling signed numbers, an unsigned variable can be used to do the conversion.

In some embodiments, if the original number is negative, that fact 890 is remembered and/or acted 496 on—by placing a minus sign in the buffer and advancing 368 the buffer pointer 214, for example—and the signed number is converted into its unsigned form, such as with the command: unsigned uNum=0−Num or uNum=neg (Num), which is then converted into the decimal display string 210; otherwise, when positive, the unsigned number is transferred to the unsigned variable used in the conversion. This can eliminate certain subtle programming bugs that can occur when unsigned values are intended to be operated on, but signed operations are inadvertently requested.

In some embodiments, the signed version of the function for a given bit size will simply call the unsigned version if the number is unsigned; otherwise for signed numbers, it could insert a negative sign into the buffer and then call 544 the unsigned version with the negated number (making it positive) and with the buffer address 962 incremented by one character to cause the number to be converted at the appropriate position in the buffer. See the section “Table-Using Technologies” for a description of specific table-based methods for handling various binary formats. In addition to those methods, the following is a list of some separate entry points 890 along with a description of what can be screened 496 in some embodiments.

Unsigned Byte (8-Bit Integer).

Handle 496 as in Table-Using Technologies. Or, these can be automatically promoted 496 to unsigned int or unsigned short and handled as shown below.

Signed Byte (8-Bit Integer).

Handle 496 as in Table-Using Technologies. Or, these can be automatically promoted 496 to signed int or signed short and handled as shown below.

Unsigned Short (16-Bit Integer).

Handle 496 as in Table-Using Technologies. Or, these can be automatically promoted 496 to unsigned int and handled as shown below.

Signed Short (16-Bit Integer).

Handle 496 as in Table-Using Technologies. Or, these can be automatically promoted 496 to signed int and handled as shown below.

Unsigned Int (32-Bit Integer).

An approach such as that shown in the section “A Funnel-Testing Approach” can be used 496; one of skill would first slightly modify the approach used in the i32toa_division function 936 (eliminate all code handled by the “if (Num<0)” brackets, since no unsigned integer will ever be negative). In alternative embodiments, one of skill having in hand the teachings of the present disclosure could replace 496 the division functions with appropriate MagicNumber operations 304. In other embodiments, one of skill could determine the magnitude of the integer by determining 356 the position of the leading bit 810, using that bit to determine the size 256 of the number, and proceeding to convert 490 the number as explained in the

“Converting 64-bit Numbers to Decimal” section of the present disclosure, which one of skill could convert to handling 32-bit integers (signed or unsigned). In another embodiment, one of skill could inspect the leading bit of the number (using the BSR command of the Intel® CPU; or by using a lookup table that inspects each byte, most-significant first, of the 4-byte integer and determines the position of the leading bit via, at most, four iterations of a table-lookup loop), and using appropriate tables similar to the Doubles1000 and Index2Doubles100 tables used for floating point numbers to extract and then convert it using an algorithm similar to the approach described in the '641 patent, but applied to integers (one would also detect possible 0 values prior to all triplets having been extracted, as described elsewhere in the present disclosure). One additional approach would be to convert the 32-bit unsigned integer to a floating-point format and then allow a floating-point method, such as described in the present disclosure, to format the number.

Signed Int (32-bit integer). This would be handled 496 similar to the methods described for Unsigned Int, except that the approach displayed in the i32toa_division function that handles negative numbers would be preserved. All other options for Unsigned Int can also apply.

Unsigned Long Long (64-Bit Integer).

Refer to the “Converting 64-bit Numbers to Decimal” section of the present disclosure.

Signed Long Long (64-Bit Integer).

Refer to the “Converting 64-bit Numbers to Decimal” section of the present disclosure.

Float (32-Bit Floating-Point).

Check 496 for a NaN value and return an appropriate string. In some embodiments, denormalized numbers are treated as the value 0. Floats can be promoted 512 to doubles and handled with a Double method.

Double (64-Bit Floating Point).

Check 496 for a NaN value and return an appropriate string. In some embodiments, denormalized numbers are treated as the value 0. In some embodiments, where the integer portion of the number fits within the range of an unsigned 32-bit integer, the integer portion can be truncated 514 and converted to 32-bit integer which is then converted by a 32-bit-integer function (as disclosed in the present disclosure) into a display string 210. A period 242 can then be inserted after that string, the integer portion that was converted is subtracted from the floating-point number (leaving just the fractional portion), and then the fractional portion of the double will be scaled by a power of 10 sufficient to shift all desired digits, plus one more, to the left of the decimal place, and the new integer of that number converted to a 32-bit integer. Prior to outputting any digits, a rounding value 254 can be added or subtracted as explained elsewhere in the present disclosure, and then the number can be converted into the appropriate digits to the right of the decimal place (in this case, one digit more than is desired will be extracted, and that digit can be overwritten with a terminating null, or with other desired padding that one of skill may desire to add). Larger numbers can be converted similarly by using 64-bit-integer functions to achieve the same result.

If a scientific-notation format 252 is desired, methods such as described in the Converting to Exponential Notation section can be used.

Extended Precision (80-Bit Floating Point).

Convert 496 based on logic of Double handler, but adapted to this type (larger exponent, larger mantissa, much larger ExtPrec1000 table, etc.). Numbers that cannot be contained in a 64-bit integer could be handled by a 128-bit-integer method similar to that described, or other methods described herein can be used.

Quad-Precision (128-Bit Floating Point).

Concepts from the present disclosure can be converted by one of skill to process these numbers.

Constructing Index2Doubles1000 Table

A process to create 376 the Index2Doubles1000 table (and Index2Floats1000, Index2Doubles10, or other similar tables) can be more complex than creating the other tables, but any desired method using any computer language or other tool can be used to create this table. The speed of the process to create this table is not extremely important since it will only be created once in most embodiments. If desired, it can be constructed 376 at run time, but that is not always necessary and it may be easier and quicker to use a static already-created table. A table 216 can be constructed once and then stored in the code 134, such as in source code, object code, library code, executable code, or in a file that is stored in non-volatile memory (e.g., a static already-created table 216). It may be quickest to keep this table as part of the library, object, or executable code, but where or how it is stored or created is up to the implementer of the method consistent with the teachings herein.

Note that a table 216 of this kind (Index2Doubles1000 table, Index2Floats1000, Index2Doubles10, or similar) could be used for integers in some embodiments. That would reduce or eliminate loading the integer into the floating-point processor 112 and then storing it in memory 114, but might require substantial amounts of memory for the tables. In one alternative embodiment, the leading bit of a 64-bit integer is identified 356 and used to index a jump table as explained elsewhere in the present disclosure.

Each Index2 . . . table 262 is functionally tied by its specific data content both to the floating-point or integer object type 892 and to the desired power of ten for the table 262. In this example, the logic of which also applies to creating other Index2 . . . tables 262 for other floating-point types 892 as applied to other powers of 10 (or to other powers, such as powers of 8 for octal display formats), an embodiment will create the entries for the Index2Doubles1000 table which uses the 64-bit double floating-point format and powers of 1000.

Since the exponent portion of a double is 11 bits and is preceded to the left by a sign bit, the embodiment accounts for at least 12 bits. Since the closest natural size 894 for the Intel® CPU is a 16-bit word, each entry in the table 262 in an initial embodiment is a 16-bit (or two-byte) entry. To accommodate all possible entries in a 16-bit word, the embodiment creates 2¹⁶ entries, or 65,536 entries of two bytes each (128 k of memory for the table). When the table 262 is complete, the embodiment will be able to use a single lookup 314 without any extra processing to immediately obtain the index into the related Doubles1000 table.

The Listing_{—}6058-2-3A.txt computer program listing appendix file, incorporated herein by reference, includes an implementation suggestion for creating the Index2Doubles1000 table in the C++ programming language.

Note that in embodiments where only a Doubles10 table is used, the above algorithm should be modified slightly so that, instead of scanning entries in the Doubles1000 table, entries of the Doubles10 table are scanned, and only the power-of-1000 values (that already exist in the Doubles10 table) are considered; instead of setting i to 0, it would be set to equal the offset of the smallest power of 1000 in the Doubles10 table; when i is incremented or decremented, then it would be adjusted by three positions instead of one; and the value numDoubles would be adjusted to reflect the number of power-of-1000 entries in the Doubles10 table.

Converting 516 to Exponential Notation 252

Some embodiments include a Doubles10 table 238 (64-bit double floating-point format, about 5 k in size). This table 238 starts with an entry of 0, and then includes all consecutive powers of ten from 1.0e−323 through 1.0e+308. This table is used to scale numbers that are desired in scientific-notation format 252 by finding 318 the nearest power of 10 that is less than or equal to the original number 208. The index value where that entry is found in this table will then be used to extract the proper scaling power of 10 from the Scale10 table 238 (at location Scale10[Index]). A cooperating table 262, Index2Doubles10, is also created similarly to how the Index2Doubles1000 table is created, except that it handles PowerOfTen=10, instead of 1000; it provides the first index 832 into the Doubles10 table, and is also used to identify floating-point NaN values (see sample source code below). The Index2Doubles10 table uses the most-significant 16 bits of the double (in the same way as explained for the Index2Doubles1000 table) to identify the entry in the Doubles10 table that is the nearest power of ten less than or equal to the number.

Also present in these embodiments is a Scale10 Table—64-bit double floating-point format, about 5 k in size. This is the counterpart to the Doubles10 table and is used to quickly convert 516 a number into exponential notation 252 where there is one non-zero digit to the left of the decimal point (23.87 will be displayed as 2.387e+001, for example, and 0.000056 will be displayed as 5.6e−005). Each entry, with exceptions as explained herein, is the negative log of the entry at the same index of the Doubles10 table. As one example, for the number 23.87 the decimal place is scaled one position to the left. The entry in Doubles10 containing the value 10¹ will be identified as the nearest power of 10 that is less than or equal to this number, so the value 10⁻¹ is the matching entry in the Scale10 table that will be used to scale the number. As another example, for the number 0.000056 the decimal place is scaled 5 positions to the right. The entry in Doubles10 containing the value 10⁻⁵ will be identified as the nearest power of 10 that is less than or equal to this number, so the value 10⁵ is the matching entry in the Scale10 table that will be used to scale the number.

There are some exceptions 890 to this pattern, due to limitations of the floating-point format that prevent certain numbers from being represented. Note that since the value at Doubles10[1]=10⁻³²³ and the value at Doubles10[2]=10⁻³²², the equivalent values found at Scale10[1] and Scale10[2] should be 10³²³ and 10³²², respectively. But the largest value supported in the double format is approximately 10³⁰⁸. In fact, the entries in the Scale10 table at positions 1 through 15 require numbers that are greater than the maximum. To handle this, an innovative fix is introduced 496. Those 15 positions will instead hold a much smaller value, and then after the number is scaled, it will be multiplied again by the value 10³⁰⁶, after which the number will be properly scaled. For example, according to this fix, the entry at Scale10[1] will be 10¹⁷ and the entry at Scale10[2] will be 10¹⁶; when a number scaled by these entries is then multiplied by 10³⁰⁶, it will have have been scaled correctly. The entries from position 16 to the end of the table are correct (for example, Doubles10[16]=10⁻³⁰⁸ and Scale10[16]=10³⁰⁸ as expected. The sample listing below shows the values for the Scale10 table.

A third table, ExpScale, is also constructed 376 to coordinate 518 with the Scale10 table. Since some entries in this table could have a value exceeding 255, each entry 820 should be at least 16 bits; using a table equivalent to the natural-word size 894 might be slightly faster. Each integer entry in ExpScale is equal to the value of the exponent in the equivalent entry of the Doubles10 table and is used to print 452 the power-of-ten exponent portion for the scientific-notation display format. For example, when converting 302 the number OrigNum=1,234,567,890, the entry found in the Doubles10 table will be 10⁹. The matching value in the Scale10 table will be 10⁻⁹ which, when used to scale OrigNum will result in the scaled value 1.234567890. The matching value in the ExpScale table will be 9, which is the value to print 452 for the exponent. When converted according to one embodiment, the output will be 1.23456789e+009. One of skill could implement any desired exponential format 252 desired by using teachings of the present disclosure, such as 1.2345e9, or 1.234567 E9, or 1.23e+009. The embodiment determines how to display 452 the “e” character and how many decimal places to display 452; this may depend on a maximum value of decimal places, and the number is preferably rounded 522 at that point (truncation or other types of rounding could be done, if desired). Also, whether the exponent value should be padded with leading zeros and whether a ‘+’ is used for positive numbers.

For some entries in both the Doubles1000 and the Scale1000 tables, the values are actually just slightly below the expected value, which means the exponent 806 for certain numbers could be one value different than the value given in the ExpScale table 234. This situation 890 is detected and corrected 496, as shown in a “dtoa” code sample provided in the Listing_{—}6058-2-3A.txt computer program listing appendix file, incorporated herein by reference. If the converted number is less than one, this situation exists, and the number is multiplied by 10 to correct it.

The Listing_{—}6058-2-3A.txt computer program listing appendix file, incorporated herein by reference, also includes example C++ commands to help construct 376 the tables 216. One of skill could use alternate methods to fill in these tables, if desired. In one embodiment, for example, hex values 896 are specified 520 for each entry 820 to ensure it is the exact bit pattern desired, independent of the compiler 126 used. The Listing_{—}6058-2-3A.txt computer program listing appendix file includes a sample algorithm implementation to create 376 the Index2Doubles10 table.

In addition, a RoundingTable 260 can be used to round 522 the number being converted based on the number of decimal places desired. It is possible, sometimes, for a rounded number to increase the most-significant digit. A problem 890 can occur when the most significant digit is a ‘9’ and is rounded up, which is the case, for example, when the number 999.999 is rounded to two decimal places. Before it is rounded 522 up, the number is below 1000 (10³), so the value 10² is determined to be the nearest power of ten less than or equal to the number, and the entry in the ExpScale tables presents the value of 2 to be used for the exponent. But when the number is scaled and rounded to two decimal places, it becomes 1000.00 which is now equal to the next power of ten, and the exponent should have been one higher. This case 890 is detected 496 by testing if the first WholeNum integer is 10, in which case we will increment ‘index’ 832 so that the next-higher exponent value in the ExpScale table will display (so the number will display as 1.00e+003, and not as 1.00e−002).

The Listing_{—}6058-2-3A.txt computer program listing appendix file, incorporated herein by reference, includes a simple rounding table 260 used by one embodiment to round 522 a floating-point number after it has been scaled but prior to outputting any part of the decimal display string 210.

When converting floating-point values to exponential notation 252, one of skill can determine whether to insert a ‘+’ to indicate 488 a positive power (to mirror the ‘-’ used to indicate a negative power), whether to use an uppercase ‘E’ or lowercase ‘e’, and other issues. Determining how to handle very small numbers may be important, and one of skill could modify the algorithms presented in the present disclosure to decide to output 524 a value of 0 for any number smaller than a minimum value, say for any number smaller than 1.0⁻³⁰⁹ (that is done by eliminating from the Doubles1000 table all entries smaller than that value, and then adjusting all other tables to reflect that change). One embodiment (illustrated with source shown in the incorporated listing appendix attempts to convert any value that is greater than or equal to 1.0⁻³²³, and displays 524 a value of 0 for any value smaller. Each type of NaN is simply displayed as the string “NaN”, but one of skill could do further processing to customize the output based on various NaN types. Due to the many issues that can accompany NaNs and very small numbers, one of skill would want to review and test the output of any embodiment containing any of the teachings herein, and may want to make various changes in how the methods work.

The Listing_{—}6058-2-3A.txt computer program listing appendix file, incorporated herein by reference, includes sample implementation code (in C++, using Microsoft Visual Studio® 2008 Professional) for one embodiment that converts 302 64-bit double floating-point values into exponential notation 252. The tables 216 it uses are described in the present disclosure, and will have been initialized before the ‘dtoa’ routine can convert double to ASCII.

A core engine of the DoubleToExpNotation algorithm can be modified by one of skill to display 452 other formats if desired, such as the standard triplet (comma-separated) format used when converting integers. The ExpScale table can be used to quickly determine the number of triplets in a number greater than or equal to 1 (divide the value at ExpScale[index] by three, then round up; for all numbers less than 1, there is one triplet of 0 left of the decimal), or a separate table that has the needed values can easily be created. Numbers with more than about 18 digits to the left of the decimal are normally displayed in exponential notation, so for numbers in that range, the DoubleToExpNotation method could be used for those numbers, and then a triplets-based method for numbers with up to 18 digits to the left of the decimal point.

If one desires to display 452 all the digits for huge numbers such as for 3.123e+253, which would have 250 zeros, one of skill should realize that after extracting 444 the approximately 18 significant digits of the floating-point value, all others are interpolated and likely to be incorrect. One could decide that after extracting the first 18 digits, any additional digits would be zeros. Small numbers also merit discussion. For example, the number 4.82e−003 has 2 zeros between the decimal point and the first significant digit; the negative exponent tells one how many decimal positions to the left the decimal point will be shifted, and any empty digit positions will have a zero. In fact, for numbers between 0 and 1, the absolute value of the entry at ExpScale[index], minus one, is the number of zeros before printing the first significant digit. Remember that negative numbers are made positive at the beginning of some conversion processes, so this applies to both positive and negative small numbers.

When it is desirable to display 452 more than one digit of the floating-point value to the left of the decimal point (such as when using the the standard triplets method for displaying integers), a modified version of the Scale10 table can be created and used (say, TripletScale10). By slightly changing the exponents for some of the values by one or two, one can make the algorithm return one, two, or three digits to the left of the decimal point to represent the first triplet in its proper format, as desired; all subsequent triplets can then be extracted 444 by the algorithm as explained herein. For any entry where there should be three digits for the first leading triplet, change (as described below) the magnitude of the exponent of the entry in the TripletScale10 table by two; for any entry where there should be two digits, increase the magnitude of the exponent of that entry by one; keep all other entries the same. For numbers less than one, the exponent for the appropriate entry of TripletScale10 should be changed to the value 1 (also equal to 10°) so that the number is not scaled; that allows the algorithm to immediately start extracting the decimal digits as triplets with the appropriate leading zeros between the decimal point and the most-significant digit.

As an example, say we want to use the table TripletScale10 to let us do the following: display 452 in standard triplet-comma-separated format 252 any number with from 1 to 18 digits to the left of the decimal, or that has its first significant digit within four places to the right of the decimal place; and display 452 all other numbers in exponential-notation format 252. In this case, first copy the entire Scale10 table to a new TripletScale10 table, then make specific changes. The entry at TripletScale10[341] is 10⁻¹⁷, and index 341 is the index selected for any number that has exactly 18 digits left of the decimal point; and any such number will have three digits in its first triplet. Change the entry at TripletScale10[341] to 10⁻¹⁵ so that when it is scaled it will scale with the first two digits to the left of the decimal point. Any number returning an index of 340 will have 17 digits, with its first triplet having two digits. The equivalent entry at TripletScale10[340] will be changed from 10⁻¹⁶ to 10⁻¹⁵. The entry at TripletScale[339] is already equal to 10⁻¹⁵ which is the correct value. But a number returning an index of 338 will have 15 digits with a full three digits in its first triplet, so the entry at TripletScale10[338] should be changed to 10¹².

The Listing_{—}6058-2-3A.txt computer program listing appendix file, incorporated herein by reference, includes sample code showing changes that could be made to the TripletScale10 table after first copying all values of the Scale10 table. Prior to running this code to make the changes, the TripletScale10 table is identical to the Scale10 table.

After these changes, the code would also be adjusted to handle different paths based on whether exponential notation 252 should be used or not. In the above case, any time the index returned is from 320 through 341, the triplets-style output should be used; otherwise, use exponential notation. For the triplets-style notation, once the index is obtained, the number of triplets to output to the left of the decimal is equal to (ExpScale[index]/3)+1. One of skill in the art may want to create 376 a separate table 216 with these values precomputed for each index entry. The number of triplets can then be used 482 as a loop counter to extract all digits, similar to methods shown in the present disclosure for converting integers to decimal display; if desired, the loop can be unrolled for a possible speed gain (one of skill would know to test this to see if it speeds up execution in the desired execution environments). Efforts have been made to verify the source code, constants, indexes 832, and other aspects of the many detailed examples given herein, but typos or other errors detectable by one of skill may nonetheless be present. However, one of skill will also recognize the concepts and teachings underlying examples given in this disclosure, even if a particular example has an error.

Observations on Multiplying by Reciprocal Power of 10

In a purely mathematical realm, “divide by 10” and “multiply by one tenth” always provide accurate and identical results. But in the computing arts, that is not true. To understand why, consider a familiar technique for converting integers from computer memory storage in binary base-two format into displayable strings of text in decimal base. For example, consider the process of converting the 32-bit number ‘4,321’ into a displayable decimal format. Internally, this number is stored in a base-two format that knows only 1s and 0s. The number has no decimal point, and therefore has no fractional digits. It is a whole-number integer. The number is stored as a string of 32 bits, each having the value of either ‘1’ or ‘0’, and the number ‘4,321’ would be stored like this: 0000 0000 0000 0000 0001 0000 1110 0001

Some known methods of converting binary numbers to decimal format use division by a power of 10. This document discloses several embodiments that use the reciprocal-multiplication 304 method using MagicNumbers 840. Differences between the division and the reciprocal-multiplication methods are stark, and show that the division instructions cannot be simply replaced with a MagicNumber multiplication. In fact, in the very compact methods discussed below, the core extraction loop in the Division Method A has seven instructions, compared to eleven instructions in the equivalent loop of Reciprocal Method A.

An assembly-language listing in the Listing_{—}6058-2-3A.txt computer program listing appendix file, incorporated herein by reference, shows a portion of a known and conceptually simple conversion method using division. The assembly-language statements clearly show what happens at the CPU level as the algorithm 1074 works (this transparency is sometimes hidden in higher-level languages such as C or C++).

Note that the division method extracts the least-significant digits first into a temporary buffer and then the digits will be reversed as they are copied to the proper destination buffer. Alternative implementations can use either a stack 920 or a queue 922 in place of a temporary display buffer to temporarily store the digits as they are extracted, and then place them in the destination buffer in the proper order.

Some implementations will extract 444 the digits in least-significant order, but then place 526 them in the proper order starting from the end of a buffer; when finished, that function will return the address of the first character in the buffer (which address 962 is unlikely to be the start of the buffer 212). This method eliminates use of a temporary buffer or reversing digit order, but it also will likely return a starting address that is not the same as the start of the buffer. This could have the unintended effect of slowing down or creating problems for other code that is designed to rely on the buffer address being the same as the start of the returned formatted display characters.

The Listing_{—}6058-2-3A.txt computer program listing appendix file, incorporated herein by reference, includes an example conversion method implementation using division, denoted Division Method A. The algorithm 1074 in Division Method A is relatively easy to understand and for decades has been a basis for many methods of converting binary numbers into decimal. In this method, division operations will place the quotient into the eax register and the remainder into edx. There is one DIVIDE instruction for each digit extracted when using assembly language, which can capture both the quotient and the remainder from the same DIVIDE instruction. Implementations in C or C++ will usually use two DIVIDE instructions per digit—one to obtain the quotient, and another to obtain the remainder.

Each iteration of the loop will reduce the number value by a factor of 10 until the number, held in eax, is 0 (meaning all digits have been extracted). On the first iteration of the extraction loop, eax will contain the value 432 and edx will contain the value 1 which will be placed into the temporary buffer. On the second iteration, eax will contain 43 and edx will contain the value 2 which will be placed into the temporary buffer. On the third iteration, eax will contain 4 and edx will contain the value 3 which will be placed into the temporary buffer. On the fourth iteration, eax will contain 0 and edx will contain the value 4 which will be placed into the temporary buffer. Then, since eax=0, the extraction loop will exit and the algorithm 1074 will reverse the digit sequence and exit.

Multiplying 304 by a reciprocal (using MagicNumbers 840), instead of using division, can be faster since a CPU MULTIPLY operation is faster than a CPU DIVIDE operation. There are two basic flavors of this method. The first flavor (Reciprocal Method A) replaces the division operations of the code discussed above while maintaining the remaining conversion logic. The Listing_{—}6058-2-3A.txt computer program listing appendix file, incorporated herein by reference, includes an implementation denoted Reciprocal Method A and denoted by reference numeral 528.

The speed of Reciprocal Method A version (on a Core2 Duo laptop running 64-bit Vista) is faster than Division Method A. Generally, the slower the DIVIDE instruction is compared to the MULTIPLY instruction on a given CPU, the faster Reciprocal Method A will be compared to Division Method A. Note that both Division Method A and Reciprocal Method A extract 444 one digit at a time, the least-significant digit first, and that whereas Division Method A uses just one DIVIDE instruction per digit, Reciprocal Method A uses two MULTIPLY instructions per digit.

Reciprocal Method B (denoted by reference numeral 530) will extract 444 the most-significant digit first, takes just one MULTIPLY instruction per digit extracted, does not use a temporary buffer, has no loop or counter overhead, and does not need to reverse or copy the extracted digits because it extracts digits in a left-to-right order. It operates almost twice as fast as Reciprocal Method A. The Listing_{—}6058-2-3A.txt computer program listing appendix file, incorporated herein by reference, includes an implementation denoted Reciprocal Method B.

The Reciprocal Method B is much faster than the other two methods (Division Method A, Reciprocal Method A), even with the code to determine the range 256 of the number to convert. Reciprocal Method B can be improved further by extracting 444 more than one digit at a time, as shown elsewhere in this document. (If desired, rather than testing every power-of-ten value, a binary-search method could be used to determine the appropriate branch point.) Each of the three methods described were tested on a Core2 Duo laptop running 64-bit Vista; the code was 32-bit code compiled under Visual Studio® 2008 Professional. Here are the times under each method to convert 100,000,000 instances of the value 4321 into ASCII displayable characters (average of three runs for each method):

Division Method A: 1.849 seconds

Reciprocal Method A: 1.422 seconds

Reciprocal Method B: 0.782 seconds

Some aspects of code herein compared to other approaches are worth noting. Shifts can be eliminated after using a MagicNumber at the point where it can be guaranteed that the no-shift version of the MagicNumber can be used; this eliminates a SHIFT instruction and can speed up execution. Also, some familiar approaches use compare statements across the range of powers of ten for the number to be converted, but those compares were used solely to determine the number of characters in the output and NOT to speed up (via the Funnel) the processing. In some embodiments described herein, the compare statements are used to funnel the number to a custom-sized portion of the algorithm 1074 that allows for very fast code; when the funnel delivers the number to a section of code, it is known at that point exactly how many digits (or triplets) the displayed number will have. The greatest magnitude of the number is known at that point, which sometimes allows for using faster algorithms 1074 via shift-less MagicNumbers 840, or via quickly reducing the number into smaller-sized components that can be handled inside the native CPU word size. The word size on most new PC CPUs is 64 bits, which can easily handle 32- or 64-bit operations. There are still many 32-bit CPUs 112 in use.

Note that when the MagicNumber used implicates a shift, then both the edx and eax registers are shifted when using Reciprocal Method B (or Reciprocal Method C 532, described in detail later in this document). The eax register is shifted first, as it will use the right-most bits of the edx register to fill its left-most bits that will be shifted right. After eax is shifted, a value of 1 is added to it to correct for lost bits from the division operation (even though this is a multiplication operation, it is the inverse of a division operation which is inexact in binary, therefore a correction value is added). The Listing_{—}6058-2-3A.txt computer program listing appendix file, incorporated herein by reference, includes a code snippet that shows how to do this when using the MagicNumber for dividing by one million in a way that will handle any input up to the maximum value for a 32-bit unsigned integer. At this point edx, which is the quotient, is the first digit extracted (“7”), and eax is the binary-fraction remainder that can be further extracted via MULTIPLY commands (MULTIPLY by 10 to extract one digit at a time, or by 100 to extract two digits at a time; or, as explained in the present disclosure, multiplying by 1000 allows for extracting three digits at a time combined with formatting).

Using the familiar method Reciprocal Method A extracts 444 digits in a right-to-left order 526. Although there can be shortcuts for small integer values (for example, any byte which is limited in value from 0 through 255 inclusive could be quickly converted into the appropriate string 940 of characters by using a 256-entry table 234 having for each entry the three-character display codes that represent that number), this right-to-left-divide-by-10 algorithm works for any size integer, provided the variables and operations used are bit-sized appropriately. Some speed improvements have been identified by dividing by a higher power of 10—for example, dividing by 100 to extract two characters at a time, or dividing by 1000 to extract three characters at a time—but they are relatively simple improvements that don't involve much change to the basic algorithm.

On the other hand, changing to a left-to-right-multiply-by-power-of-10 algorithm brings several issues and opportunities to be addressed.

First, manipulating integers 898 can be many times faster than manipulating floating-point 900 numbers. If a number exists in an integer format, there is a cost to convert 536 it into a floating-point format to take advantage of the Floating Point Processor (FPU). It is therefore counter-intuitive for a person skilled in the art to think that converting 302 a binary number 208 into a displayable character string 210 could be faster by first converting it into a fixed- or floating-point format. But some embodiments described herein do exactly that, converting from integer to fixed-point format and then to decimal for display.

Second, multiplying a number by a reciprocal power of 10 can cause digits to be lost if not handled carefully. For example, with the number ‘7654321’ from the above example, using the MULTIPLY instruction to multiply the number by 1/1000000, instead of using the DIVIDE instruction to divide the number by 1000000, results in a binary-fraction remainder, rather than a decimal remainder, that should be properly handled (by preserving the value in the eax register and correcting it, if necessary). If properly executed, the fractional remainder can be quickly extracted, as shown herein. Or, the decimal remainder can be computed as shown in Reciprocal Method A. While using integer DIVIDE (as in Division Method A) can be easy and loses no digits, the familiar method cannot work by simply replacing a DIVIDE operation with a MULTIPLY. A new algorithm, a new way of thinking, is called for. Some embodiments described herein use 538 fractional values to capture any lost digits.

Third, memory structure issues reverse. A programmer implementing the familiar right-to-left method 526 will obtain a memory buffer 212, determine where the right end of that buffer is (a memory location having a higher memory address than the start), and start storing extracted 444 display characters near that right boundary of the buffer, working toward the left end of the buffer by placing new characters at consecutively lower memory addresses. (Or, the programmer will extract the number in right-to-left order into a temporary buffer and then reverse it.) A prudent implementer will ensure that there is plenty of storage space to the left of where the first digit will be placed, otherwise the process could either fail or overwrite memory sitting at a lower memory address 962 than the buffer. But the memory to the right of where the first character is stored can be easily protected.

In contrast, under a left-to-right method 534 the extracted characters are placed in the buffer 212 starting near the left end (lower memory address) and advancing to the right (higher address). If not handled properly, memory objects sitting at a higher address than the right end of the buffer could be overwritten and corrupted. Embodiments described herein recognize this risk and take it into account.

Converting 64-Bit Numbers to Decimal

Various issues arise when converting 490 64-bit numbers to decimal. A 64-bit number can be as large as Ser. No. 18/446,744,073,709,551,615 and can have from one to seven triplets. Using 64-bit code on a 64-bit CPU 112 to convert a 64-bit number can be easier, and faster, than using 32-bit code to convert a 64-bit number. Some teachings herein are directed to using 540 32-bit code to convert 64-bit numbers, with methods that work on both 32-bit and 64-bit CPUs.

One of skill will note that some teachings also apply to using 64-bit code to convert 64-bit numbers. Additionally, some teachings apply to converting 490 larger-bit numbers, such as 128-bit numbers or 256-bit numbers 208. One difference is added complexity as the bit size increases. As complexity increases, other issues may arise, such as tradeoffs 902 of speed vs. complexity between different approaches, calculating the appropriate MagicNumbers, and so on.

When using 32-bit code, one goal of a present method is to quickly divide 378 the 64-bit number into 32-bit portions that can each then be converted 490 quickly using 32-bit instructions. In one embodiment, the 64-bit number 208 is first divided 378 into two numbers: a 64-bit number that is less than 19 billion and represents the upper 4 triplets (numbers 7, 6, 5, and 4), and a 32-bit number that is less than one billion that represents the lower three triplets (3, 2, and 1). Then, the 64-bit number is further divided 378 into two 32-bit numbers: one that is less than 19 representing triplet 7, and one that is less than one billion representing triplets 6, 5, and 4. At this point, the 64-bit number will have been divided 378 into three 32-bit numbers, each representing one or three triplets, that can each be quickly converted 490 to decimal 210.

When using 64-bit code in some 64-bit execution environments, the division 378 of the number into 32-bit sub-components need not be done, and the number can be quickly divided into two 64-bit numbers: one representing the top triplet, and one representing the bottom six triplets. The conversion 490 can then be done quickly from that point. In some environments, however, such as is the case with Intel® i7™ CPUs (marks of Intel Corporation), a 64-bit multiply is more expensive than 32-bit multiplies. So for numbers using more than 32 bits, it will be faster to use the 32-bit method detailed in ‘qtoa’, although the first process that divides the number into two 32-bit numbers can be performed with two 64-bit MagicNumber multiply ops, which is faster than the four 32-bit multiplies currently needed for the largest numbers.

One of skill could readily adapt the 32-bit code that converts a 64-bit binary number into 64-bit code that converts 540 a 128-bit number. One difference would be that much larger numbers can be handled, and therefore additional funnel compare statements 222 would be added. (Alternatively a binary-search method as is known in the art could be used to identify the left-most triplet.) Another difference would be which MagicNumbers 840 to use, and possible correction factors during extraction. When using DIVIDE operations, the CPU will return the integer quotient and an exact integer remainder. But when using MagicNumbers to replace DIVIDE operations with MULTIPLY operations, a subtle change 890 occurs: instead of producing a remainder as an exact integer number, it produces the remainder as a binary fraction (which is used in some embodiments), which is inexact for many operations due to overflow/underflow issues. It has been found that adding 496 a value of one immediately after the binary fraction is created can correct for the error.

Here are several methods 540 for converting 64-bit numbers into decimal format using 32-bit code.

Strategy 64-A

This can be the fastest way to convert 540 the largest 64-bit numbers; it assumes the number 208 to convert will be huge, and assumes one is extracting 444 triplets. The method slows down slightly for smaller numbers, but could still be extremely fast. This 64-bit method would execute quickest when implemented in 64-bit code, but a 32-bit implementation would still be extremely fast compared to prior-art implementations.

a) Create two almost-identical paths: the filtering path 904 and the extraction path 906. Execution starts and remains in the filtering path until code has identified the first triplet by continually extracting triplets (thereby reducing the original number). Once the most-significant triplet has been identified (its value is not 0), execution jumps to a routine that handles the first triplet (which is unique in that it can have one, two, or three digits) starting at exactly the point where the extraction point left. The remainder of the number is then extracted 444. Note that after all but the last triplet have been tested, the filtering path has guaranteed that the number is one triplet (possibly with the value 0) and it can extract the number directly if desired without jumping to the extraction path, saving the cost of a jump operation (for example, it could use a quick table lookup as explained elsewhere in the present disclosure).

A difference between the paths is that the filtering path 904 will extract triplets into a CPU register 206 to identify the highest triplet, testing each triplet to find the first non-zero entry, at which time it jumps to software 136 or logic 120 that handles a first triplet in the extraction routine. The filtering path itself will not convert any number to decimal (except for single-triplet numbers at the end, as described above), but will continue to reduce the number until the first triplet has been identified.

The extraction path 906 is a very fast path to convert every triplet of a number 208 into its decimal equivalent 210. The extraction path 906 can be entered at any point and will extract until the last triplet is converted. The extraction path will not test any values, but will convert each triplet. In some embodiments containing one extraction path, a destination pointer 962 is adjusted in the filtering path before jumping to the extraction path. In some alternative embodiments, there are multiple extraction paths which are each customized for the exact number of triplets to be extracted, and the destination pointer will not need to be adjusted in the filtering path.

b) Both paths use the 65-bit MagicNumber (0x1:12E0BE82:6D694B2F with a 94-bit shift) to divide the 64-bit binary number by one billion, which takes four 32-bit MULTIPLY operations in a 32-bit implementation, or two in a 64-bit implementation. This operation involves multiplying a 96-bit MagicNumber by a 64-bit number, which would normally take six MULTIPLY operations (there are three 32-bit numbers in the 96-bit MagicNumber and two 32-bit numbers in the 64-bit binary number being converted). Since the value of the high 32-bit portion of the MagicNumber is one, two MULTIPLY operations can be avoided by adding the 32-bit portions of the original binary number to registers at appropriate times, as shown herein (since one times any number equals that number, an embodiment can avoid 542 multiplying by one and, instead, substitute that number for the result). Similarly, in a 64-bit implementation, one MULTIPLY can be avoided and replaced 542 with an ADD. The upper portion will then be some number less than 19 billion (and will contain the four highest triplets numbered 7, 6, 5, and 4), and the lower portion will be the fractional remainder which, when extracted, is some number less than one billion (and will contain the three lowest triplets numbered 3, 2, and 1).

c) Both paths can then use the 35-bit MagicNumber 0x4:4B82FA0A with a 64-bit shift (no shift is actually needed; code can use the high qword of the result) to divide the upper portion (which is some number less than 19 billion) by one billion. The upper 64 bits of the result will then be a number less than 19 (this is triplet 7, and only the lower 32 bits of this upper portion are needed since the value will never exceed 18), and the lower 64-bit portion will be the fractional remainder which, when extracted, is some number less than one billion (and represents triplets 6, 5, and 4—and because it's less than one billion, only the upper 32 bits of that portion are needed). The fractional remainders will be extracted 538 by multiplying the respective fractional remainder by 1000, with each multiplication extracting the next triplet into the edx register.

d) Both paths will then extract triplets 3, 2, and 1 from the lower portion obtained in b) above by multiplying the appropriate fractional remainder by 1000, with each multiplication extracting the next triplet into the edx register.

Strategy 64-B

This is faster than Strategy 64-A for medium-to-smaller numbers, and may be the fastest overall. With this method, the binary number 208 is first scanned to find 356 the most-significant bit 810; the position of that bit is used 416 as an index 832 into a 64-entry jump table 232 to go to the appropriate method. If no bit is set (meaning the number is 0), the routine can jump to the method that handles a single triplet or, alternatively, to a method that will insert a “0” string at the proper position in the output buffer 212 and then return.

One of skill would understand that, with very slight changes in the algorithm, the binary number 208 could be scanned in multiple steps, with the resulting jump points being appropriately determined. For example, one implementation scans the binary number 32 bits at a time and references 398 the appropriate portions of the jump table 232 based on which half of the 64-bit number is being scanned. One of skill could also use smaller portions to scan, or could extract more than one bit to be used as the index. Alternatively, when it is discovered that the 64-bit binary number occupies 32 or fewer bits, several compares of the index 832 could be used (rather than a jump table) to branch to the appropriate extraction routine (by comparing to one billion, one million, and one thousand, for example). Note that one of skill could construct the jump table 232 in reverse order, or that one could construct more than one table. Alternatively, instead of using a jump table, an embodiment could use a series of compares 222 after identifying the most-significant bit (which allows for fast 32-bit funnel compares). For example, if the bit position of a 64-bit number is greater than 59, jump to the seven-triplets conversion procedure, and so on.

Note that there are boundary conditions 890 between some of the triplet ranges due to the nature of binary numbers. As an example, consider the number 1024. In binary form, the 64-bit number is 0000 0100 0000 0000 (48 leading zeroes are omitted for brevity), and the first or leading bit is at position 10 (the least-significant bit is bit 0, the most-significant bit is bit 63). This is the lowest-possible number that starts with a bit at position 10. The number has two triplets: triplet 2 is “1” and triplet 1 is “024.” The highest possible number that has bit 10 as its leading digit is 2047 which is 0000 0111 1111 1111 in binary. Numbers starting with bit 10 as the leading bit will have two triplets, so the value 10 can be used to jump directly to the procedure that extracts two triplets from a number. (Note that any number can be preceded by any number of zeroes without affecting the value of that number. In these calculations, it is possible to inspect an upper triplet and find it has a zero value. All triplets prior to the leading triplet will have a zero value, and they are ignored for purposes of clarity and for speed. Therefore, this description assumes that the first triplet of a number is the triplet determined by the leading bit—the first bit that is set to one—for the binary number.)

Next, consider the number 1023, which is one less than 1024, and which is 0000 0011 1111 1111 in binary. Its leading bit is bit 9, and the number has two triplets (triplet 2 is “1” and triplet 1 is “023”). The lowest possible number to start with bit 9 is 512, which is 0000 0010 0000 0000 in binary, and includes only one triplet: “512”. Thus, a number whose leading bit is bit 9 could be either a two-triplet number (such as 1023) or a one-triplet number (such as 512), and can be any other number between 512 and 1023; a number whose leading bit is bit 9 is therefore considered a boundary condition (ambiguous). To handle a boundary condition (there are six boundary conditions in a 64-bit integer), the entry in the jump table will jump to a short procedure that will determine which of two paths to take for the number: the one for numbers where the leading bit is one more position to the left, or the one for numbers where the leading bit is one more position to the right. This decision can be made by inspecting the integer value directly, or a first triplet can be extracted and tested to see if it is 0 (if 0, take the lower path, otherwise take the higher path).

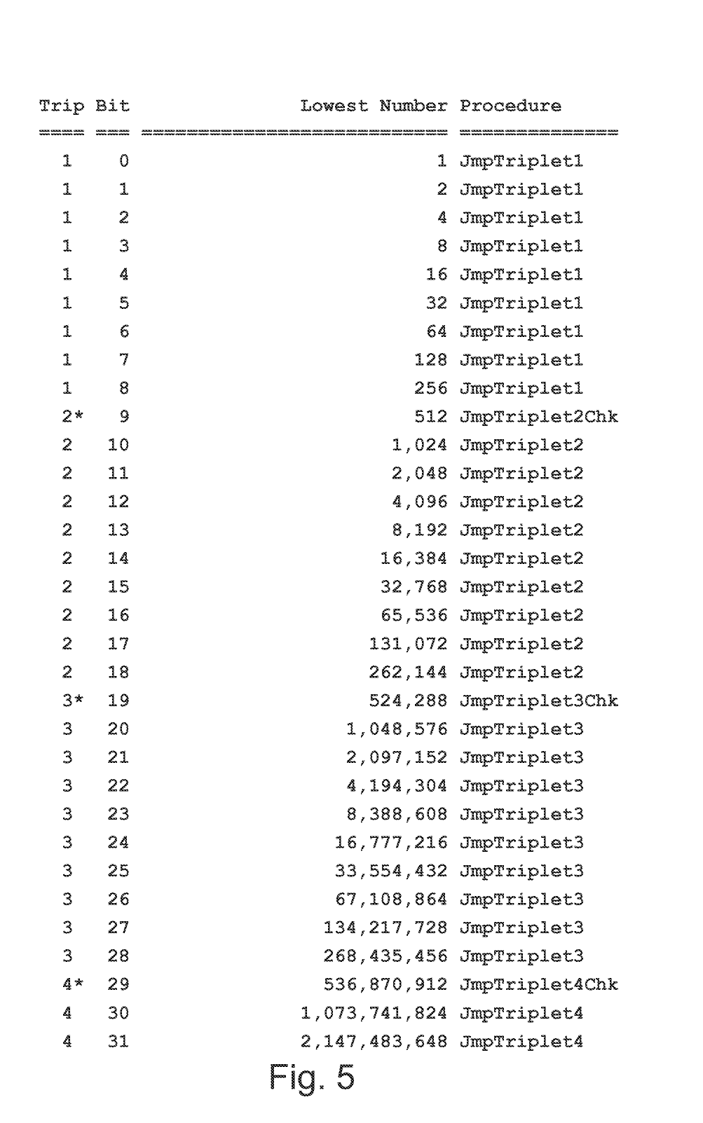

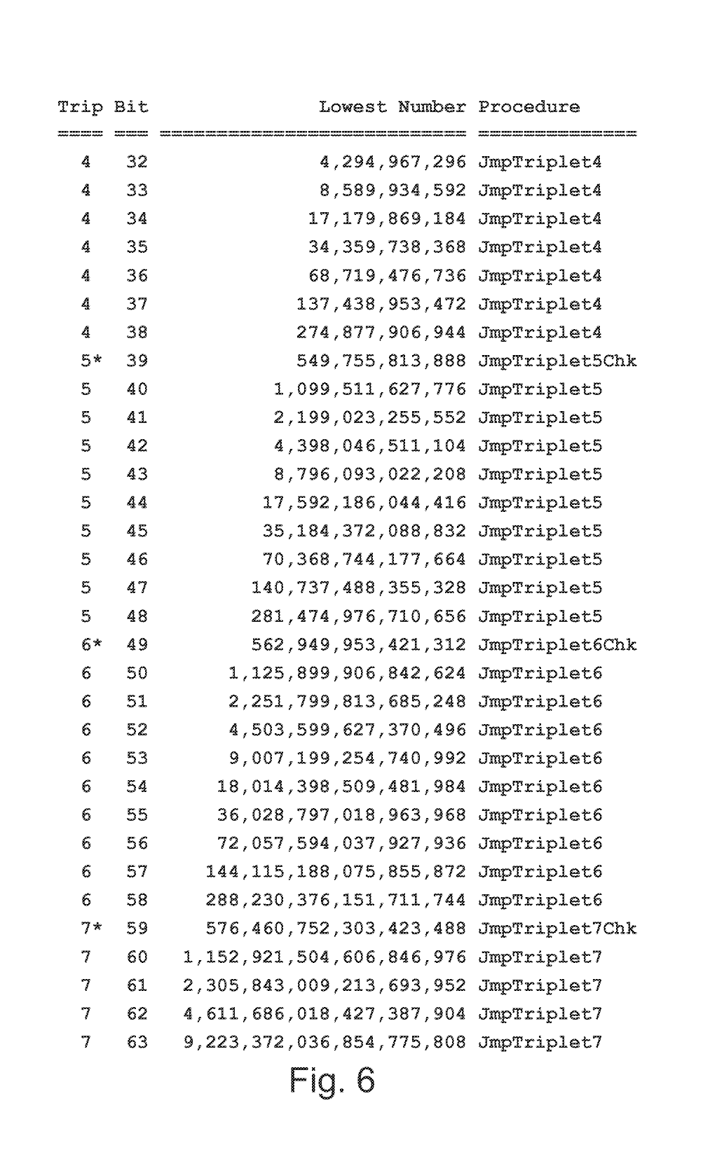

A jump table of 64 entries can be used based on the leading bit of any 64-bit integer to be converted to decimal. An outline of the jump table is given in FIGS. 5 and 6. This table and the other tables 216 are each subject to Copyright NumberGun, LLC 2012. In the Figures, triplets with an asterisk represent boundary issues 890 where it is possible that the number represented by the specified Bit# may have the number of triplets indicated, or it may have one less. The procedure jumped to for each of those boundary conditions then determines which next direction to jump, as described above, before converting the rest of the number. All other triplets can be converted directly, so the entry in the jump table will jump directly to the appropriate point in the extraction path.

The Listing_{—}6058-2-3A.txt computer program listing appendix file, incorporated herein by reference, includes a sample implementation of a main portion of an algorithm that can be used 540 to extract 64-bit integers with 32-bit code, using methods described in the present disclosure, and assuming the various triplets tables and other tables 216 have been initialized. References to the tables herein assume that the tables have been properly initialized 376 prior to the function 936 being called. Note that, to speed up the function, no stack frame 908 is created. Additionally, rather than incrementing a destination buffer pointer, instead a displacement value is used 370 as part of the address, and that displacement value is manually incremented by the programmer to ensure the components of the display string are placed exactly where needed; in this manner, no clock cycles 891 are used to maintain a display pointer.

### Some Additional Aspects of Some Embodiments

Some embodiments including custom format 494 elements (namely, digit group separators 228, decimal markers 242, currency indicators 250, negative indicators 248, and/or padding 248) simultaneously (at a low level such as within assembly code statements, and from a caller's perspective) with determining display codes 210, no matter what algorithm and instructions are otherwise used (MULTIPLY, DIVIDE, ADD, SUBTRACT, etc.). In particular, some embodiments include a thousands separator automatically with the display codes by including the separators in the table 234 of triplets (or n-lets). Some embodiments use MULTIPLY instead of DIVIDE to format numbers, even though the remainder relied on by the familiar conversion is thereby not provided by a DIVIDE. Some embodiments convert 384 an integer to floating-point first before formatting it into decimal. Some embodiments extract an integer number whose absolute value is less than 1,000 by using 314 a very fast lookup table method without using the FPU or SSE (streaming SIMD extensions, SIMD is single instruction multiple data) family of instructions (or related instructions). Some embodiments extract display codes while still using the FBSTP instruction, by converting 504 an integer into a string of up to 19 characters in BCD format.

Some provide an FBSTP-using method that contemporaneously includes formatting characters (e.g., thousands separators) during the conversion 490 processing.

In some embodiments, the number 256 of bits 910 is constantly being reduced as the number 208 is being converted. Some embodiments that handle 64-bit numbers become faster (in 32-bit execution environments) as the number being produced reduces—each division by 1000 removes about 10 bits, and once there are 32 bits or fewer, the algorithm switches to a much-faster path that takes only one division (or one MagicNumber multiplication) per triplet. In a division algorithm, when there are more than 32 bits, each triplet will require two divisions; when there are 32 or fewer bits, each triplet requires just one. In some MagicNumber 840 multiplication embodiments, the initial multiplication can take four or more multiplications, and subsequent extractions can take two multiplications until there are only three triplets left, after which one multiplication can extract each remaining triplet.

Aspects of Converting Integers to ASCII Format

A table-based method for converting 302 integers 208 of any size into ASCII format 210 will now be described; the following method assumes 64-bit integers 898 are being converted, but the tables 216 can be adjusted by one of skill to handle any other size. This method uses several tables 216 to quickly identify a triplet to convert to ASCII format. It applies to integers 898 rather than floating-point numbers 900; it can handle negative numbers; and it properly handles numbers that will have one or more zero ‘0’ characters 885 in the ASCII format. Converting a 64-bit integer into ASCII format is used as an example. Assume OrigNum 208 is 15,000,708.

Some embodiments assume the following static read-only tables 216 exist. CommasTable 234 includes display strings for all 1000 possible triplet values (from “000” to “999”, each entry being null-terminated). LookupTable 238 contains thousands multiples (as explained below). TripletIndex table 232 shows, for each value in LookupTable, the proper pointer into CommasTable for the current triplet being converted. TripletID table 912 contains values used to identify the current triplet of OrigNum being converted (there are up to seven triplets in a 64-bit integer; the first one to the left of the decimal point is triplet 1, and the last one is triplet 7). BitPosition table 262 contains index values used to identify the greatest number from LookupTable that is less than or equal to OrigNum. BitBrackets table 262 contains pointers to BitPosition table based on the position of the most-significant bit found in OrigNum.

The Listing_{—}6058-2-3A.txt computer program listing appendix file, incorporated herein by reference, includes sample code for the creation of the LookupTable, TripletIndex, and TripletID tables. LookupTable is a table of 64-bit integer entries (for this embodiment handling 64-bit integers), and TripletIndex and TripletID are the same size.

The BitPosition, and BitBrackets tables are created 376 as follows. BitPosition table can be considered as several smaller “mini” tables 216 made contiguous one with another, with each table identifying the appropriate index into LookupTable based upon the bit pattern of the number being converted. Since 11 bits are used as the index, and since any number less than 1024 has a maximum of ten bits, the first mini table 216 will handle all values for OrigNum less than 1024. The values then, to start this table, are the values from 0 through 1023. The BitBrackets table identifies, for each bit identified in OrigNum as the leading bit, which mini table to use; therefore, the first 10 entries of BitBracket will be set to equal the starting address of the BitPosition table, meaning that for any number whose leading bit is 0 through 9, it will use the table starting at the base of BitPosition to index into LookupTable.

For all other values for the leading bit 810, there is a slight adjustment required to allow the algorithm to operate cleanly. When the algorithm operates, it subtracts 10 from the value returned as the bit position of the leading bit. For example, when OrigNum=1025 is used, the leading bit position will be 10, and the shift value will become 10−10=0, meaning no shift will occur. That means that the value 1025 will be used to index the BitPosition table. This value is actually too high by exactly 1024. In fact, this is the case with every possible OrigNum that has a leading bit at position 10 or higher. So to make the algorithm work, we can do one of several things: we can clear the high bit of the index after extracting it so it becomes ten bits instead of eleven (but this requires some code in the conversion algorithm); or we could subtract the value 1024 from the index (which again requires code that takes time to execute); or we could offset the entries in the BitPosition table by adjusting pointers in the BitBrackets table by exactly 1024 entries, which is done only when creating the entries and does not require any code in the conversion algorithm. In one embodiment, the latter method is used since it has zero impact on the speed or code of the conversion algorithm, and it's very simple to implement at the time of creating 376 the table, as shown next.

At this point, two 64-bit unsigned integer variables 914 will be used: Innerindex and TempNum. NextBitPosition is a 32-bit integer pointer which, when incremented, will have its value increased by four byte positions for each unit of increment. Other variables used below are 32-bit integers. Set NextBitPosition equal to the address 962 of the next entry in the BitPosition table (equal to the address of BitPosition[1024]). An outer loop will now be started with the variable NextBit looping 342 from 10 through 63. Set BitBracket[NextBit] equal to (NextBitPosition−1024) so that it is adjusted to point to 1024 entries prior to the next entry that will be added to the table (being adjusted as described in the prior paragraph). Inside this outer loop, an inner loop will iterate 1024 times from 0 through 1023 (using the 64-bit index Innerindex, which ensures that the value TempNum will not be truncated 514 to 32 bits). At the start of each iteration, set TempNum equal to TempNum=(Innerindex|(1<<10))<<(NextBit−10). Using any desired method, set FoundIndex to equal the index of the largest value in LookupTable that is less than or equal to TempNum; FoundIndex will then become the next entry at NextBitPosition, which address 962 will then be incremented, i.e., *(NextBitPosition++)=FoundIndex.

After the above process completes, the tables 216 will be ready. The table creation and initialization process can be performed either by the current program before any integer is extracted, or the tables 216 can be created and initialized 376 by another program and stored statically, then loaded by the current program as described elsewhere in the present disclosure. The variable BitPositionBase will be an integer pointer (_int32*BitPositionBase) while the other new variables are integers.

Start: If OrigNum is 0, jump to OrigNumIsZero. Otherwise, set ExpectedTriplet to 0.

GetIndex: BitPos=position of most-significant bit of OrigNum (will be from 63 to 0). In this case, BitPos=23. In assembly language, an embodiment can use the very fast BSR command (in a 32-bit execution environment, each dword will be handled separately—the high dword first—and if a bit is set in the high dword, the value 32 will be added to the bit position returned). In C, an embodiment can use a byte-oriented lookup table 218 (handling each byte 1056 starting with the highest byte first, and adjusting the value returned based on which byte has the first set bit) to quickly identify the first set bit. An embodiment can also use another method (such as consecutive shift/test operations) to identify 356 the high bit. Then, set ShiftAmt=BitPos−10. In this case, ShiftAmt=13. This will allow isolating the bit range from 10 thru 0 (total of 11 bits). If ShiftAmt<0, jump to UseBaseTable; this will happen when OrigNum<1024. Otherwise, set BitPositionBase=BitBrackets[BitPos]. This identifies the portion of the BitPosition table to use. Index=OrigNum>>ShiftAmt. This isolates the 11 most-significant bits of OrigNum. This is the first index, used to access the BitPosition table; to obtain the second index: set Index=BitPositionBase[Index]. This is now the index used to identify all other key values.

GotIndex1: If LookupTable[Index] is greater than OrigNum, subtract 1 from Index. At this point, Index is the value used to identify the first triplet. CurTriplet=TripletID [Index] (in this example, the value is 3). Remember the first triplet for the original number. This number ranges from 7 down to 1. The number 18,000,000,000,000,000,000 has 7 triplets, and the value ‘18’ is in triplet 7. This number happens to be the largest number in LookupTable, and is very close to the maximum value that can be contained in a 64-bit integer. The value CurTriplet lets the embodiment know if one or more triplets were skipped over as will happen when the middle triplet of the original OrigNum above is reached, where there are only ‘0’ digits in that triplet. If on any iteration 342 the value for CurTriplet is less than expected, the difference represents the number of “000” triplets that need to be displayed before continuing (if ExpectedTriplet is greater than CurTriplet, output NumCopies=ExpectedTriplet−CurTriplet copies of the “000” triplet). If the embodiment doesn't handle this, the output will be incorrect for numbers with any triplet equal to 0. At this point, set ExpectedTriplet=CurTriplet−1 to identify the next expected triplet. Display triplet at CommasTable[TripletIndex[Index]]. The actual position of the first digit can be obtained via a lookup table, or a FirstTriplets table can be used instead of CommasTable for the first triplet; both methods are described elsewhere in the present disclosure. Alternately, if TripletIndex[Index]<10, there's one digit; else if <100, there are two; otherwise, there are 3. Do any desired output processing 494 after looking up string to output, e.g., currency indicator 250.

MainLoop: This is the loop 342 to handle the remainder of the number. OrigNum=OrigNum−LookupTable[Index]. This removes the first triplet from the number. In this example case, OrigNum now=15,000,708−15,000,000=708. If OrigNum==0, jump to NumIsZero. Otherwise, jump 398 to GetIndex.

UseBaseTable: Control comes here when OrigNum is less than 1024, in which case the embodiment can avoid computing any other index, and can use OrigNum as the Index. Set Index=OrigNum. Set CurTriplet=TripletID[Index]. Identify whether any triplets were skipped (as per the process mentioned above using CurTriplet and ExpectedTriplet), and output any needed “000” triplets.

UseBaseTable2: CurTriplet=TripletPos[Index]. Triplet to display 452 is at TripletIndex[Index]; append it to the buffer and update 368 the output-buffer pointer. Then set OrigNum=OrigNum−LookupTable[Index]. If OrigNum is not zero, jump to UseBaseTable2.

NumIsZero: If ExpectedTriplet is greater than CurTriplet, output NumCopies=ExpectedTriplet−CurTriplet copies of the “000” triplet. Output string for “000”. Add terminator and exit.

OrigNumIsZero: Control comes here only when OrigNum starts out with a 0 value. Display ‘0’, add terminator, do any other formatting for 0. Exit.

Features of Some Transformation 302 Algorithms

In some embodiments, a small binary integer value 208 (in some embodiments, this includes any integer ranging from from 0 through 255, or from −999 through and including+999, but the range can easily be extended if one of skill uses more memory; or the range can be modified using methods described in the present disclosure) can be converted to a string with no multiplication 542 by using it as the index into a table such as the FirstThousand table (described below) to extract the value. In some embodiments, a zero value for any type of data can be immediately converted 490. Some embodiments convert all numeric types 892 that are natively supported by Intel® and compatible CPUs: 8-bit byte (signed or unsigned), 16-bit short (signed or unsigned), 32-bit int (signed or unsigned), 64-bit long long (signed or unsigned), 32-bit float, 64-bit double, 80-bit extended precision, and future types such as 128-bit quad-precision numbers, without using the same method for all types (i.e., custom methods are used for each bit size); alternatively, some methods are designed to handle bit sizes smaller than the largest that the method could handle. Some embodiments provide 546 a printf-style interface 924 for C, C++, C#, Java, and similar programming languages. Some provide code 202 and/or code 204 versions for Apple iOS operating systems, for various Microsoft operating systems, for Linux and other UNIX-based operating systems, and/or for handhelds, embedded systems, and other environments (marks of their respective owners).

Some embodiments convert number types to floating-point first before converting to decimal output; but there are some exceptions. Any integer (of any bit size) whose value is >(−1000) and <(+1000) can use a quick lookup table, with no other operation required. In some embodiments, if many zero values are expected and a goal is outputting zero as fast as possible when it occurs, then the value 0 could be detected at the front and immediately written into the buffer without being copied from anywhere. Some embodiments will quickly disassemble 378 a floating- or fixed-point number into its components, changing them into integers, and then continue converting them to a display string while using only general-purpose CPU registers (in some embodiments, the FPU or similar coprocessor is used only near the very beginning of the conversion process).

An Assembly Code Excerpt

Assume an embodiment is formatting the digits to the left of the decimal sign, extracting 444 three digits at a time. For each iteration 342, the extracted value (X) will be between 0 and 999 inclusive. The embodiment could use code like this (all assembly language listings, tables, C listings, and other code in this document whether recited directly or incorporated by reference are Copyright NumberGun, LLC 2012):

; Assume ebx=value extracted (X),

; and edi=>destination . . .
mov eax, [DisplayCodes+ebx*4];
; grabs the three digits plus comma from the table
mov [edi], eax

Alternative Binary Formats

One of skill will understand how to adapt the teachings herein to different number-storage formats 926. Rather than the IEEE 754 specification describing the 64-bit floating-point format 926, for example, an embodiment may convert from the base-10 floating-point format 926 described in U.S. Pat. No. 7,149,765 to a decimal base formatted for display. U.S. Pat. No. 7,149,765 is entirely incorporated herein by reference, with particular attention to FIG. 1 and columns 2-9 of that document. That base-10 floating-point format 926 uses a 64-bit integer number for the integer portion (to the left of the decimal), and a 32-bit integer number for the fractional decimal portion (to the right of the decimal).

Additional Variations

Some embodiments handle multiple binary-number sizes and will provide 496 custom methods for each size 890 using teachings from the present disclosure. To make things fast, some use 548, 496 the smallest size number that can accommodate a specified, bounded data range since, the smaller the number to convert, the faster the conversion. For example, if a programmer is creating a method to deal with time, an 8-bit unsigned integer, which can range from 0 to 255, may be adequate (the maximum hour in a day is 23; the maximum minute is 59; the maximum second is 59; each of these possible values falls within the number's bounds). For dates, a 16-bit unsigned integer may be used (the year 2012 takes two bytes of storage). In some embodiments, the conversion and formatting technology is fine tuned 458 to the development target. Whether a caller 1018 uses 8-bit ASCII strings (char*) or 16-bit Unicode strings (wchar_t*); whether it targets managed/CLI/.NET code 928 or native/unmanaged code 930, a suitable library of multiple functions 936, each targeting slightly different types of binary numbers, or targeting different user needs, may be created using technology from the present disclosure to speed up binary-to-decimal conversions.

The Tables

Some embodiments are table-based, which means they rely on one or more tables 216. Many time-consuming calculations that would otherwise be used are replaced with tables 216 whose content is carefully chosen to provide functionality used to convert 302 the binary numbers 208 into their decimal-display representation 210. Some embodiments provide both 8-bit ASCII tables and matching 16-bit Unicode tables 216 that work whether the underlying code is managed (cli) 928 or unmanaged (native) 930.

Note that the first triplet for a number will have one, two, or three digits, whereas the remaining triplets will have three digits each. Therefore, it could be useful to have a table 262 that can quickly identify 408 the size of the first triplet to make it easier to properly place remaining triplets after the first triplet.

FirstThousand. Table of byte chars (1999 entries, each four chars wide): {‘−’, ‘9’, ‘9’, ‘9’; ‘−’, ‘9’, ‘9’, ‘8’; . . . ; ‘9’, ‘9’, ‘9’, ‘\0’}. These elements are each listed herein as single-byte chars; every group of four chars is equivalent to one four-char entry of the table. Use 4 chars for each entry (each char consumes one byte of storage). For each entry that would ordinarily consume fewer than 4 chars (all 8-bit numbers greater than −100), fill extra char slots with null values (‘\0’). For example, the number −7 would be {‘−’, ‘7’, ‘\0’, ‘\0’}. Each entry is accessed as: FirstThousand[num+999], where ‘num’ is the binary value to be converted to decimal. This way, the table can be used to very quickly access the decimal display of any number from −999 through +999. Each entry can be moved 346 by a single fast 32-bit move operation. Some ranges can be optimized by noting exactly how many characters 885 are being moved, and whether 32-bit or 16-bit operations will occur. Special case 890 for any number less than −99: add 496 a terminating null value at the end of the copied string (because each number in this case, for example “−100”, is exactly 4 chars in length, there is not a terminating null for the display string). To save execution cycles 891, it may be preferable to add a null after the fourth char of the display buffer in every case without checking to see if the number was one that called for the extra null; this will not harm the output, and this method does not require any if/then comparisons that could slow down execution.

FirstThousandw (note the ‘w’ at the end to denote ‘wide-char). Table of double-byte wide chars (1999 entries, each four wide-chars wide, the double-byte char complement to the single-byte char table FirstThousand): {L‘−’, L‘9’, L‘9’, L‘9’, L‘−’, L‘9’, L‘9’, L‘8’, . . . , L‘9’, L‘9’, L‘9’, L‘\0’}. Use 4 double-byte wide chars for each entry (each char consumes two bytes of storage). For each entry that consumes less than 4 wide chars (all 8-bit numbers greater than −100), fill extra char slots with null values (L‘\0’). For example, the number −7 would be {L‘−’, L‘7’, L‘\0’, L‘\0’}. Each entry is accessed as: FirstThousandw[num+999], where ‘num’ is the binary value to be converted to decimal. This way, the table can be used to very quickly access the decimal display of any number from −999 through +999. Each entry can be moved by a single fast 64-bit move operation (or by two 32-bit move operations). Some ranges can be optimized 496 by noting exactly how many characters 885 are being moved, and whether 64-bit or 32-bit or 16-bit operations will occur. Special case 890 for any number less than −99: add a terminating null value at the end of the string (because each number in this case, for example “−100”, is exactly 4 chars in length, there is not a terminating null for the display string). To save execution cycles, it may be preferable to add a null after the fourth char of the display buffer in every case.

Triplets.

Table 234 of byte chars (1000 entries, each four chars wide), one 4-char entry for each number from 0 to 999. Each number is left-padded with zeros, and each entry is null terminated with a ‘\0’ null character: {‘0’, ‘0’, ‘0’, ‘\0’, ‘0’, ‘0’, ‘1’, \‘0’, . . . ‘9’, ‘9’, ‘9’, \‘0’}.

Tripletsw

(the ‘w’ denotes ‘wide-char’). Table 234 of double-byte wide chars (1000 entries, each four wide-chars wide), one 4-char entry for each number from 0 to 999. Each number is left-padded with zeros, and each entry is null terminated with a ‘\0’ null character: {L‘0’, L‘0’, L‘0’, ‘L\0’, L‘0’, L‘0’, L‘0’, ‘L\0’, . . . L‘9’, L‘9’, L‘9’, L‘\0’}.

TripletsComma.

Table 234 of byte chars (1000 entries, each four chars wide), one 4-char entry for each number from 0 to 999, with a prepended comma (and no null terminator). Each number is left-padded with zeros, and each entry is prepended with a comma: {‘,’, ‘0’, ‘0’, ‘0’, ‘,’, ‘0’, ‘0’, ‘1’, . . . ‘,’, ‘9’, ‘9’, ‘9’}. Alternatively, the comma could be placed as the fourth character, rather than the first, for each 4-char entry, with appropriate changes made to other tables and to appropriate points in the algorithms by one of skill in the art.

TripletsCommaw

(‘w’ denotes ‘wide-char’). Table 234 of double-byte wide chars (1000 entries, each four wide-chars wide), one 4-char entry for each number from 0 to 999, with a prepended comma (and no null terminator). Each number is left-padded with zeros, and each entry is prepended with a comma: {L‘,’, L‘0’, L‘0’, L‘0’, L‘,’, L‘0’, L‘0’, L‘1’, . . . L‘,’, L‘9’, L‘9’, L‘9’}. None of the entries are null-terminated. Alternatively, the comma could be placed as the fourth character, rather than the first, for each 4-char entry, with appropriate changes made to other tables and to appropriate points in the algorithms by one of skill in the art.

Note that for each of the comma tables above, it is possible to use a trailing comma instead. One of skill in the art would understand how to modify the remaining code 202 to properly accommodate trailing commas as opposed to leading commas.

Table-Using Technologies

In some embodiments, the technologies are divided 496 several ways in order to maintain the fastest-possible speed. The methods are grouped 550 according to bit-size (8, 16, 32, and 64); grouped 552 according to sign of the number (signed and unsigned); grouped 554 according to type of number (integer and floating point); grouped 556 according to whether thousands separators are desired; and grouped 458 according to the underlying execution technology (managed/cli/.NET 928 and unmanaged/native 930).

The algorithms below apply to both char (single-byte) and wchar_t (double-byte) output. One skilled in the art guided by teachings herein would know how to adjust 550 the buffer-copy operations to be fast, according to the number of bytes to be copied. For example, copying four single-byte characters can be performed with one 32-bit move operation, while copying four double-byte characters can be performed with either two 32-bit move operations, or one 64-bit move operation if available. This is left to the implementer. The skilled-in-the-art implementer will also know to not mix single-byte char variables with double-byte char variables. Additionally, an implementer skilled in the art guided by teachings herein would know that the position ‘buf+2’ would point to two bytes after the start of the buffer ‘buf’ in single-byte implementations, and it would point to four bytes after the start of the buffer ‘buf’ in double-byte implementations (since each position in the buffer takes two bytes). And an implementer skilled in the art of assembly language would know that, in assembly language, the above example ‘buf+2’ behaves differently than in the C or C++ language: it will mean the location that is two bytes after the start of the buffer ‘buf’ whether using single-byte or double-byte implementations.

In some implementations, the CPU DIVIDE instruction is slower when performing a signed divide compared to an unsigned divide. Also, in some implementations, the algorithms below can be modified 496 slightly to handle signed integers in this way: when ‘num’ is negative, convert it to a positive number (unsigned Unum=0−num) and place a ‘-’ char at the beginning of the buffer. Then, perform the lookup-and-copy operations using the positive number as the index, placing the copied data to the right of the ‘-’ char (since the negative sign was just placed at the start of the buffer, the first lookup value will be copied to the position at buf+1).

8-bit Signed integers. Do a quick table lookup based on the value: FirstThousand [num+9 9 9]. Special case for any value less than −99: add a null ‘\0’ at the end of the buffer after copying the table entry. Rather than doing a branch/compare, it could be quicker to add a terminating null ‘0\’ value as the fifth char of the buffer.

8-bit Unsigned Integers. Do a quick table lookup based on the value: FirstThousand [num+9 9 9]. A terminating null will be automatically included (if the table is set up with terminating nulls for entries that require three or fewer display characters).

16-bit Signed Integers (without commas). The Listing_{—}6058-2-3A.txt computer program listing appendix file, incorporated herein by reference, includes a pseudocode listing. Note that for the code listed, the TripletsComma table has commas as the first character of each entry; also, in the branch handling negative numbers, the sequence ((0−num) %1000) could be rewritten as (num %−1000):

16-bit Signed Integers (with commas). The Listing_{—}6058-2-3A.txt computer program listing appendix file, incorporated herein by reference, also includes a pseudocode listing for this situation.

16-bit Signed Integers (with user-specified commas). The Listing_{—}6058-2-3A.txt computer program listing appendix file, incorporated herein by reference, also includes a pseudocode listing for this situation.

16-bit Unsigned Integers (without commas). The Listing_{—}6058-2-3A.txt computer program listing appendix file, incorporated herein by reference, also includes a pseudocode listing for this situation.Pseudocode listing:

16-bit Unsigned Integers (with commas). The Listing_{—}6058-2-3A.txt computer program listing appendix file, incorporated herein by reference, also includes a pseudocode listing for this situation.

16-bit Unsigned Integers (with user-specified commas). The Listing_{—}6058-2-3A.txt computer program listing appendix file, incorporated herein by reference, also includes a pseudocode listing for this situation.

Some embodiments process 558, 496 dates and times with special cases 890, by recognizing when they use byte-sized numbers (hour, minute, date, second, month are all <60), which are then processed extremely quickly as table lookups. Some embodiments provide custom functions 932, 936 to return times and dates in multiple, user-selectable display formats using technologies described herein.

Application Program Interfaces 934

Some embodiments provide one or more digital-base conversion functions 936 having function headers (a.k.a. function specifications, signatures) 938 shown in the Listing_{—}6058-2-3A.txt computer program listing appendix file, incorporated herein by reference. These include ASCII versions for native/unmanaged code 930; some embodiments also provide wide-char (Unicode16) versions for each one of these. Notwithstanding anything to the contrary elsewhere in this document, copyright is claimed by NumberGun LLC in these procedure headings (a.k.a. signatures) only to the extent they were not previously published by others. NumberGun LLC recognizes and respects industry standards, interoperability based on shared interface definitions, and the intellectual property rights of others.

In addition, some embodiments provide a printf-like function 924 that allows customers to have more control over the placement, formatting, and alignment of output digits. The above functions allow the user to determine whether to use commas or not (by selecting the appropriate function), and to customize the comma character. Thousands and decimal separators can first be determined by the current locale, but can also be overridden globally or based on each function call 544, as one can see in the calls that allow a separator to be specified.

In some embodiments, the above functions come in native-ASCII, native-wide char, and/or managed code 928 versions, e.g., managed Strinĝ functions. The native functions may also have assembly 866 counterparts. A DLL (dynamically linked library or dynamically loaded library) file will work for native implementations 930. Native users may have the option to either use a DLL or to use the code from an object library which can be linked into the user's program. Calling 544 functions from a library can be a bit faster in execution than calling 544 from a DLL.

With regard to the managed/.NET model and the Objective C language used in iOS environments, some or all String variables are immutable (String with an uppercase ‘S’ is the main managed string variable type for Microsoft's managed and .NET code). Once a String is formed, it cannot be changed. It can be referenced, copied, or deleted. Instead of modifying an existing String, a new String that contains the modifications is created. The longer the String, the more expensive it can be to make changes. Once a String is created, it can be passed around to any function, and nobody has to worry about it changing since it's immutable. But for code that manipulates Strings, that process is substantially slower compared to native code that can just manipulate a string 940 in place, without then having to incur the additional cost of allocating a new string. However, both managed 928 and native 930 code can access the same global memory with no speed penalty, and managed code can also manipulate char* or wchar_t* arrays just as quickly as native code. These character arrays can allow functions in some embodiments to operate more quickly; the functions can build up the character string in an array, representing the decimal version of the binary number, and then the character string is converted to a new String instance (this conversion can be costly, especially for larger Strings, since all the characters are copied to a new location).

Some embodiments mix managed 928 and unmanaged 930 code. The granularity is as small as an individual function 936; each function is either managed or unmanaged/native. But it is costly for managed code to call an unmanaged function (due to having to switch control from one execution environment to another, which can involve copying data and additional overhead used to prevent or detect potential security or data corruption problems), and it is difficult for unmanaged code to call a managed function 936. To maintain speed, those of skill in the art avoid unnecessary calls of unmanaged functions from managed functions.

In some instances, however, native code 930 will still be preferred (usually due to speed issues) and so it will sometimes be helpful to call a native function from managed code. This can be the case where many conversions are “batched up” in a single array and converted 560 all at once. In this case, the switching costs between the managed and unmanaged costs can be partially mitigated by making one function call instead of several calls.

PreFetch

In some embodiments, the conversion algorithms can use several hundred Kbytes of data in lookup tables. If that data is not already in the L1 or L2 data cache 944, it can be relatively costly to access, in that the first access could take 100-200 extra clocks (or more). However, prefetch instructions can pre-load 562 the data cache with the desired data; the prefetch instructions 116 would be given early enough so that when the tables 216 are accessed, their data content 118 is in the cache 944. In hardware embodiments, a dedicated cache 944 could be created and implemented that would complement hardware-level support for these algorithms. Putting everything into microcode 946 could be the fastest embodiment. Alternatively, some embodiments embed 562 read-only tables and data (such as MagicNumbers and multipliers, for example) in the code 202 segment close to the functions that use them, so that when the code path starts execution, portions of the tables and data will load with the code path.

A Printf Example

Some embodiments integrate the numeric conversion 490 routines with printf custom formatting 494. For example, consider the apparently simple code: char buffer[150];

int nApples=150;
int nOranges=243;
sprintf(buffer, “The store sold % d apples and % d oranges”, nApples, nOranges);

This code will insert the string “The store sold 150 apples and 243 oranges” into the field ‘buffer’. But when these library functions have not been optimized, the various components work separately, not together; they produce the output, but not with extreme speed. Also, they were likely written in C or C++, not assembly language, pointing to another potential bottleneck.

For example, a naïve implementation could perform two memory allocations (one for a buffer used to convert nApples to a null-terminated display string, another for a different buffer for converting nOranges). Then, the first portion of the string “The store sold” would be copied, one byte at a time into the user-specified destination buffer, and each time asking if the end of the string had been reached or a formatting char encountered (the ‘%’ in this case). Then the number 150 would be converted to an integer by some “itoa”-type function into a null-terminated string into a temporary buffer and then copied to position in the destination buffer, one byte at a time, and at each byte the function would check to see if the terminating null was found. This process would continue until the decimal representation of the number 150 was copied. The process would continue, copying the string “apples and” to the buffer, and then the number 243 would be converted to a decimal string in another buffer, then copied back to the destination buffer. These processes would continue until the finalized string was created. Some implementations may create the number display strings directly at the proper position in the destination buffer, thereby eliminating the need to copy the number display strings.

Accordingly, an embodiment with code 202 and code 204 that integrates and coordinates rapid binary-to-decimal conversion 490 (as described herein) of multiple types of binary numbers with custom formatting 494 can be substantially faster than naïve versions of printf, sprintf, or similar functions 924. “Similar” functions, a.k.a. printf-style functions, include those which present 546 users 104 with an interface (a.k.a., signature, API, heading) that is consistent with the following description from a Wikipedia article on “printf format string”:
Printf format string (of which “printf” stands for “print formatted”) refers to a control parameter used by a class of functions typically associated with some types of programming languages. The format string specifies a method for rendering an arbitrary number of varied data type parameter(s) into a string. This string is then by default printed on the standard output stream, but variants exist that perform other tasks with the result. Characters in the format string are usually copied literally into the function's output, with the other parameters being rendered into the resulting text at points marked by format specifiers, which are typically introduced by a % character.

Although printf-style functions 924 (including printf, fprintf, sprintf, and other variants) are widely used in C, C++, C# and other C-derived programming languages (e.g., in C#, the String.Format method is used), printf-style functions 924 are not limited to those programming languages. The Wikipedia article gives examples of printf-style functions (denoted herein by reference numeral 924, without thereby denigrating the innovations described herein) from FORTRAN, COBOL, LISP, Perl, PHP, Python, Java, and other programming languages. Format specifiers for printf-style functions 924 are typically in the form of a string whose syntax permits literals 943 and references to variables 914. Output of a printf-style function is typically a string, sent to a stream such as standard out (stdout) or to a buffer in memory or on disk or through a socket, for example.

Hand-Held Devices

Some embodiments are particularly suited for smartphones, tablet computers, and/or other hand-held devices 102. Since these devices are usually smaller, lighter, and possibly less powerful than desktop equivalents, they may convert 302 numbers more slowly. Some devices 102 don't have any FPU, and some don't support DIVIDE in the main CPU.

Using 338 Exponent Bits as an Index

Some embodiments inspect the bits in the original number to determine the size of the number, which can be useful in quickly converting the number to decimal format. Different methods can be used depending on whether the binary number is a floating-point or an integer number.

In at least one embodiment for converting floating-point numbers, the exponent bits of the number are used 338 to determine the number's magnitude. The bits are used to create an index 832 into another table. As for the minimum number of bits to use as an index (into LookupTable), it has been determined that using 10 bits works reasonably well; using more bits will also work, but makes the resulting tables bigger. Nonetheless, even though 10 bits work for an index into the LookupTable, some embodiments use 11 bits as an index into a BitPosition table in order to identify the index for the LookupTable. Although the 11 bits are used to index the BitPosition table, some embodiments do not use the lower half of the bit range since the highest bit is set for all entries in that position. Accordingly, an embodiment could overlay 564 tables to make the total table about half the size it otherwise would have been. This adds complexity during the creation 376 of the tables, which is only performed one time. Once created, all the tables are read-only and will not change in these embodiments. So they can be stored wherever most convenient (in the .obj, .exe, .lib, etc. file, or in some other table). They could also be created 376 at run time.

In at least one embodiment for converting integer numbers to decimal, the bits of the number are scanned to determine 356 the most-significant bit 810 of that number. The position of that most-significant bit can be used as an index. The index can then be used to index a jump table 232 that quickly directs 496 the program flow to the portion of the conversion code that is best suited to converting a number of the current number's size, eliminating many “if-then-else” statements that would otherwise be used to convert the number. Or, where one of skill determines it desirable (for example, in CPU environments where either there is no native instruction like the BSR instruction on the Intel® chip to quickly determine the most-significant bit, or where that instruction is slow relative to other options), the index could be used in a series of very fast and small “if-then-else” statements 222 to funnel the code execution based on the size of the number.

An advantage of using the index in a series of “if-then-else” statements is that these statements can be quickly performed using an integer size that is native to the CPU; this is especially helpful in situations where the bit size of the number being converted is greater than the bit size of the CPU, such as when converting a 64-bit (or higher) number in a 32-bit execution environment. Using a language such as C or C++ can obscure these speed-relevant issues from a developer, but one advantage of methods herein described is that those issues become transparent when looked at via assembly language in view of the present disclosure, and the tradeoffs 902 can be more fully appreciated by one of skill in the art. For example, a 32-bit CPU can easily compare a 32-bit (or smaller) integer with another 32-bit integer; this compare is very fast and small. The Listing_{—}6058-2-3A.txt computer program listing appendix file, incorporated herein by reference, includes a code snippet in C++, and then the same code snippet in assembly language, to compare 32-bit integers. Comparing 64-bit numbers in a 32-bit execution environment, though it appears to have the same complexity in C++, is much more complex than comparing with 32-bit numbers, as shown by other code snippets in Listing_{—}6058-2-3A.txt.

The code snippet examples show much more complexity with 64-bit numbers than 32-bit numbers when running in a 32-bit execution environment. The code dealing with 64-bit numbers takes longer to execute; when 32-bit operations can be designed to replace 64-bit operations in a 32-bit execution environment, faster throughput can occur. The same approach scales to larger-bit environments, meaning, for example, that 128-bit operations in a 64-bit execution environment are slower than 64-bit operations in that environment.

Some Observations about Familiar Approaches

One familiar approach to converting binary to decimal includes an “itoa” (integer-to-ascii) routine (a.k.a. function, method, procedure) to output numbers. This well-known approach, which was used by inventor Eric J. Ruff over a year before the priority date of the present application, used the “divide-by-ten” method to continuously divide a number by 10, take the remainder (which was a number from 0 to 9) and convert it to ASCII (by adding the ASCII value for the digit ‘0’ which is 0x30) to it, then use the quotient of the number divided by 10 for the next iteration, and iterating until it becomes 0 and all remainder digits have been output. This builds the ASCII format from the right to the left. Then, depending on the situation, one could copy the converted decimal number to the desired memory buffer to align it as desired.

Mr. Ruff also created a file-viewer program that would display the bytes of a file in hex format, in the late 1980s. The following description of that file-viewer program is based on his recollection, without the benefit of a code review since the location (and continued existence) of the file-viewer program's code is presently unknown. Since every byte in a file would convert to a two-digit hex code (ex: the number 0 is 0x00 hex, or ‘00’; the number 109 is ‘6D’ and the number 255 is ‘FF’), this “itoh” (integer-to-hex) code used a fast lookup-table that contained 256 two-byte entries. The code could very quickly convert a single byte into its two-byte ASCII representation without doing any math at all. Mr. Ruff's earliest versions of converting to hex were converting a nibble at a time, so it would take two passes through the algorithm for each hex display. He later determined that it was faster to use the 256-byte lookup table to get two hex digits on each pass. These familiar methods of converting binary numbers were conceptually simple. The first (itoa) method was slow but simple to create and it worked. The second (itoh) method was even simpler and extremely fast. Both methods were quick and easy to implement and use.

Some Observations about Testing

One of skill will understand that testing 566 the conversion of large-bit numbers cannot be comprehensive. Consider that there are Ser. No. 18/446,744,073,709,551,615 64-bit numbers to test (to include testing of all negative values, increase that number by 50%), but there are only 31,536,000 seconds in a year. Assume a super-fast computer 102 and an extremely fast test algorithm that can test 100,000,000 conversions per second (this is much faster than the average number of conversions one could feasibly test with typical laptops or workstations). Given these assumptions, it would take more than 5,849 years of continuous uninterrupted testing 566 to complete the test (and more than another 2,924 years to test all the negative numbers) for just one 64-bit algorithm implementation. Therefore, testing 566 the conversion 302 of every possible individual 64-bit value for each and every algorithm is not feasible given today's available processor speeds and available computing resources.

Accordingly, one testing approach is to analyze source code (either during execution, during debugging, or reviewing source files visually), to seek logical errors. This is, of course, done by many software developers and is also known by many software developers to be useful but no guarantee except in very limited circumstances.

Another approach is to compare 566 a test implementation's output automatically with a previous commercially available (but often slower) function for base conversion.

Another approach is to test 566 various focal points 948: First, the number 0. Then all numbers less than 1000. Then, numbers less than 1024. Then, less than 2048. Then, less than 10,000; then 65,536; and so on. These examples consider that changing to a different power of ten, or adding another bit to the width of the number, are focal points 948 that help identify stress points in the algorithm for more thorough testing 566. Extreme values can also be tested, such as all integers from 0 to 4,294,967,295 (the highest possible 32-bit number), all of which can be tested in a reasonable amount of time. Additionally, all values that cross boundary points can be tested, such as those used to test inside if-then-else statements or those used in jump tables, along with several immediately-adjacent neighbor values on each side of each boundary point, and the code behavior can be carefully inspected as various inputs advance toward and/or recede from each respective boundary. Additionally, random values within various ranges could also be tested 566.

Another approach is to test 566 purposely invalid input, and to compare results to assess how other commercially-acceptable methods handle such input. One of skill in the art would consider ensuring that the output or end result when bad input is encountered, when implementing methods as described herein, falls within expected ranges (to avoid the familiar garbage-in-garbage-out trap, divide-by-zero errors, bad-pointer exceptions, etc.).

Some Observations about 32-Bit, 64-Bit Terminology

Some embodiments provide 496 a specific version for 32-bit numbers, and some provide 32-bit code to handle any 64-bit number. Those of skill will understand that terms such as 32-bits and 64-bits can apply to different aspects of computing technology, depending on the context. The role of context is noted, for example, in a Wikipedia article titled “64-bit”:

In computer architecture, 64-bit integers, memory addresses, or other data units are those that are at most 64 bits (8 octets) wide. Also, 64-bit

CPU and ALU architectures are those that are based on registers, address buses, or data buses of that size. 64-bit is also a term given to a generation of computers in which 64-bit processors are the norm. 64-bit is a word size that defines certain classes of computer architecture, buses, memory and CPUs, and by extension the software that runs on them . . . .

Without further qualification, a 64-bit computer architecture generally has integer and addressing registers that are 64 bits wide, allowing direct support for 64-bit data types and addresses. However, a CPU might have external data buses or address buses with different sizes from the registers, even larger (the 32-bit Pentium had a 64-bit data bus, for instance). The term may also refer to the size of low-level data types, such as 64-bit floating-point numbers.

Given the frequently low-level nature of embodiments described herein, the number of bits generally refers to the number of bits 910 in a representation of a number in computer memory 114, to the number of bits 910 in a processor register 206, and/or the number of bits 910 which can be moved using a single processor 112 MOVE instruction or operated on with a processor 112 operation such as MULTIPLY. The context and meaning will be clear to those of skill.

Passing an Array

For some programming languages or environments, there is substantial overhead in calling an external function. But some embodiments allow a programmer to pass an array 950 full of numbers 208 to convert, with a coordinated array 950 of buffer space 212, so that with one call 544 to the external function, multiple numbers 208 can be processed 302. In some embodiments, the array could include different types 892 of numbers 208 to convert. For example, a whole web-page-full of numbers could be passed and handled in one very fast call. This can be a very effective way to dramatically increase the speed of converting numbers, especially in a managed code environment where a super-fast native function 930, 936 could be called once to handle many inputs with one call.

Some Observations about Rounding

Due to the way floating-point numbers are handled internally, there is often a need to round 522 the numbers so that they display properly. There are several levels of rounding 522, each one taking more time than the previous level but also providing a bit more precision: you can skip rounding, can add 0.5 to the DITR (Digit Immediately To Right), can use these Pos/NegRoundingTables, and/or can use the tie-breaker method. Disclosed herein is an innovative table-based method that allows selection 568 of one of several rounding methods, plus an innovative tie-breaker method for special cases 890. These methods 952 look at the Least Significant Digit (LSD, or the digit that will be rounded) and the Digit Immediately To its Right (the DITR) to determine how to round 522. In some cases, as in the tie-breaker method disclosed below, it is helpful to examine additional digits further to the right. Numbers can then be rounded according to the following methods. One of skill would note that the methods taught herein can also apply to rounding integers; for example, in some embodiments where an integer is treated as a fixed-point number and where the internal precision of the decimal portion is greater than the precision to display, the number should be rounded before being displayed).

The following is a list of rounding methods 952 for floating-point numbers recommended by the IEEE (which can apply also to integer and fixed-point numbers). For illustration purposes, the examples here assume each number will be rounded 522 to two decimal places: the LSD is therefore the second decimal digit, and the DITR is the third decimal digit. (Of course, these methods apply to rounding at any decimal-digit position, and one of skill can modify the methods accordingly.)

A) Round (or truncate 514) toward 0. The numbers 9.991, 9.995, and 9.999 would all round to 9.99; and the numbers −9.991, −9.995, and −9.999 would all round to −9.99.
B) Round toward −infinity. The numbers 9.991. 9.995, and 9.999 would all round to 9.99; and the numbers −9.991, −9.995, and −9.999 would all round to −10.00.
C) Round toward+infinity. The numbers 9.991, 9.995, and 9.999 would all round to 10.00; and the numbers −9.991, −9.995, and −9.999 would all round to −9.99.
D) Round toward nearest, ties toward even (this is the recommended default). The numbers 9.991 and 9.994 would both round to 9.99; 9.996 and 9.999 would both round to 10.00; and 9.995 would round to 10.00 (because the LSD 0 is even), but 9.985 would round to 9.98 (because the LSD 8 is even). The numbers −9.991 and −9.994 would both round to −9.99; −9.996 and −9.999 would both round to −10.00; and the number −9.995 would round to −10.00 (because the LSD 0 is even), but −9.985 would round to −9.98 (because the LSD 8 is even).
E) Round toward nearest, ties away from 0. The numbers 9.991 and 9.994 would both round to 9.99; and the numbers 9.995, 9.997, and 9.999 would all round to 10.00. The numbers −9.991 and −9.994 would both round to −9.99; and the numbers −9.995, −9.997, and −9.999 would all round to −10.00.
Each of the above rounding methods can be performed using a lookup table specifically designed for the rounding method. Some methods 952 herein use RoundingTables 260 which have values that perform the proper rounding when the appropriate value is added to a number being rounded 522, as described below. The Listing_{—}6058-2-3A.txt computer program listing appendix file, incorporated herein by reference, includes data values for several rounding tables.

Use the PosRoundingTables 260 when dealing with positive numbers, and the NegRoundingTables 260 when rounding negative numbers. Note that some binary-number conversion algorithms described in the present disclosure will first convert 362 negative numbers to positive before any processing, and yet the rounding for negative numbers differs from the rounding of positive numbers. One of skill would ensure that if the current number 208 being converted was negative at the start, the NegRoundingTables are to be used to cause the correct rounding to occur. One of skill may note that other values can be used that cause the same rounding to occur to the LSD. Note that some values are negative, some positive, but each value, whether negative or positive, will be added during the rounding process. One of skill may notice that, for Methods A, D, and E, the values in the NegRoundingTables are the negatives of the values in the Positive versions; one could, therefore, subtract the values from PosRoundingTables A, D, and E rather than add the values from NegRoundingTables A, D, and E, when rounding negative numbers, thereby reducing memory requirements. In an initial embodiment, the separate tables would be used, consuming slightly more memory, to prevent confusion in the algorithm.

Due to the structure of 64-bit double floating-point numbers, which have only 53 mantissa bits, they can handle only 16 to 17 digits accurately; any additional digits extracted are likely to be inaccurate for doubles once they are stored to memory (when kept in the FPU registers, they are normally maintained with 80 bits of precision, but the extra precision is lost when they are written to 64-bit memory). The teachings herein apply to all floating- and fixed-point formats; for 32-bit floats there are fewer mantissa bits, and therefore fewer significant digits; for 80- and 128-bit floating-point numbers, there are more mantissa bits, and therefore more digits of accuracy. So in cases where there are 16 or more significant digits required from a 64-bit double floating-point number, one of skill will recognize that any rounding method could give inaccurate results. But 64-bit integers, which can handle 19 to 20 digits, can give accurate rounding results with 18 to 19 digits (the last digit, which will become the DITR, is lost after the rounding operation). Therefore, rounding integers with up to 18 digits can give precise, expected results (although any integer that is the result of converting a floating-point number will still be limited to the precision of the original floating-point format). Although the methods disclosed herein can be implemented by using the FPU (or other technology) to perform the rounding, the integer-based methods do not suffer from any rounding imprecision once the floating-point number is converted to an integer.

Converting Floating-Point Number with Rounding

Rounding 522 can be accomplished by adding a certain value to the number based upon the DITR, the rounding mode, and the LSD. So it can be helpful to make those last two digits easy to access. To do this correctly, the LSD and the DITR should be available for inspection. In current methods, this is difficult and expensive in terms of CPU clock-cycles required. The FPU is normally used to round floating-point numbers, but there is a faster method 952 that can be performed using the CPU's general-purpose registers 206, once the number is scaled appropriately. In some embodiments, once a floating-point binary number has been scaled 354 by the Scale1000 table as explained elsewhere in the current disclosure, a rounding value can be added to that number from a RoundingTable, the entry of which is based upon the number of decimal digits to display. That process is effectively implementing Rounding Method E 952, above; it causes all numbers whose DITR is from 0 through 4 to round toward 0, and whose DITR is from 5 through 9 to round away from 0. But at times, other rounding methods are desired. Here is a way to implement these rounding methods with very little clock-cycle cost. (One of skill will note that this rounding method that uses the general-purpose registers can be readily modified to operate entirely within the FPU, if desired.)

Intel has provided the FIST/FISTP commands for decades, which are used to convert a floating-point number to an integer, while at the same time rounding the number as desired (the number to be rounded is scaled so that the LSD moves to the immediate left of the decimal point; for example, to round the number 9.999 to two decimal places, it would be first scaled to 999.9 and then rounded by adding 0.5 to the number making 1000.4, after which the integer portion would then be converted to a decimal display string “10.0” taking into account the position of the implied decimal point). This is a key step in many prior-art methods that convert a floating-point number to a decimal string. The FIST/FISTP commands require specific programming of the rounding mode of the FPU to ensure the desired rounding result, and this programming is quite expensive clock-cycle wise. A programmer must save the existing FPU control word, upload a new one to perform rounding as needed, do the rounding operation and optionally store the number to memory, and then restore the original control word. This is slow, complex, and problematic.

Intel later introduced the FISTTP command which will truncate 514 a floating-point number into a 64-bit integer without the expensive reprogramming of the FPU. In addition, SSE2 and AVX technology supports other commands, including CVTTSD2SI, which can also be used. But since these commands truncate (they round according to Rounding Mode A), to use them with a different rounding mode requires one more digit (the DITR) to be to the left of the decimal point so that the LSD can be inspected along with the DITR and then rounded as desired. Some methods described herein assume use of either the FISTTP or CVTTSD2SI commands. Alternate methods separate the floating-point number into its component parts and then use the general-purpose registers to produce the rounded number.

Some embodiments operate as follows. Assume the number to round is OrigNum=133.985, and it will be rounded to two decimal places. According to the five rounding methods 952 described above, the desired output at the end of the algorithm will be one of:

### A) 133.98

### B) 133.98

### C) 133.99

### D) 133.98

### E) 133.99

Follow these steps:

1. Use a method such as described in the section “Converting to Exponential Notation” to scale 354 the floating-point number that is to be rounded (the new value will be SaledNum). With ScaledNum still in the FPU, determine how many decimal places are desired (in this example, NumDecimalPlaces=2).

2. Use NumDecimalPlaces as an index into the table MultiplesOfTen (the first entry of MultiplesOfTen is the value 10, followed by 100, then 1000, etc.
each entry is ten times the previous; each can be stored as a double or as an integer, preferably the natural-word size), and multiply ScaledNum by that entry to obtain NewNum=ScaledNum×MultiplesOfTen[NumDecimalPlaces]=133985.0 (there could be additional digits after the first decimal place, but they will be ignored except if the tie-breaker method is used). In some embodiments, the appropriate multiples of 10, which already exist in either the Doubles10 table or the Scale10 table, are used. In some embodiments, this step 2 is combined with step 1, whereby the index to be used to identify the scaling value from the Scale10 table is adjusted by the number of desired decimal digits, plus one, to arrive at NewNum directly without requiring an additional multiplication step. The key is to select a scaling value such that the DITR (the digit ‘5’ in this case) moves immediately to the left of the decimal point.

3. Using the fast FISTTP or CVTTSD2SI command, convert NewNum to a 64-bit integer IntNum=133985. Remember that, due to the scaling, the actual desired decimal place comes after the first three digits (i.e., after the digits “133”). Once the number has been rounded (i.e, step 5 has completed), some embodiments will directly convert this number, using the fact that the Index obtained in step 1 can be used (as explained elsewhere in the present disclosure) in conjunction with other tables to determine that there is one triplet to the left of the decimal, and the first triplet is three digits wide, and that immediately after this triplet there are NumDecimalPlaces decimal digits to extract.

4. Without modifying IntNum, divide a copy of IntNum by 100 to obtain the remainder RoundIndex=85 (in an alternative embodiment, a MagicNumber method could be used instead of dividing by 100; or, the integer of ScaledNum in step 1 could be obtained and then multiplied by the same index of

MultiplesOfTen, and that value subtracted from the value from step 3 to obtain RoundIndex). This index includes the LSD as the first digit, and the DITR as the second. RoundIndex will be an index into one of five tables, depending on the desired rounding: PosRoundingTableA, PosRoundingTableB, PosRoundingTableC, PosRoundingTableD, or PosRoundingTableE, depending on the desired rounding mode. (When rounding negative numbers, the behavior can be different than when rounding positive numbers; therefore, each PosRoundingTable also has a negative counterpart: NegRoundingTableA, NegRoundingTableB, etc., each of which can be used to round negative numbers.)

5. Assuming we are using Rounding Method D, the next step will be RoundedNum=IntNum+PosRoundingTableD[RoundIndex], which produces the value 133985+(−5)=133980, given that the entry at RoundingTableD[RoundIndex] is −5. If we instead wanted to always round up for any rounding digit that is 5 or greater, we could use RoundingTableE, and the process would produce RoundedNum=IntNum+RoundingTableD[RoundIndex]=133985+5=133990. The RoundingTables will have been pre-initialized with the proper values so that the rounding mode occurs properly. The user can even specify the rounding mode for any particular number, as it costs very little to perform the rounding operation compared to other methods which involve reprogramming the rounding mode of the FPU, or performing a series of several DIVIDE and COMPARE commands. The rounding method used can be changed as easily as selecting a different table.

6. At this point, the number can now be converted in one of several ways. In some embodiments, IntNum is divided by MultiplesOfTen[NumDecimalPlaces], and the quotient is converted to a decimal string 210 using an appropriate integer conversion method, then a decimal point is placed after the converted number in place of a null, and then the remainder is converted at the proper position in the output buffer 212 using an appropriate integer conversion method to finish the display string 210. In some alternative embodiments, a MagicNumber 840 multiplication is used to replace the division operation, and the quotient is converted as described above, followed by placement of a decimal point and then conversion of the binary fractional remainder from the MagicNumber operation to extract the number of desired decimal digits. In another embodiment, IntNum is treated as a fixed-point integer with a decimal point in the appropriate position, but the last decimal digits are truncated so that the last digit (which was the DITR) is not displayed. In other embodiments, the number is loaded into the FPU, divided by the multiplier used to scale it, then converted as a double floating-point value with NO rounding (keep the number in the FPU, else precision can be lost).

To initialize 376 the RoundingTable for each method, one of skill will remember that each entry can be either positive or negative. For any given index, the value to store in the table at that index is the value such that, when it is added to the value of the index that determines the position for the number in the table, the value of the LSD becomes the desired value according to the strategy for the rounding mode. In some embodiments, a global rounding mode is specified, in which one of the RoundingTables is selected and is then always used during number conversions.

In this example, the following are the results that would have been obtained when rounding the number 133.985:

### PosRoundingTableA[Remainderindex]=−5

### PosRoundingTableB[Remainderindex]=−5

### PosRoundingTableC[Remainderindex]=+5

### PosRoundingTableD[Remainderindex]=−5

### PosRoundingTableE[Remainderindex]=+5

Now, assume we are to round OrigNum=−133.995, a negative number. The above steps are followed, with a few differences as noted.

1. Remember that the number is negative, because that fact is required for proper rounding later, and for proper conversion from binary to a decimal format.

2. Same as for positive numbers.

3. Same as for positive numbers.

4. Same as for positive numbers.

5. Same for positive numbers, except the NegRoundingTables are used instead.

6. Same as for positive numbers, but it must be remembered that the number to now convert is a negative number (even if it is still positive in memory).

One of skill may want to make the number negative before continuing on, assuming the next code path handles both positive and negative numbers. Or, the appropriate conversion could be branched to at this point.

Tie-Breaker Method 952

When using rounding method D, special rounding occurs when the DITR has the value 5: the rounding goes sometimes upward, sometimes downward, but always toward the even LSD. Theoretically, this is the point exactly midway between two LSD values, but if there were other non-zero digits somewhere to the right of the DITR having the value of 5, then it should be handled as though it was a 6. In fact, this is exactly the case any time NewNum has a non-zero decimal portion and the DITR is 5.

To detect this, create a table TieBreaker that has 100 entries (to match each possible value of RoundIndex produced in step 4). To initialize the table, set each entry where the DITR has a value of 5 to the value 1 (i.e., the value for entries at indexes 5, 15, 25, 35, 45, 55, 65, 75, 85, and 95 will be set to 1); set all other entries to 0 (there will be 10 entries of 1, all others with the value 0). Then, at the end of Step 4, there are some additional steps to take. If not using the PosRoundingTableD, skip this step and go to step 5. Otherwise inspect the value TieBreaker[RoundIndex] for a value of 1; if it's 0, skip this step and go to step 5. If it's 1, compare the value NewNum with IntNum. If it's the same, skip this step and go to step 5. If it's greater, the DITR value of 5 is not really a tie breaker, so add 1 to both RoundIndex and IntNum so that they are adjusted as if there were no tie-breaker needed. Then continue with step 5.

A Demo/Test Program Tool

A programmed tool 202 to demonstrate aspects of embodiments could have features such as the following. Different options 890 could be set based on signed/unsigned, data size, native/managed, commas as thousands separators vs. no separators, different vendors, different rounding options. A user may be able to determine how many times to repeat each test (the number of cycles), and for each test 566 determine how many iterations will be performed. In one approach, there are four different methods for determining which number 208 to convert. The first converts the same number over and over. The second allows a step value (positive or negative), and when the maximum is reached, the test will wrap back to the first value. The third allows for a factor to be multiplied. The fourth allows a user to provide the original numbers, stored in a file in their raw format.

Overhead 954 impacts testing, so one approach includes an option to run the tool in a test without actually converting any numbers. When that option is checked, the program will cycle through the numbers as instructed, but it will call a dummy routine that just does a quick return—and this overhead time can be isolated and remembered and then subtracted from the actual test times to give a good idea of the actual time for converting the numbers. However, some compilers 126 may optimize out the dummy routine, unless it does more than a mere return, e.g., it could increment a global variable 914 and then return. With most if not all tools that generate executable code from assembly language, one could alternatively use assembly language, when testing native code 930, to ensure that no portion of the test is optimized away, thereby assuring that all test loops are actually performed.

Some approaches log info to a file 956, such as the options chosen and the elapsed times (overhead, conversion). Some approaches invoke the tool to convert a file of binary values to strings 210, 940 dumped into another file, then software (not necessarily the tool being tested or demonstrated) converts those strings to binary which the tool is then called on to convert to strings and the two string files can be compared. The various options can also be easily reset though the user interface. In some approaches, if any number in a ‘Type of test’ area has a decimal in it, all numbers are converted to double floating-point values when preparing for the next number to test; if no comma, the tool uses integers. Note that if the test results return milliseconds, not nanoseconds, the results for small numbers may show infinity (dividing by 0), so the test ideally consumes substantially more than 1,000 nanoseconds for a reliable time measurement.

Handling 496 Zero Digits

Consider now a flawed method discussed in the '641 patent for converting a binary floating-point number to a decimal representation by using various tables. To the extent permitted by applicable law of a given jurisdiction, the entire U.S. Pat. No. 5,796,641 is incorporated herein by reference, with particular attention to FIGS. 2-6 and columns 3-6 of that '641 patent.

### Example 1

Consider the number OrigNum=1,000. OrigNum is equal to 10³. As viewed, there is a ‘1’ followed by three ‘0’ digits. The '641 patent's method (“641 method”) as understood by inventor Eric J. Ruff does not describe what to do to handle the digit ‘0’. Following the method described in the '641 patent, the first digit of OrigNum will be correctly identified as being equal to 1000. This allows code to extract a ‘1’ digit (using some method not described, but set that aside for the moment). After identifying this ‘1’ digit, the value 1000 is subtracted from OrigNum (OrigNum=OrigNum−1000=0). The next step is to inspect OrigNum to see if it is equal to 0; if so, stop—the method has finished. In this example, OrigNum−1000=0. So after extracting the ‘1’, the '641 algorithm ends with the output “1” instead of the correct output “1000”. It does not differentiate between the numbers 1, 10, 1000, 1000000, etc.

### Example 2

Consider the number OrigNum=400,009. According to the '641 method as understood by inventor Eric J. Ruff, the first digit ‘4’ will be identified by the second table which tells us that the left-most digit is equal to 400,000. After extracting the digit ‘4’ (by some method not described), the '641 method subtracts 400,000 from OrigNum. Doing this gives OrigNum−400,000=9. So the next digit extracted will be nine, and after that iteration, OrigNum will become 0 and the algorithm 1074 ends. The extracted string ‘49’ is not correct (the correct result is “400009”).

A First Improvement on a '641 Method to Fix the ‘0’ Problem

Some embodiments described herein allow extraction 444 of any number of consecutive 0s. To do this, a table 238 PowerOfTen is constructed to indicate what power of 10 has just been identified in an iteration through digit groups, and to remember that value at each iteration. When a new digit has been found, if the new PowerOfTen is more than one step from the previous PowerOfTen, the embodiment knows there were ‘0’ digits skipped, and so will know to add 496 them to the output string.

In Example 1, when the number 1000 is identified as being equal to the first digit, the PowerOfTen table tells the embodiment this digit is in the position CurPosition=3 (i.e., this is in the place indicated by 10³, so the power of ten at that position is 3). The embodiment saves that value, then outputs the digit ‘1’ and sets PrevPosition=CurPosition. Then, after subtracting 1000 from the number (OrigNum−1000=0), the value 0 ends the loop (and the PowerOfTen table returns the value 0 at this point, and CurPosition will be set to −1, meaning no more digits). But as a last required step, the embodiment's new algorithm will note that since the previous digit was at PowerOfTen position PrevPosition=3 and the next expected position was supposed to be 2 (PrevPosition−1=2) but is instead −1, the math (PrevPosition−1)−CurPosition=3 tells the embodiment to output 496 three ‘0’ digits. The final output will be “1000” which is correct.

In Example 2, after the number 400,000 is identified as being equal to the first digit, the table tells the embodiment this digit is in the position CurPosition=5 (i.e., 400,000=4×10⁵). The embodiment outputs the digit ‘4’, and sets PrevPosition=CurPosition. Then subtract 400,000 so that OrigNum=

OrigNum−400,000=9. The value is not 0 so the loop does not end, and the PowerOfTen tables tells the embodiment that the digit at this position is at CurPosition=position 0. Since the expected value for CurPosition was (PrevPosition−1=4), and instead it is 0, that tells 496 the algorithm 1074 it must output one or more zeros before processing the next digit. So the calculation (PrevPosition−1)−CurPosition=4 indicates that four ‘0’ digits must be appended to the output buffer. The output string will then be “40000”, which is correct at this point. The method will then append a “9” digit as it concludes, to obtain the final and correct output of “400009”.

A Second Improvement on a '641 Method

As described herein, an embodiment can eliminate the SUBTRACT, SHIFT, and AND commands when identifying the first index, and instead use 338 the upper 16 bits (unmodified) of the floating-point number to then access an intelligently-designed table (such as the Index2xxx tables that use a 16-bit index to access the Doubles10, Doubles1000, ManyThousandsDigits, or similar tables), as described in this present disclosure. That cuts off one to two clocks per iteration, at a cost of using a lookup table with 65,536 entries, each 16 bits wide.

A Third Improvement on a '641 Method

If the algorithm 1074 is designed to handle three digits at a time, it can be made more than twice as fast. Some embodiments combine features of the previous algorithms, and/or of other algorithms 1074 described herein, with the '641 method. Assuming sufficient memory 114 is available, the embodiment can have a table ManyThousandDigits 238 representing powers of 1000 from 10⁻³⁰⁹ to 10³⁰⁶, plus many additional entries representing multiples of each power of 1000. Make the first entry of the table the value 0. Then, the next entry will be 10⁻³⁰⁹ (the first power-of-1000 base number) followed by 998 additional entries, each of which is a multiple of the power-of-1000 base number, starting with a multiple of 2 times that base and ending with a multiple of 999 times that base. Then, add the next power-of-1000 entry (10⁻³⁰⁶), along with 998 additional multiples of that entry as was done for the previous base. Follow this pattern until the table has been filled. One of skill may want to extend the table on the front end to handle smaller numbers, and will also have to limit the high end of the table, since the maximum value for a 64-bit double floating-point number, which is approximately 1.79767e+308, will not allow creation of numbers larger than the maximum. Each entry in the table is a 64-bit double. When complete, the table 238 will have approximately 205,000 entries, each 8 bytes wide, for a total table size of about 1.6 MB.

A ValueToPrint table 234 can be created at the same time as the ManyThousandDigits table. Each time a new power-of-1000 base entry is entered, the entry at the same index of ValueToPrint would be 1 (after the first entry of 0 at the start of the table). As each multiple of the power-of-1000 base is used to create a new entry in ManyThousandDigits, each of those multiples become entries in the ValueToPrint table at the same index 832. Thus, the first entry in the ValueToPrint table will be 0, followed by 999 entries of 1 through 999, followed by 999 more entries of 1 through 999, and continuing that pattern until it ends when it has exactly as many entries as the ManyThousandDigits table.

Create another lookup table 218, Index2ManyThousandDigits, similar to that in the '641 approach, and use it to identify the first digit of OrigNum; i.e., identify the greatest value in the table that is less than or equal to OrigNum (to create the table, used methods similar to those described herein that are used to create the Index2Doubles10 table, although the ManyThousandsDigits table is the one to be indexed here). If the selected entry is too large (i.e., if ManyThousandDigits[Index]>OrigNum), the index used will be decremented by one.

The improved algorithm 1074 operates as follows. One of skill can implement this algorithm in C, C++, assembly language, or by using any other appropriate language. First, handle any NaN value for the number (OrigNum), and if the number is negative, convert it to positive using methods described elsewhere in the present disclosure. At this point, OrigNum is a positive number that can be extracted by this improved method. Next, set up a pointer 214 to the output buffer and use 338 the upper 16 bits of the floating-point number as an index into the Index2ManyThousandDigits table: Index=Index2ManyThousandDigits[upper 16 bits].

Then, use Index to identify the greatest value in the ManyThousandDigits table that is less than or equal to OrigNum. Test the value; if it's too large, decrement Index: if (ManyThousandDigits[Index]>OrigNum), decrement Index by 1. Index is now used to access other tables to convert a triplet to the output buffer. Use that Index into the table ValueToPrint which will give, for each Index, the index into a Triplets table that represents the display string for the triplet identified (TripletIndex=ValueToPrint[Index]); append that display string 940 to the output buffer. TripletIndex can also be used as the entry into FirstDigitChars to identify 334 how many digits are in the first triplet; this and other methods, described in the present disclosure, can be used to efficiently extract the first triplet, and then all others after that. Some embodiments will use triplets tables with thousands separators, as described elsewhere in the present disclosure.

Then, subtract from OrigNum the value at ManyThousandsDigits[Index] and repeat the process. Keep track of CurPosition and PrevPosition as mentioned above in order to know when to print any “000” triplets that may have been skipped over. Since the above method is extracting 444 triplets, CurPosition and PrevPosition identify 326 the triplet number, not the digit number; an additional table (TripletID) can be created that, for every entry of the ManyThousandDigits table, identifies the triplet ID (as used herein, the first triplet to the left of the decimal point is triplet 1; the next to the left is triplet 2; and so on, until all triplets have been numbered). Note that for all entries in ManyThousandDigits with a value less than 1, there is one triplet to the left of the decimal point (which will have a value of 0). Make sure to differentiate between positive and negative numbers at the end, if there is any special processing required based on the sign of the number. After the integer portion of OrigNum equals zero, all triplets to the left of the decimal point will have been extracted.

A rounding method 952 can also be used as described herein, if desired, prior to starting the above extraction process. To print decimal digits to the right of the decimal place, after all triplets to the left of the decimal place have been extracted, use any other method disclosed herein to append the converted decimal places to the output buffer.

In certain execution environments, such as those with very slow or non-existant MULTIPLY or DIVIDE instructions, this method could be one of the fastest. It uses simple FST, FADD, and FSUB instructions (or equivalents) which are very fast. In a variation, the embodiment can use the 80-bit floating-point format to help reduce rounding 522 errors.

In an alternative embodiment that can handle integers, rather than floating-point values as described above, the above-described method, modified appropriately, can be used for 64-bit integers, for example. Refer to the section Aspects of Converting Integers to ASCII Format for one example.

A Funnel-Testing Approach

Some embodiments use 386 a funnel algorithm 1074 based on size tests, similar to sample code shown in the Listing_{—}6058-2-3A.txt computer program listing appendix file, incorporated herein by reference.

Some Additional Observations about Assembly Code 866

It is often assumed that creating an assembly-language implementation would be the fastest, and thus presumptively the preferred, way to implement algorithms such as base conversion algorithms 1074. However, that is not always the case. For example, when creating managed code, it may not be possible for someone to code assembly language directly. In some development environments coding in assembly language and/or similar languages such as p-code or MSIL is not even an option; developers instead use a high-level-language compiler. In view of performance gains from optimizations available by various C and C++ compilers, for example, in many cases it may be preferable to implement an algorithm 1074 using code in a high-level language. From the high-level language a developer can gain faster development times, increased maintainability, much easier conversion from 32-bit to 64-bit code, and other advantages. And in some cases where assembly language is not available but in-line optimizations exist, the high-level language compiler can sometimes produce code which will run as fast as what could have been created with hand-optimized assembly language; and if not, it can come very close. Also, some assembly-language programmers may not be skilled in optimization strategies, and the compiler may therefore win the speed tests.

So in some cases, assembly language 866 is preferred, but in others it is not. Sometimes clarity and maintainability are preferable to raw speed, once the high-level implementation is fast enough. Of course, significant improvements in the available algorithms can change developers' views of how fast is fast enough.

Faster Integer-to-Decimal Conversion

Additional information is provided below about a new table-based method to convert 490 binary numbers to decimal. This method can be implemented in native code 930 or in managed (e.g., .NET) code 928 with specific optimizations for the specific environment. It can be targeted toward single-byte ASCII or double-byte characters.

This method may have several characteristics, including one or more of the following characteristics for a given embodiment. It is table-based, making it very fast. For CPU environments where division operations are expensive, it can be implemented with no divisions. For CPU environments where division operations are not costly, it can be implemented with smart divisions that eliminate other instructions. It does not always involve loops; it is easily implemented 360 in an “unrolled” fashion that eliminates looping 342 overhead. It can eliminate 534 the “reverse copying” step that is common in binary-to-decimal conversions that would otherwise create a decimal string in reverse order which is then copied back in the correct order. In managed code, it can take into account both the pros and cons of immutable strings 940. In native code, it can take advantage of better performance from reduced overhead.

Some Background: Native 930 Vs Managed 928 Code

“Native” is a term that applies to code that runs directly on a CPU, or directly on a virtual machine or processor emulation, without additional software. A programmer can use a programming language (such as C, C++, or assembly language) to create native code. Before the concept of managed code, all code was essentially either native or interpreted. Native code could either be directly compiled into machine language to run directly on the CPU, or it could be interpreted and run by a native code engine running directly on the target CPU. Interpreted code required a native interpreter that would interpret source code and then run a “native interpretation” of that code. Native code is usually constrained by an operating system that controls and manages the computer components and allows multiple programs to run at the same time.

In native code, each program will generally manage its own memory allocations and deallocations. Each program manages the release, or deallocation, of various memory blocks no longer in use (known as “garbage collection”). If this complex process is not properly managed, various bugs (such as “memory leaks” or memory-access violations) could be introduced into the program code.

In native code, character strings are usually mutable—they can be easily modified as desired. Although this has traditionally been considered an advantage in terms of performance, it is now widely understood to also be a disadvantage in terms of bugs that can be easily introduced and which can be hard to detect and correct.

Managed code blurs the lines between interpreted and native code, while giving most of the benefits of native code. Managed code was designed to address various shortcomings of native code and to ease managing code created in multiple programming languages. “Managed” is a term used by Microsoft to describe intermediate code that is designed to run under a Common Language Runtime (CLR) that manages the code, which code is known as “bytecode” or “p-code” (for “portable code”). The bytecode is compact, but cannot be directly run by any CPU (although a CPU could theoretically be designed to natively run bytecode). It is compiled into machine code before it can run on a CPU;

alternatively, the bytecode can be run by a special interpreter. Typically, the bytecode is processed by a just-in-time (JIT) compiler that can customize the code for a specific operating system and CPU that is running the code, although it can also be processed and compiled at installation or at some other time, rather than run time, by an “ahead-of-time”, or AOT, compiler.

Managed code is targeted towards Microsoft's .NET environment, whose intermediate code is known as .NET Common Intermediate Language (CIL). The .NET environment provides a rich set of application programming interfaces (APIs) that greatly simplify the programming process. It has been designed to reduce or eliminate various bugs and security hazards that are weaknesses of native code (such as memory leaks and either intentional or unintentional destruction of character strings or other items stored in physical memory). Specifically, garbage collection is now integral to the managed code and is not handled expressly by the programmer.

Also, managed character strings are immutable: they cannot be changed (at least, in theory; it takes great effort, but it can be done). Rather than change a string, a new string is created. For example, consider the variable 914

‘FirstName’ that currently points to the string “John”. Changing the value of the string to “Jonathan” involves creation of a new string “Jonathan” that will replace the previous string “John”. Once this change has been made, the string “John” will be garbage collected and removed from the memory pool—as long as there are no other variable references to that string—allowing that portion of memory to be reused by another allocation. This happens both intelligently and automatically, which can result in a quicker development process with fewer bugs. Also, managed strings can be moved at any time as a result of garbage-collection strategies.

Contrast that change with native code. Under native code, the programmer can simply overwrite the original “John” string to convert it into “Jonathan”. This is very fast—but if not done correctly, bugs can be introduced. Memory that is not to be touched could be overwritten, which could easily happen if the memory block used for the original string “John” was not long enough to hold the new name which is longer; the programmer might realize a new memory block will be allocated, but may forget to properly release the previous block, causing memory leaks; and there are other potential bugs that could be introduced. Although the execution process can be much faster with native code, the avoidance of many memory-related bugs, combined with a likely shorter development path, is a benefit to using managed code which, to many of skill in the art, may be more important than raw speed.

Managed code can be created by using Microsoft's Visual Studio® products, primarily by using the C++/CLI, Visual Basic®, and/or C# programming languages (marks of Microsoft Corporation). Although each language may have its own strengths and weaknesses, they each produce bytecode that runs consistently and equally well under the CLR, and the functions 936 and data structures created by one language can be readily used by a different language. Managed and native (sometimes called “unmanaged”) code can be intermixed, but with strict rules and with performance penalties. For pure managed applications, Microsoft recommends using the C# programming environment.

Note that Java® is also a bytecode language that uses its own CLR and JIT compiler (mark of Oracle). Java is considered a competing platform to Microsoft's managed code. It allows users to easily target both Windows and non-Microsoft platforms, and it provides APIs very similar to those found in .NET. Technically, Java operates in a manner very similar to Microsoft's managed environment on the .NET platform.

A Funnel Algorithm for Integers

This funnel algorithm 1074 converts binary integers into decimal strings. The resulting strings can have thousands separators and/or decimal points if desired. For example, the 32-bit binary integer containing the value 1234567890 can be converted into the decimal representation “1234567890”, or into the comma-separated decimal representation “1,234,567,890”.

The algorithm is termed by the inventors a “funnel algorithm” because it logically separates each number into a series of “triplets” using a funnel 222 (a.k.a. sieve) of varied number sizes. A “triplet” is a group of three digits; the first triplet of a number, however, can either be one, two, or three digits. For example, the above number “1,234,567,890” contains four triplets. The first triplet “1” is one digit, whereas all succeeding triplets will be three digits. Triplets are an example of “digit groups.”

The triplets in a number can be optionally separated by using a thousands separator 228 defined by the local culture. In the U.S., for example, a comma will be used as the thousands separator. In various European countries, however, either a space or a period is the preference. This algorithm seamlessly accommodates the local cultural preference, be it “1,234,567,890” or “1 234 567 890” or “1.234.567.890”, etc. —or having no thousands separator, such as “1234567890.”

This algorithm focuses on performance, namely speed balanced with memory requirements that permit use on the target device or system 102 without increasing memory and/or code-size usage by more than a few percentage points over alternative conversions. This algorithm can be modified in ways that retain its general approach but might adversely affect its performance. For example, it is possible to create just one table of numbers (from “,000” to “,999” as described below) and use that table to produce comma-separated numbers, or numbers without commas. This could involve additional if-then or other programming constructs that could reduce performance. It is generally simpler and faster to create multiple versions of the algorithm, each one specifically targeted to the desired output as described below.

Tables for the Funnel Algorithm

In the implementation below, there are single-byte and double-byte-wide versions of the tables 216. The tables contain multiple entries, each of which is exactly four characters 885 in length. The single-byte tables use one byte per character, thus each entry is four bytes wide. The double-byte tables use two bytes 1056 per character, thus each entry is eight bytes wide. The entries are all placed contiguously, allowing each entry to be directly accessed as an array 950, as is commonly known to those skilled in the art.

A given implementation will be either single-byte (using only single-byte tables) or double-byte (using only double-byte wide tables) wide. Of course, as previously mentioned, a skilled programmer could use just one table, or just a few tables, and easily adapt them to the algorithm in various embodiments. It will also be noted that some tables used in a funnel algorithm embodiment may also be used in other embodiments, and vice versa.

A managed code implementation may also include a double-byte string table of immutable strings (not just an array of four-character entries) representing all the numbers from “−999” to “999” (as described below). The actual storage used for these immutable strings is implementation dependent. Each string can have a width varying from one to four characters, each of which is a double-byte-wide character.

These tables can either be generated at run time or can be precompiled. Multiple versions of the tables can increase performance of the algorithm. Each of these tables will come in two versions: the single-byte version, and the double-byte wide version (identified by the ‘W’ at the end of the table name). Here are the tables; as with other algorithm-specific tables herein, these tables are Copyright NumberGun, LLC 2012 to the full extent permitted by applicable law:

thousandChars.

This table 234 contains 1,999 four-character entries ranging from “−999” thru “0” thru “999”. Any unused characters are padded with 0 characters (‘\0’) at the end. This table can be constant 916, as it will not change once it is created. This table is used to obtain the first triplet of any number being converted. The thousandChars tables can be created in C++ with statements such as pseudocode shown in the Listing_{—}6058-2-3A.txt computer program listing appendix file, incorporated herein by reference.

triplets.

This table 234 is used to quickly obtain all triplets after the first (which is obtained by the above ‘thousandChars’ tables). It is used when thousands separators are not used. The triplets tables can be created with the commands in C++ similar to those shown in the Listing_{—}6058-2-3A.txt computer program listing appendix file, incorporated herein by reference.

tripletsComma.

This table 234 is used to quickly obtain all triplets after the first (which is obtained by the above ‘thousandChars’ tables). It is used when thousands separators are used. It can be modified based upon the local culture, so that decimal strings created from these tables utilize the correct thousands separator. The entries can have the thousands separators as the first character (as here), or as the last, in which case other coordinating 518 changes would be made by one of skill in the art. The tripletsComma tables can be created with commands in C++ similar to those shown in the Listing_{—}6058-2-3A.txt computer program listing appendix file, incorporated herein by reference.

FirstTripletDigits.

This table 262 can speed up processing by a direct table lookup to obtain 334 the number of digits for the first triplet (from thousandChars). This acknowledges that the triplets representing the numbers 0 through 9 have one digit, the triplets representing the numbers from 10 through 99 have two digits, and the remaining triplets representing the numbers from 100 through 999 have three digits. The size of the first triplet is used to properly place the next triplet immediately after the first (for all numbers having more than one triplet).

It is possible to dispense with this table, and to instead use a simple if-then-else type of construct:

if (num < 10)

len = 1;

else if (num < 100)

len = 2;

else len = 3

Both methods (table, if-then-else construct) are contemplated for one or more embodiments. It appears that the table-lookup method would usually be faster, but it uses another table consuming some memory. The approach detailed below uses this table. Since each entry 820 in this table is one of only three values (1, 2, or 3), a byte or char table is sufficient. (One of skill in assembly language may note that when the entries are byte entries, they cannot be directly added to a register of a different size. If they are 32-bit integer entries, for example, they can be directly added to a 32-bit register, which can be slightly faster for many implementations.) Note that each entry is actually a number (a ‘char’ in C/C++ is actually a signed 8-bit integer). As this table is used to obtain a number rather than a displayable character, there is no double-byte wide version of this table. Variations of table bit size 256 are contemplated. Here is C++pseudocode to create the table in a char-sized version:

char FirstTripletDigits[1000] = {
// first ten entries are all 1

1, 1, 1, 1, 1, 1, 1, 1, 1, 1,

// next 90 entries are all 2

2, 2, 2, . . . 2,

// next 900 entries are all 3

3, 3, 3, . . . 3 };

thousandStrings.

For managed code, it is useful to have a table 234 of immutable strings 940 representing the decimal representations of numbers from −999 to +999. Sometimes a relatively small number 208 is to be converted into decimal; having this table provides an extremely fast lookup 328 that is many times faster than using the normal integer-to-decimal conversion routine. Sample code to create this table using Microsoft C++/CLI syntax for managed code is shown in the Listing_{—}6058-2-3A.txt computer program listing appendix file, incorporated herein by reference:

The Funnel Algorithm for Native Code

Three versions of the native code funnel 222 algorithm are indicated: converting 490 integer into decimal without commas (“NoComma”); converting 302 integer into decimal using thousands separators based on the current locale (“Comma”); converting 302 integer into decimal using a user-specified thousands separator (“UserComma”). There are subtle differences between them, but much of the algorithm is shared among the versions.

The below-described algorithm uses a 32-bit signed integer as input. One skilled in the art guided by the teachings herein can easily adapt this to handle other-bit sizes 256 and/or unsigned integers. Note that for unsigned inputs, there is no test for negative numbers, so the algorithm may execute slightly faster as it can eliminate the portion of code related to negative numbers.

Additionally, smaller-bit sizes may also operate more quickly and may be desirable. Larger-bit sizes can also be used by the addition of more test cases for each triplet; the larger the number, the longer the decimal output and the longer it takes to run the algorithm. But there is nothing other than hardware limitations to prevent this algorithm from scaling up or down to any size.

Each algorithm assumes the user 104 will supply the output buffer 212 into which the decimal representation is inserted; other embodiments allocate the buffer themselves. This buffer is at least large enough to handle the largest possible output string 210. For 32-bit integers with commas, the largest string is “−2,147,483,648”, which is fourteen characters plus a terminating null, or at least 15 characters in length. Performing 494 alignment, padding, or other manipulations will increase the buffer-size requirements. Other than initialization procedures that could modify the internal tables, these algorithms are thread 882 safe.

Intialization

To setup the funnel algorithm prior to first use, it may be desirable to query the operating system or user configuration to determine 418 the proper thousands separator based on the current locale (or based upon a user-supplied locale). When that separator is determined, the embodiment can traverse the tripletsComma table and replace 478 each comma with the single-byte thousands separator; then it can traverse the tripletsCommaW table and replace 478 each comma with the double-byte thousands separator.

Note that these tables will not necessarily be made as constant tables (using the keyword ‘const’) as that may cause the compiler to insert these tables into read-only memory. If that is the case, the table cannot be changed as just discussed. In some circumstances, however, where the locale will not change and commas are the desired thousands separator, it may be desired to make the triplets and tripletsComma tables constant. Alternatively, if the embodiment is in a locale where a thousands separator other than the comma is preferred, the above tables can be easily created using that desired thousands separator in place of a comma.

The Funnel Algorithm

For ease of description, the funnel algorithm 386 described is a NoComma version. Differences for the other versions are noted. In addition, the term “comma” is used to mean “thousands separator” and is not limited to using only a comma. The input number to convert to decimal is ‘num’ and the user-supplied buffer is bur. There are three local variables 914 that may be used: num1, num2, and num3, each of which is the same type as the input num. Another variable, ThisNum, is of the same size as num, but is unsigned.

In Operation, First, Set pDest=buf.

If num is negative: Insert a ‘-’ as the first char in the buffer and set pDest to point to the next char. Then make num positive (“ThisNum=0−num”); otherwise, assign it to the unsigned variable: ThisNum=num. [In a different embodiment, the number will be maintained as a negative number and no minus sign will be inserted separately; instead, num can be used as an index into thousandChars for the first triplet and that value copied directly with the minus sign; there can be one funnel for negative values and one for positives; the negative funnel can test for negative values, and math division operations can divide by −1000 instead of dividing by +1000 in order to produce positive values used to index the triplets or tripletsComma table, whichever is to be used. The path for positives will not need to use the variable ThisNum but can act on num directly. Also, an unsigned version of this algorithm will use an unsigned variable num, and will not need to assign it to another unsigned variable. One of skill would ensure that the converted string is null-terminated when finished, which is done explicity when using the tripletCommas table.]

If ThisNum is less than 1,000: Copy the four chars from thousandChars[ThisNum+999]. Use a cast to allow the compiler to move the characters in the fewest steps possible. Since none of the numbers in this range have any commas, there is no difference between the versions. Return a pointer to buf and exit.

If ThisNum is less than 1,000,000: num1=ThisNum/1000. Copy the first triplet to the buffer: copy the four chars from thousandChars[num1+999] to pDest. Not all the chars will be used, as this first triplet could be one, two, or three chars in length. But copying all four chars can be done in one CPU move operation, so there is no reason to differentiate before copying the string. Add FirstTripletDigits[num1] to pDest to make it point to the location for the next triplet. For the no-comma version copy the four chars from triplets [ThisNum−(num1*1000)] to pDest; this gets the remainder of the “ThisNum/1000” division without an additional division operation as is usually done. This copy operation copies a terminating null, so we are finished: return a pointer to buf and exit. For the Comma version, copy the four chars from tripletsComma[ThisNum−(num1*1000)] to pDest. Then insert a null at the location (pDest+4), then return a pointer 214 to buf and exit. For the UserComma version, copy the four chars from tripletsComma[ThisNum−(num1*1000)] to pDest. Then insert the user-supplied comma at location pDest, insert a null at location (pDest+4), then return a pointer to buf and exit.

If ThisNum is less than 1,000,000,000: num1=ThisNum/1000; num2=num1/1000. Copy the first triplet to the buffer: copy the four chars from thousandChars[num2+999] to pDest. Not all the chars will be used, as this first triplet could be one, two, or three chars in length. But copying all four chars can be done in one CPU move operation, so there is no reason to differentiate before copying the string. Add FirstTripletDigits[num2] to pDest to make it point to the location for the next triplet. For the no-comma version, copy the four chars from triplets[num1−(num2*1000)] to pDest. Then copy the four chars from triplets[ThisNum−(num1*1000)] to (pDest+3). Return a pointer to buf and exit. For the Comma version, copy the four chars from tripletsComma[num1−(num2*1000)] to pDest. Then copy the four chars from tripletsComma[ThisNum 31 (num1*1000)] to (pDest+4); insert a null at location (pDest+8), then return a pointer to buf and exit. For the UserComma version, copy the four chars from tripletsComma[num1−(num2*1000)] to pDest. Then copy the four chars from tripletsComma[ThisNum 31 (num1*1000)] to (pDest+4); insert a null at location (pDest+8), insert the user-supplied comma at locations pDest and (pDest+4), then return a pointer 214 to buf and exit.

Default for ThisNum greater than or equal to 1,000,000,000: num1=ThisNum/1000; num2=num1/1000; num3=num2/1000. Copy the first triplet to the buffer: copy the four chars from thousandChars[num3+999] to pDest. Not all the chars will be used, as this first triplet could be one, two, or three chars in length. But copying all four chars can be done in one CPU move operation, so there is no reason to differentiate before copying the string. Add FirstTripletDigits[num3] to pDest to make it point to the location for the next triplet. For the no-comma version, copy the four chars from triplets[num2−(num3*1000)] to pDest. Then copy the four chars from triplets[num1−(num2*1000)] to (pDest+3). Then copy the four chars from triplets[ThisNum 31 (num1*1000)] to (pDest+6). Return a pointer to buf and exit. For the Comma version, copy the four chars from tripletsComma[num2−(num3*1000)] to pDest. Then copy the four chars from tripletsComma[num1−(num2*1000)] to (pDest+4). Then copy the four chars from tripletsComma[ThisNum 31 (num1*1000)] to (pDest+8); insert a null at location (pDest+12), then return a pointer to buf and exit. For the UserComma version, copy the four chars from tripletsComma[num2−(num3*1000)] to pDest. Then copy the four chars from tripletsComma[num1−(num2*1000)] to (pDest+4). Then copy the four chars from tripletsComma[ThisNum 31 (num1*1000)] to (pDest+8); insert a null at location (pDest+12), insert the user-supplied comma at locations pDest, (pDest+4), and (pDest+8), then return a pointer to buf and exit.

Using Divisors that Fit Bit-Size

Some embodiments can speed up converting large integers (and floating points, too) into decimal by using 570 divisors 958 that fit a specified bit-size 256. When dividing large numbers (dividends 960) that exceed a current execution-environment bit size, some embodiments use only divisors that fit inside that bit size. This can reduce complexity and reduce the number of division operations, thereby operating faster than otherwise. Also, computing the remainder 834 can be faster. The remainder can be computed via division, using techniques described herein for division, or it can be computed via multiplying the quotient by the divisor and then subtracting that result from the original dividend. Alternately, in assembly language, the remainder is a free byproduct of the division (for instance, on Intel-compatible CPUs performing a 32-bit divide, the quotient will be in eax and the remainder in the edx register immediately after the DIVIDE operation has finished). In yet another alternative, the quotient can be obtained by multiplying by a MagicNumber which is the reciprocal of the divisor; in this case, the remainder is a binary fraction which can be very quickly extracted via MULTIPLY operations.

For example, the largest power of one thousand that still fits into a 32-bit space is the number 1,000,000,000. To convert the number 7,666,555,444,333,222,111 (which takes 64 bits of storage) into decimal, one approach first divided the number by 1,000,000,000,000,000,000 to extract digits, which caused the compiler to call 544 an inefficient subroutine that performs four CPU DIVIDE operations and resulted in a 32-bit quotient (value=7) and a 64-bit remainder (value=666,555,444,333,222.111). That left a 64-bit number to further break down, which when divided by the 64-bit divisor 1,000,000,000,000,000 used another four DIVIDE operations to obtain a 32-bit quotient (value=666) and another 64-bit remainder (555,444,333,222,111). This process continued with one more iteration of dividing a 64-bit dividend by a 64-bit divisor (555,444,333,222,111 divided by 1,000,000,000,000). That was in addition to dividing the number by other powers of ten, so there were several wasted operations that could have been avoided by breaking this down differently. Although an advantage of this method was that the number was broken down into triplets (reducing the total number of CPU operations) and the decimal representation was created in a left-to-right manner (which eliminated the operations to reverse the output), one could reasonably conclude that it still took too many DIVIDE operations.

To reduce the number of DIVIDE operations, the number is broken down with several 32-bit division operations. One would first divide the 64-bit number by the 32-bit divisor 1,000,000,000 (using two DIVIDE operations), extracting a 64-bit quotient trip7654 (the upper four triplets) and a 32-bit remainder trip321 (the lowest three triplets). Then divide the 64-bit trip7654 again by the 32-bit divisor 1,000,000,000 (using two DIVIDE operations) to extract trip7 (the seventh, or most significant) triplet, leaving a 32-bit remainder trip654. The value trip7 is ready to process with no additional DIVIDE operations, while the 32-bit variables trip654 and trip321 can each respectively be extracted quickly with one 32-bit DIVIDE operation per triplet extracted. This method reduces the number of DIVIDE operations to ten DIVIDE operations for the largest 64-bit numbers.

Note that MagicNumber 840 reciprocals could be used to eliminate some, or all, of the DIVIDE operations noted above, or in other examples herein. One such embodiment is shown above in the section “Strategy 64-B”.

As noted elsewhere herein, references to the number of bits occur in different contexts, so bit-size has different meaning depending on the context. In the present discussion, there are two “bit-ness” issues. The first is the bit size 256 used for the current environment (one might call this the “execution-environment bit size”), which today is usually either 32-bit or 64-bit, with some 128-bit aspects available in some computers. A 32-bit CPU will provide a 32-bit execution environment, meaning that the “natural” bit size used by the CPU for the execution environment is 32 bits. But note that a 64-bit CPU can provide either a 32-bit or a 64-bit execution environment, depending on the operating system and also depending on the software implementation.

The actual size of the binary numbers is also denoted by the bit size 256, but is independent of the execution environment. The bit size of a binary number tells one how much storage is used to store that number in memory. It also determines the possible range of values that number can have. One can have 8-bit, 16-bit, 32-bit, 64-bit, 80-bit, 128-bit, 256-bit numbers—or any other size one prefers. It is most efficient to use a number storage representation bit size that fits within the execution-environment bit size, although it is not always possible to restrict the sizes: sometimes one has no feasible option other than to use larger bit sizes. If the storage bit size of a number exceeds the execution-environment bit size, extra software support is invoked to manipulate the numbers. Otherwise, when the size of binary numbers being operated on fits within the execution environment bit size, the hardware support from the CPU dramatically simplifies and speeds up those operations.

One familiar division routine for dividing a 64-bit number by any other number does some expensive things that an embodiment as taught herein can avoid. First, when the dividend is a 64-bit integer, it converts the divisor into a 64-bit number. This conversion adds overhead 954, especially if the divisor is 32 bits or less. Second, since this type of division is relatively complex and long, the familiar approach calls a separate function 936 to handle it. But this can involve several pushes onto the stack 920, a function call, setting up the local frame 908 for that function, and then eliminating the frame 908 and restoring the stack and registers 206. Third, this familiar approach computes the quotient using an expensive division operation that performs two 32-bit divide operations, for divisors that fit in 32-bit storage, or just one 32-bit divide operation after some time-consuming shifts in a loop with a larger divisor. For large divisors, the process can take three to four times longer.

But dividing a large (64-bit or larger) number by a number that can fit in the current execution environment's bit size is a much more efficient process that uses just one division for each natural-word-size portion of the dividend. So modifying an algorithm by using 570 a divisor that fits in 32 bits can improve the speed. For example, assume a 32-bit execution environment. Assume one wants to divide the 64-bit number 7,666,555,444,333,222,111 by the 32-bit divisor one billion. The division can be performed as shown in the Listing_{—}6058-2-3A.txt computer program listing appendix file, incorporated herein by reference.

Handling Large Divisors

A familiar 64-bit division routine is very slow when the divisor is large. It includes a loop that shifts both the divisor and the most-significant double word of the dividend until the divisor fits into 32 bits. It follows that with one division and a multiplication, with a quick test at the end that determines whether 1 will be subtracted from the quotient. It is faster with divisors having fewer bits.

Some embodiments provide an innovative alternative approach for handling 572 large divisors, as follows. Replace the shifting loop with the efficient BSR command (“bit scan reverse”) 574 that on modern processors operates in 1 or 2 clocks. Then do one shift operation 308 for the registers 206 involved, and keep the remaining code, which follows with one division and a multiplication, with a quick test at the end that determines whether 1 will be subtracted from the quotient. This will speed up the 64-bit division operation in 32-bit code tremendously, sometimes by a factor of 3 or so. This can be scaled to 128-bit and 256-bit divides, for possibly even bigger speed improvements. In the 64-bit divide operation in the 32-bit execution environment, the high double word which has 32 bits is tested one bit at a time, so it may use up to 32 iterations of the bit-shift loop; but for 128-bit numbers in that same 32-bit environment, the loop can take up to 64 iterations on the highest quad word.

One of skill in possession of the current disclosure will appreciate that this innovative alternative approach is independent of number conversions 490, 302 (although it can be used in that context), and can benefit any division where the numbers being operated on are greater than the bit size of the execution environment.

Fastest Way to Convert Small Numbers

A super-fast method can be used to convert 490 numbers within a narrow contiguous range, say between 0 and 999. One of skill in the art could increase or narrow this range, depending on memory and other issues. One embodiment of this method was implemented by inventor Eric J. Ruff in managed code 928 to provide rapid conversion of small numbers, and it converted numbers at a speed of over four hundred million conversions per second on a 2.66Ghz Intel® Core2 Duo CPU. When a read-only or immutable table 216 can be guaranteed to be kept safe from alteration (or when the user determines, otherwise, that the risk of alteration is minimal and therefore acceptable), a table of addresses of number strings can be accessed almost instantly.

This method uses a memory table 234 full of decimal strings 210, plus a table equal in size to the range of numbers to convert (there will be one entry per number in the range), each entry 820 of which is the address pointer 962 to the decimal representation for the number represented at that index (call this table of indexes FastAddressTable). The method uses 416 the binary number input parameter 918 as an immediate index 832 into an address table, and returns the address of the string. The method can be implemented as a direct table access, obviating the need for a function call, such as:

ConvertedStr=FastAddressTable [Num];

The address can then be printed, saved to a file 956, or copied to another location, but a prudent implementer will make sure that no attempt is made to alter it (alteration would likely corrupt future use of the table). Alternatively, one of skill could put the instruction above into a function call similar in form to other number-conversion function calls. On many compilers, however, this could result in additional overhead of a normal function call unless the compiler is able to (and is properly instructed to) make the function an in-line function which eliminates that overhead.

Assume a native code implementation using single-byte chars, and assume the range 0 to 999. The memory buffer would be filled with the decimal strings of the numbers in the range, each separated with a null, each in sequence. In this example, the memory buffer would look like this: “0”, 0, “1”, 0, . . . “999”, 0

The address table (FastAddressTable) 236 would point to each string in the table 234. Assuming the table starts at memory address 0x4000, the entries in the table would be:

| | |
|---|---|
| 0x4000 | // Points to first string, “0” |
| 0x4002 | // Points to second string, “1” |
| 0x4004 | // Points to third string, “2” |

... and so on

In this example, there is no extra space between the strings 940. One of skill in the art may decide to adjust the location of the strings in the buffer so that each is aligned on a four- or eight-byte boundary, and the entries in the address table will appropriately show the proper address for each decimal string. Also, one of skill in the art would realize that this table can be easily created in managed code 928 with either a static table loaded at run time or when accessed in a DLL, or it can be easily created programmatically.

A slight alteration to the above method is made when consecutive negative numbers are used in the range. Since in most programming languages an index 832 will be positive, and with this method the index is the number being converted which can be negative, the index is offset 370 by another value to ensure the range is not negative. It has been found that when negative numbers are in the range, adding the negative of the value of the first number of the range, for each use of the method, will produce the desired results.

For example, assume the desired consecutive range is −999 to 999, and the strings range from “−999” through “999”, each string 940 also being null-terminated. Assume also that this new table, NewAddressTable, has an equivalent number of entries, each pointing to the start of the respective string. The first number in this range, then, is −999, and its negative is 999. The proper way to access any element in this range would be as follows:

ConvertedStr=NewAddressTable [Num+999];

In assembly language, the offset 999 can be added to the index in a manner which incurs no additional cycle 891 cost, since a displacement offset can be added to a memory address 962 with no speed cost. In a high-level language, some compilers may be able to apply that same optimization as long as the offset is treated as a constant 916 and not a variable.

Another alteration that can be used is similar in nature to having a negative range, but can be used for other ranges which do not start with 0. For example, assume one of skill desires a super-fast method of converting the year of birth to a decimal string using the table BirthyearTable. Assume also it can be guaranteed that all birth years are for living people. In such a case, one would expect it possible to have some birth years prior to 1900, but none prior to 1850. Therefore, a range from 1850 to 2100 would cover all birth years until the year 2100 (represented as “1850”, 0, “1851”, 0, . . . , “2099”, 0, “2100”, 0). The number in the range would be handled 370 as above:

### ConvertedStr=BirthyearTable[BirthYear−1850];

Here's an equivalent 32-bit assembly-language snippet:
mov eax, [BirthYear]
mov eax, [BirthyearTable+eax*4+(−1850*4)]
   Note that in assembly language, since each entry is four bytes, the eax register is multiplied, or scaled, by a factor of four to make sure it indexes the proper entry, and the offset of −1850 is similarly scaled; this is done automatically by a high-level compiler such as those used for C or C++, but is done manually in assembly language. This method will ensure that all used indexes fall within the specified range—at least until sometime after the year 2100, or until it encounters some living person whose real birth year was prior to 1850, which appears quite unlikely.

Additionally, this same approach can apply to other situations with multiple numbers. For example, when creating 558 a date 966, both a month and a day will need to be converted into decimal strings. A string of all dates of the year (“Jan 1”,0,“Jan 2”,0, . . . etc.) could be created, each being null-terminated, and then the date would be accessed by using the day of the year as an index (assuming the day of the year was immediately available). Or a table of months could be used to access the month (“Jan”,0,“Feb”,0, etc.) and a table of days to access the day, as described above.

Speeding Up Memory Accesses

In general, the smaller and/or the fewer the CPU instructions in a code path, the quicker the code path will finish execution. Although CPU 112 internals keep changing and improving, thereby smoothing out many differences which in previous CPUs were larger, the MOV command still fits this general rule, and specifically when accessing memory 114 through a pointer 962 versus through global memory space 968. Placing tables 216 into global memory 968 where they can be directly accessed 410 via a numerical offset from a segment register 206 (usually data or code), rather than in memory allocated on the stack 920 or from some other memory pool that must then be accessed via a pointer 962, can sometimes produce a measurable speed improvement by eliminating an instruction 116 and/or by using the CPU resources more efficiently.

When accessing memory, the Intel® CPU allows up to four address 962 components: displacement, base, index, and scale factor. In its Intel® 64 and IA-32 Architectures Optimization Reference Manual, Intel states in section 3.5.1.6: “Addressing modes that use both base and index registers will consume more read port resource in the execution engine and may experience more stalls due to availability of read port resources. Software should take care by selecting the speedy version of address calculation.”

As an example, assume the table ExpScale is located in global memory (the variable ExpScale will be converted into a memory displacement by the compiler) and that an entry from that table, denoted by index=123, is to be accessed. Assume also that the variables ‘var’ and ‘index’ are 32-bit signed integers. Here is one example in C++, where ExpScale is a global variable:

var=ExpScale[index]; The compiler could convert that C++ code into the following assembly language instructions:
mov eax, dword[index]
mov ecx, dword[ExpScale+eax*4]
mov[var], ecx

Note that the instruction loading the ecx register uses a displacement (′ExpScale′ is a numerical offset based off the DS segment register), an index (eax), and a scale factor (*4). The above three instructions require 16 bytes in the code path.

Now consider the case where the table ExpScale is located in a buffer allocated from a memory pool, and that the variable ExpScale points to that memory pool. To access the 123^{rd} entry, here's one example in C++: var=ExpScale[index]; It looks the same in C++, but the compiler would convert that code into the following (or equivalent) assembly language instructions (one of skill will note that since ExpScale is a pointer 962 to memory, it will be accessed and loaded into a register 206, in addition to the ‘index’ variable being loaded into a register):

mov ecx, dword [index] mov edx, dword [ExpScale] mov eax, dword [edx+ecx*4] mov dword [var], eax Note that two registers are loaded before the table can be accessed. The instruction loading the eax register with the value from the table uses a base register (edx), an index register (ecx) and a scale factor (*4). The above four instructions require 15 bytes in the code path. In a test on Mr. Ruff's laptop, the second set of instructions required 48% more time to execute than the first (the first set averaged 1.38 clock cycles vs. 2.05 for the second set). One of skill will realize that CPU environments keep changing, that testing will help determine whether this performance improvement (⅔ of a clock cycle) is critical and is available in the various execution environments to be used, and that many iterations of even small improvements can add up to an important difference.

Additional Observations

The discussion herein is derived in part from NumberGun LLC internal documentation. Aspects of the conversion and formatting programs that will be made available commercially by NumberGun LLC and/or documentation may be consistent with or otherwise illustrate aspects of the embodiments described herein. However, it will be understood that documentation and/or implementation choices do not necessarily constrain the scope of such embodiments, and likewise that commercially released products and/or their documentation may well contain features that lie outside the scope of such embodiments. It will also be understood that the discussion herein is provided in part as an aid to readers who are not necessarily of ordinary skill in the art, and thus may contain and/or omit details whose recitation herein is not strictly required to support the present disclosure.

Printf Compiler Overview

An innovative “printf compiler” feature 970 that allows creation, during run time, of very fast formatted strings will now be presented. The phrase “printf compiler” as used herein was coined by the inventors for their use. Search engine results describing conventional compiler operations on conventional printf functions carry different meaning. As discussed herein, in use a printf compiler 970 has two parts: a printf compiler function (e.g., ngParse( ) 974 that is called once to prepare 576 fast output code 972 (a.k.a. fastcode 972) based on a custom format 494 string 942, and a companion function (e.g., ngFormat( ) 976 that can then execute 578 the fastcode 972 to perform the formatting commands 978 of that format string to generate the desired output 210, and can be called as many times as needed using the same fast output code 972.

In some implementations, this innovation 970 operates as a runtime compiler. This means that any format string (also referred to as a “format control string” herein) 942, whether static or newly created within a running program 132, can be compiled on-the-fly to create super-fast output according to the specified format, thereby delivering maximum high-velocity display output in virtually all scenarios. There is no built-in limit on the number or size of the format commands 978, other than memory-related or stack-related constraints that would be recognized by one of skill in the art of programming.

Some methods described herein can be implemented in several ways. In some embodiments, a compiler-based two-step solution for formatting strings can be implemented. A first step is a compiling step 576, which is called prior to a second formatting step 578, will parse 580 a format string 942 embedded with formatting commands 978 and create 582 a table 972 of specific formatting instructions 116 that is saved for later use. The second step, the formatting step 578, can then access the saved table 972 one or more times to create formatted output 210 without the need to parse or compile the format string 942 again. The terms “first” and “second” refer to the order of these two steps 576, 578 relative to one another and do not prohibit performance of other progam 132 steps prior to step 576, or between steps 576 and 578, or after step 578.

In some embodiments, the two steps 576, 578 are internally combined so that a user (e.g., a developer or an existing program) 104 sees the printf-compiler 970 as a one-step solution that can be used as a replacement of familiar printf-like formatting, which requires no separate compilation step (internally, parse 580 and compile 576 steps take place first, followed by a table-based formatting step 578 that creates the desired formatted output string 210). In some other embodiments where the two steps are combined, the table 982 creation step is skipped and the formatted output 210 is created 578 directly as each formatting instruction 972, 984 is determined.

One of skill could combine these methods so that, even though they are distinct and the parsing step is performed only once for a given format string, a developer sees them as one and therefore need not be concerned with various internal details. For example, in some embodiments, a class 980 or other module 204 containing technology described herein is created. Each new class instance 980 is initialized 584 by passing to it a format string 942 which is then parsed 580 and compiled 582 as explained herein; then, once such class has been instantiated, every call to format output will use 578 the instruction table 972 as described herein without requiring any further parsing or compiling of the format string.

In some implementations, the ngParse( ) function 974 will parse a format string to create a table 982, 216 of specific, detailed commands 984 that, when executed, will produce the formatted string as desired. The table or other custom implementation 982 is specific to the format control string 942 in question. The code fragments 984 correspond to the literal portion(s) and the parameter reference(s) of the format control string, although not necessarily in a one-to-one manner. But a format control string having different literal portion(s) and/or different parameter reference(s) would typically compile to a different custom implementation. For example, changing the length of a literal portion would change the choice of CopyStr<n>command 984, changing the data type of a parameter referenced in the control string would change the base conversion 490 command 984 invoked for that parameter, omitting a literal portion or a parameter reference would place fewer commands 984 in the table 982, adding a literal portion or a parameter reference would place more commands 984 in the table 982, and so on. This format string specificity is also clear to those of skill from the algorithms used to stich commands together or otherwise create custom implementations 982; the commands selected and the sequence they are placed in within the table 982 depend on the format string's content.

Format string specificity is also clear from the separation of the control string parsing, custom implementation 982 creation, and custom implementation 982 execution steps, e.g., one parsing leads to one implementation creation that permits multiple subsequent implementation executions without repeated parsing. That is, some embodiments execute (578) the custom implementation after the parsing and compiling steps, and then repeat the executing step at least once with the same custom implementation without repeating the parsing step and without repeating the compiling step between in between the executing steps.

The table of commands is designed to eliminate much, if not all, of the overhead 954 that exists in familiar art when interpreting and executing format strings as with, for example, the familiar ‘printf’ family of commands (which include printf( ), sprintf( ), fprintf( ), wprintf( ), snprintf( ), and other variations that include the name ‘printf’ in the function name). As described herein, the innovative design is structured so that the overhead 954 of parsing a string, identifying individual components, determining the proper binary-to-decimal conversion method for each numeric parameter 918, determining padding and/or alignment or positioning of parameters, and otherwise determining exactly how to create the desired output, is handled 586 one time only for a given format control string 942. Thereafter, each invocation of ngFormat( ) 976 can go to directly formatting the parameters unimpeded, since all the parsing and compiling and formatting decisions for that format control string has been completed previously. In other words, in some embodiments, after execution of ngParse( ) or its equivalent 974 there are no more formatting decisions to be made 588, no more formatting options to be determined or interpreted 588; the only formatting decisions that remain are based upon the actual size or length or sign of the actual user parameters, which can vary with each invocation 544 of ngFormat( )

When combined with other NumberGun™ technology for fast binary-to-decimal conversion 490 of numbers 208 described herein, the printf compiler 970 teachings herein can further reduce the time required to produce the formatted string 210. In some embodiments, all the functions share the same stack frame, reducing clock cycles 891 (NumberGun is a mark of NumberGun, LLC).

Technical benefits provided to web and application developers 104, for example, may include spending much less time to render web 986 or screen pages, which means fewer CPU clock cycles 891 consumed by a server 102, and therefore much faster speeds in generating readable output, in turn enabling much more bandwidth capacity for the server. Following are some examples.

### Example 1

// Compile the format string . . .
NG_FORMAT*salesFmt;
salesFmt=ngParse(“Total sales on {1=time t32̂Mmm. ̂d,”
+“̂yyy as of @h:@m:@s@a} is ${2F.2}”);

When finished, this ngParse( ) function 974 returns a pointer to an NG_FORMAT structure 982 that contains all (or at least some of) the commands 984 to create the desired output for any set of parameters 918 that match the original format string 942 specifications. As will be described further, the above ngParse( ) command assumes that two parameters (identified by {1 . . . } and {2 . . . }) will be passed in conjunction with this format string (in addition to two other parameters used each time ngFormat( ) is invoked: a pointer to an output buffer, and a pointer to the NG_FORMAT structure that was created by the call to ngParse).

Once the NG_FORMAT structure has been created, the implementer can create formatted input by invoking 544 ngFormat( ) with a specified buffer 212, a pointer 962 to the format-control-string-specific NG_FORMAT structure desired, and with variable parameters 918 that will be formatted according to the rules of the original format string. One such invocation could be as follows:

### Example 1

### Continued

char buffer[200];
int result;
double totalSales=123456.775;
result=ngFormat(buffer, salesFmt, time(0), totalSales);
   The output for this command, if executed at the date and time indicated, will be:
Total sales on Sep. 20, 2012 as of 11:58:47 pm is $123,456.78
   When implemented as a class 980, the pointer to the salesFmt NG_FORMAT table need not be specified since it can be maintained in an accessible property 988 of the class for each invocation of the ngFormat( ) method.

This ngFormat( ) command does no parsing, but instead directly calls a series of commands 984 embedded in a table 982 that build 578 a proper output string 210. In the above command, ‘result’ will contain the length of the finished formatted output string stored in ‘buffer’. This happens much faster than if the original string was parsed every time a formatted string was created. In many embodiments, all format strings are parsed up front 590 upon program 132 start so that the compiled strings 984 are ready immediately when needed later.

One of skill will note that this innovation can sometimes dramatically reduce the overhead 954 needed to create a display string via format commands in a format string. In some embodiments, the printf compiler ngParse( ) 970 is specifically designed to process 496 certain structures that contain multiple data components, such as date and time structures 966. This reduces the need for the developer to understand some of the technical intricacies of those structures, reduces the amount of technical work the programmer would otherwise need to do in breaking out the individual components of the structure, and reduces the number of parameters that must be passed on the stack when the ngFormat( ) function is called, thereby speeding up execution of the formatting process. For example, in the above implementation, the printf compiler (ngParse) is aware of the ‘time_t32’ object (a 32-bit version of the ‘time_t’ object returned by the time(0) function shown above). When invoking ngFormat( ) as above, the ‘time_t32’ object is passed as a parameter to the function. This means the programmer will not have to separate each individual component, but can instead focus on what he or she wants the formatted output to look like.

Developers may note that in some implementations, ‘time_t’ is actually a 64-bit object, called ‘time_t64’ herein. One of skill would ensure the proper size is known and used; the size of such structures, such as ‘time_t’, will depend upon the libraries and/or operating system used, which one of skill would be able to determine by referring to the appropriate references. Some debugging aids, as described below in the Testing and Debugging Issues section, can also help determine 592 the size 256 of any variable 914 passed on the stack 920.

The type 892 of a format parameter 918 in the format string 942 can be declared, if it is different from the default 994. If no type is specified for a parameter, in some embodiments it will default to a signed 32-bit integer; other embodiments can have other default types. Note that parameters indicated as less than 32-bits wide will actually be passed on the stack as 32-bits wide in a 32-bit execution environment. The actual size in a 64-bit execution environment may vary, and one of skill can use any method to determine 592 the actual size on the stack. In some 64-bit implementations, some of the parameters may be passed in registers 206, so one implementing this invention should be intimately aware of the parameter-passing conventions 992 of the target execution environment 100.

In some embodiments, the last-used format type of a parameter is remembered (i.e., stored as a data value in a computer-readable memory) so that subsequent uses of that parameter will use that most-recent type, unless another type is specified, which then becomes the default type 994 for that parameter (until changed again). In some embodiments, different types can be specified for a single given parameter to allow the same parameter to be printed out in multiple ways. For example, a 32-bit float could be first printed out as a normal 32-bit floating-point number, then printed out as a 32-bit integer in a decimal display, and then in a hex-format display, yet the parameter need be passed only once, as shown here:

### Example 2

NG_FORMAT*newStr;
float fNum=1234.567;
// Do this to compile the format string
newStr=ngParse(“Float: {1M.3}−Int: {1uD}−Hex: {1xd}”);
// Format the number three ways like this . . .
result=ngFormat(buffer, newStr, doubleNum);
// To create this string:
Float: 1,234.567-Int: 1,150,964,261-Hex: 0x449a5225

Each invocation of ngFormat( ) requires, at a minimum, two parameters: a buffer 212 to contain the output, and a pointer to a NG_FORMAT table 982 that contains the formatting commands. The first parameter is a 32-bit pointer to the output buffer which is not a format-function-caller-accessible parameter in some embodiments, although one of skill could make it available by either renumbering all parameters so this becomes {0}, or it could be referenced as {−1} or {X}, if desired. The second parameter is a 32-bit pointer to the compiled NG_FORMAT string, and is referenced as {0}. The next parameter would be {1}, then {2}, etc. In Example 1, {1 . . . } is the 32-bit ‘time_t32’ object that has the current date and time, and {2 . . . } is the 64-bit floating-point number containing the sales figure being reported. If {0} is referenced in the format-control string, in some embodiments this is interpreted as a reference to the actual format string itself.

To better understand how to specify the desired format, the following section describes the available command set in one embodiment. Note that additional and/or different commands 978 can be added, and different command syntaxes 996 can be used, e.g., percent-based syntax versus curly-brace-based syntax. Note also that any characters or shortcuts can be used as commands 978, e.g., ‘z’ could be used instead of ‘s’ for a command to copy a string variable's value or a string constant 916 into the output buffer. One of skill could implement these and other similar changes to the list of commands 978, as desired. Additional commands 978 can be created by one of skill. One restriction is that the characters chosen for the commands should eliminate ambiguity for the compiler, i.e., the same command should not be used to mean two different things when that command is encountered in the same context. It is permissible, however, to reuse characters to mean something else when the context makes their definition unambiguous.

Command 978 Set

An intuitive and easy-to-remember command set is desirable to simplify program development. Short single-character commands 978 are easier to handle than long ones when developing software, in that they are quicker to parse and often easier to remember.

In some implementations, a format control string is made of multiple components 998, each of which is either a literal string 943 to print, or a format command 978 enclosed in braces. Anything that is outside the braces is a literal string that will be printed 452 exactly as it appears. All components of the format string will be printed sequentially in the order encountered in the format string. A command that is unrecognized can, in some embodiments, be treated as a literal string 943; in some embodiments it could be ignored, while in others it could cause an error message to display.

Additionally, it is helpful to design a command set that is fast and easy to parse 580. For example, some embodiments use a pair of braces to denote the beginning and the end of each complete format-command specification. Since format-type specifiers use specific characters that are not reused to specify options, both format-type specifiers and options can be intermixed inside the braces without impairing the speed or complexity of the parsing and compiling process.

In some embodiments each format command is surrounded by opening ‘{’ and closing ‘}’ braces (this is sometimes referred to as curly-brace-syntax). Each opening brace is paired with a closing brace. To print one of these braces in a string, two consecutive brace characters indicate that a literal brace character is to be printed at that point. Use “{{” to print an opening-brace character, or use “}}” to print a closing-brace character.

In some embodiments there are two types of format commands 978: those 1002 used to display a parameter variable with some type of formatting, and those 1000 that do not display a variable. Format commands 1002, 978 that format and display a variable contain a numerical index as the first component immediately after the opening brace (to identify that variable parameter), followed by optional formatting commands as described below, and ending with a closing brace. Format commands 1000, 978 that do not display a parameter variable contain a letter as the first character immediately after the opening brace, followed by zero or more other parameters. Note that these rules are up to the implementer of the technology described in the present document; the rules stated here, therefore, represent one embodiment out of many that could be used. Nevertheless, the rules stated herein were designed to be logical, descriptive where possible, short, and easy to remember.

Non-Parameter Format Commands

In some embodiments, the general format for a non-parameter format command 1000 is as follows:
{type[optional commands]}

One of skill could create various non-parameter format commands. In some embodiments, the command {T#} specifies a tabbing command with a number representing the column position in the output buffer to tab to. For example, the command {T19} would instruct the output pointer to advance to position 19 in the output buffer, inserting spaces along the way; if it has already reached or passed this position, it does nothing. In other embodiments, it will always force the output pointer to advance to position 19, even if this would overwrite part of the output (this is an effective way to truncate output of a string). This command simplifies aligning output on columnar boundaries. For example, the command “{1s}{T15}{2s}{T35}{3$F.2}” will cause a string represented by parm1 to be printed at the far left of the buffer, followed by a string represented by parm2 to be printed starting at offset 15 (filling all skipped positions with spaces), followed by a formatted 64-bit floating-point double represented by parm3 to be printed starting at offset 35 (filling in all skipped positions with spaces), and formatted with thousands separators and rounded 522 to two decimal places, with a preceding currency symbol. One of skill and in possession of the present disclosure would recognize that the above command could also be rendered without using any tabbing command: “{1<15s}{2<20s}{3$F.2}”. Either method can be used, as the same (or a similar) compiled table will be created.

In some embodiments, the command {M#} is used to remember a position in the output buffer. This could be used to right- or center-justify several components together, for example, as explained in the Brute-Force Method of Justifying Components section below.

Here are some suggested non-parameter format commands 1000: {I} (upper-case T) Index the immediately succeeding format command; stop and capture results as soon as the last instruction required for that format command has finished.

{I+} Start a new index here; if indexing is already in progress, stop and capture results, then start a new index operation.
{I−} Stop and capture current indexing result.
{M} Memorize the current value of DestPtr.
{M<#:c} Left-justify and pad output in the output buffer, starting with the portion of the buffer memorized by the previous {M} command and ending with the portion at the current value of DestPtr; add padding at the end to obtain the length indicated by the value after the ‘<’ character; if optional ‘:’ is specified, pad with the character immediately after the colon, otherwise use the default padding character (which would be a space in many if not all embodiments); in some embodiments, the padding could consist of a string of multiple characters listed here; other padding options could also be implemented as long as the syntax is unambiguous.
{M>#:c} Right-justify and pad output in the output buffer, starting with the portion of the buffer memorized by the previous {M} command and ending with the portion at the current value of DestPtr; insert extra padding to the left to obtain the length indicated by the value after the ‘>’ character; if optional ‘:’ is specified, pad with the character immediately after the colon, otherwise use the default padding character; other padding options could be used as explained above.
{M̂:c} Center-justify and pad output in the output buffer, starting with the portion of the buffer memorized by the previous {M} command and ending with the portion at the current value of DestPtr; add extra padding equally to both sides of the marked output to obtain the length indicated by the value after the ‘A’ character; if optional ‘:’ is specified, pad with the character immediately after the colon; other padding options could be used as explained above.
{T#} Tabulate to the indicated column.
{W} Output display string will be 16-bit wide characters (if used, this should be the very first item encountered in the format string).

Normal Format Commands

In some embodiments, the general format for a parameter format command 1002 is as follows:
{index[options][type][options]}

The options inside the square brackets are optional. The simplest format command consists of an index inside braces, such as {1}. If the type of the variable is not specified, it defaults to a 32-bit signed integer in some embodiments. In other embodiments, the default could be a 64-bit integer, or some other default chosen by one of skill. In some embodiments, if a parameter is used more than once, it will retain the most-recently-specified type until a different type is specified. Each variable has an index number that identifies which parameter is to be used for that variable; the variables can be listed in any order in the format string, as the index refers to the order in which the parameters are accessed on the stack. As described above, all the user parameters passed to the ngFormat( ) command are numbered starting with 0, with the exception of the buffer parameter which is the first one specified.

In these embodiments, the index represents the position of the parameters passed on the stack. For example, in Example 1 above:
result=ngFormat(buffer, salesFmt, time(0), totalSales);
   the parameter ‘buffer’ is not accessible in the format control string 940, 942; ‘salesFmt’ is referenced as {0}; the output from the function ‘time(0)’ is referenced as {1}; and the parameter ‘totalSales’ is referenced as {2}. In some embodiments, the ngFormat( ) function 936 is aware that {0} represents the original format string 940, 942; the ‘s’ type specifier is therefore not required for this parameter.

In Example 1, the standard C++ library function ‘time(0)’ will return a ‘time_t’ object that is 32 bits wide in some implementations, or 64 bits wide in others (the internal format or structure of which is adequately described and available to those of skill, but is also partially reproduced in the section below named Description of Date/Time Structures). Once the NumberGun™ formatting functions are made aware of this, they can directly manipulate the object to obtain the desired date/time components; the ‘time_t’ object is adequately described and referenced in numerous places freely accessible online (NumberGun is a mark of NumberGun, LLC). Since it is one of several multi-component structures dealing with dates and/or times, the printf compiler 970 will be informed as to which structure is being used to create the output for this parameter. Therefore, the command {1=time_t32 . . . } is used, specifying that the subsequent format commands specified inside this {1 . . . } format command assume the parameter is a legitimate ‘time_t32’ parameter, and it acts accordingly. One of skill understands that the compiler cannot always know exactly the type of each parameter, so a valid and proper format should be specified for each parameter. Other date and time commands can then be used to format the date or time as desired; common formats are shown at a latter place below in the present document. In some embodiments, the ‘A’ character is used to refer to date components, and the ‘@’ character is used to refer to time components (when they are used in conjunction with a ‘=time_t32’ structure, for example).

The next parameter, specified as {2F.2}, is a 64-bit floating-point double variable. This specifies that parameter {2} is to be converted into a display string, that it is a 64-bit floating-point double, that it is to be formatted with thousands separators (denoted by ‘F’; when no separators are needed, use ‘f’ instead), and that it should be displayed after rounding 522 to two decimal places. In some embodiments, other commands can also be specified with floating-point parameters: they can be printed in exponential notation with either a lower- or upper-case ‘E’; they can be displayed in hexadecimal or binary; they can be rounded by selecting one of 5 different rounding methods; and so on. The tables below show some possible formatting options.

In some embodiments, a user would be able to set global prefix and/or posffix settings for one or more variable types. One way to do this is to keep a global short option string 940 for each variable type; once a type is identified, the global prefix could be processed, and then all specified options in the format string. In the event of any ambiguity, the last format specifier governs, which means that any local specifier from the format string 942 will override any global setting for that variable type.

Format-Type Specifiers

In some embodiments, format specifiers 1004 can be used alone or with options 1006. All characters within the braces are format specifiers; none will be interpreted as literals 943 (except when using structure specifiers, as described). “Exponential notation” is the same as “scientific notation” herein.

Characters and Strings

Some embodiments use the following format specifiers 1004 for characters and strings (the ‘#’ characters below represent one or more digits used to specify a numeric-integer parameter):

c 8-bit character
C 16-bit character
s null-terminated string, 8-bit characters
s# null-terminated string, stop at earlier of null or after # characters
s:#:## null-terminated string, start at position # from the left, display up to ## characters (stop at null)
s-#:## similar to above, but the ‘-’ instead of the colon says to reverse the direction, that is, start # characters from the end of the string, then display up to ## characters (stop at start of string)
S null-terminated string, 16-bit chars
S# null-terminated string, 16-bit chars, stop at earlier of null or after # characters
S:#:## null-terminated string, 16-bit chars, start at position # from the left, display up to ## characters (stop at null)
S-#:## similar to above, but the ‘-’ instead of the colon says to reverse the direction, that is, start # characters from the end of the string, then display up to ## characters (stop at start of string)

In some embodiments, the following options can be used for characters and strings:

w ensure the output is in wide-char characters
<#:c left-justify, pad with spaces to make at least # characters wide, e.g.
{1s<15}; if optional colon is specified, use the specified character(s) for padding
>#:c right-justify, pad with spaces to make at least # characters wide, e.g.
{1s>15}; if optional colon is specified, use the specified character(s) for padding
̂:c center, pad on both sides to make at least # characters wide, e.g. {1″15s}; if optional colon is specified, use the specified character(s) for padding

Integers

Some embodiments use the following specifiers 1004 for integers. Note that when a number is fewer than 32 bits, it may format faster if a smaller bit size is specified when size-specific functions recognize the smaller formats. Insert a ‘u’ immediately in front of the specifier for the unsigned version of that integer:

j 8-bit signed integer
J 8-bit signed integer (same as lower-case version, since there are no thousands)
k 16-bit signed integer, no separators
K 16-bit signed integer, with thousands separators
d 32-bit signed integer, no separators
D 32-bit signed integer, with thousands separators
I (lower-case ‘L’) 64-bit signed integer, no separators
L 64-bit signed integer, with thousands separators

In some embodiments, the following options 1006 can be used for integers either before or after the type specifier 1004. Multiple options can be used, in any order, with no spaces or other characters in between (note that a space character is an option, as explained below). If options conflict—say you specify “{2bxd}” to convert parameter 2 as a 32-bit signed integer in binary and in hexadecimal—the last one governs (in this case, the number will be printed in hexadecimal format). Note also that some options, such as the space and the minus sign, are interpreted slightly differently depending on whether they come before or after the type specifier; the details are noted below (they are marked “**position dependent**”):

b display in binary format with no separation characters, e.g. {1 bd} or {1 bD} displays parameter 1 in a 32-bit binary format
B display in separated binary format (i.e., 00011111:10101110), e.g. {1Bk}
e display in exponential notation using lower-case ‘e’, e.g. {1 ed}
E display in exponential notation using upper-case ‘E’, e.g. {1 Ed}
o display in octal format, e.g. {lod}
x display in hexadecimal format using lower-case letters, e.g. {1xd}
X display in hexadecimal format using upper-case letters, e.g. {1Xd}
y display in separated hexadecimal format (i.e., abcd-1234) using lower-case letters, e.g. {1yk}
Y display in separated hexadecimal format (i.e., ABCD-1234) using upper-case letters, e.g. {1Yk}
, scale number by 1/1000 for each comma, i.e, use {1 D,} to divide number by 1000 before displaying (1,234,567 displays as “1,235”), or {1D,,} to first divide by 1,000,000 before displaying; number will round 522 up (unless a rounding specifier is included to override default rounding)
% scale number by 100, i.e., use {1d %} to multiply number by 100 (123 displays as “12300”)
w ensure the output is in wide-char characters
<#:c left-justify, pad with spaces to make at least # characters wide, e.g.
{1<15D}; if optional colon is specified, use the specified character(s) for padding
>#:c right-justify, pad with spaces to make at least # characters wide, e.g.
{1>15D}; if optional colon is specified, use the specified character(s) for padding
̂:c center, pad on both sides to make at least # characters wide, e.g. {1″15D}; if optional colon is specified, use the specified character(s) for padding
.# print decimal point and # decimal places (from 0 to 15; all decimal positions will show ‘0’; can be used to line up integers with floating points), e.g. {1D.2}
− print minus sign to right for negatives (no display for positives), e.g. {1 D−}
{sp} (space character) use trailing ‘−’ for negatives, leave space for positives to match trailing ‘−’ for negatives (used to make right-justified numbers line up), e.g., {1D}
(use parentheses for negatives instead of ‘−’; no space reserved at end for positives, e.g. {1(D})
) use parentheses for negatives; reserve space at end for positives, e.g. {1)D}
+**position dependent**—when in front of type specifier, always display the sign ‘+’ or ‘−’ immediately in front of the number, e.g. {1+D}; when after the type specifier, always display ‘+’ or ‘−’ immediately after the number, e.g. {1 D+}
$ **position dependent**—when in front of type specifier, always insert currency symbol before first digit, e.g. {1$D}; when after the type specifier, always insert currency symbol after last digit, e.g. {1 D$}
$$ **position dependent**—when in front of type specifier, always insert currency symbol, then a space, before first digit, e.g. {1$$D}; when after the type specifier, always insert a space, then currently symbol, immediately after last digit, e.g. {1D$$}

Note that in some embodiments, an apostrophe is used to signal that the number is to be formatted with thousands separators, rather than using an upper-case letter. This may be easier for a user to remember, although it does require one extra character to signal that separators are required.

Many individuals of skill in the art are familiar with the ‘printf’ command used in C and C++ and with the type specifiers 1004 particular to that command. Some of the above commands are identical to the ‘printf specifiers, some are slightly different. For example, printf would recognize the command’% u′ as specifying an unsigned integer. The equivalent command as herein described would be either {1 ud} to specify a 32-bit unsigned integer format for parameter 1, or {1 u} which also specifies the same thing, given that the default type of 32-bit signed integer will be used when none is specified. Note that when parsing a percent-based syntax, the parsing rules will change; some percent-based embodiments will support a parsing syntax based either entirely, or in part, upon well-understood rules for the familiar printf( ) function.

Some embodiments have interfaces 924 that are fully compatible with established printf commands. Thus, some embodiments include a DLL file or other library or component which can be plugged into legacy code to provide that code with the technical mechanisms described herein (e.g., table of commands, stitched code fragments) without breaking the legacy code. Additionally, some printf-compatible 924 embodiments can also include extra features and options, such as some of those listed above.

Floating-Point Numbers

Some embodiments use the following specifiers 1004 for floating-point numbers. If no decimal places are specified to print, the number will be rounded 522 and up to six decimal positions will print (use the “.#” option for precise control of the decimal display):

m 32-bit float, no separators, e.g. {1 m}
M 32-bit float, with thousands separators, e.g. {1M}
f 64-bit float, no separators, e.g. {1f}
F 64-bit float, with thousands separators, e.g. {1F}

In some embodiments, the following options 1006 can be used for floating-point numbers either before or after the type specifier. Multiple options can be used, in any order, with no spaces or other characters in between (note that a space character is an option, as explained below). If options conflict—say you specify “{2bxF}” to convert parameter 2 as a 64-bit double floating-point number in binary and hexadecimal—the last one governs (in this case, the number will be printed in hexadecimal format). Note also that some options, such as the space and the minus sign, are interpreted differently depending on whether they come before or after the type specifier; the details are noted below (they are marked “**position dependent**”):

b display in binary format with no separation characters, e.g. {1 bf} or {1 bF} displays parameter 1 in a binary format
B display in separated binary format (i.e., 0:00011111:10101110000000000000000), e.g. {1Bf}
e display in exponential notation using lower-case ‘e’, e.g. {1 ed}
E display in exponential notation using upper-case ‘E’, e.g. {1 Ed}
g display in either decimal or exp. notation using lower-case ‘e’, e.g. {1gF} (for 64-bit doubles, numbers from approximately 10⁻⁶ to 10¹⁷ will display as decimal numbers, all others in exp. notation)
G display in either decimal or exp. notation using upper-case ‘E’, e.g. {1 GM}
o display in octal format, e.g. {lof}
x display in hexadecimal format using lower-case letters, e.g. {1xf}
X display in hexadecimal format using upper-case letters, e.g. {1Xf}
y display in separated hex format (i.e., 0:0123:3bae−120d) using lower-case letters, e.g. {1yf}
Y display in separated hex format (i.e., 0:0123:3BAE−120D) using upper-case letters, e.g. {1Yf}
, scale number by 1/1000 for each comma, i.e, use {1M.3,} to divide number by 1000 before displaying (1,234,567.89 displays as “1,234.568”), or {1M,,} to first divide by 1,000,000 before displaying; default rounding mode will be used, unless otherwise specified
% scale number by 100, i.e., use {1m %} to multiply number by 100 (0.15 displays as “15”); to insert percent sign, add as a literal 943, e.g. “Percent: {1m %}%” will display the number 0.15 in the string as: “Percent: 15%”
*# rounding mode: *0=round to nearest, ties to even; *1=truncate to 0; *2=truncate to −infinity; *3=truncate to +infinity; *4=round to nearest, ties away from 0
.# print decimal point and # decimal places (from 0 to 15), e.g. {1F.2}; use default rounding mode (*0) if none specified
w ensure the output is in wide-char characters
<#:c left-justify, pad with spaces to make at least # characters wide, e.g.
{1<15f}; if optional colon is specified, use the specified character(s) for padding
>#:c right-justify, pad with spaces to make at least # characters wide, e.g.
{1>15f}; if optional colon is specified, use the specified character(s) for padding
̂#:c center, pad on both sides to make at least # characters wide, e.g. {1″15f}; if optional colon is specified, use the specified character(s) for padding
(use parentheses for negatives instead of ‘-’; no space reserved at end for positives, e.g. {1(f})
) uses parentheses for negatives; reserve space at end for positives, e.g. {1F)}
− print minus sign to right for negatives (no display for positives), e.g. {1F-}
{sp} (space character) use trailing ‘-’ for negatives, leave space for positives to match trailing ‘−’ for negatives (used to make right-justified numbers line up), e.g., {1F}
+**position dependent**—when in front of type specifier, always display the sign ‘+’ or ‘−’ immediately in front of the number, e.g. {1+D}; when after the type specifier, always display ‘+’ or ‘−’ immediately after the number, e.g. {1 D+}
$ **position dependent**—when in front of type specifier, always insert currency symbol before first digit, e.g. {1$D}; when after the type specifier, always insert currently symbol after last digit, e.g. {1 D$}
$$ **position dependent**—when in front of type specifier, always insert currency symbol, then a space, before first digit, e.g. {1$$D}; when after the type specifier, always insert a space, then currently symbol, immediately after last digit, e.g. {1D$$}

Note that in some embodiments, an apostrophe is used to signal that the number is to be formatted with thousands separators, rather than using an upper-case letter. This may be easier for a user to remember, although it does require one extra character to signal that separators are required.

Other Types

In some embodiments, the following format specifiers can also be used:

p 32-bit pointer, print in lower-case hex mode (abcd1234)
P 32-bit pointer, print in upper-case hex mode (ABCD1234)

Structure Specifiers

Additionally, format specifiers 1004 of the “=” flavor can be used in some embodiments to denote structures 990 understood by the embodiment. Each structure can have several sub-components 1008, each of which can be specified within the same format command for the given parameter 918 (within the same set of curly braces). For example, date and time structures are frequently printed, and it is helpful to present time-saving options to the user that provide the technical benefit of making it easier and faster to display dates and times. Literal characters 943, such as spaces, periods, and commas, can also be used in structure specifiers; the first character immediately after the name of the structure specifier can be a literal (in this example, if the first character is not a ‘A’ or ‘@’ character, it will be interpreted as a literal character to display directly in the output).

In some embodiments, format specifiers 1004 like the following can be used:

=tm 32-bit pointer to a ‘tm’ structure for date/time
=time_t32 32-bit ‘time t’ structure for date/time
=time_t64 64-bit ‘time t’ structure for date/time
=ftime 64-bit LARGE_INTEGER or FILETIME structure for date/time
=MSDOS 32-bit MS-DOS date/time structure: low 16 bits=date, hi 16 bits=time
=MSDATE 16-bit MS-DOS date structure
=MSTIME 16-bit MS-DOS time structure

Each of the above format specifiers 1004 indicates a multi-part structure 990 with multiple components 1008, each of which may be displayed in one or more formats. When used, each succeeding format component will appear between the structure specifier and the closing brace for the parameter 918 being formatted.

For example, assume we want the date and time to display as: “Sep. 3, 2012 8:34:57.123 pm”. Assume further that the date/time variable is a 64-bit FILETIME structure containing that date/time, and that it is passed as parameter 1. Use the following command string 942 to produce that output:
“{3=ftimêMmm̂d, ̂yyy @h:@mm:@ss.@t @a}”

Note that in some embodiments all the date components 1008, plus various literal separation and spacer characters, can be used within a single format specification for a given parameter 918. ‘̂’ is used for date components and ‘@’ is used for time components to eliminate ambiguity between month and minute, both of which start with the letter ‘m’ (this also helps simplify the parsing operation).

In some embodiments, if no sub-components are specified, a default format 1010 for the structure would be written. Additionally, other structures could be created to handle other formats. For example, =IPa could be used to format IP addresses that are stored as a 32-bit integer in the format “123.456.008.001”; =IPb could use an alternate format “123:456:8:1”. And, of course, each structure created could allow a user to access and format each individual sub-component 1008. For example, since an IP address 964 has four components, each could be specified with digits, such that {=IP1:2:3:4} could indicate the order for each component followed by the desired separator character. This concept can be extended to accommodate structures as complex and/or as large as needed, thereby saving much time (both development and execution) for the user. It could be adapted, for example, to creating HTML code that has a prefix tag, followed by data, followed by a post-fix tag, where the data is a parameter passed to the function 936, and the tags would automatically be understood and written appropriately by the structure function.

Here are some components 1008 that can be used in some embodiments. Each would be used after the appropriate “=” specifier 1004 that specifies the structure 990 that includes the component. One of skill could create other specifiers—these are simply illustrative of the concept. Many components, such as the month, have multiple formats. For technical clarity, the more times a format sub-component specifier is replicated, the longer the output will be (this applies to the month, for example, which can be displayed as “9” or “09” or “Sep” or “September” depending on the specified format: ̂m, ̂mm, ̂Mmm, or ̂Mmmm). Here are some sample format commands (one of skill would recognize that some of these formats do not apply to some of the above structures; only appropriate component formats should be used; see “Some Date/Time Structures” below):

̂m=9 (smallest number for month)
̂mm=09 (two-digit month)
̂mmm=sep (month)
̂Mmm=Sep (Month)
̂mmmm=september (month, spelled out)
̂Mmmm=September (Month, spelled out)
̂d=3 (smallest number for day)
̂dd=03 (two-digit day)
̂yy=12 (two-digit year)
̂_{yyy}=2012 (four-digit year)
@h=8 (smallest number for hour)
@hh=08 (two-digit hour)
@H=20 (military time denoted by uppercase; always two digits)
@m or @mm=34 (two-digit minute)
@s or @ss=57 (two-digit seconds)
@t=123 (milliseconds, with leading zeros; always three digits)
@a=am (or pm)

### @A=AM (or PM)

Some Technical Mechanisms

In some embodiments, the NG_FORMAT table 982 is a result of a process that occurs when the ngParse( ) command compiles a format string by parsing 580 it and building 582 a table 982 of instructions 984 that can then be used to output 452 the exact formatting 210 requested. Each instruction 984 in the table may have its own parameters 918 that further instruct it as to what exactly it must do at its step in the process. As an example, assume the format string used in Example 1 above. The following ngParse( ) command will create the NG_FORMAT table which can then be accessed with the ‘salesFmt’ variable, as shown in the ngFormat( ) command:
// Compile the format string . . .
NG_FORMAT*salesFmt;
salesFmt=ngParse(“Total sales on {1=time t32̂Mmm. ̂d,”+“̂yyy as of @h:@m:@s@a} is ${2F.2}”);
// Format the data using the precompiled format string char buffer[200];
int*result;
double totalSales=123456.775;
result=ngFormat(buffer, salesFmt, time(0), totalSales);

Assume further that after the above ngFormat( ) command is called 544 on the date and at the time indicated below, the output will be:
Total sales on Sep. 20, 2012 as of 11:58:47 pm is $123,456.78

The next section describes the inner details of an NG_FORMAT table that is created by a version of ngParse( ) as the format string is compiled, and which is then used as a parameter by ngFormat( ) to actually perform the format operation according to the original format string.

Structure of the NG_FORMAT Table

In some embodiments, the resulting NG_FORMAT table 982 would be similar to that shown below. One of skill may want to create a custom type or structure for the NG_FORMAT table, although it can be treated as a pointer 962 to a pointer 962 to a 32-bit integer (int32**) with indexing and/or type-casting used as necessary to access any element of the table. One version of the table starts with a variable-sized header 1012 (4-byte aligned for 32-bit execution environments, 8-byte aligned for 64-bit execution environments) that contains data useful in formatting the variable parameters. It contains a four-byte pointer 962 to the first Entry of the table (Entry 0, which would normally be aligned to start on at least a four-byte boundary), a four-byte pointer to the last Entry (Entry 16), a four-byte integer containing the total size of the header 1012, and then a copy of the original format string 942. The header 1012 can also contain other useful information that one of skill may desire, such as a header-ID signature to help validate the header (the header size does not need to be tiny, but can be whatever size one of skill deems appropriate to contain needed and desired information). In some embodiments, rather than copying the format string into the header, a pointer to the original format string can be stored here (the same value as that passed to the ngParse( ) command) in order to save time by not having to copy the string. However, in cases where the format control string is not a constant variable, it could be modified at some point by another process during program execution. Therefore, whenever there is a chance that the format string could be discarded or changed at some time while the string may still be needed for formatting, the entire string should be copied to a buffer (possibly immediately after the header); the pointer 962 to the format string would then point to the new location for the string. In cases where the ngParse( ) and ngFormat( ) commands are always executed one after the other, such as when emulating or replacing a printf-like command 924 without a separate compilation step, it would be safe to forego copying the string and to use the original format string where it exists.

The formatting commands 984 come after the header 1012 in this version, and each command is listed as a 16-byte entry in the NG_FORMAT table 982 with a 4-byte Address component followed by a 12-byte Data component. The Address is the 32-bit address of the command to execute that will follow the instructions in this entry; the Data area is available for local data used in conjunction with this command. In some embodiments, each command entry is 20 bytes 1056 or more; one of skill could adjust this as needed depending on what the needs are for the various implemented commands. The more detailed or explicit each command, the faster the formatting can be. For example, a CopyStr5 command 984 with the parametear 58 (as shown at Entry 14), can be used to copy exactly five literal characters 943 starting at offset 58 of the original format string into the output buffer; when finished, control will pass to the next command at Entry 15 (in some embodiments, the portion of the original format string could be copied into the data area of the entry—provided it fits—for even faster processing, since no offset would need to be loaded, as it would be known that the data to be copied is always located at Entry[4]). This next command at Entry 15 will cause execution of the Double_F function 936, with data parameters 2, 2, and 0, to format the 64-bit floating-point double number passed as parameter #2 (indicated by the {2} in the format string) into a decimal string with thousands separators, two decimals of precision, and using default rounding method 0. When finished, control passes to the next command entry at Entry 16, which exits the process and returns to the caller 1018. One of skill would normally declare the ngFormat( ) command as a ‘cdecl’ command in C or C++, which tells the caller to clear the stack 920; this helps eliminate some stack-related problems that can occur when using functions 936 that accept a variable number of parameters 918.

For 64-bit execution environments, the address of the command 984 stored at Entry[0] will require 8 bytes rather than 4, and will therefore push all other Entry offsets to the right by 4 bytes, and can additionally require the size of each Entry to be increased (it is suggested to keep the size a multiple of 8 so that each Entry can be properly aligned). In some embodiments for 64-bit execution environments, however, the addresses can still be 32 bits, although the upper 32 bits (which would be the same for each address) may need to be preserved in the header to be combined, if necessary, with the lower 32-bit portion of the address of the command 984.

One of skill could decide the number of bits used to store each parameter 918. When enough room is available, using a full natural-word size can be faster; if many parameters are used, many can be stored in one or two bytes 1056; in extreme cases where more memory is needed, the entire succeeding entry could be used for data (and the function using all these parameters would know to adjust the NextCommand pointer to jump 398 over that entry). One of skill could restructure the table as needed to meet other technical goals or requirements. The exact structure of the table 982 may vary, provided the table is structured such that all instructions and data needed can be accessed when needed and in the proper order. The structure described herein can be used in an initial embodiment.

Additionally, various offsets, indexes, pointers, counts, and other parameters can be contained in the table. To a certain extent, some of these types are interchangeable (sometimes with small changes). For example, one of skill could decide to use a pointer 962 rather than an index 832, which in some embodiments could result in faster formatting; choosing which format to use is up to the skilled implementer and depends upon the goals (for example, if stitching to create a custom command, using an index is more helpful than using an address or pointer; when preparing for a normal ngFormat( ) command, using an address is more helpful). For clarity and for purposes of illustration, however, indexes and offsets are shown in the sample table shown below.

Assume a completed NG_FORMAT table 982 such as the one described below:

| | | |
|---|---|---|
| Command/Var | Data | Description |

Header: ptrFirstEntry (points to Entry 0); ptrLastEntry (points to
Entry 16);
sizeTable (total size in bytes of this table, including the header);
copy of OrigStr

| | | |
|---|---|---|
| 0: CopyStr15 | 0 | Copy 15 chars from ofs 0 (“Total |
| | | sales on”) |
| 1: Validate_time_t32 | 1 | Validate/process structure at parm 1 |
| 2: time_t32_Mmm | 1 | Using entry 1 above, output month |
| | | string (“Sep”) |
| 3: CopyStr2 | 30 | Copy 2 chars from ofs 30 (“.”) |
| 4: time_t32_d | 1 | Using entry 1, output day (“20”) |
| 5: CopyStr2 | 34 | Copy 2 chars from ofs 34 (“,”) |
| 6: time_t32_yyy | 1 | Using entry 1, output year (“2012”) |
| 7: CopyStr7 | 40 | Copy 7 chars from ofs 40 (“as of”) |
| 8: time_t32_h | 1 | Using entry 1, output hour (“11”) |
| 9: CopyStr1 | 49 | Copy one char from ofs 49 (“:”) |
| 10: time_t32_tm | 1 | Using entry 1, output minutes (“58”) |
| 11: CopyStr1 | 52 | Copy one char from ofs 52 (“:”) |
| 12: time_t32_s | 1 | Using entry 1, output seconds (“47”) |
| 13: time_t32_a | 1 | Using entry 1, output am/pm (“pm”) |
| 14: CopyStr5 | 58 | Copy 5 chars from ofs 58 (“is $”) |
| 15: Double_F | 2, 2, 0 | Use parm 2, 2 decimals, rounding |
| | | mode 0 to output num |
| | | (“123,456.78”) |
| 16: Exit | 20 | Cleanup, write terminating null to |
| | | buffer, pop 20 bytes (all parms) |
| | | off stack |

In some embodiments, when using structure specifiers no parameter is needed at Entry[4] or for all the other commands operating on that structure following the initial validate command (in the present example, Entry 1 will validate 594 the structure 982, so it needs to know which parameter to access); the initial ‘validate’ command validates the structure and then places it into a known local variable or structure. That way, all the subsequent subcommands operating on that structure (in the present example, Entries 4, 6, 8, 10, 12, and 13 are subcommands) will then use that local variable/structure to access the data. In some embodiments, if the ‘validate’ command determines that the data for the structure is invalid, it will insert some type of safe version of the structure into the local variable, with further processing using that safe value. In other embodiments when the structure is invalid, some string will be copied to the output buffer (such as “**invalid**”, or an empty string) and a flag can be set which the related subcommands could access so that the desired action can be taken. In other embodiments, it may be desirable to skip all subcommands when the structure is invalid, in which case an extra parameter could be stored with the initial validate command (Entry 1) that would point to the Entry to jump to (in the above case, Entry 14) to skip all subcommands.

In some embodiments, rather than specifying the parameter index (as shown above in lines 1 and 15), an offset from the stack frame 908 could be specified. This technical adjustment makes it easier to handle parameters of different sizes (e.g., in the example above, the buffer pointer, the compiled-string pointer, and the ‘time_t32’ object are 32 bits, while the ‘totalSales’ parameter is 64 bits; since each is a different size, it is helpful to inform the command as to the exact starting address for each parameter). This structure is well suited to an assembly-language implementation, but one of skill could implement this in other high-level languages such as C or 0++, or as a hybrid of a high-level language plus some assembly language, making tweaks and modifications as desired.

This method uses a NextCommand pointer (sometimes referred to as EntryPtr) which is initialized to point to the first instruction to execute (at Entry 0). Each instruction uses a 32-bit pointer to a specific code label (defining either a function call or a jump destination; this depends on whether the implementation uses calls 544 or jumps 398 to execute instructions 116, as described herein, although the code label could be the same in either case) which is accessed either directly or indirectly from the table to perform a specific function. In some embodiments, commands perform more than one function; in some embodiments where the parsing/compiling is done live, the commands can contain direct addresses, while in other embodiments the commands can contain indexes to another table of commands that could be updated as needed.

In this example, each table Entry has 12 additional data bytes that can be used for parameters 918 for the function (some embodiments use a different number of bytes). The parameters can specify characters to print, offsets into strings or other structures, a count, an index to a parameter passed by the caller, a pointer to some structure or variable, or whatever makes sense or is required for each function. For example, one could use the 12 additional bytes to contain the string to be copied from OrigStr in cases where there are 12 or fewer bytes to copy, and where the custom copy command always copies an exact number of characters (such as CopyStr1 and CopyStr2); in such a case, no offset would be required (the offset is always at position 4 of the Entry), and one CPU instruction could therefore be avoided.

In the rare event a function needs more data bytes than available in the Entry, various technical options can be used. In some embodiments, space from the very next Entry will be used and the command for that Entry will simply call a return statement (or jump 398 to a jump instruction that returns control to the proper Entry). In some embodiments, all the bytes for one or more next Entries can be used, and the function will adjust the NextCommand pointer so that it skips over those Entries and points to the proper Entry to be handled when it finishes. In other embodiments, additional memory could be allocated, or another portion of the table could be used, and a pointer to that memory location would be inserted into the 16-byte command entry. One of skill can employ these or other technical methods to customize the tables as needed.

In some embodiments, the commands 984 are structured as functions 936 that are called and then return when completed, with a control loop calling each command in turn. In this case, the Exit command at Entry 16 could set a flag to indicate to the control loop that it has finished.

In other embodiments, the commands 984 are structured as jump locations to the code address that contains the method that implements the command; when each one finishes, it will jump 398 to the next entry position in the list making sure to increment the NextCommand pointer appropriately. Although a bit more complex, this method could be faster than using functions that return. In fact, it is possible to structure a command table that does not call any function and does not use a return statement (except at the very end, to return to the caller 1018). Such an embodiment would operate more quickly by eliminating the need to push parameters on the stack, or preserve and restore registers 206, and to setup any additional stack frame. Converting a call-return sequence into a jump eliminates additional overhead.

Commands 984 can be very specialized. For example, CopyStr2 will always copy exactly two characters starting at the indicated offset; that eliminates having to use a count parameter, since when the format string is parsed by ngParse( ), it will know exactly how many characters are in each literal string. One of skill could decide the granularity of such CopyStr commands; for example, in some embodiments, there is a specific CopyStr command for every string size from one through 12 (e.g., CopyStr1 thru CopyStr12), and a generic CopyStr for lengths that are greater and that require an additional separate parameter for the count. This innovation allows the smaller copy operations to take place without requiring use of a counter to know when to stop, providing technical benefits such as faster processing and greater ease debugging the copy operation commands (this also takes advantage of the twelve data bytes in the entry). In some embodiments, some generic calls to CopyStr will instead be broken down to multiple calls, each on its own line, of specific CopyStr# calls so that a count parameter is not needed (e.g., instead of using a CopyStr command to copy 30 bytes, two Entries of CopyStr12 plus one Entry of CopyStr6 could be used, with the appropriate offsets for each).

The command ‘Validate_time_t32’ is known as a master command 1014, since it can validate and prepare data and signals for sub-component functions 1016. It uses a single data parameter (‘1’ in the example) to declare it will operate on user parameter 1, and that it will treat it as a ‘time_t32’ object (in some embodiments, the parameter can be a pointer or an offset to the proper location on the call stack). The master command can do any data validation required, do any processing necessary, and can even call other functions (system functions provided by the O/S, for example) if necessary, and it can prepare data (e.g., local stack variables) for sub-component functions. In some embodiments, the command can break out all the date/time components that can be available. In some embodiments, since all the components to use are specified in the format string, it can break out just those specific components that will be displayed (these parameters can be signaled in the ‘Data’ portion of the entry). In some embodiments, it can set a validation flag that can be used by the sub-component functions to determine whether any output should be attempted, e.g., if the parameter is deemed invalid by the master entry, one or more asterisks could then be written by sub-component commands to signal invalid data. In some embodiments, the value passed as a parameter by the caller could be placed in the data area for this entry, making it easier for sub-component functions to access. In some embodiments, additional variables 914 on the stack 920 can be used, or data space from other entries in the NG_FORMAT table can be used, or memory can be obtained from a memory pool (and in at least some of these embodiments, no reference to the master command's Entry would be needed since all the relevant data would be located in known local variables that do not depend on the Entry number). Whenever such data space or variables are used, the related sub-component functions 1016 will be aware of how to access the data they need in order to properly format their sub-component portion of the structure. Any special information they need should be included in the ‘Data’ section of their respective command Entries.

The command time_t32_Mmm listed above on line 2 is an example of a sub-component function 1016 that is related to Entry 1. The connection is established by the Data entry ‘1’ in the table for this Entry on line 2. In the example above, this sub-component function can use that number as an index into this table, letting it see any information that was initialized by the master Entry (Entry 1); in some embodiments, local stack variables 914 will be used instead to hold any and all data relevant to, or produced by, the master Entry. If an invalid flag is set, for example, it could print one or more asterisk characters instead of trying to print invalid data. In some embodiments, the data area for a sub-component function can also include a CopyStr* command, with the proper parameters in the Data area, to copy literal characters after formatting the parameter; if this is done, it could replace the next CopyStr* command that would have otherwise been at the next Entry in the NG_FORMAT table (this method could be slightly less efficient than a separate CopyStr* command).

Most of the remaining Entries are similar to what has been described above. For Entry 10, the ‘time_t32_tm’ command will format the minute portion of the ‘time_t32’ structure (while the ‘time_t32_dm’ command would format the month portion of the structure, using one or two digits as needed). Each command should have a unique name so that it references a unique address in the code path; it is recommended also that each name be descriptive, which will aid in implementing and debugging and testing any given embodiment. Where possible (or where desirable by one of skill), each command can be very specialized. In some embodiments, for example, there will be a separate function for each sub-component of the structure being used, and the name for each function will include the descriptors used in the sub-component format specifier (e.g., ‘time_t32_Mmmm” would be used for the function that would print “September” and ‘time_t32_yy” would be used for the function that would print “12” for the year in the above example). The names selected for the commands 984 may vary, although in this description they have been selected to make it more clear what the functions will do. Technical benefits such as speed and reduced risk of implementer confusion are provided by the ability to immediately jump directly to the code that will produce the formatted output exactly as specified by the user without needing too many parameters (which would otherwise require one or more if/then statements to determine the proper format) by using either a call or a jump command, as explained above.

It is generally beneficial to have commands 984 as specialized as possible. Otherwise, each instruction 984 may have extra if/then/else logic (software 136 and/or hardware 120) that could have been avoided by taking advantage of more information from the format string 942 during the ngParse( ) parsing and compilation steps.

An Example Using the NG_FORMAT Table

Referring to Example 1 and the NG_FORMAT table 982 above (pointed to by the variable 914 ‘salesFmt’), consider the following. In this discussion, ‘salesFmt’ will be treated as a pointer to a pointer to a 32-bit integer (int32**). Assume the formatting function ngFormat( ) 976 is called 544 as shown in Example 1:
result=ngFormat(buffer, salesFmt, time(0), totalSales);

After initializing some variables, a very small loop can be used to process the commands. When finished, ‘buffer’ 212 will point to the formatted output and the size of the created output string will be returned 464 to the caller 1018.

The Listing_{—}6058-2-3A.txt computer program listing appendix file, incorporated herein by reference, includes some sample code in assembly language showing one way to use the table to format the string 210. This mechanism assumes that each command Entry contains the actual address of the function to call (rather than an index) and that each function exits with a return statement.

In the example, the ngFormat( ) command sets up a stack frame 908 and allocates space for local temporary variables. After preserving some key registers 206, the key variables are initialized. In this assembly-language 866 implementation, key variables are maintained in registers ebx (NextCommand), esi (OrigStr), and edi (DestPtr); this means that the functions that are called 544 do not need to spend time accessing those variables so that they execute more quickly. One of skill can decide which, if any, variables to keep in registers. One of skill would also recognize that the above code can be optimized without departing from the spirit of the present invention. For example, since key variables (such as NextCommand, OrigStr, and DestPtr) are kept in registers, one of skill may decide to not reserve storage for them or save them to memory.

Note the ParmBase0 equate: ParmBase0 equ ebp+12. This equate shows the position of the parameter 0 passed to the ngFormat( ) function (which in the above embodiment is located at 12 bytes offset from the ebp register). In this scenario, parameter 1 would be at 16 bytes offset; if parm 1 is 32 bits wide, parm 2 would be located at 20 bytes offset, but if it was 64 bits wide, parm 2 would be located at 24 bytes offset. The offsets of the parameters are thus based upon the size of the preceding parameter; in a 32-bit execution environment, all offsets will be evenly divisible by the number four. In some embodiments, the offset for a parameter is based upon the location of ParmBase0, i.e., parameter 0 is at offset 0, parameter 1 is at offset 4, etc. In others, the offset for a parameter can be based upon the ebp register, e.g., parameter 0 is at offset 12, parameter 1 is at offset 16, etc. One of skill could choose either method, or a different one, to access the parameters. In a high-level-language implementation, a skilled implementer would select mechanisms provided by the language provider (for example, for C++ implementations, one would use the mechanisms described in reference material for the ‘stdarg’ library, which is freely available online). Note that different methods may be needed for 64-bit execution environments, where some parameters are passed in different types of registers 206 and some on the stack 920, as explained elsewhere in the present disclosure.

Note also that while {0} indicates a reference to the original format string, the actual parameter passed at that position is a pointer 962 to the NG_FORMAT table. One of skill can choose, as is done in some embodiments, to treat that {0} as pointing to the format string 942; one would make sure the code accesses the proper string, which is not necessarily the first element in the NG_FORMAT table (in the above embodiment, for example, a copy of the format string is stored at the location that is 12 bytes offset from the start of the table).

After key variables are initialized, the command pointed to by NextCommand is executed. When finished, it returns to the main ControlLoop, the NextCommand pointer 962 is advanced to point to the next command (by adding 16 bytes to it, since each Entry in the example table above occupies 16 bytes). It then checks to see if the ‘finished’ variable was set to 1; if not, it loops to the ControlLoop label and continues with the next command. If it was set to 1, the function is finished and exits properly (restoring key used registers 206 and removing the stack frame 908). In the technical mechanism of the embodiment illustrated above, the caller 1018 will clear the pushed variables from the stack.

Let's now look in detail at the above NG_FORMAT table. After entering the ngFormat( ) command and initializing key variables as described above, the first command at Entry 0 is called: CopyStr15. This command will copy exactly 15 characters (“Total sales on”) from OrigStr[0] (it starts at offset 0 as indicated in the data portion of the entry) into the current buffer position located at DestPtr. It will add 15 to DestPtr (so it will point to the position for the next character) and then return.

Next, the command at Entry 1 is called: Validate_time_t32. The 1 in the data area indicates this command will operate on the 32-bit object located in the position of parameter 1. Note that in some embodiments, either the value 4 (as a byte offset from parameter 0) or the value 16 (as an offset from the ebp register), might be used instead. In any case, each command will be properly coordinated to communicate properly with the NG_FORMAT table in order to access exactly the right data. This command 984 will grab the value located at that offset and perform any tasks needed. In this example, the object is actually a 32-bit integer which is assumed to be a valid time_t32 object. All the sub-commands that act on the object also know this, so they don't need to check any flags indicating an invalid number. If desired, using a local variable to contain the validated object after Validate_time_t32 has processed it (say, Time_t32_val′) makes it easier and quicker for the sub-commands to access that value.

If one of skill decides it is useful to validate 594 the object, a local-variable flag ‘isValid’ could be used to indicate whether it is valid so that sub-commands could determine quickly whether they need to handle an error. This same process can be used to validate 594 other structures (such as the ‘tm’ structure, for example; it takes little to no extra execution time to include as many local variables as needed for each format structure, and makes the relevant data immediately accessible to the sub-commands). Additionally, some validating 594 commands 984 could also extract the sub-objects needed and store them in local variables if needed. No portion of the date or time is yet written to the output buffer; that is handled by the specific commands that follow.

Next, the command at Entry 2 is called (“time_t32_Mmm”) with the data parameter of 1, which tells this command the value it is looking for can be accessed by looking at the data for Entry 1 (in some embodiments, the value it needs is instead stored in one or more local variables). If the data is invalid, the command returns without making any change to the destination buffer; or in some embodiments, it may first add a string such as “***” to indicate an invalid value was encountered, and then update DestPtr and return. If the data is valid, this function uses any appropriate technical mechanism (call a system function that can return the proper month as an integer, for example, and then use that integer as an index into a table of month entries to obtain the proper entry; or use a custom routine to do the same thing) to obtain a string representing the first three letters of the month, with the first letter upper-case and the others lower-case, which in this case is the string “Sep” which is then copied to the buffer position pointed to by DestPtr. After adding 3 to DestPtr, this function returns.

Next, the command at Entry 3 is called: CopyStr2. This will copy exactly two characters from OrigStr[30] (“.”) into the buffer position pointed to by DestPtr. After adding 2 to DestPtr, this function returns. In some embodiments, the characters to copy can be stored in the respective data portion of each Entry specifying a copy command.

Next, the command at Entry 4 is called: time_t32_d, with the data parameter 1. After checking for a valid flag at entry 1 (or checking the appropriate local stack variable), it operates similarly to the command at Entry 2, returning a value of 20, which is then converted to the decimal string “20” representing the day of the month, and which is copied to the buffer position pointed to by DestPtr. After adding 2 to DestPtr, this function returns. Note again that local variables could be used to store the needed data, saving the code for this and other sub-commands from having to access data stored at another command Entry.

In a similar manner, the commands from Entry 5 through Entry 14 are handled, each one either copying a portion of OrigStr or formatting a sub-component of the time_t32 object.

Next, the command at Entry 15 is called: Double_F, with the data parameters 2, 2, and 0. The command will operate on the 64-bit number located in the position of parameter 2 on the stack, which is to be treated as a 64-bit double floating-point number. The next local parameter (also 2) says to format the double (thousands separators are included due the the upper-case ‘F’ in the type specifier; if no separators were to be used, the command would have been Double_f—with a lower-case f, as per the type specifier) with two decimal places, and the third local parameter (value=0) says to use the default rounding 522 method (round to the nearest digit, ties round to the even digit). After outputting the decimal string and updating DestPtr to point to the next position, this function returns. In some embodiments, the rounding function is only partially implemented, and in some no rounding is performed.

Finally, the command at Entry 16 is called. It adds a terminating null at the current DestPtr position, sets the ‘finished’ flag to 1, then returns. Upon returning, the control loop finds that the ‘finished’ flag is now set, and it is ready to exit. As described elsewhere herein, when stitching or jumps are used instead of calls, there is no control loop and a ‘finished’ flag would not be necessary. The total size of the formatted string is returned in the eax register to the caller, saved registers are restored, the stack frame is removed, and the function clears. The formatting function ngFormat( ) should use the ‘cdecl’ calling convention so that the caller will clear the stack; this eliminates some bugs that can be created when using functions 936 that allow a variable number of parameters to be passed to them.

One of skill could implement special handling for every type, including options and sub-commands, using the architecture described in this present disclosure. It can be expanded to handle very complex scenarios. For example, in some embodiments, formatted components can be padded and/or justified (left, right, or center).

Brute-Force Method of Justifying Components

In some embodiments, any command 984 to justify and/or pad 596 a component would be listed as a separate command entry immediately after the component that is to be adjusted. Assume for discussion these justification commands 984 are named Justify_left, Justify_right, and Justify_center. For this to work as now described, assume that the previous command wrote its output in a left-justified, non-padded manner (i.e., it wrote the data to the output buffer normally, since left-justified and non-padded is the normal output method if no alignment is otherwise specified). Also, a command to save 598 the initial value of DestPtr should be executed prior to formatting the element to be justified (such as “StartDest=DestPtr”). That will permit the Justify_* command to determine 600 the exact amount of justification to add (the total size of the previous command would then be equal to DestPtr−StartDest). Some such commands could also have a “fill” parameter that specifies what character(s) to use for padding, if desired. In some embodiments, the command “StartDest=DestPtr” is executed 598 as the first part of any instruction that writes to the buffer. In other embodiments, that command will be inserted 598 into the table just before the last-written command Entry only when a Justify_* command has been detected. After saving the starting value of DestPtr, the next formatting command will write a formatted element to the buffer; then the justification command will be called.

Note that in some embodiments, each formatting command that converts a parameter will have two entry points: one where the first command saves DestPtr, and one that starts immediately after that command. That way, the DestPtr value would be saved 598 only when needed, with less overhead.

Here is an example:
Fmt_s_just:
; Use this label if output will be justified
   mov [StartDest], edi; edi is DestPtr
Fmt_s:
; Use this label if output will not be justified
; . . . code to output the string starts here

The above example command ‘Fmt_s’ is called when a string is to be inserted into the buffer as requested by a format command such as {1 s}. Since no formatting is requested, there's no need to save the current value of DestPtr. But when a format command such as {1<12s} is used that requires justification, the command ‘Fmt_s_just’ is the address to follow to prepare the output for justification with the next justification command. This saves time by executing only the commands that need to be executed.

Processing 596 a Justify_* command is straightforward in this example. The total amount of padding is TotalPadding=TotalWidth−(DestPtr−StartDest) (this assumes that the parameter has already been formatted and written to the output buffer as per the format instructions). If TotalPadding is less than one, no change need be made. In some embodiments, though, a strict justification feature could ensure that the formatted string is never larger than requested. In such a case, when TotalPadding is negative, meaning the output just written is too large, the output could be simply truncated by adjusting the current value of DestPtr to equal the previous starting value plus the length requested (or, DestPtr+=TotalPadding will move DestPtr back). A strict justification feature that truncates 514 if needed could be the default behavior when the actual written length exceeds the specified padding length. Or a separate justification format-type specifier could be used to let the user decide what should happen for output exceeding a desired size. A more complex method could truncate 514 a component from the front and shift the right-most portion to the left, if desired.

When TotalPadding is greater than 0, the behavior depends on the specific command specified. Justify_left is the easiest to handle; one could simply add TotalPadding spaces (or use a specified filler) to pad to the requested size, then adjust DestPtr and return.

Justify_right 596 would be slightly more complex. All the just-formatted characters 885 should be right-shifted in the output buffer by TotalPadding characters. One of skill would copy that portion of the string in a right-most-characters-first manner to prevent corruption of the string that could occur when using a left-most-characters-first method. The TotalPadding number of characters just freed up in between where the first character of the component used to be and where it is after the shift would then be filled in with spaces (or the specified filler, as mentioned above).

Justify_center 596 can insert padding on both sides. Set LeftPad=RightPad=TotalPadding/2. If TotalPadding is odd, the value 1 must be added to either LeftPad or RightPad (so that the actual total characters of padding is correct); in most embodiments it will not matter, but one could choose either one. Then the just-formatted component will be right shifted LeftPad characters in the same manner as described above for the Justify_right command. Then LeftPad spaces (or fill characters) will be carefully written to the location where the formatted component used to start, and RightPad spaces (or fill characters) will be written at the new position of where the formatted component now ends. Following this, DestPtr will be adjusted (DestPtr+=TotalPadding) and the function 936 will return.

Justification 596 as described above has technical advantages. First, since a justify command 984 is treated as a full separate command, ngFormat( ) will not have to spend any time checking for any justification settings for any component, unless (and only when) one has been specifically requested. Second, the method is very fast and does not need any additional buffer. Other methods, however, could still be used to justify components. For example, in some embodiments a justification flag and padding length could be added as data parameters to the command entry for any command where justification is requested. Some embodiments may handle right- and center-justification differently, by first determining the size of the string to be written, then calculating the exact number of characters to pad on the left of the string, then writing those pad characters, and then writing the requested string characters (and when centering, then writing the proper number of pad characters, if any, to the output buffer immediately after the string characters).

The non-parameter format command {T#} can be used in a way similar to the “<#” option that means to left-justify and pad. In some embodiments, it is translated into the Justify_left command and treated exactly as such after the preceding Entry command.

A related method is the non-parameter format command {M}. This command can be used to simply store the value of DestPtr by saving it to a local variable (e.g., the command {M} could be used to remember the position of DestPtr and store it in the local variable Marker). Then, after several commands that write output, the format command {M>35} could be used. This would say to right-justify the output from the position stored in local variable Marker up to the current position of DestPtr, and pad on the left to make the size equal to 35 characters in length. When this is used, the ngParse( ) command will specify the padding length (equal to 35 in this example) as a local-data parameter for the command ‘M_right’. Note that one of skill could allow multiple markers to be used (such as {M1}, {M2}, etc.); the ngParse( ) command would then be responsible for matching up the justification request with the its companion Marker command (e.g., the index values must match).

Here are some format examples. The following format command string will right-justify the output:
“The date is: [{M}**{1=time t32̂Mmm. ̂d, ̂yyy}**{M>35}]”
   like this:
The date is: [**Sep. 25, 2012**]

The following format command string will left-justify the output:

“The date is: [{M}**{1=time t32̂Mmm. ̂d, ̂yyy}**{M<35}]”
like this:
The date is: [**Sep. 25, 2012**]

The following format command string will center-justify the output:

“The date is: [{M}**{1=time t32̂Mmm. ̂d, ̂yyy}**{M̂35}]”
like this:
The date is: [**Sep. 25, 2012**]

Preparing to Parse a Format String to Create the NG_FORMAT Table

There are many ways to parse 580 the format string 942 that one of skill could choose. Many different structures for the NG_FORMAT table 982 could be designed. In an initial embodiment, the structure outlined above may be used. The completed table should be accurate, complete, and able to precisely represent the steps to create formatted output as specified in the format string. As a technical tradeoff 902, the more detailed and specialized the table 982, the faster the formatted output 210 can be generated 578; when details are left out, that means each command will have more work to do, which can slow down processing. A technical goal of some embodiments of an invention described herein is to do as much work as possible in the parsing and compiling steps.

In some embodiments, a default size 256 is chosen for the table 982 of commands 984 and that amount of memory is allocated from a memory pool 880. The pool can be located anywhere accessible to processor(s) 112, e.g., in global memory, in memory allocated from the operating system, or in memory allocated on the stack. If stack memory is used, one of skill should ensure there will be enough stack space; if not, either increase the stack size or allocate the memory from a different memory pool. If during parsing it becomes apparent that the table is too small, the memory can be resized upward (or a larger memory allocation can be obtained and then all entries of the table to that point can then be copied to the new location) and the parsing/compiling process could then resume. In some embodiments, the specified format string can be parsed to determine the exact size needed for the table, to avoid the possibility of running out of space before the table has been finalized. In an initial embodiment, a memory allocation of 4 k bytes 1056 can be used, and then expanded if necessary during the compilation process.

When the table is completed, a pointer to the address of the completed NG_FORMAT table will be returned to the caller. In this present disclosure, the term ‘Table’ will be used to describe the NG_FORMAT table 982, and an index 832 used (such as Table[8]) will specify a byte offset into Table. ‘Entry’ is a variable that will point to a command Entry. Each Entry can be numbered 579: Entry 0 is the first Entry; Entry 1 is the second Entry; Entry 13 is the fourteenth Entry. An index enclosed in brackets indicates a specific byte offset of that entry, e.g., Entry[0] points to the beginning of the entry where a command address or index will be written, and Entry[4] points to a data area four bytes 1056 into the entry.

In some embodiments, and as described herein, the table will have a header 1012 including a 32-bit integer located at Table[0] and pointing to the first entry of the table, followed by a 32-bit integer located at Table[4] pointing to the last entry of the table, followed by a 32-bit integer located at Table[8] specifying the total size of the Table, and then followed by a copy of the format string starting at Table[12]. The first Entry will follow the end of the format string, and will be aligned on a four-byte boundary (one of skill could align on eight-byte or sixteen-byte boundaries, or otherwise, if desired). Once the format string has been copied into the Table, the string will be padded if necessary to cause the desired alignment of the command entries, and the first command entry will start at that aligned position (i.e., Table[0] will contain a pointer to that first command Entry that is located at an aligned memory address immediately after the format string). Once the last command ‘Exit’ has been entered into the table, the value of the address pointing to the start of that last Entry will be written to Table[4], the total size of the table will be written to Table[8], and then a pointer 962 to the completed table will be passed to the calling routine.

Note that the first two 32-bit integers (located at Table[0] and Table[4]) can be the byte offset from the start of the table to the position where the first and last Entries, respectively, are located; this works well for both 32-bit and 64-bit execution environments. In an initial 32-bit execution-environment embodiment, however, each of these integers can be the memory address pointing to those Entries.

In some embodiments, each Entry will be exactly 16 bytes. Entry[0] will contain a 32-bit address pointing to the command that will be called to execute the command represented by this Entry. The remaining 12 bytes, starting at Entry[4], are available for local data used by the command referenced at Entry[0]. In some embodiments, an index rather than an address will be stored at Entry[0]. In some embodiments, a running total of the size of all expected parameters, based on the format-type specifiers, will be maintained (TotalParametersSize). This size could then be stored at Entry[4] of the last Entry (the Exit command) and is helpful if one of skill chooses to implement the ngFormat( ) command with a StdCall calling convention where the ngFormat( ) command would clear the stack upon returning.

In some embodiments when Unicode16 characters are used 432, each Entry can be 24 bytes (or more) in order to accommodate double-byte characters more easily (for the CopyStr# commands). For 64-bit execution environments, the address for each function 936 to be stored at Entry[0] should be a 64-bit address, and therefore a larger size for each Entry should also be considered, such as 20 bytes when outputting single-byte characters: the remaining 12 bytes used for local data would then start at Entry[8]. When outputting double-byte characters in such a 64-bit execution environment, a size of 32 or more bytes should be considered.

When parsing the control string and when compiling the table, many technical decisions can be made that impact execution speed as a tradeoff 902. Sometimes one may desire to increase the speed of format-control-string compilation 576, and other times one may take more time on compilation to ensure faster speed when formatting 578.

For example, in embodiments where the formatting 578 must be as fast as possible, one might choose 577 to copy 602 portions of the original formatting string to Entry[4] of a CopyStr# command so that no offset is needed when copying literal characters 943 to the output buffer, rather than using an index that points to the original format-command string 942 (and the appropriate CopyStr# commands would be modified to take that into account). This would make the string instantly available since it would avoid an extra load of an index to get the starting position of the string 940 to be copied (i.e., the string to be copied would always start at Entry[4]). But this might not be chosen where the compiling and formatting commands are always executed in tandem, since the time to copy the string into the table would exceed the time to execute one instruction to load an offset to the original format string.

In other embodiments, the command entries become a pattern that is used to “stitch” 604 the actual code bytes 984 together to create a new custom function 1020 that can execute 578 all the commands with in-line code. Stitching 604 can be done on the fly, as described in the section “An Innovative Stitching Algorithm”. Such a process completely eliminates function calls 544 and/or jumps 398 to each Entry command of the NG_FORMAT table 982, thereby speeding up execution.

In some stitched embodiments, an initial code path 1022 is placed 579 at the front, and an exit code path 1024 is placed at the back, of the custom function 1020 being created. A linking command 984, 1026 may be added 579 between each separate command code path in order to keep current a pointer to the table of local parameters each function needs. Additionally, the entire NG_FORMAT table can be copied 589 so that it is contiguous with the newly-created custom function; doing so can remove the need to use any parameter on the stack to point to the NG_FORMAT table.

In some cases there will be errors in the format-command string 942. In some embodiments, the parser will determine that the errors should be treated 496 as literal strings, and an Entry will be created with an appropriate CopyStr command that will output a portion of the original format string. If it is possible to resynchronize with the format string, it is useful to do so and to then continue creating Entries until finished. Otherwise, the remainder of the string could be handled with the CopyStr command, or it can be ignored and skipped. One of skill would choose a desired strategy for handling these errors, considering that it is often advantageous to help a user avoid technical errors when using a product embodying some of the teachings of the present document.

In other embodiments, once it is determined 496 there is an error in the format string 942, an error indicator (a message string, or multiple asterisks, for example) 1028 could be written via a WriteErrMsg command to indicate an error was detected in the format. Some errors are relatively benign, such as passing more parameters than are needed, e.g., passing two integers when the format control string only refers to one. Other errors can cause a running program to crash, as can happen when the size of a variable parameter, as specified in the format string, differs from the actual size of that parameter as passed on the stack; or when the number of parameters indicated in the format-command string is more than the number of variable parameters passed on the stack when the ngFormat( ) command is called; or when the parameters are passed on the stack in an order differing from that indicated in the format-command string.

See the “Testing and Debugging Issues” section for some information on specific tools that could be used to help determine whether format-command string issues are related to the size and/or number of parameters specified in the string or passed on the stack. The testing and debugging tools as described in the present document may not work in a managed environment, although testing with their equivalents in a native environment can still be helpful.

When it has been determined that the format-command string has a non-zero length, the parsing 580 can start (otherwise, an Exit statement would be the only instruction in the table). In this first act of an overall parsing step (which can be repeated multiple times in the form of an outer loop as known to one of skill), the string is searched for the first opening brace T character it finds, which is used to denote a format parameter. If it finds none, the entire string is literal, and a CopyStr command will be created at the first entry, and then the process will terminate as described above by formatting a closing Exit statement. In some embodiments where braces are not used, the string is searched for the first opening percent sign “%” or other character denoting a format variable.

A Parsing 580 Example

Once memory has been allocated and the header 1012 has been initialized as described above (except for the pointer to the last Entry command that will be stored at Table[4], which will be updated at the end), the null-terminated format string will be parsed 580. In some cases, the format string can be of a different type, possibly not null-terminated (and in some cases, all strings could be of a different internal format); in such a case, one of skill could adjust details of the procedures explained in the present disclosure so that the desired result occurs by using indexes for each such string, rather than pointers, and ensuring that the index remains within the proper bounds for the string(s) being manipulated.

In this example, the string is parsed until the end is reached, at which time the Table 582 is finalized. String parsing and Table creation may also be interleaved in other sequences, with parsing paused partway through the control string while a portion of the Table is initialized. Parsing may also be terminated (as opposed to merely paused) before reaching the end of the format control string in some cases, e.g., on encountering an unknown format specifier or a halt-parsing format specifier (useful in debugging the parser). In general, after the Entry for the last command is completed (a CopyStr# or similar command if any literal characters still remain), a new Entry command is created for the Exit instruction. Table[4] is updated with the pointer to the Exit command, Table[8] is updated with the size of the table, and a pointer to the Table is returned to the caller. Note that if the string is a zero-length string, only one entry will be created: the Exit entry.

To illustrate the parsing and compiling steps, assume memory has been allocated and the header initialized as described above, and that EntryPtr points to the position for the first command. The following code fragment shows a format-command string 942 with multiple literal-character strings, multiple parameter types, number formatting, and some aligning steps. This example is fairly complex in order to show several aspects of the parsing 580 and compiling 582 steps:
int index=47;
char *fname=“John”;
char *lname=“Smith”;
char *ssNum=“123-45-6789”;
double bal=−7788.99;
char *msg=“overdrawn”;
char *OrigStr=
   “{1}:{T4}{{{2s:0:1} {4s:0:10<10} SS#**{3s-0:4}”+“{5F).2>13}{M}***{6s}***{M>19}}}”;
char buffer[100];
NG_FORMAT *table=ngParse(OrigStr);
int result=ngFormat(buffer, table, index, fname, ssNum, lname, bal, msg);

Based on the above format, the output string would be:
“47: {J Smith SS#**6789 (7,788.99)”+“***overdrawn***}”

Here is the resulting table 982 of selected 577 commands in execution sequence 579 after compiling the output string:

| | | |
|---|---|---|
| Command/Var | Data | Description |

Header: ptrFirstEntry (points to entry 0); ptrLastEntry
(points to entry 15); sizeTable (size of this Table); copy
of OrigStr

| | | |
|---|---|---|
| 0: i32toa_d | −1 | Convert parm 1 as default 32-bit signed |
| | | int (“47”) |
| 1: CopyStr1 | 3 | Copy 1 char from ofs 3 (“:”) |
| 2: Tab | 4 | Set DestPtr to offset 4, fill skipped |
| | | positions with spaces (“ ”) |
| 3: OpenBrace | | Insert an opening brace (“{”) |
| 4: Left | −2, 1 | Copy 1 char from left of parm 2 (“J”) |
| 5: CopyStr1 | 18 | Copy 1 char from ofs 18 (“ ”) |
| 6: Left | −4, 10 | Copy up to 10 chars from parm 4 |
| | | (“Smith”) |
| 7: Align_left | 10 | Align-pad to width 10 (“ ”) |
| 8: CopyStr7 | 31 | Copy 7 chars from ofs 31 (“SS# **”) |
| 9: Right | −3, 4 | Copy 4 chars from right of parm 3 |
| | | (“6789”) |
| 10: CopyStr1 | 46 | Copy 1 char from ofs 46 (“ ”) |
| 11: F_Open | −5, 2, 0 | Convert parm 5 as 64-bit double, |
| | | thousands separators, two decimal places, |
| | | default rounding, open paren for negative |
| | | (“(7,788.99”) |
| 12: CloseNum | | Insert close paren if prev num is neg |
| | | (“)”), else insert space char |
| | | (look at ‘isSigned’ local var) |
| 13: Align_right | 13 | Align right (insert “ ” in |
| | | front of num) |
| 14: Mark | | Save current DestPtr (MarkPos = 42) |
| 15: CopyStr3 | 60 | Copy 3 chars from ofs 60 (“***”) |
| 16: Str | 6 | Copy parm 6 as string (“overdrawn”) |
| 17: CopyStr3 | 67 | Copy 3 chars from ofs 67 (“***”) |
| 18: Mark_right | 19 | align right, starting at position saved |
| | | as MarkPos; (NumChars = 19 − (DestPtr − |
| | | MarkPos) = 19 − (57 − 42) = 4) − |
| | | insert four spaces “ ” at offset 42 in |
| | | buffer after shifting right four spaces |
| 19: CloseBrace | | Insert closing brace (“}”) |
| 20: Exit | 36 | Cleanup, exit, pop 36 bytes (all parms) |
| | | off stack |

Here are steps (or acts, if that term is preferred) taken to produce the above table 982 by the above format-command string. First, the header 1012 will be organized as described above. EntryPtr points to the first command position (Entry) inside a buffer area that will contain the finished NG_FORMAT Table (for purposes of this description, the buffer is assumed to be large enough to hold all elements of the Table); the appropriate header has already been created as explained previously. As each Entry is completed, EntryPtr will advance 579 to point to the next available Entry slot. OrigStr points to the format-command string. StartPos will point to the starting offset position in OrigStr for the current command, while CurPos will advance character by character, pointing to the current offset position being processed. At this point, a main loop is entered whose main purpose is to scan OrigStr until it finds an opening brace T character, at which point it knows a format command has been found; or until it finds a null character, meaning the end of the string has been found. When a target character is found, control will branch to an appropriate routine that will process the rest of that command, and then return back to the main loop.

While parsing the format-command string, the end-of-string indicator is checked for at each character position (a null character for null-terminated strings, for example); when encountered, parsing stops and the last commands are written, followed by a closing Exit command and finalizing the header. If encountered unexpectedly, one of skill could implement an error-handling routine. The remaining description here assumes that proper error-handling is inserted at all appropriate points of the code by one of skill to detect the end of the string or other format errors, and is not mentioned at each additional step below in order to make the description simpler.

Setting aside for a moment this particular example, it will be understood that in some embodiments, a Finite State Machine 1030 is built 606 dynamically, based on the format control string 942. That is, any familiar mechanisms for building finite state machines may be adapted for use in building parsers 974 or command tables 982 described herein, or functionally equivalent mechanisms to perform the parsing and/or formatting functions of the parsers and/or command tables described herein. Moreover, any description herein (or subset of such description) of a control string parser 974 shall be considered a description of a parsing means if such a means is claimed, and likewise any description herein (or subset of such description) of a command table 982 or stitched code fragments 1020 for generating a formatted output buffer or other formatted string 210 shall be considered a description of a formatting means or an output generation means if such a means is claimed. The output buffer may be a memory buffer, or it may be a data-receiving mechanism such as a stdout or cout pipeline component or a file handle or a network transmission socket or a function that prints/displays characters as they are received.

Turning back now to the particular example at hand, a general outline of a process 576 is as follows. At the start of the main loop, each character will be scanned until an opening brace is found. If any literal characters were identified (which is the case when CurPos is greater than StartPos), a CopyStr command will be inserted 577 at Entry[0], and the index 832 StartPos will be written to Entry[4]. In some embodiments, if the number of literal characters will fit in the Entry, i.e., there are 12 or fewer characters, they can be copied to Entry[4] in place of the offset. Regardless, EntryPtr will then advance 579 to the next Entry position. The character immediately after the opening brace determines where the code will branch. If it's a digit, this is a format command that will be processed by the GetCommand( ) process (this will process the parameter and any related information, creating a proper Entry, or Entries, for that parameter). In this example, any time a parameter index is stored at Entry[4], it will be initially stored as a negative index number (no other command will use a negative value in this slot of the Entry); once the Table has been filled, all index parameters will then be updated with an offset that ngFormat( ) requires to access the table (this method is described below). Other commands will be called 544 appropriately; each will create the appropriate Entry commands in the table and then advance EntryPtr to point to the next available position when it returns.

When the null (end-of-string) character is found, the EndOfString( ) command will insert an Exit command, and will advance EntryPtr to the next command slot, which is now the end of the table. After the above code is finished, all that is left in this example is to update the Table header: Table[4] will be set to the position of the start of the Exit command (which is 16 bytes before the current value of EntryPtr); and Table[8] will be set to the size of the table, which is the byte distance between EntryPtr and the start of Table header. A pointer to the start of Table is then returned to the caller, pointing to a finished NG_FORMAT table.

Here are specific selections 577 and sequencing 579 that occur with the above format string 942. (Note that Entry[num] is used to refer to the specific byte offset of the Entry that EntryPtr is currently pointing to.)

Entry #0: The first opening brace is found as the first character. Since both CurPos and StartPos=0, there are no literal characters to be found. Since the next character is a digit, GetCommand( ) will be called 544 to process it. It will find that no format type has been specified, so it will use the default format (32-bit signed integer, which could have also been represented by the ‘d’ format specifier). The index is found to be 1, and the GetCommand( ) process looks for any options (finding none in this case) and searches for the closing brace, updating CurPos to point to the character immediately after the closing brace. Since there is nothing left to parse, Entry is updated: Entry[0] contains the address of the format routine that handles this format (called ‘i32toa_d’ in the table), and Entry[4] will be set to −1 to indicate parm 1. EntryPtr will then be advanced to the next position, and StartPos will be set to CurPos (both set to 3).

Entry #1: An opening brace is found when CurPos=4. Since StartPos=3, one literal character must be copied. Entry[0] will be set to the address CopyStr1, and Entry[4] will be set to StartPos. EntryPtr will advance to the next position.

Entry #2: The switch statement is entered, and logic (software 136 and/or hardware 120) will flow to the ProcessTab( ) command. It identifies the value 4 and sets CurPos to point to the character after the closing brace (CurPos=8). Entry[0] is set to the address Tab and Entry[4] is set to 4. EntryPtr will advance to the next position, and StartPos will be set to CurPos (both set to 8).

Entry #3: An opening brace is found when CurPos=8. No literals will be output, and GetCommand( ) will find another opening brace as the next character, signifying that a literal open-brace character should be output. Entry[0] is set to the address OpenBrace, EntryPtr will advance to the next position, and StartPos will be set to CurPos (both set to 10).

Entry #4: An opening brace is found when CurPos=10. No literals will be output, and GetCommand( ) will find that parm 2 is type specifier ‘s’ which denotes a string. Since there is a colon next, this signifies either a Left, Mid, or Right string copy command. Since there is no minus sign, it will not be a Right command. The number (0) tells us this will be a Left command, and the number following the next colon (1) indicates one character should be copied from the string. Entry[0] is set to the address Left, Entry[4] is set to −2 to indicate parm 2, and Entry[8] is set to 1 to show one char only is to be copied from the string. EntryPtr will advance to the next position after the closing brace, and StartPos will be set to CurPos (both set to 18).

Entry #5: An opening brace is found when CurPos=19. Since StartPos=18, one literal character must be copied. Entry[0] will be set to the address CopyStr1, and Entry[4] will be set to StartPos. EntryPtr will advance to the next position.

Entry #6: Since a digit is found at position 20, GetCommand( ) will receive control from the switch statement. The index value 4 is identified (meaning parm 4), and ‘s’ denotes a string to process. The next colon signifies either a Left, Mid, or Right command will be selected. Since there is no minus sign after the first colon, and since the first number is 0, it will be left. The number after the second colon tells us to copy 10 characters. But some options follow. The ‘<’ character tells us this command will be left justified and padded to fill 10 characters; it also tells us that DestPtr (a variable 914 used when actually formatting data as per the table instructions) should be saved prior to writing the data, in order to let us know how to pad the field. The last character is the closing brace, which tells us this command is ready to be added to the table, and CurPos is set to equal the character after (set to 31). Entry[0] will be set to the address Left (which has, as its first instruction, “StartDest=DestPtr”) and Entry[4] will be set to −4 (parm 4) and Entry[8] will be set to 10. EntryPtr will advance to the next position, which is ready to be filled in.

Entry #7: Entry[0] will be set to the address Align_left, and Entry[4] will be set to 10. EntryPtr will advance to the next position, and StartPos will be set to CurPos.

Entry #8: An opening brace is found when CurPos=38. Since StartPos=31, seven literal characters must be copied. Entry[0] will be set to the address CopyStr7, and Entry[4] will be set to StartPos. EntryPtr will advance to the next position.

Entry #9: Since a digit is found at position 39, GetCommand( ) will receive control from the switch statement. The index value 3 is identified (meaning parm 3), and ‘s’ denotes a string to process. The next colon signifies either a Left, Mid, or Right command will be selected. Since there is a minus sign after the first colon, and since the first number is 0, it will be Right. The number after the second colon tells us to copy 4 characters starting from the end of the string and moving forward. The closing brace is found and CurPos is set to equal the position immediately after (CurPos=46). Entry[0] will be set to the address Right. Entry[4] will be set to −3 (parm 3), and Entry[8] will be set to 4. EntryPtr will advance to the next position, and StartPos will be set to CurPos.

Entry #10: An opening brace is found when CurPos=47. Since StartPos=46, one literal character must be copied. Entry[0] will be set to the address CopyStr1, and Entry[4] will be set to StartPos. EntryPtr will advance to the next position.

Entry #11: Since a digit is found at position 48, GetCommand( ) will receive control from the switch statement. The index value 5 is identified (meaning parm 5), and ‘F’ denotes a 64-bit double floating-point value that should be converted to decimal using thousands separators. Upon further parsing, a closing parenthesis is found, meaning negatives will be surrounded with parentheses, and positives will have an extra space after the formatted number (the command ‘F_Open’ formats the double as requested, and will insert an opening parenthesis at the start if the number is negative). Further parsing identifies a period, which indicates the next number will determine the requested decimal precision (value=2 decimals). Next, a ‘>’ character is identified, followed by the number 13, which means to right-justify the number to 13 characters. Since the next character is a closing brace, this Entry and the next are now ready to create (and CurPos will be set to point to the next character at position 57). Entry[0] will be set to the address F_open (which starts with the instruction “StartDest=DestPtr” in order to remember the starting position to help with aligning), and three parameters 918 will be written starting at Entry[4] (these can be written as bytes if desired, but processing may be slightly faster if they are written as 32-bit integers—which is done in this case, since the 12 data bytes allow it). Therefore, Entry[4]=−5 (meaning parm 5); Entry[8]=2 (meaning two decimal places); and Entry[12]=0 (meaning use default rounding 522; this can be specified for all floating-point values being converted—if not explicity stated with a format-type option, the value 0 will be used as the default). EntryPtr will advance to the next position, and StartPos will be set to CurPos.

Entry #12: This Entry is intimately tied to the parameter used in the previous entry (parm 5). Since the ‘)’ specifier was identified in the previous entry, either a closing brace or a space must be written immediately after the formatted number; the CloseNum command does this (it inspects the local variable 914 ‘isSigned’ and will write a ‘)’ if negative or a “if positive). Entry[0] therefore will be set to the address of CloseNum. EntryPtr will advance to the next position. Note that in ngFormat( ) it is helpful if, when processing Entry #11 during formatting (and when processing all signed numbers of any type), a local variable such as ‘isSigned’ is set to 0 if the number is positive, or to 1 if negative; it can then be quickly inspected and the correct character will be written. Alternatively, a local variable 914 can be set to either the ‘)’ or the blank ‘ ’ character to be written at the proper position at the end of the number, thereby saving some time by eliminating some small if/then logic.

Entry #13: Entry[0] will be set to the address Align_right and Entry[4] will be set to 13. EntryPtr will then advance to the next position.

Entry #14: An open brace is found at position 57. The switch statement then sends control to ProcessMark (which during formatting will store the current position of DestPtr), which sets Entry[0] to the address Mark. The closing brace is found and CurPos and StartPos will be set to the next character (60). EntryPtr will then advance to the next position. The local variable MarkInProcess can be set to one to indicate that a position has been marked.

Entry #15: An opening brace is found at CurPos=63. Since StartPos=60, three literal characters must be copied. Entry[0] will be set to the address 962 CopyStr3 and Entry[4] will be set to StartPos. EntryPtr will advance to the next position.

Entry #16: Since the character after the opening brace is a digit, GetCommand( ) will receive control from the switch statement and will identify the value 6, followed by the string format type ‘s’. Since no other options are specified, this is a normal string copy, so Entry[0] will be set to the address Str and Entry[4] will be set to −6 (meaning parm 6). CurPos and StartPos will both be set to point to the character after the closing brace (both set to 67), and EntryPtr will then advance to the next position.

Entry #17: An opening brace is found at CurPos=70. Since StartPos=67, three literal characters must be copied. Entry[0] will be set to the address 962 CopyStr3 and Entry[4] will be set to StartPos. EntryPtr will advance to the next position.

Entry #18: Since the character after the opening brace is the letter ‘M’, ProcessMark( ) will get control. It will identify that the next character is a ‘>’ and the number immediately following is the value 19, meaning to right justify the block starting at the position saved in a prior Mark command. Since in this case there was a previous Mark command detected (when processing Entry #14, MarkinProcess was set to 1), Entry[0] will be set to the address Mark_right and Entry[4] will be set to 19. CurPos and StartPos will both be set to point to the character after the found closing brace (both set to 76), EntryPtr will advance to the next position, and MarkinProcess will be cleared to 0. If MarkinProcess had the value 0, that would mean there was no previous Mark command, so this Mark_right command would have been in error. In some embodiments where a matching Mark command does not exist, this command would then just be skipped; in others, a command to display an error message could be inserted at this position.

Entry #19: A closing brace ‘} will be found at CurPos=76; since StartPos has the same value, there are no literal characters to print. The switch statement then sends control to FoundClose ( ). This function 936 looks at the next character; if it is a closing brace, it is legal (because the immediately preceding character was also a closing brace) and means to write a closing brace literal; otherwise it's an error and it will be skipped over, or handled as one of skill deems best. In this case, it is legal, so Entry[0] is set to the address CloseBrace. Both CurPos and StartPos will point to the character immediately after the second closing brace (both will be set to 78), and EntryPtr will advance to the next position.

Entry #20: A null is found as the very next character. Since StartPos=CurPos, there are no literal characters to copy. Entry[0] will be set to the address Exit, and Table[4] will be set to point to the current position of EntryPtr. EntryPtr will then advance to the next position, which identifies the size of the table that has been completed. Table[8] will be set to the byte difference between EntryPtr and Table so that it records the size of the table.

The NG_FORMAT table 982 of this example now contains all commands 984 to format data exactly according to the format-command string. However, it is still appropriate to ensure 608 that all the commands 984 that require a parameter 918 will be able to access the proper position on the stack 920; at this point, each Entry with a parameter specifier needing to be adjusted has a negative value at offset Entry[4], allowing it to be easily identified and replaced with the proper stack-offset value. One method 608 to do so is shown below in the section “Method to Determine Parameter Position and Call-stack Size” (note that this section refers to some additional work done during each of the above steps where a parameter is being referred to). Once that is completed, a pointer 962 to Table is returned to the caller.

Method 608 to Determine Parameter Position and Call-Stack Size

In some embodiments, it is necessary to determine exactly where each parameter will reside in the stack for the ngFormat( ) command to execute successfully. In addition, if the StdCall calling convention is used, the ngFormat( ) command may need to know exactly how many bytes should be cleared off the stack. The following technical methods can be used to solve these issues; one of skill may however use other methods to accomplish the same goal.

The method here limits the ngFormat( ) program to handling 64 parameters, but it is easily extended by one of skill by using a larger bit size for the two variables ParmUsed and ParmSize. Two 64-bit integer variables (ParmUsed and ParmSize) are initialized to 0 at the start of ngParse( ). Each bit represents a parameter, with the first user parameter 1 being handled by bit 0, parm 2 handled by bit 1, and so on, with parm 64 handled by the last bit which is bit 63. Since the 32-bit embodiment of ngParse( ) is always aware that the first two parameters passed to it—the output buffer and the pointer 962 to the NG_FORMAT table—are 32 bits in length, it can reserve the bits to handle user parms 1 through 64. A clear bit (equal to 0) in ParmUsed means that that parameter was not used, and a set bit (equal to 1) means that it was used. A clear bit in ParmSize means the parameter is 32 bits wide, while a set bit means it is 64-bits wide. That covers all the possibilities expected with the current format specifiers listed above. Any parameter that is interpreted as being smaller than 32 bits is actually passed on the stack as a 32-bit-wide value; any parameter using a 32-bit type is, of course, assumed to take 32 bits on the stack; and any parameter using a 64-bit type is assumed to require 64 bits on the stack 920. Note that it is certainly possible for the user to specify a size that does not match up with the actual size. This is an error and should be corrected; see the “Testing and Debugging Issues” section below for more information about mismatched stack parameters and some ways to try to identify them.

When any parameter is identified in the format-command string (any parameter starting with an index), that index 832 is used to set the appropriate bit in ParmUsed to show that that parameter is used. One way to do this is with a command similar to the following (where Index is always 1 or greater):
ParmUsed|=(1LL<<(Index−1));
   Then, if the specific type is 64 bits (such as any parameters using the type ‘I’, ‘L’, ‘f’, or ‘F’—i.e., upper- or lower-case ‘L’, or upper- or lower-case ‘F’), the appropriate bit of ParmSize should be set in a similar manner:
ParmSize|=(1LL<<(Index−1));

When the parsing is finished and the Exit command is entered into the last Entry position, Entry[4] can be set to equal the size of parameters passed on the stack. Note that the size of parameters does not include the return address pushed on the stack by a call 544 statement, nor does it include the size of other items pushed onto the stack (such as the original value of the ebp register when creating a stack frame); one implementing the methods herein disclosed should take those into account when accessing any parameter on the stack and/or when setting up parameter offsets in the Entry table, or when restoring the stack upon completion and on exiting ngFormat( ). The size of parameters is first set to BytesOnStack=8 (representing the buffer and the NG_FORMAT table, the first two parms passed to the ngFormat( ) command which are each 4 bytes wide), then the size of the other user parameters will be added to it. The most-significant set bit of ParmUsed tells us the highest index used for local parameters; for example, if bit 5 of ParmUsed is the highest set bit, that means that Index=6 was the HighestIndex expected, meaning that 6 user parameters are expected to be passed onto the stack. Since the default size of each parameter is four bytes (32 bits), multiply that number by 4 and add that to BytesOnStack, i.e., BytesOnStack+=HighestIndex*4.

If the value of ParmSize is 0 (that means no bits were set), all the parameters were 32 bits wide and BytesOnStack is correct. But if it is not 0, each bit must be inspected, and the value 4 must be added to BytesOnStack for each set bit (since that signifies that that specific parameter was 4 bytes wider than the default). The total size of bytes on the stack has now been determined, based on the key information retained in the original format-command string. To finish, then, set Entry[4] (of the last Entry, which is the Exit command) equal to the final value of BytesOnStack.

One of skill would acknowledge that when implementing a 64-bit version of the present invention, the method to access 610 the correct parameter could differ from the 32-bit methods described herein, e.g., some parameters could be placed into general-purpose registers, some could be pushed on the stack, and some could be placed into one or more XMM# registers. One of skill could consult technical information for the hardware/OS combination targeted to determine an appropriate method to access 610 each specific parameter. In any event, the methods disclosed herein can be helpful in creating a proper solution for accessing the correct parameter 918 at the correct time in a 64-bit execution environment. Of course, in an assembly-language environment, the developer could model a 64-bit solution similar to that detailed in the present disclosure, modified to fit the 64-bit environment with 64-bit parameters the default size passed on the stack.

If parameters wider than 64 bits are expected on the stack, ParmSize could be adjusted appropriately. For example, if one or more parameters could be 128 bits wide, then ParmSize could be made 128 bits wide instead of 64 (i.e., 16 bytes long instead of 8), and then two bits could be used to indicate the size of each parameter (64 parameters times two bits each equals 128 bits), and then 32-bit, 64-bit, and 128-bit parameters could be tracked. If one of skill wanted to allow for more parameters, say up to 128 parameters, then both ParmUsed and ParmSize would be again resized accordingly (doubled in that case). Of course, the method of adding extra bytes for any parameter larger than the default, when using ParmSize, would be adjusted to handle different size options based on two bits for each parameter instead of one (which allows up to four possible sizes).

In some embodiments, lookup tables can be used to determine the highest set bit of ParmUsed, and to determine the values to add to BytesOnStack based on each byte of ParmSize. In any event, one of skill would choose the appropriate size of width of ParmSize to achieve the desired result of being able to identify the size of each user parameter.

When setting up the parameter index that identifies the correct value to place at Entry[4] for each entry expecting a parameter index (or offset, depending on the implementation), and which Entry offset currently contains a value equal to the negative of the specified index 832, one of several different methods could be used consistently to allow each Entry's command to identify the exact position of the parameter on the stack, taking into account the size of each parameter below it on the stack. This requires intimate knowledge of how variables are passed on the stack, as part of a calling convention 992.

As an example, assume the following code snippet, and assume that p1 is a 32-bit string pointer, p2 is a byte (32 bits on stack), p3 is a 64-bit signed integer, p4 is a 32-bit float, p5 is a 64-bit double, and p6 is a 16-bit short (32 bits on stack):
stdcall ngFormat, buffer, table, p1, p2, p3, p4, p5, p6 al: mov [SizeString], eax

The parameters 918 are passed on the stack in reverse order, and when the ngFormat( ) command is called 544, the address of the very next instruction is passed on the stack and then ngFormat receives control. Assuming ngFormat sets up a normal stack frame 908 using the ebp register 206, the stack 920 will look something like this:

| Stack Addr | Data | To access: |
|---|---|---|
| 6F390 | [p6] | [ebp + 44] |
| 6F38C | [p5 hi dword] | [ebp + 40] |
| 6F388 | [p5 lo dword] | [ebp + 36] |
| 6F384 | [p4] | [ebp + 32] |
| 6F380 | [p3 hi dword] | [ebp + 28] |
| 6F37C | [p3 lo dword] | [ebp + 24] |
| 6F378 | [p2] | [ebp + 20] |
| 6F374 | [p1] | [ebp + 16] |
| 6F370 | [table ptr] | [ebp + 12] |
| 6F36C | [buffer ptr] | [ebp + 8] |
| 6F368 | [al addr] | [ebp + 4] |
| 6F364 | [orig ebp] | [ebp + 0] <== ebp |

The base-frame pointer (ebp) 962 will remain pointing at location 6f364 on the stack (stack addresses shown in hex; offsets from ebp shown in decimal; actual values can vary as is known to those of skill) even if other values are pushed on the stack later; it can therefore be used to access any of the parameter variables. For example, to access parm 1, the address [ebp+16] is used, since parm 1 is 16 bytes (0x10 in hexadecimal) above the value of ebp. Likewise, parm 6 would be addressed as [ebp+44].

In this context, it is useful to convert each parameter index stored in the NG_FORMAT table into an offset based on the ebp register 206. This is simpler to do after the table has been completed because at that time the entire format-command string will have been parsed, ParmUsed and ParmSize will be complete, and each index that needs to be updated is stored as a negative value in the table.

To convert each index 832 into an offset, here is one useful method. Create a 64-entry array 950 of integers, say “int Offset[64];”. Initialize Total with the starting value 16, which is the ebp offset used to access parm 1, and set the first value in the Offset array 950 to that value, i.e., Offset[0]=Total. For the next value, we need to add to Total the size of the parameter we just handled, since the next parameter starts immediately where the last one ended. Look at the first bit of ParmSize, which tells us the size of parm 1; if it is set, add 8 to Total, otherwise add 4, then store that amount into the next slot of the Offset array, i.e., Offset[1]=Total. Continue this process to fill up the Offset table; it's OK to stop after the Offset entry representing the maximum index has been updated.

Then, with the Offset array containing the appropriate offset values for each parameter, a simple loop can be used to go through each Entry in the table (except the last), and for each Entry where there is a negative value at Entry[4], this is a value that must be replaced with a proper offset from Offset table. To do this, obtain the value at Entry[4], negate it (this makes it a positive number), subtract one from it (since the value for parm 1 is stored at Offset[0]), then use that value as the index into the Offset array to select the replacement value and then store it at Entry[4]. When this has completed, the NG_FORMAT table is ready to be used to format data.

Some Methods to Increase Parsing Speed

In some embodiments, when a digit is encountered in the string immediately after an opening brace, GetCommand( ) will be called 544 to process all possibilities when an opening brace is found. If desired, a separate GetDigitN( ) function 936, 1032 could be called, one for each possible digit, saving a tiny bit of execution speed. For example, GetDigit1 would know that the first digit has the value ‘1’ and would then start looking at the next character 885 until all index characters are converted into the proper binary value. Otherwise, the more-generic GetCommand( ) function will determine the index value by scanning until no more digits are found, and will use an ascii-to-binary method (such as setting an initial cumulative index value CumIndex to zero, then for each digit found, multiplying CumIndex by 10 (or using a shift method instead of multiplication) and adding the value of the found digit minus 0x30) to convert the decimal digits into a binary number.

Some compilers will convert the above code for the switch statement into many if/then/else statements, but that is a very slow sequence of code statements to execute. A much faster method would be to use 398 a jump table FindIndexJumpTable (some compilers do something similar to this; some are better than others). Such a table (implemented in assembly language, for example) could have 256 entries, each 32 bits in size (thus requiring 1 k of memory) to cover all possible characters 885, as it would be accessed using the index of the 8-bit character at OrigStr[CurPos]. The entry representing any undesired (or unexpected) character would be set equal to the code address that would handle the default (such as ProcessErr above). Otherwise, each entry would have the proper address to handle transfer of code when the character represented by that index is found.

In some embodiments, the high bit of each character 885 is never used; it could therefore be cleared before using FmtStr[CurPos] as the index into the table, making the required table size only 512 bytes. In other embodiments, where an even smaller table is desired, an interim table could be first accessed to convert a character into an index into a smaller table. Each of these methods using 398 smaller jump tables requires extra overhead that could slow down execution, unlike the full 256-entry tables.

In some embodiments, several jump tables 232 are used depending on the context. One table can be used to identify the first digit, and a second different jump table could be used to find the other digits until format control-string processing has finished. A technical benefit of using two tables to process indexes, for example, is that a first table could quickly initialize a cumulative total with a value based on the first digit found, and a second table could then more quickly process succeeding digits in the format string. Note that every time a succeeding digit is found, the cumulative total is first multiplied by 10, and then the newest digit is added to that total (after first subtracting the value 0x30 from it). But when the newest digit is ‘0’, there is nothing to add, so this second jump table could isolate the ‘0’ digit and save execution time by not adjusting and then adding its value.

In practice, this two-table method is several times faster than others because it uses 256 entries to handle the initial digit, and another 256 entries to handle subsequent digits, so that it handles all possible 8-bit numbers. It can still be made faster, in fact, by having the second table process each found digit in a way unique to it (rather than generically, where 0x30 must be subtracted from it to combine it with the cumulative total), which would remove the need to subtract 0x30 from the character (e.g., when the character ‘8’ is found, the second jump table could jump to a routine that multiplies the cumulative total by 10 and then adds 8 immediately). The Listing_{—}6058-2-3A.txt computer program listing appendix file, incorporated herein by reference, includes ngAscToInt.Asm, which is part of one embodiment implementation that quickly picks digits in a number in a string and converts the ascii form into an unsigned integer; note that the function therein uses a very fast shift method that is faster on many CPUs than multiplying by 10.

One of skill could modify the teachings above to process signed integers; a jump point could be created to handle a minus ‘-’ sign at either the front or the end of the number. In addition, each operation could also be tested for overflows with code added at the .Next0 and the .Next1to9 sections. In addition, one of skill can extend this to handle ASCII decimal strings containing floating-point numbers, and/or any 64-bit or larger number whether integer (signed or unsigned) or floating point, and/or numbers that include thousands separators and currency signs. The core of this method does not use any ‘if’ statements, and is very fast and clean (another technical benefit, since clean coding enhances code correctness, portability, and adaptability). Additionally, one of skill can readily adapt these methods to handle double-byte characters.

Testing and Debugging Issues

Bugs in software happen. When striving for faster execution, as with inventions described in this present disclosure, complexity can increase, resulting in more time to develop, resulting in more and different kinds of bugs, which leads to additional time needed to test and debug the process implementation. But the tradeoffs going forward can be worth the extra pain. The following is a list of some aids and suggestions that can help discover potential bugs in using the technology disclosed herein. This is not to say that these processes are inherently prone to bugs; they are not. But some of the methods disclosed herein can be outside the range of what many skilled programmers have dealt with in the past, particularly those otherwise skilled programmers who are relatively inexperienced with “assembly language programming” (a term which as used herein includes, e.g., ARM processor programming, Intel® x86, Pentium® or Core® processor programming (marks of Intel Corporation), Motorola 680x0 processor programming, Microsoft MSIL language programming, bytecode programming, IBM System/360 low-level programming, and programming in languages processed by the MASM or FASM tools, to name some of the many possible examples). “The Intel® CPU” and “the Intel® chip” in a given discussion refer to any Intel-branded CPU having the register(s), instruction(s), and/or other characteristic(s) implicated in the discussion per the understanding of one of skill.

When testing 566 an embodiment of the technology described in the present disclosure, a problem that many users could encounter is a mismatch between the width of one or more parameters declared in the format string compared to the actual width of the parameters as they appear on the call stack. This can cause a program to crash, or at least misbehave by displaying incorrect results. When a function is called 544, one or more variable parameters can be pushed onto the stack. When the function exits, the stack should normally be cleared of the exact number of bytes 1056 pushed onto the stack as parameters to that function—no more, no less.

For example, Microsoft Windows® architecture programming will generally use one of two calling 544 conventions: ‘Cdecl’, where the caller is responsible for clearing the stack (this makes it easier to pass a variable number of arguments, as is desired in implementing the ngFormat( ) function); and StdCall, where the callee clears the stack before returning control back to the caller. Although StdCall is a bit faster, Cdecl can minimize stack-based errors when using functions that can receive a variable number of parameters.

This stack-mismatch problem can surface when implementing portions of one or more of the present inventions because the ngFormat( ) command can take a variable number of parameters. One of skill using C++, for example, can use the stdarg library that uses the va_list type, plus the va_start, va_end, and va_arg macros, to help with a function that is to handle variable-length parameter lists (a search on the Internet for “C++ variable number of arguments” will provide an ample list of instructions suitable for aiding skilled C++ programmers in using variable-argument functions). Alternatively, one of skill in assembly language can directly access any argument pushed on the stack when using such a function—with less execution overhead, but with potentially more risk if the actual total size of the parameters passed on the stack is not exactly equal to the expected total size.

Another problem can arise when the size (and/or exact position) of a variable parameter is not exactly what was expected, or when the destination buffer is not sufficiently large to hold the output (which can often happen due to the sizes, or the order, of the parameters getting mixed up). This problem can be especially difficult when using pointers 962 to strings (as indicated by the ‘s’ format type, for example); if the offset is off even by a little, the pointer to the string that the function would then try to use would be incorrect and could cause memory-access errors, or could result in garbage that would then be copied into the destination buffer, possibly overwriting it and other parts of memory.

One should be very careful when dealing with functions that accept a variable number of arguments. Therefore, it would be helpful to provide some debugging 566 tools that can aid a developer in implementing this technology. The following tools can help users of the technology disclosed in the present document eliminate potential problems when using ngFormat( ) or other functions that accept a variable-length list of parameters.

int GetFormatTableExpectedParameterSize(NG_FORMAT table)

This function 1034 will inspect a given NG_FORMAT table and return the total size, in bytes, that are expected to be passed on the call stack as parameters when using the table. Note that the header of the NG_FORMAT table contains a 32-bit pointer or index to the last entry (starting at offset 4 of the header), and the number of bytes expected to be passed on the call stack for this function is located in the data area of that last entry (at Entry[4]).

For example, assume the following format string is compiled by ngParse( )
NG_FORMAT *compiledStr;
char *formattedStr;
compiledStr=ngParse(“Item: {1s}, Count: {2d}, Val: {3m}, Cost: {4F.2}”);
ngFormat(Buffer, compiledStr, desc, index, value, cost);

In use, the NG_FORMAT string pointed to by ‘compiledStr’ will expect 28 bytes of data to be passed on the call stack: 4 bytes for the buffer pointer, 4 bytes for the pointer to the NG_FORMAT table, 4 bytes for a string pointer, 4 bytes for a 32-bit integer, 4 bytes for a 32-bit float, and 8 bytes for a 64-bit double (as specified by the ‘F’ in the format-command specifier “{4F.2}”). The following command:
int count=GetFormatTableExpectedParameterSize(compiledStr);
   would return the value 28, which is the expected size for all the parameters and which is stored in the last Entry of the table.

void DetermineEmptyStack(void)

This is a little function 1036 that simply stores the value of the esp register into a global memory variable (say, ‘EmptyStackEspBaseline’) when no parameters are passed to the function. This function would be run, with no parameters, prior to running the GetActualParameterSize( ) function below. Here is one implementation:
; Declare variable in data area . . .
EmptyStackEspBaseline dd 0
; Declare function in code area . . .
DetermineEmptyStack:
   mov eax, esp
   mov [EmptyStackEspBaseline], eax
   ret

This saved value ‘EmptyStackEspBaseline’ is then used by the other debugging tools below to identify the size of passed parameters. Before the GetActualParameterSize( ) function (described below) can be used, this DetermineEmptyStack( ) function would be run first to identify the value of the esp register, which can then be used as a baseline for determining the exact size of any parameter type (or groups of parameters together). Note that both DetermineEmptyStack( ) and the various GetActualParameterSize( ) functions below must be run from within the same scope (i.e., from the same block of the same function); otherwise, the information returned could be incorrect.

int GetActualParameterSize( . . . )

This function 1038 will return the total size of all parameters passed to it on the stack, no matter the type nor the size nor the number of the parameters. It will return the value of ‘EmptyStackEspBaseline’ minus the current value of the esp register, which will be the total size of the parameters that the compiler pushed on the stack when calling 544 GetActualParameterSize( ) This will work for any number of parameters of any kind (in native C++ code). One could take the parameter list used for the ngFormat( ) function and use it as the parameter list for this GetActualParameterSize( ) function to see the exact size that will be created when the function is called from within the high-level language being used, and then that can be compared with the value returned by GetFormatTableExpectedParameterSize( ). To see the size of any single parameter, use it as the only parameter to this function. Remember, though, that the DetermineEmptyStack( ) function must be called 544 first for the function to work properly; if it is not called first, any call to GetActualParameterSize( ) will likely cause a crash; it should therefore be used carefully. The Listing_{—}6058-2-3A.txt computer program listing appendix file, incorporated herein by reference, includes one implementation of GetActualParameterSize( ).

Note that web addresses, hyperlinks, URLs, reference to internet searches, and the like herein are provided for illustration only and are not intended to incorporate required material into the present document. Web addresses are also modified, e.g., by replacing “.” by “dot” in order to make it clear that live links are not intended.

Description of Date/Time Structures 990

time_t

www dot cplusplus dot com/reference/clibrary/ctime/time_t/ explains: “It is almost universally expected to be an integral value representing the number of seconds elapsed since 00:00 hours, Jan. 1, 1970 UTC. This is due to historical reasons, since it corresponds to a unix timestamp, but is widely implemented in C libraries across all platforms.” There is a Y2038 problem: en dot Wikipedia dot org/wiki/Year_{—}2038_problem. This is the format for st_mtime, st_atime, and st_ctime as per sys/stat.h include file.

SYSTEMTIME

msdn dot microsoft dot com/en-us/library/tc6fd5zs.aspx

struct tm

www dot cplusplus dot com/reference/clibrary/ctime/tm/ Structure has nine elements (all integers): The tm structure contains nine members of type int, which are:

1 int tm_sec;
2 int tm_min;
3 int tm_hour;
4 int tm_mday;
5 int tm_mon;
6 int tm_year;
7 int tm_wday;
8 int tm_yday;
9 int tm_isdst;

The meaning of each is:

| Member | Meaning | Range |
|---|---|---|
| tm_sec | seconds after the minute | 0-61* |
| tm_min | minutes after the hour | 0-59 |
| tm_hour | hours since midnight | 0-23 |
| tm_mday | day of the month | 1-31 |
| tm_mon | months since January | 0-11 |
| tm_year | years since 1900 | |
| tm_wday | days since Sunday | 0-6 |
| tm_yday | days since January 1 | 0-365 |
| tm_isdst | Daylight Saving Time flag | |

The Daylight Saving Time flag (tm_isdst) is greater than zero if Daylight Saving Time is in effect, zero if Daylight Saving Time is not in effect, and less than zero if the information is not available.
*tm_sec is generally 0-59. Extra range to accommodate for leap seconds in certain systems.
See also strftime( ): www dot kernel dot org/doc/man-pages/online/pages/man3/strftime.3.html (uses tm struct)

FILE_BASIC_INFO, FILETIME, and LARGE_INTEGER msdn dot microsoft dot com/en-us/library/aa364217(v=vs.85).aspx Each time element is a LARGE_INTEGER (union, basically a 64-bit integer). See also msdn dot microsoft dot com/en-us/library/aa364226(v=vs.85).aspx which explains: “All dates and times are in absolute system-time format. Absolute system time is the number of 100-nanosecond intervals since the start of the year 1601. Can handle 2544 years (from 1601 to 4145).”

FILETIME structure: Same as given for FILE_BASIC_INFO. See msdn dot microsoft dot com/en-us/library/ms724284.aspx

MS-DOS Date and Time

msdn dot microsoft dot com/en-us/library/ms724247.aspx File times (NTFS): msdn dot microsoft dot com/en-us/library/ms724290.aspx

Handling Signs for Numbers

One of the technical challenges in compiling the format string and thereby creating the NG_FORMAT table is handling 496, 488 negative numbers versus their positive counterparts. Normally, positive numbers are displayed with no sign before or after the number, whereas negative numbers will have a minus sign immediately in front of the number. Sometimes, however, a space is desired immediately at the end of each positive number so that it will line up in columnar format with negative numbers having a trailing minus sign. Sometimes it is a user's preference to always have a plus sign or a minus sign immediately before the number, and sometimes immediately after. Sometimes it is preferable to use parentheses around negative numbers, in which case it may also be desirable to include a space at the end of positive numbers so they line up with negatives in the same column, or not.

In other words, sometimes there will be a prefix character in front of the number, other times not; then the number will be displayed; then an optional post-fix character may be displayed. In all of these cases, as long as the prefix and post-fix characters are properly displayed, the number will be displayed properly when treated as though it were a positive number (with the exception of rounding negative numbers, which is handled differently as explained elsewhere above).

In some embodiments, a small prefix function 1040, 936 will first be called to decide, depending on the sign of the number and the specified rule (default or set by user preference), whether to write a prefix character, and to also make sure the number is positive (converted from negative as necessary). Then a function 936 to format the unsigned version of the number will be called. Then, if there are any post-fix characters required, another small post-fix function 1042, 936 would be called to write the needed character based on both the rule and the sign of the number (when no post-fix character is required, no function need be called at that point).

There can be multiple versions of the prefix function 1040 to reduce the number of if/then statements. For example, when the rule always requires either a plus or minus sign before the number, a function ngltoa_Required could be called to write a plus if the number is positive and load the number into a local unsigned variable 914 or register 206 (but if it's negative, write a minus sign and make the number positive and store it in the local unsigned variable), and then increment DestPtr before returning. Or when the rule requires a leading minus if negative but nothing if positive, a function ngltoa_Minus could be called to do the following: if the number is negative, write a minus sign, increment DestPtr, set a local variable to the positive version of the number (localNum=0−Num); if positive, set localNum=Num. A similar ngltoa_OpenParenthesis function could be called if negatives are to be enclosed in parentheses. Another ngltoa_None could be called when no leading sign is used for either negatives or positives (but negatives will have a trailing minus sign).

Similarly, there can be multiple versions for the post-fix function 1042. When no post-fix character is needed, no function is called. If the rule requires a minus sign for negatives and a space for positives, a WriteSpaceMinus function could output either a space or a minus sign depending on the number's sign, increment DestPtr, then return. If the rule requires a closing parenthesis for negatives and nothing for positives, a WriteNothingCloseParen function would check the sign of the number: if positive, it would do nothing, otherwise it would output a closing parenthesis, increment DestPtr, then return. A WriteSpaceCloseParen function would write a space for positives and a closing parenthesis for negatives, increment DestPtr, then return. Note that separating the formatting of the number from the prefix and the post-fix operations is a technical approach that helps enable precise and fast formatting. Similarly, a WriteMinus function could be called to write a minus sign after negatives, and nothing after positives. Separating these prefix and post-fix operations can be an effective way of simplifying the implementation of methods disclosed in the present document. (Note that in some embodiments, these functions won't return to the caller; they may instead jump to the next function if using jump tables; some may simply flow through to the next function if the commands are stitched or if they are immediate headers to the main number-conversion function.)

In some embodiments, the prefix functions 1040 would be created as different headers for the core function, each with its own jump location, each header code path then linking to the main number-formatting functions without having to return to a control loop. For this to work, the code at each header location should load the number appropriately, handle any prefix required and set any needed flags (and convert the negative to a positive number if needed), ensure the number is available in an unsigned variable (or in a register), then jump to the core routine to convert the unsigned number to the proper display format. This strategy makes it possible for the parsing process to select the specific function 936 needed to handle both the prefix-character and formatting of the number as demanded by the instructions in the format string. During the parsing phase, the proper header address for the appropriate number-conversion function 936 can be loaded into the table Entry, along with a local data parameter pointing to the proper variable parameter 918 to be processed. Once the number has been formatted, if the rule requires a possible post-fix character, a separate Entry would be created to call the proper post-fix function; otherwise, no Entry is needed for a post-fix function.

The Listing_{—}6058-2-3A.txt computer program listing appendix file, incorporated herein by reference, includes sample code that shows how one could set up the different header entry points in a number-conversion function using assembly language.

During the parsing 580 operation, once the appropriate prefix rule has been determined for the number (assuming, as in this case, the number is a 32-bit integer), the appropriate command address will be inserted at Entry[0]: if it's a normal signed integer, use ‘ngltoa_Minus’; if a plus sign or a minus sign is always required, use ‘ngltoa_Required’; if parentheses are used to indicate negative numbers instead of a single minus sign, use ‘ngltoa_Open’; if a trailing minus sign is used at the end to indicate negative numbers, use ‘ngltoa_NoPrefix’; and if the number is unsigned, use ‘ngltoa_Unsigned’. Other types of headers could be created and used similarly, based on other desired formatting and the sign of the number. This will take care of both handling the prefix character (if any) and then converting the binary number into the appropriate string. Note that when this method of headers is used, similar versions of these headers should precede every number-format method so that the prefix and post-fix signs for all sizes and types of numbers can be handled in a consistent manner. If the specified options require any processing at the end of the number, another Entry command will be created that will call the appropriate post-fix function as described above.

Additional Technical Aspects

One might think that a printf-type command is useful only when using mono-spaced fonts 884, but that is incorrect. No matter what type of font is used, data must still be formatted. In the case of variable-spaced fonts 884, the spacing between the words or elements of the formatted string—indeed, the spacing of each and every character of the string—may be exactly decided based upon the specific font chosen, its size, and the screen or printer (or other output) device on which the string is to be displayed. But the various data elements must still be formatted before the space-sizing function can be called. Dates (e.g., “Dec. 25, 2012” or “2012-12-25”), times (e.g., “4:30 pm” or “1630 hours”), IP addresses (e.g., “192.168.0.5” or “192:168:000:005”), numbers (e.g., “(45,567,567.99)” or “−45567567.9857”), and other elements must still be formatted.

It would thus provide technical benefits to be able to create 302 a formatted display string, and to also simultaneously (e.g., without requiring an additional procedure call) create 612 an index into that string that could be used to quickly identify the position 1044 and length 1046 of any key formatted element 1048. This could further reduce processing time in preparing formatted elements to be written to an output device. In one embodiment, a function ngFormatIndex( ) 1050 could be called that would return both a formatted string and an index into the formatted elements.

Consider the following code snippet:

void sampleFormatIndex( ) {

char *command = ″{I+}{1s}:{T10}{I+}{2=time_t32\hat{ }Mmm” +

“. \hat{ }d, \hat{ }yyyy}{I−} don't index this {I+}{3}″;

char *item = ″Birthday″;
time_t timeNow = time(0);
int num = 9876;
NG_FORMAT *fmt = ngParse(command);
int *index;
char buffer[200];
int totalLen = ngFormatIndex(index, buffer, fmt, item,

timeNow, num);

// This would create the following string:
// ″Birthday: Sep. 27, 2012 don't index this 9876″
// The following index would be created (three

elements: ptr, then length):

| | | |
|---|---|---|
| // Ofs | Len | String |
| // 0 | 10 | ″Birthday: ″ |
| // 10 | 13 | ″Sep. 27, 2012″ |
| // 41 | 4 | ″9876″ |

}

When parsing 580 the format-command string 942 in conjunction with function such as ngFormatIndex( ) 1050, each time the {I+} command is encountered, an entry is made into the index array 950 with the current position of DestPtr (alternatively, this can be the offset of that position relative to the start of the output string). This operation can be signaled and initiated by a StartNewindex command in the NG_FORMAT table. When the {I-} command is encountered, the size of that segment of the output string can be updated in the index table. Or when a new {I+} command is encountered when a current index command is active, the size can also be updated and then a new indexing operation registered (by creating a new entry with the current position of DestPtr) and started. In some embodiments, a {I} command will be interpreted to mean that the immediately succeeding formatting command is to be indexed, with the indexing completing as soon as that format command has completed; in this case, a StopAndRecordIndex command would be inserted into the NG_FORMAT table as soon as the last command needed to complete the formatting command has completed.

If-Less Processing as a Technical Mechanism

When parsing 580 a format string, each character 885 is inspected, and a specific action is taken depending on the value of the character. If-then statements can be used 322 to evaluate each character. For example, according to some embodiments, a format string is initially scanned to identify the first opening brace T (used to identify a format command). If the current character is not a brace, the next character must be looked at. If it's a closing brace, the immediate next character would also be scanned to determine if a literal closing brace should be output (if not, this would be an error that must be handled as explained in this present disclosure). And if it's a null, the end of the string has been reached and the process must exit appropriately.

The code to handle such can be implemented in different ways. One of skill could implement this logic (software 136 and/or hardware 120) using 342 ‘while’ loops, ‘do-while’ loops, ‘switch’ statements, ‘if’ statements 322 with goto statements, and/or by using other methods. Technical tradeoffs 902 exist. When some conditions are more likely than others to occur, handling such more-likely conditions first can speed up the process. When there are very few conditions to check, if-then-else processing 322 can be very fast, but the jump-table 232 solution quickly beats it (differences will be found with different CPUs, but the trend shown below should still hold). Various compilers will treat ‘switch’ statements differently once the number of comparisons exceeds some threshhold. Some may always convert the multiple cases of a switch statement to if-then-else statements; some may change to a binary-search method rather than normal if-then-else statements after a threshold number of conditions; and some could use 398 a true jump-block style.

When there are many conditions to test for, a program can quickly slow down with if-then-else processing 322. Consider implementing an embodiment of the present invention where a valid character must be found immediately after finding an opening brace. Any of the following 17 characters can require that a unique action be taken when encountered (a null character, which cannot be displayed as a single character below, is considered included in the list):
{01234567891MTW}
   Any of the following 62 characters could be valid depending on implementation details (some are valid only in certain situations, making the handling even more complex):
0123456789cCsSwjJkKdDuUlLbBeEoxXyY< >̂%,+($.−)mMfFgG*pPITW={ }
   (There is a space character after the minus sign, which is intentional since it is a valid character. A null character is also included, but cannot be displayed.)

One of skill would acknowledge the potential difficulty of handling the last situation shown above. A very large series of if-then-else statements could be chosen 322, or a switch statement could be created (either of which could be done by one of skill). In some embodiments, a jump table (as shown further below) 232 could be created to handle the flow.

In many situations it is difficult to determine the likelihood of occurrence of any given character, and so it may be difficult to fine-tune a series of if-then-else statements to run fast in all situations. In contrast, however, a jump table 232 is always optimized because it acts immediately upon each and every possibility through a very fast jump 398 directly to the appropriate code.

In some managed code 928 environments where the format-command string is an immutable string, a null character 1052 may never be encountered. Since the null has traditionally been placed after the valid characters of a string (in native code 930 environments), the position where the null would normally exist is considered an invalid index, and some managed code environments automatically detect and enforce index-bounds checking for security or other reasons. Therefore, at each character, and just before trying to inspect that character, the code should first determine if it has passed the last valid character in the string 940 and then, if so, finish processing (a loop could be constructed that runs from the first to the last character, preventing any attempt to inspect beyond the last valid character of the string).

In some embodiments where immutable strings are used as format-command strings 942, it could be determined 496 that some special character that is not currently a valid character used in a format string (such as a tilde ‘˜’ character, or two such characters in sequence) would signal the end of the string. Such an implementation could speed up processing the string without requiring the implementer's code to test the current position each time to see if the end of string has been reached (although in some managed implementations 928, the underlying code that is inaccessible to the programmer will always enforce such a test and could therefore also slow down processing; and in other managed implementations, the underlying code can omit the end-of-string testing and speed up when it has identified a loop that will not go beyond either the first or last character of the string). When possible, one of skill may have a faster implementation by selecting a null-terminated string type (or character-array type) that would bypass an enforced end-of-string check at each character position of the string, and/or by bypassing a mechanism that requires checking the bounds of an index.

Testing 566 an if-then-else block vs. a switch-statement 1054 block vs. an assembly-language jump block produced the following results. Both the if-then-else and the switch blocks were built with Microsoft Visual Studio® Professional 2008 C++ (mark of Microsoft Corporation) and compiled with optimizations on; the jump-table version was built with FASM. Ten million iterations of each test were performed. For each test, a 31-character null-terminated string 940, 942 was parsed which had 22 target characters that would be acted on when all 44 conditions were tested (none would be found for the first test, but more would be considered as the number of conditions increased). The numbers below are the average of three tests for each scenario, expressed in seconds. A Hewlett-Packard HDX16 Notebook PC (marks of Hewlett-Packard Development Company, L.P.) with a 2.66Ghz Intel® Core™ 2 Duo processor, (marks of Intel Corporation) and 32-bit code running on 64-bit Vista® Home Premium operating system (mark of Microsoft Corporation), were used for the test:

| # Conditions | If-then-else | Switch | ASM Jmp Table |
|---|---|---|---|
| 2 | 0.707 | 0.593 | 0.359 |
| 4 | 1.284 | 1.004 | 0.619 |
| 8 | 2.085 | 0.972 | 0.655 |
| 16 | 3.916 | 1.009 | 0.635 |
| 32 | 7.738 | 1.243 | 0.889 |
| 62 | 12.075 | 1.497 | 1.149 |
| 62 (no jumps) | 13.478 | 0.702 | 0.328 |

Times generally increase as more conditions are tested, since more jumps will be taken as more character tokens are recognized and acted on. The If-then-else block is also highly sensitive to the number of conditions. The Switch block is not as sensitive, but execution time for the optimized VS C++ does still increase due to the number of items processed; it generally requires 40% to 65% more time than the ASM Jmp Table method. The ASM JmpTable block shows strong consistency, and is generally affected only by the number of jumps 398 actually taken, not by the number of items (conditions to be tested) in the table. Compare its times for checking 2 conditions where no jumps are taken, with the last line of 62 conditions, also where no jumps are taken (for this last test, in order to test the impact of no jumps, the string was modified so that no characters in the string matched any of the conditions).

In some embodiments using jump tables 232, each function that receives control in the main loop will return to the “caller” when finished via a jump 398, as shown in an assembly-language code snippet in the Listing_{—}6058-2-3A.txt computer program listing appendix file, incorporated herein by reference. Each 32-bit address label after “.MainLoop” is included in the table named PJmpTable table at its appropriate position based upon the ASCII value of the character or digit, i.e., “.Charls0” is at offset (0x30*4); “.GotMinus” is at offset (0x2d*4); and so on. All unused slots (for all characters that are ignored) would be initialized to the value of the address “.MainLoop” so that each of those characters is skipped.

The example shows how the code used to produce the timings under the “ASM Jmp Table” column above was structured. But this can be substantially improved again. Rather than having each code segment jump back to the caller, it can grab the next character and jump to the appropriate destination, just like the main loop, and avoid additional overhead, thereby doubling the speed as per test results by Eric J. Ruff. When 62 conditions were tested, and where control is always passed back to a control loop, the results listed above reported 1.149 seconds were required by the “ASM Jmp Table” method. But when each called 544 function jumped to the next code path instead of back to the control loop, the average speed dropped to 0.520 seconds. A code snippet in the Listing_{—}6058-2-3A.txt file, incorporated herein by reference, shows the changes for the first two commands (the same change would be made to all the commands).

Note that jump tables 232 can be stored either in the code or the data section (or in another specified section). One of skill should test to see which location works best. Each jump table will require 1 k (1024 bytes) of data to hold the jump addresses; the more jump tables used, the greater the chance of cache misses by the CPU. When implemented in assembly language, however, the code-size issues are usually minimized due to smaller code space required, compared to compiled high-level language implementations. When the tables are located in the code section close to the code that accesses them, they may be more likely to be in the CPU cache.

A code snippet in the Listing_{—}6058-2-3A.txt computer program listing appendix file, incorporated herein by reference, shows how the jump table for the above examples was created, shown using FASM syntax for both code and macro. Note that one of skill can use any appropriate method to create the jump tables; one should ensure that the proper code-path address are at the correct position in the table (in this example, it is based on the ASCII value of the character which is used as an index into the table). The table is first initialized to contain a default address for every character, which in this case is the .MainLoop. Then, for each character that will be handled by a particular code path, the position at that index is updated with the specific address to that path (in this example, a macro is used to store the code-path address (Addr) at the appropriate index (Pos) in the table).

Some Other Tables

Tables 216 can be used for both code processing and for converting values, which can be used as an index, into a display string. When formatting strings 210 according to a format-command string 942 as described herein, some embodiments use tables 216 for one or more of the following operations 614, 520, 616-624, 356.

Converting 614 a value into a binary string of 0's and 1's. A 2048-byte table of 8-character entries could have the complete string for each byte value from 0 (which would be “00000000”) to 255 (which would be “11111111”). When converting a value, each byte of the value can be used as an index into that table to quickly obtain the proper display string.

Converting 302, 520 a value into a hexadecimal string 940. A 512-byte table of two-character entries could have the proper display string for each byte value from 0 (which would be “00”) to 255 (which would be “ff”). When converting a value, each byte of the value can be used as an index into that table to quickly obtain the proper display string. Two tables could be used, one for lower-case and one for upper-case, depending on the desired output case.

Converting 616 from lower- to upper-case, or vice-versa. A 256-byte table for LowerToUpper would have entries for all possible characters from 0 to 255, except that all lower-case entries (from ‘a’ through ‘z’) would instead have the respective values ‘A’ through ‘Z’ to allow very fast case conversion. A similar UpperToLower table would have the entries for ‘A’ through ‘Z’ changed to ‘a’ through ‘z’. Note that such tables can also be effectively used to help with converting case in foreign languages; multiple tables may need to be created, but each table could be used to handle case conversion for one or more related languages.

Converting 618 a value into an octal string. Since each octal digit ranges from 0 through 7 and requires three bits, a pair of octal digits requires six bits and can represent numbers ranging from 0 through 63. A 128-byte table could be constructed with two-byte entries representing all possible octal pairs in that range (from ‘00’ through ‘77’) to help speed up conversion of a binary number to octal representation. Note that each six-bit group would need to be properly masked off and/or shifted so that it can be used as an index into the table to quickly convert that group into octal display.

Determining 620 the proper code path based upon alignment. When moving data, execution speed increases when the source is aligned. In 32-bit code, there are four possible alignments. A table with four code addresses, each pointing to the proper destination based upon the alignment found, can be used to speed up processing. This can be readily expanded to 64-bit (and larger) environments where 8-byte (and larger) alignment is required by using a table with eight (or more) code addresses.

Determining 622 the proper code path based on the byte position of a 0 in a register. When a 0x00 byte is found using multi-byte techniques disclosed in the present disclosure, a fast BSF command (operated on the register or memory location containing the bits that identify found 0x00 bytes) will identify the bit offset of the first set bit indicating the least-significant byte containing the 0x00. That bit offset then becomes an index into a 32-entry jump table: the first eight entries jump to the code path that handles the case where a zero byte is found in the first byte; the next eight entries are used where the zero is the second byte; the next eight entries are used where the zero is the third byte; and the remaining eight entries are used where the zero is the fourth byte. Eight entries are used because different algorithms 1074 could use a different specific bit to indicate a zero (in one method described in the present disclosure, the high bit of each byte would be used). For 64-bit environments (and larger-bit sizes), this can have an even bigger speed impact (64-entry tables, or larger for larger-bit sizes, would be required).

Counting 624 the number of set bits in a byte. A table of bytes, shorts, or integers (one of skill can select the desired size) would contain the number of set bits for every value from 0 (which has 0 set bits) to 255 (which as 8 set bits). This table could help in scenarios where the number of set bits needs to be quickly determined.

Determining 356 the leading set bit 810 in a byte. A table of bytes 1056, shorts, or integers (one of skill can select the desired size) would contain the bit index of the leading bit for every value from 0 to 255. For example, for the value 83 (which has the bit pattern ‘01010011’), the table would return the value 6, since the leading bit is at bit index 6; the value 1 (which has the bit pattern ‘00000001’) would return the value 0; and the value 0 (which has the bit pattern ‘00000000’ and therefore has no leading bit) would return a value of −1 to indicate no leading bit. This table could help in scenarios where the number of set bits needs to be quickly determined, and/or where the BSR or other bit-identifying CPU function is not available or is otherwise not used.

A Stitching 604 Algorithm 1074 and Use of its Results

In some applications, a very fast and stable method of creating format strings 210 is needed where it is desirable to have a custom formatting solution 204 that runs from beginning to end with no unnecessary calls or jumps to save as much time as possible. In fact, the present invention can be used to piece together sections of code in the exact same sequence as would be done by using a table; however, in this method, the NG_FORMAT table 982 is used as an outline for the stitching 604 code which is followed to piece together sections of executable binary code 984 to create a single executable code path that can be directly executed 578 by the CPU without any CALL instructions and/or without any JUMP instructions to pass control from one code fragment 984 to the next code fragment. This may be considered reminiscent of what a modern compiler does when it “inlines” code (inserts the body of a function into the code, rather than calling the function). But whereas a modern compiler would still have a main loop that it returns to, in this method herein described there is no such loop, and all the code is stitched together to create a monolithic code path.

This method 604 can be implemented by using a suitable assembly-language tool such as FASM. One difference in some embodiments between the NG_FORMAT table used for stitching compared to the normal table is that, instead of including the address of each command in the table at position Entry[0], a unique index is used that can be used to reference the address, and the size of the code segment starting at that address, of each respective command, both of which are used to stitch the code together.

To explain the process, assume a very small table 982 with very simple commands 984. One of skill will acknowledge that using a much larger table, or using many very complex commands, does not make the stitching 604 process more difficult—the process is the same no matter the size of the table nor the complexity of the command instructions. Each command instruction 984 occupies an exact number of bytes, so it therefore has a starting and an ending offset. In FASM (as in some other assembly-language compilers), the ‘$’ symbol is used to obtain the current value of the instruction pointer 962 and can be used to easily determine the size of a segment of code.

The command ngStitchCommands( ) 1058 is called to create an executable code path based on a parsed NG_FORMAT table. In this example, one change required when creating the NG_FORMAT table that is passed as a parameter 918 to the ngStitchCommands function 1058 is that each address in the table at Entry[0] is an index to the command, rather than the address. That index is used to obtain the address of each function (which functions as a source pointer 962 to copy the code to another location) and the size of the function (which informs as to how many bytes should be copied). The Listing_{—}6058-2-3A.txt computer program listing appendix file, incorporated herein by reference, includes ngStitch.Asm code showing one implementation that formats a specific string about 20 times faster than an optimized sprintf version written in C++ for MSVC Pro 2008 (Microsoft Visual C++® and its acronym MSVC are marks of Microsoft Corporation).

Some Additional Technical Considerations

Some embodiments include code using a table containing a pointer or address 962 to a command or function for each step in the format process, and including some local data in the table for at least one of the commands. Some embodiments include code creating such a table during execution of the program that uses the table. Some embodiments include code creating such a table prior to executing the program that uses it. Some embodiments include code using addresses or indexes in the table to call functions that return. Some embodiments include code using addresses or indexes in the table as jump addresses to code that does not return to a caller. Some embodiments include code using the table in a manner that lets each code path jump to the next command in sequence. Some embodiments include code using the table to stitch together a custom program that exactly executes the formatting commands, making that custom program available during runtime 1073; option to create the stitched program during runtime; option to create the stitched program offline 1072 and then save it to disk or other storage. Some embodiments include code using such a table to create format strings without creating a standard function stack frame 908. Some embodiments include code creating such a table by using jump tables in a parsing step.

Dealing with a variable number of parameters 918 is relatively starighforward in assembly language. Once a routine has setup the stack frame 908, it knows the positions of the pointer to the buffer (ebp+8), the format-command string (ebp+12), and the first user parameter is in the very next position at (epb+16). It can then rely on the information in the command string to tell whether the next parameter is anything other than 32 bits wide; if not, the next parameter is 4 bytes away. If so, the next parameter is 8 bytes away (for 64-bit integers and doubles, for example). Dealing with a variable number of parameters in C or C++ can be considerably more difficult, due to major constraints that prevent one from full access to the stack 920, namely, access of the kind available in assembly language. A risk exists that the format-command string does not accurately reflect what is passed on the stack; this document provides some information on tools that can identify how many bytes are being passed on the stack. If the command string implies there are more bytes on the stack than are really pushed, in some implementations the parser blindly uses what's on the stack, meaning it could produce gibberish or which, if it's looking for a string pointer and it gets an invalid value, could cause a memory-access error or crash.

Teachings herein can be used to create any type of formatted string 210, and do so faster than familiar methods. Some embodiments handle all the numeric formats generally encountered, plus string and character formats. Some allow for easy alignment (left, center, right) and padding of any single component or group of components (one could, for example, center justify a large section of a formatted string which has, inside of it, smaller sections that are left- or right- or center-justified). Some embodiments can be used for creating html strings, and because those strings are generally quite long and quite verbose, application of the technical teachings herein may prove to be very, very fast compared to pre-existing methods. Here are some reasons why formatting into an output buffer can be very fast after the format control string is first compiled: no format string to parse, no format-string literal characters to count, no format-string null terminators to find, only one stack frame 908 to create no matter how many components exist in the format string, fewer parameters to pass in most cases, few (if any) if/then statements, super-high-velocity number conversions, and less work for the developer once he/she is familiar with our solution. Some embodiments of a printf compiler 970 handle any kind of html output that represent table data, or similarly-formatted lines that are in effect custom printf-type statements with extra format specifiers. Some embodiments will run in web browsers, and some will run in the servers that deliver the data to the browsers.

Some embodiments include ngStitch( ) as an alternative to ngParse( ) to create a custom block of code rather than a table. Instead of a table of pointers to specialized commands, reached by jump instructions or calls, the codes for those commands are concatenated. This will reduce or eliminate even the small overhead of jumps 398 to and from the table. Where ngParse( ) returns an NG_FORMAT table, ngStitch( ) returns a function pointer. Using the stitching algorithm 1074 described herein is one way to create such a table.

Some embodiments include a variant of ngFormat( ) call it ngFormatn( ) which takes vectors/lists/arrays 950 of buffers and variables and produces n formatted strings, each formatted according to the same format string using the same NG_FORMAT table. For example, result=ngFormatn(n, buffers[ ], salesFmt, times[ ], totalSales[ ]) would fill respective buffers (or one big buffer—much the same in some languages) with strings reporting successive times from an array 950 of times and the corresponding sales figures from an array 950 of sales figures. This provides a technical benefit by avoiding the overhead of successive calls when code would have otherwise called ngFormat multiple times with the same format string and successive data values that can already be known.

Some Additional Insight into Handling Null-Terminated Strings

When formatting strings, it is common to copy bytes from one or more user-supplied null-terminated strings into the destination buffer. For very small strings, say, around five or six characters or smaller, copying one byte at a time can be very fast. The Listing_{—}6058-2-3A.txt computer program listing appendix file, incorporated herein by reference, includes a very tight loop labeled CopyBytes: with code that can be used when an entire string is to be copied.

One could speed up this process by unrolling 360 this loop and/or by making other adjustments (load ax or eax, for example, and then store ax or eax at edi), then checking each byte one at a time to ensure that the process exits when the end has been found. For example, consider the code snippet .LoopFaster example in the Listing_{—}6058-2-3A.txt computer program listing appendix file, incorporated herein by reference, which uses some familiar methods. The above process is much faster, requiring up to 11 instructions before finding a zero byte, yet this will have processed four bytes with those 11 instructions. Although the speed has increased, accessing multi-byte data at the first line could cause slower execution if the string address is not properly aligned, or a memory fault if using xmm (or other) registers to process more bytes each time. To address this, one could detect 296 whether the source position is aligned, process the string a byte at a time until it is aligned, and then proceed to operate on dwords at a time. Note that for 32-bit execution environments, four-byte alignment should suffice, and for 64-bit alignment, eight-byte alignment should suffice. (However, it is possible in these, and in larger-bit environments, that the recommended alignment size is different, and so the CPU manufacturer's alignment guidelines should be followed; information about properly aligning data is readily available to one of skill.)

Even in the above processes where the speed has been substantially improved (long strings can be processed at around 11 instructions per every four bytes, instead of 20), achieving very rapid execution becomes increasingly difficult when bytes must be copied from the right end of the string or from some position other than the very first byte, and/or when only a specified maximum number of bytes are to be copied. When the string length is known, one would be able to adjust the above algorithms to copy exactly the correct number of bytes to the exact desired destination. But getting 626 the string length 1060 correctly and efficiently remains a technical consideration that will now be addressed.

The end of a null-terminated string, which determines the string length 1060, can be found by checking each byte of the string to determine if it is a null (zero). Some methods manipulate strings 32 bits at a time, or more, to identify a null. Another method, believed to be a faster general-purpose-register method than any previously described, is presented herein.

When a string's length 1060 is to be determined 626, it can be generally assumed that the string is made up of ASCII characters 885, meaning the range of characters is from 0x00 through 0x7F. For each of these characters, the high bit is clear. In the present method, the alignment of the string's starting address will be first determined (in a 32-bit implementation, a copy of the address will be ANDed with the value 0x03 and four jump entries will be needed to handle each of the four possible alignment conditions; in a 64-bit implementation, the address will be ANDed with 0x07 and eight jump entries will be needed). The jump table will then cause a jump to the proper code path based on the string's alignment, handling each of the four cases: the string is 0-byte aligned, meaning no bytes need be handled separately; it is 1-aligned, meaning three bytes must be handled separately; it is 2-aligned, meaning two bytes must be handled separately; or it is 3-aligned, meaning one byte must be handled separately. One of skill can use any method to handle the 1-, 2, and 3-align cases. Then code will either flow through or jump 398 to the case where the source address has been aligned (it has been determined that in some cases, dealing with aligned source strings can increase execution speed by up to 25 percent).

In this main loop which uses general-purpose registers only, a dword is loaded (in 64-bit execution environments, a qword is loaded, and the value 0x0101010101010101 is used as described below). It has been found that when subtracting the value 0x01010101 from a dword, any byte of that dword that has the value 0x00 (null) will have the high bit set (if the next-higher byte has either the value 0x00 or 0x01, its high bit will also be set, but that is not an issue since this algorithm 1074 will first detect the zero-byte before it). Although it is fast to determine any high bit which was originally cleared to 0 and has now been set to 1, it is actually faster (by at least one instruction) to simply determine if any high bit has changed by appropriately using the XOR instruction. And in such a tight loop of just a few instructions, eliminating even one instruction (as can be done here) can make a noticeable improvement.

The method detects any byte in the register 206 whose high bit has changed after 0x01010101 has been subtracted from it. Any byte having the value 0x80 will have its high bit (which was set to 1) cleared to 0, meaning that the XOR instruction will identify a byte of 0x80 as having its high bit changed, the same as any byte of 0x00. But this is a low-probability occurrence in most strings. First, since most strings do not have any characters higher than 0x7f, any time a high bit has changed, it most likely means that the byte had a value of 0x00. Nonetheless, because a 0x80 character may be in the string, any time a high bit has changed, the code then quickly inspects the high bits to see if it was really a 0x00 byte whose high bit changed to a one (which can be isolated with two instructions). If so, the end of string has been determined and a fast routine can execute to determine exactly which byte was the zero byte; if not, a jump 398 to the proper position to continue searching will occur, and the next dword will be inspected. The Listing_{—}6058-2-3A.txt computer program listing appendix file, incorporated herein by reference, includes a core routine with .FastLoop that is unrolled twice so that the counter is updated only once every eight bytes; one could unroll this more if desired.

The above code segment uses 11 instructions for every eight bytes in the main loop until either a 0x00 or 0x80 is found in any group of four bytes; then, with two additional instructions it isolates the 0x00 byte and branches depending on whether a null byte was found (and finalizes the size) or it continues searching. This algorithm can be expanded to any bit size. Additionally, it can handle Unicode16 characters 885 by substituting the value 0x00010001 (or 0x0001000100010001 for 64-bit execution environments) as the value being subtracted from the register. For Unicode16 characters, other portions of the code should be adjusted (one skilled in the art would recognize where the changes should occur) to accommodate the fact that each character is two bytes wide rather than one. Note that in the above code, the “lea” instruction allows the register 206 holding the value from the source string to be unchanged while a copy of that value, with 0x01010101 subtracted from it, is created by this instruction. This saves execution time since the original source value is needed in the very next instruction that isolates the high bits that have changed.

The above algorithm for getting 626 a string's length 1060 can be changed to a very fast string copy 628 algorithm: each time any bytes from the source are loaded into a register, immediately move (copy) those bytes to the same relative offset pointed to by the destination register (and offset by the eax register when the source position has been similarly offset). This also applies to any bytes handled due to the string address not yet having the desired alignment. Note that the copy commands are commented out in the above code snippet, but show where the instructions could be placed after the MOV and before the LEA instruction.

Other operations on string bytes can also be interleaved with testing for the end-of-string null during a traversal of a string. For example, the bytes loaded in the register could be added or otherwise used to generate 620 a hash 1062 of the string. Or the group of bytes could be tested against target character(s) 885 other than null: to do so, setup beforehand a register (say, the ‘ebx’ register) that contains, in every byte position, the character to be searched for (assume a search for the letter ‘A’, which is 0x41; set ebx to 0x41414141); then, as soon as the data bytes have been loaded and before the LEA instruction, XOR the loaded register with ebx, which will convert any byte with ‘A’ to zero, then follow the same process to find the zero which was an ‘A’ (for unaligned strings, each unaligned byte should be tested directly for the target before the main loop is entered). If it is known beforehand that all the characters are alphabetic, one could use XOR with 0x20202020 to flip the case, use OR with 0x20202020 to force 616 lower case, or use AND with 0xDFDFDFDF to force 616 upper case. Or the group of bytes could be otherwise operated upon.

If the bytes won't be modified but are used to create a hash 1062, or are to be copied, or are to be added to a cumulative sum, for example, the code to do so could be interleaved at any time between the MOV instruction that loads the bytes into the register 206 and the jump 398 statement; if the bytes need to be modified, such as when searching for a letter ‘A’, that modification should take place immediately after the MOV instruction that loads the bytes (since the immediately succeeding LEA instruction acts based upon the value in the loaded register). In some embodiments, if the characters are to be copied, that can happen at many points during traversal (wherever the EDX register 206 is unchanged). Hashing could likewise happen at many such points. Searching for a specific character as described above would take place before the LEA instruction.

As is known, one skilled in the art has some flexibility as to which registers to use for the various purposes in the algorithms 1074 herein, as long as they are used consistently and the requirements of certain CPU functions (such as the MUL and DIV commands for Intel-compatible CPUs) and of the host operating system (the need to preserve certain registers) are respected; as such, different registers could be used to achieve the same or similar results.

In some embodiments, a string may need to be changed 616 to upper case (or lower case), and the process will, of course, need to stop as soon as a null has been found. One method to do this is to replace the first MOV statement, and instead use Convert case code like that shown in Listing_{—}6058-2-3A.txt computer program listing appendix file, incorporated herein by reference.

In testing, the interleaved copying is almost instantaneous. It added only about 10% execution time to the code determining the string length; whereas if one copied the bytes later, after first determining the string length, it would almost double the time required. This is due in part to the way the CPU works at overlapping multiple instructions: the time required to store the data being copied was almost totally overlapped by the other instructions, so this copying introduces almost no overhead when searching for the terminating null. Unlike some approaches, one embodiment requires only 13 instructions for every 8 bytes when copying instructions are inserted into the code above.

Web Pages

Formatting 632 web pages 986 can require substantial work and can benefit from the innovations described in the present document. The terms ‘render’, ‘rendered’, and ‘rendering’ are often used to describe the formatting 632 processes used to create web pages 986 and therefore can be synonyms for ‘format’, ‘formatted’, and ‘formatting’. Web pages 986 are rendered 632 by parsing/compiling a format template 1064, and then formatting them according to the instructions of the template. In practice, rendering templates 1064 can utilize additional programming logic 136 such as if/then/else/elseif logic; do-while, for, repeat-until, and other similar loops; local variables and counters; etc.; implementing the innovations 202, 204 herein described can decrease the time required to render 632 web pages by decreasing the time spent on transforming 302 numbers 208 and/or custom formatting 494 strings during the rendering 632, thereby speeding up both the user-perceived and the actual time required to display web pages on a client device.

### Additional Examples of Combinations

The following examples further illustrate various ways different teachings herein can be highlighted and/or combined.

Some embodiments include a computer-readable storage medium configured with data and with instructions that when executed by at least one processor causes the processor(s) to perform a process (a.k.a., method, algorithm, technique) for digital base conversion and formatting of an original value, the process including the steps of: accessing 410 a table of digit group entries in which entries are at least two characters wide and contain at least one custom formatting character (i.e., comma, space, apostrophe, or period); and stamping 412 copies of table 234 entries into a buffer for output as an integral part of conversion of a digital value from one base to a different base, thereby producing a formatted converted value.

In some embodiments, table 234 entries are four characters wide, and the custom formatting character is a thousands separator (e.g., comma or space) 228. In some, the stamping proceeds 534 from left-to-right, namely, from most significant to least significant digit group.

In some embodiments, the process further includes funnel 222 testing each of at least two digit group subsets of the original value, and the stamping step is interleaved with the funnel testing step, and funnel testing tests the size of a digit group subset, and a subset is not necessarily a proper subset and includes one or more digit groups 224.

In some embodiments, reinterpret-cast operations 390 are part of the funnel testing step. These reinterpret-cast operations 390 treat a group of characters as a word, dword, or other set of byte data rather than interpreting them as characters.

In some embodiments, the process further includes pushing and popping 332 at least one digit group of the original value on/off a stack, and the stamping proceeds 526 from right-to-left, namely, from least significant to most significant digit group; a variation uses a queue or other buffer instead of a stack.

In some embodiments, the buffer includes safety zones 818 and the stamping overwrites at least part of at least one safety zone.

In some embodiments, the table 234 entries include entries consistent with at least one of the following table entry descriptions:

(a) ‘000’, ‘001,’ through ‘999,’;
(b) ‘,000’, ‘001’ through ‘,999’;
(c) ‘000’ ‘001’ through ‘999’;
(d) ‘ 000’ ‘001’ through ‘ 999’;
(e) ‘0000″0001’ through ‘9999’;
(f) ‘000\n″001\n’ through ‘999\n’ where \n indicates a null;
(g) ‘−999″−998’ through ‘0000’ or another zero identifier through ‘+998″+999’;
(h) ‘−999″−998’ through ‘0000’ or another zero identifier through ‘ 998″ 999’;
(i) ‘(99)“(98)’ through ‘ 00’ through ‘ 98” 99’;
(j) ‘0’ through ‘999’.

In some embodiments, the process includes converting 302 a binary integer original value, or a binary fixed-point original value, or a binary floating-point original value, into a decimal formatted converted value.

In some embodiments, the process includes using at least one other table 218 to identify a scale factor and then using 482 the scale factor to loop through digit groups of the original value in a loop that performs the accessing and stamping steps; a variation unwinds (a.k.a. unrolls) the loop.

In some embodiments, the process includes placing 366 digit groups in at least two of the following manners in the output buffer: overlapping digit groups, adjacent digit groups, digit groups spaced apart by less than the maximum number of characters in a digit group.

In some embodiments, the process includes converting 384 a binary integer original value into a binary floating-point value and from there into a decimal formatted converted value 210; a variation converts a binary floating-point original value into a binary integer value and from there into a decimal formatted converted value.

In some embodiments, the number of bytes in each entry of the table 234 is 4 or 8 or 16.

In some embodiments, the process includes using 338 part of an exponent of the original value as an index into a table of powers of P, where P is a power of ten. In some embodiments, all the exponent bits are used 338, and in some the exponent and more bit(s) from another component of the floating-point value are used 338 as an index into a table of powers of P.

In some embodiments, the process integrates digital base conversion 490 with custom formatting 494 in response to a call to a printf-style function 924 (namely, printf or another function guided by a format string which accepts one or more literal values 943, variable names, and/or format specifiers).

In some embodiments, the buffer is initialized 634 with pad characters (e.g., space, asterisk, period) 246.

In some embodiments, the table 234 entries are in 2-byte characters, e.g., Unicode16.

In some embodiments, multiple output formats are dynamically selectable 438 by a user without changing calls for formatting individual numbers.

In some embodiments, the process performs digital base conversion 490 in part by obtaining 442 a division remainder by a multiplication operation of a recently obtained quotient rather than performing a modulus (“get remainder”) operation.

In some embodiments, multiple individual converted formatted outputs are produced 560 and displayed. In some these outputs are displayed 454 one after another at successive locations so that each output can still be seen even after subsequent outputs are produced, and in some they are displayed 456 one after another at the same location with subsequent outputs overwriting prior outputs.

Some embodiments provide a computer system 102 including: a logical processor 112; a memory 114 in operable communication with the logical processor; a set of one or more tables 216 residing in the memory and having content which functions in cooperation with digital base conversion code 202 to convert a digital number from one base to another base; and digital base conversion code 202 residing in the memory which upon execution by the processor performs any of the methods described and/or claimed herein.

In some embodiments, the system includes custom formatting code 404 integrated with the digital base conversion code 202 to convert a digital number from one base to a custom formatted representation in another base.

Some embodiments provide configured non-transitory (i.e., not a mere propagated signal) computer-readable storage medium or memory with table data and executable instructions to perform any method (namely, process, algorithm, or technique) described and/or claimed herein.

Some embodiments provide data structure, such as a computer-readable memory configured with any one or more tables 216, 982 described and/or claimed herein, with base conversion and/or custom formatting functionality described and/or claimed herein.

In some embodiments, a process includes using 304 MagicNumbers without any additional shift, in a context in which all possible inputs will work without that shift; thereby saving execution time. In some, a process includes quickly verifying 372 a MagicNumber-plus-shift combination. In some, a process includes converting 304 binary integer into decimal via MagicNumber-plus-shift sequence, thereby allowing super-fast extraction 444 of triplets by moving the next triplet to the edx (or rdx) register by multiplying the eax (or rax) register by 1000.

Some embodiments provide a process that includes super-fast conversion 302 of IP addresses 964 by obtaining a formatted table with values from “000:” to “255:” (or from “0:” to “255:”), a user having specified the IP address either as one 32-bit binary integer or as four separate numbers (any bit size); using each byte as an index in the IP lookup-table, grabbing each entry, and stuffing it in a buffer. (If no leading 0's are used, for each entry have a length table that gives the length for each entry to help with adjusting the buffer destination pointer.)

Some embodiments provide a table-based method of converting binary integer to decimal format wherein one table 234 is used for the first leading triplet, and a second table 234 is used for all remaining triplets (i.e., two tables used). Some provide a table-based process which includes, when formatting a first leading triplet, using a non-formatted triplets table (with values from “0” to “999”) for both comma and non-comma formatting. If the TripletsComma table 234 has prepended commas, for example, one can save some memory, and reduce table count.

Some embodiments use negative values as indexes into a table 234 by adding a displacement value.

Some embodiments use Pos/NegRoundingTables as described herein. Some use a TieBreaker method when rounding, as described herein.

Some embodiments use a Doubles10 table to be indexed both as a Doubles10 table (creating and using Index2Doubles10) and as a Doubles1000 table (creating and using Index2Doubles1000 which looks only at this Doubles10 table—this saves memory).

Some embodiments provide a computer-readable storage medium configured with data and with instructions that when executed by at least one processor causes the processor(s) to perform a technical process for generating 494 an application-specified formatted output string from values within a computing device, the process including the steps of: parsing 580 at runtime a format control string 942 which includes at least one literal (i.e., non-parameter) portion 943 and at least one reference 945 to a non-literal parameter; and based on the parsing, compiling 576 at runtime 1073 a custom implementation of a printf-style function. In some embodiments, the table 982 of commands includes code pointers 962 and space for parameter 918 values.

In some embodiments, the parsing and compiling steps produce as part of the custom implementation a table 982 of commands and upon execution 578 by at least one processor and provision of a particular non-literal parameter the custom implementation will generate an output string that conforms to the format control string 942 and contains a then-current value of the particular non-literal parameter 918.

In some embodiments, the process includes invoking 544 commands of the table in sequence by executing CALL instructions 1068. In some, the process includes invoking 544 commands of the table in sequence by executing JUMP instructions 1066.

In some embodiments, the process includes invoking 544, 578 the custom implementation 982 multiple times after the parsing and compiling steps, without repeating the parsing 580 or compiling 576 steps, thereby generating multiple output strings containing multiple respective non-literal parameter values.

In some embodiments, the parsing and compiling steps produce as part of the custom implementation a stitched 604 sequence 982 of code fragments 984 which are free of command/fragment-invoking JUMP instructions 1066 and also free of command/fragment-invoking CALL instructions 1068. For example, in some embodiments neither a JUMP nor a CALL instruction is used to invoke the commands of the table, because the instructions are inlined or otherwise free of reliance on a JUMP or CALL to invoke them. Upon execution by at least one processor and provision of a particular non-literal parameter 918 the custom implementation will generate an output string that conforms to the format control string and contains a then-current value of the particular non-literal parameter.

In some embodiments, the format control string 942 conforms with one of the following: an established percentage-sign-based syntax 996, an established curly-brace-based syntax 996.

In some embodiments, the commands 984 of the custom implementation 982 include a copy-three-characters command 984 and a copy-four-characters command 984. In some, the code fragments 984 of the custom implementation 982 include a copy-two-characters fragment 984 and a copy-three-characters fragment 984.

In some embodiments, the process further includes determining 608 a parameter call stack position and a parameter call stack size for the non-literal parameter.

In some embodiments, the parsing step 580 includes utilizing a jump table 232 containing an entry for each character 885 that can appear in a format control string 942.

Some embodiments provide a computer system 102 including: a logical processor 112; a memory 114 in operable communication with the logical processor; and a custom implementation 204 of a printf-style function residing in the memory and having a customized format sequence 982 corresponding to a particular format control string, the customized format sequence including commands and/or code fragments 984, the customized format sequence upon execution interacting with the processor and memory to generate an application-specified formatted output string 210 from values within the memory.

In some embodiments, the custom implementation includes at least one of the following: a prefix function 1040 for formatting positive numbers versus negative numbers, a post-fix function 1042 for formatting positive numbers versus negative numbers.

In some embodiments, the custom implementation includes code 204 to create a formatted display string 210, and to also simultaneously create an index into that string that can be used to quickly identify 597 a position 1044 and/or identify 597 a length 1046 for any selected formatted element 1048 of the display string 210.

In some embodiments, the custom implementation includes code to parse the format control string by if-less processing 222.

In some embodiments, the custom implementation includes code fragments 984 stitched 604, without command/fragment-invoking CALL instructions or command/fragment-invoking JUMP instructions, into a single executable code path 1070 that can be directly executed by the processor.

Some embodiments use a table data structure 982 to stitch 604 together a custom implementation 976, 204 that executes the formatting commands. Some make that custom implementation available during runtime 1073. Some provide an option to create 604 the stitched custom implementation during runtime 1073. Some provide an option to create the stitched custom implementation offline 1072 outside a program 132 and then save it to disk or other non-volatile storage for later use by the program 132.

Some embodiments use such a table 982 to create format strings without creating a standard function stack frame 908.

Some embodiments create such a table 982 by using jump tables 232 in a format control string parsing step 580.

Some embodiments include in a table 982 of commands of a custom implementation of formatting capability at least two of the following commands 984: CopyStr<n> for n=2 through 10, Tab, OpenBrace, Left, Align_left, Align_center, Right, F_Open, CloseNum, Mark, Mark_right, CloseBrace, Index. Some include one or more commands 984 to perform 490 a numeric base conversion. Some embodiments include software 136 or hardware circuitry 120 defining a customized format sequence of a custom implementation of formatting capability having at least two of the following: CopyStr<n> for n=2 through 10, Tab, OpenBrace, Left, Align_left, Align_center, Right, F_Open, CloseNum, Mark, Mark_right, CloseBrace, Index. More generally, software 136 and special-purpose hardware 120 can often be interchanged.

Some embodiments provide a system 102 including: at least one processor 112; a memory 114 in operable communication with the processor(s) and containing a format control string 942 which is a parameter 918 of a printf-style function 924, the format control string including at least one literal portion 943 and also including at least one reference 945 to a non-literal parameter; and a custom implementation 982 of the printf-style function, the custom implementation being specific to the format control string in that the custom implementation includes code fragments 984 which are sequenced 579 to correspond to the literal portion(s) and the parameter reference(s) of the format control string, the custom implementation further characterized in that execution 578 of the custom implementation by the processor produces a string 210 which is formatted as directed in the format control string.

Some embodiments include software 136 logic or hardware circuitry 120 defining a customized format sequence of a custom implementation of formatting capability which takes vectors/lists/arrays 950 of one or more buffers 212 and multiple variables 918 and produces 560 n formatted strings, each formatted according to the same format control string 942. Variations produce indexes giving the positions 1044 of key items in each string 210.

Some embodiments include a method of and means for determining 636 the length 1060 of a null-terminated string using general-purpose registers of a CPU, the method including subtracting the value 0x01 from each byte being inspected in a single operation (e.g., subtract 0x01010101 from a 32-bit register holding four bytes; or subtract 0x0101010101010101 from a 64-bit register holding eight bytes; etc.), followed immediately by XORing that result with the original values of the bytes being inspected, followed immediately by ANDing that result with the value 0x80 for each byte (i.e., 0x80808080 for 32 bits, 0x8080808080808080 for 64 bits, etc.) to create the value X (e.g., there are only three instructions between having loaded the group of bytes and the jump instruction that transfers to the proper code path as described in the following), and then immediately jumping to the top of the loop if X=0 in order to inspect the next group of bytes; and if X is not zero, then immediately reversing all the bits of the original group of four bytes, and ANDing that value against X to produce the value Y, which will equal 0 if there were no 0 bytes in the group, otherwise the lowest set bit in the value Y represents the high bit of a zero byte in that group of bytes (e.g., when X has been determined to not be 0, two instructions only are executed before the next jump takes place); then, if Y=0, transferring control back to the main loop, otherwise determining which byte was the 0 byte and adjusting the size to reflect the actual size of the null-terminated string. One set of variations includes unrolled loop 812 methods of the foregoing. A means 636 for determining 636 the length 1060 of a null-terminated string includes code in assembly language and/or another programming language which performs this method.

Some embodiments include a method of copying 628 a string to a destination by using the length-determining 636 algorithm of the preceding paragraph but inserting a single MOVE statement within the next four instructions after the group of bytes was loaded into a register. A means 628 for copying 628 a string includes code in assembly language and/or another programming language which performs this method.

Some embodiments include a method of and means for traversing 638 a string, including determining 620 the alignment of the string's starting address, through a jump table 232 then causing a jump to a code path based on the string's alignment, handling each of at least four cases: the string is 0-byte aligned, meaning no bytes will be handled separately; it is 1-aligned, meaning three bytes will be handled separately; it is 2-aligned, meaning two bytes will be handled separately; or it is 3-aligned, meaning one byte will be handled separately, and then either flowing through or jumping to code for the case where the source address has been aligned. A means for traversing 638 a string includes code in assembly language and/or another programming language which performs this method.

Some embodiments include a method of and means for traversing 638 bytes of a string, including subtracting 0x01 from each byte, XORing that subtraction result with the original byte, ANDing that XOR result with the value 0x80 for each byte, and interleaving at least one of the following byte-wise operations 1076 with the subtracting, XORing, and ANDing steps: searching 640 for a null that terminates the string, copying 628 bytes of the string, hashing 630 bytes of the string, searching 640 for a particular character in the string, performing another byte-wise operation 1076 on the string. A means 640, 628, 630, 640 for performing the corresponding operation on a string includes code in assembly language and/or another programming language which performs the respective method 640, 628, 630, or 640.

### CONCLUSION

Although particular embodiments are expressly illustrated and described herein as processes, as configured media, or as systems, it will be appreciated that discussion of one type of embodiment also generally extends to other embodiment types. For instance, the descriptions of processes also help describe configured media, and help describe the technical effects and operation of systems and manufactures. It does not follow that limitations from one embodiment are necessarily read into another. In particular, processes are not necessarily limited to the data structures and arrangements presented while discussing systems or manufactures such as configured memories.

Specific features of an example may be omitted, renamed, grouped differently, repeated, instantiated in hardware and/or software differently, or be a mix of features appearing in two or more of the examples. Functionality discussed as being at one location herein may also be provided at a different location in some embodiments.

Reference herein to an embodiment having some feature X and reference elsewhere herein to an embodiment having some feature Y does not exclude from this disclosure embodiments which have both feature X and feature Y, unless such exclusion is expressly stated herein. The term “embodiment” is merely used herein as a more convenient form of “process, system, article of manufacture, configured computer readable medium, and/or other example of the teachings herein as applied in a manner consistent with applicable law.” Accordingly, a given “embodiment” may include any combination of features disclosed herein, provided the embodiment is consistent with at least one claim.

Any apparent inconsistencies in the phrasing associated with a given item in the text should be understood as simply broadening the scope of what is referenced. Different instances of a given item may refer to different embodiments, even though the same item name is used.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims as filed are part of the specification.

While exemplary embodiments have been described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

Although some possibilities are illustrated here by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways without necessarily omitting desired technical effects from the collection of interacting modules viewed as a whole.

All changes which fall short of enveloping an entire abstract idea but come within the meaning and range of equivalency of the claims are to be embraced within their scope to the full extent permitted by law.

1. A computer-readable storage medium (114) configured with data (118) and with instructions (116) that when executed by at least one processor (112) causes the processor(s) to perform a technical process comprising the steps of:
parsing (580) a format control string (942) which is a parameter (918) of a printf-style function (924), the format control string including at least one literal portion (943) and also including at least one reference (945) to a non-literal parameter; and
compiling (576) a custom implementation (982) of the printf-style function, based on the parsing, by selecting (577) and sequencing (579) code fragments (984), the custom implementation being specific to the format control string in that the code fragments are selected and sequenced to correspond to the literal portion(s) and the parameter reference(s) of the format control string.

2. The computer-readable storage medium of claim 1, wherein the format control string has at least one of the following syntaxes: a percent-based syntax, a curly-brace-based syntax.

3. The computer-readable storage medium of claim 1, wherein the parsing step comprises utilizing (398) a jump table (232) which contains an entry (820) for each character that can appear in a format control string.

4. The computer-readable storage medium of claim 1, wherein the format control string parsing and the custom implementation compiling steps are performed during a runtime (1073) of a program (132) after the printf-style function has been invoked (544) in the program.

5. The computer-readable storage medium of claim 1, wherein the compiling step comprises stitching (604) code fragments together to create a single executable code path (1070) that can be directly executed (578) without any CALL instructions (1068) to pass control from one code fragment to the next code fragment.

6. The computer-readable storage medium of claim 1, wherein the code fragments of the custom implementation comprise at least two of the following: a copy-two-characters fragment, a copy-three-characters fragment, a copy-four-characters fragment.

7. The computer-readable storage medium of claim 1, wherein the method further comprises executing (578) the custom implementation after the parsing and compiling steps, thereby producing a formatted string (210), and then repeating the executing step at least once with the same custom implementation without repeating the parsing step and without repeating the compiling step in between the executing steps.

8. The computer-readable storage medium of claim 1, wherein the method further comprises executing (578) the custom implementation after the parsing and compiling steps, thereby producing a formatted string (210), and identifying (597) a position 1044 for a selected formatted element (1048) of the formatted string.

9. The computer-readable storage medium of claim 1, wherein the format control string includes at least one reference to a non-literal parameter which is a numeric type, and the method further comprises base converting (490) a value supplied for the non-literal parameter from a binary representation into a decimal format string at least in part by placing (366) digit groups (224) which contain at least four characters (885), thereby using (364) a table (234) whose entries (820) include the digit groups.

10. The computer-readable storage medium of claim 1, wherein at least one of the following conditions is satisfied:
the method comprises digital base conversion (490) integrated with custom formatting (494) in response to an invocation (544) of the printf-style function;
the method further comprises a batching conversion (560) step which converts (490) multiple numbers (208) of a single array (950) in one call (544) which passes at least one of the following as a parameter (918) of the call: the array, a pointer (962) to the array.

11. A system (102) comprising:
at least one processor (112);
a memory (114) in operable communication with the processor(s) and containing a format control string (942) which is a parameter (918) of a printf-style function (924), the format control string including at least one literal portion (943) and also including at least one reference (945) to a non-literal parameter; and
a custom implementation (982) of the printf-style function, the custom implementation being specific to the format control string in that the custom implementation includes code fragments (984) which are sequenced (579) to correspond to the literal portion(s) and the parameter reference(s) of the format control string, the custom implementation further characterized in that execution (578) of the custom implementation by the processor produces a string (210) which is formatted as directed in the format control string.

12. The system of claim 11, wherein the custom implementation comprises functionality of at least three of the following code fragments (984): CopyStr2, CopyStr3, CopyStr4, CopyStr5, CopyStr6, CopyStr7, CopyStr8, CopyStr9, CopyStr10, Tab, OpenBrace, Left, Align_left, Align_center, Right, F_Open, CloseNum, Mark, Mark_right, CloseBrace, Index.

13. The system of claim 11, wherein the custom implementation comprises code fragments (984) which are stitched (604) together in sequence without any JUMP instructions (1066) and without any CALL instructions (1068) present to transfer control from one code fragment to the next code fragment in the sequence of code fragments.

14. The system of claim 11, wherein the custom implementation comprises code fragments (984), and also comprises a header (1012) which contains a pointer (962) to the first code fragment.

15. The system of claim 11, further comprising printf-style function library code (204) which upon execution by the processor parses (580) the format control string and compiles (576) the custom implementation based on the parsing by selecting (577) and sequencing (579) the code fragments to correspond to the literal portion(s) and the parameter reference(s) of the format control string.

16. The system of claim 11, further comprising digital base conversion code (202) which upon execution by the processor utilizes (364) at least one digit group (224) table (234) to convert (490) a value supplied for the non-literal parameter from a binary representation into a formatted string (210).

17. The system of claim 11, further comprising at least one of the following:
a funnel (222) to identify (318) a size range (804) for a number (208);
a safety zone (818) in an output buffer (212);
a web page (986) which is formatted (632) at least in part by execution of the custom implementation.

18. The system of claim 11, further comprising at least one of the following:
a length determining means (636) for determining the length of a null-terminated string;
a searching means (640) for searching for a null that terminates a string;
a copying means (628) for copying bytes of a string;
a hashing means (630) for hashing bytes of a string;
a searching means (640) for searching for a particular character in a string.

19. The system of claim 11, further comprising at least one of the following:
a table (238) of powers of P, where P is a power of ten;
a user-specified template (240) defining at least two of the following: digit groups (224), separation character (228), decimal point character (242);
a table (258) containing reciprocal values (840) for use in multiplication (304) operations;
a rounding table (260);
a table (262) for size estimation (408).

20. The system of claim 11, further comprising a table (234) which has entries (820) consistent with at least one of the following table entry descriptions:
(a) ‘000,’ ‘001,’ through ‘999,’;
(b) ‘,000’‘,001’ through ‘,999’;
(c) ‘000’ ‘001’ through ‘999’;
(d) ‘000’ ‘001’ through ‘999’;
(e) ‘0000’ ‘0001’ through ‘9999’;
(f) ‘000\n’ ‘001\n’ through ‘999\n’ where \n indicates a null;
(g) ‘−999’ ‘−998’ through ‘0000’ or another zero identifier through ‘+998’ ‘+999’;
(h) ‘−999’ ‘−998’ through ‘0000’ or another zero identifier through ‘ 998’ ‘999’;
(i) ‘(99)’ ‘(98)’ through ‘ 00’ through ‘ ‘98’ 99’;
(j) ‘0’ through ‘999’.
